(19) United States
(12) Patent Application Publication
(10) Pub. No.: US 2004/0257610 A1
(43) Pub. Date: Dec. 23, 2004

(54) Service providing apparatus that shares print environments

(76) Inventors: Masanori Itoh, Yokohama-shi (JP); Hiroshi Hiraki, Saitama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/804,000

(22) Filed: Mar. 19, 2004

(30) Foreign Application Priority Data
Mar. 20, 2003 (JP) 2003-078990
Mar. 20, 2003 (JP) 2003-078991
Mar. 20, 2003 (JP) 2003-078992
Mar. 17, 2004 (JP) 2004-076964
Mar. 17, 2004 (JP) 2004-076965
Mar. 17, 2004 (JP) 2004-076966

(51) Int. Cl. G06F 15/00; G06F 15/16; G06F 3/12; G06F 15/167

(52) U.S. Cl. 358/1.15; 709/203; 358/1.16; 709/213

(57) ABSTRACT

A service providing apparatus for sharing print environment is disclosed. The service providing apparatus includes a first sharing unit that shares print environment thereof with other apparatuses. The first sharing unit further includes a connection management unit that manages the connecting of the first sharing unit to a second sharing unit of another apparatus, and a transfer unit that transfers at least one of reservation information and a document related to a print reservation to the second sharing unit. The service providing apparatus enables a user to share print environment thereof.

### BACKGROUND OF THE INVENTION

1. Field of the Invention

The present invention generally relates to a service providing apparatus, and more particularly, to a service providing apparatus that shares print environments, a method of providing print environment sharing services, and a computer program that manages connection and disconnection.

2. Description of the Related Art

The processing capability of central processing units (CPUs) has been improved, and notebook computers (PC) are widely used. Printers are also widely used for printing documents prepared with PCs.

A PC is generally connected to a printer via a local area network (LAN) in a office. The PC requires a computer program called a printer driver for printing a document using a printer. The printer driver is installed in the PC in advance.

When a user attends a meeting out of the office, the user may take the user's PC. The user may want to print a document using a printer nearby.

The user can store the document in a recording medium such as a flexible disk, and take the document to the meeting room. The user can ask someone to print the document.

On the other hand, systems that can provide print service via a network are often used.

Japanese Laid-Open Patent Application No. 2003-15848, for example, discloses a server that can provide print service to users. In response to receipt of information about the user and a location where the user wants to print, the server identifies printers located close to the designated location, and sends the user (user's terminal) the information of the printers. In response to receipt of the information of the printers, the user selects one of the printers, and sends print data to the server. In response to receipt of information of the selected printer and the print data, the server transfers the print data to the selected printer.

However, the user may not want to take a heavy PC to the location where the meeting is to be held. The battery of the PC may not last long.

Even if the user takes her PC to the location, the user needs to change the various settings of the PC so as to hook up the PC to a LAN or a printer. The user may need to install the printer driver of the printer that the user is going to use.

It is not so easy to establish a print environment at a remote location.

The user can store the document in a recording medium, and take the recording medium with her. However, if an application program that is not so usual is used to create the document, the user cannot print the document using other PCs unless the unusual application program is installed in the other PCs.

The system disclosed in the above document still carries the following problems. If the system expands and the number of printers included in the system increases, the system cannot search for printers close to a designated location as quickly as expected. Additionally, if a printer is relocated due to a change in office layout, for example, and a new printer is added to the system, printer data stored in a server need to be updated since the server retains printer address, printer name, and information about printer drivers, for example. The system may not be practically operable.

Additionally, according to the system disclosed in the above document, a server is connected to each printer 1-to-1. Since the system requires a communication route to each printer, communications between the server and the printer are at risk.

### SUMMARY OF THE INVENTION

Accordingly, it is a general object of the present invention to provide a novel and useful print service providing apparatus in which at least one of the above problems is eliminated.

Another and more specific object of the present invention is to provide a print service providing apparatus that can share print environments with a user terminal and can quickly print a document requested by the user at a designated location maintaining the security of the document.

Yet another object of the present invention is to provide a system including the print service providing apparatus that can be easily built up and be modified.

To achieve at least one of the above objects, an apparatus according to an aspect of the present invention includes:

a first sharing unit that shares a print environment thereof with other apparatuses,

wherein

the first sharing unit further comprises:

a connection management unit that manages the connecting of the first sharing unit to a second sharing unit of another apparatus; and

a transfer unit that transfers at least one of reservation information and a document related to a print reservation to the second sharing unit.

According to another aspect of the present invention, an apparatus may include:

a first sharing unit that shares a print environment thereof with other apparatuses,

wherein

the first sharing unit further comprises:

a search unit that searches for a printer location; and

a transfer unit that transfers at least one of reservation information and a document related to a print reservation to the second sharing unit.

According to yet another aspect of the present invention, a service providing apparatus may include:

a screen data providing unit that provides data related to a screen to a user terminal in response to a request from the user terminal; and

a print reservation request transmission unit that transmits a reservation request to a print environment sharing service providing unit in response to the request from the user terminal,

wherein

the service providing apparatus is included in a print environment sharing service providing system, the system comprising:

at least one print environment sharing service providing apparatus including a print environment sharing service providing unit that provides a sharing service of a print environment;

the service providing apparatus; and

the user terminal.

Other objects, features, and advantages of the present invention will become more apparent from the following detailed description when read in conjunction with the accompanying drawings.

### BRIEF DESCRIPTION OF THE DRAWINGS

FIG. 1 is a network diagram showing a system according to an embodiment;

FIG. 2 is a schematic diagram showing the software structure of a SPS server according to an embodiment;

FIG. 3 is a schematic diagram showing the hardware structure of the SPS server according to an embodiment;

FIG. 4 is a conceptual diagram for explaining a connection request;

FIGS. 5A through 5C are schematic diagrams for explaining the adding of data to a service list according to an embodiment;

FIG. 6 is a conceptual diagram for explaining a disconnection request;

FIGS. 7A through 7C are schematic diagrams for explaining the deleting of data from the service list according to an embodiment;

FIG. 8 is a conceptual diagram for explaining the connection request according to an embodiment;

FIG. 9 is a schematic diagram for explaining the adding of data to the service list;

FIG. 10 is a conceptual diagram for explaining the disconnection request according to an embodiment;

FIG. 11 is a schematic diagram for explaining the deleting of data from the service list;

FIG. 12 is a conceptual diagram for explaining a connection request;

FIGS. 13A-13B is a schematic diagram for explaining the adding of data to the service list;

FIG. 14 is a conceptual diagram for explaining a disconnection request;

FIGS. 15A-15B are schematic diagrams for explaining the deleting of data from the service list;

FIG. 16 is a schematic diagram for explaining the functions of the SPS server according to an embodiment;

FIG. 17 is a conceptual diagram for explaining the checking of consistency;

FIG. 18 is a flow diagram for explaining connection processing according to an embodiment;

FIG. 19 is a flow diagram for explaining connection processing according to an embodiment;

FIG. 20 is a flow diagram for explaining connection processing according to an embodiment;

FIGS. 21A and 21B are schematic diagrams showing the interface (I/F) of an “addServiceList” method according to an embodiment;

FIGS. 22A and 22B are schematic diagrams showing the I/F of an “checklist” method according to an embodiment;

FIGS. 23A and 23B are schematic diagrams showing the I/F of an “sendInfo” method according to an embodiment;

FIGS. 24A and 24B are schematic diagrams showing the I/F of an “changeServiceList” method according to an embodiment;

FIGS. 25A and 25B are schematic diagrams showing the I/F of an “changeLog” method according to an embodiment;

FIGS. 26A and 26B are schematic diagrams for explaining the checking of consistency;

FIGS. 27A and 27B are schematic diagrams for explaining the checking of consistency;

FIGS. 28A and 28B are schematic diagrams for explaining the checking of consistency;

FIGS. 29A-29D are schematic diagrams for explaining service connection/disconnection screens according to an embodiment;

FIGS. 30A-30B are schematic diagrams for explaining the selecting of print location according to an embodiment;

FIG. 31 is a sequence chart for explaining the transferring of reservation information;

FIG. 32 is a schematic diagram for explaining the I/F of a reservation transfer method according to an embodiment;

FIG. 33 is a block diagram showing the functional structure of an MFP according to an embodiment;

FIG. 34 is a block diagram showing the hardware structure of the MFP according to an embodiment;

FIG. 35 is a network diagram showing a system according to another embodiment;

FIG. 36 is a schematic diagram showing the software structure of the SPS server according to another embodiment;

FIG. 37 is a schematic diagram showing the functional structure of the SPS server according to an embodiment;

FIGS. 38A-38G are schematic diagrams for explaining the searching for a print location according to an embodiment;

FIG. 39 is a sequence chart for explaining the searching for a print location according to an embodiment;

FIGS. 40A-40E are schematic diagrams for explaining the searching for a print location according to an embodiment;

FIG. 41 is a sequence diagram for explaining the searching for a print location according to another embodiment;

FIG. 42 is a network diagram for explaining a system according to another embodiment;

FIGS. 43A-43C are schematic diagrams for explaining the searching for a print location according to an embodiment;

FIG. 44 is a sequence diagram for explaining the searching for a print location according to another embodiment;

FIG. 45 is a schematic diagram of a service list of a print environment sharing service (A-1) according to an embodiment;

FIG. 46 is a network diagram showing a system according to an embodiment;

FIGS. 47A-47E are schematic diagrams for explaining the searching for a print location according to an embodiment;

FIG. 48 is a sequence chart for explaining the searching for a print location according to an embodiment;

FIGS. 49A-49E are schematic diagrams for explaining the searching for a print location according to an embodiment;

FIG. 50 is a sequence chart for explaining the searching for a print location according to an embodiment;

FIG. 51 is a sequence chart for explaining the searching for a print location according to an embodiment;

FIG. 52 is a sequence chart for explaining the searching for a print location according to an embodiment;

FIG. 53 is a sequence chart for explaining the acquiring of a printer list according to an embodiment;

FIG. 54 is a sequence chart for explaining the acquiring of a printer list according to another embodiment;

FIG. 55 is a schematic diagram for explaining a printer list according to an embodiment;

FIGS. 56A-56C are schematic diagrams for explaining the selecting of a printer according to an embodiment;

FIG. 57 is a sequence diagram for explaining the acquiring of printer capability information according to an embodiment;

FIGS. 58A and 58B are schematic diagram for explaining the setting of print conditions;

FIG. 59 is a sequence chart for explaining a print reservation request and a print start request according to an embodiment;

FIGS. 60A and 60B are schematic diagrams for explaining the starting of print according to an embodiment;

FIGS. 61A and 61B are schematic diagrams showing the interface (I/F) of a print reservation method according to an embodiment;

FIGS. 62A and 62B are schematic diagrams showing the interface (I/F) of a print start method according to an embodiment;

FIGS. 63A and 63B are schematic diagrams showing the interface (I/F) of a reservation overview acquisition method according to an embodiment;

FIG. 64 is a schematic diagram showing the interface (I/F) of a reservation information transfer method according to an embodiment;

FIGS. 65A and 65B are schematic diagrams showing the interface (I/F) of a SPS overview acquisition method according to an embodiment;

FIGS. 66A and 66B are schematic diagrams showing the interface (I/F) of a SPS information acquisition method according to an embodiment;

FIGS. 67A and 67B are schematic diagrams showing the interface (I/F) of a printer overview acquisition method according to an embodiment;

FIGS. 68A and 68B are schematic diagrams showing the interface (I/F) of a print property acquisition method according to an embodiment;

FIG. 69 is a schematic diagram showing the interface (I/F) of a route information acquisition method according to an embodiment;

FIG. 70 is a schematic diagram showing a reservation management information list according to an embodiment;

FIG. 71 is a schematic diagram showing a reservation information list according to an embodiment;

FIG. 72 is a schematic diagram showing reservation detail information according to an embodiment;

FIG. 73 is a schematic diagram showing the functional structure of a SPS server according to another embodiment;

FIG. 74 is a schematic diagram showing an exemplary software structure of a Web server according to an embodiment of the present invention;

FIG. 75 is a schematic diagram showing an exemplary hardware configuration of a Web server according to an embodiment of the present invention;

FIG. 76 is a schematic diagram showing an exemplary functional structure of a Web server according to an embodiment of the present invention;

FIG. 77 is a schematic diagram showing an exemplary functional structure of a PDA according to an embodiment of the present invention;

FIGS. 78A through 78E are schematic diagrams for explaining an exemplary document selection operation according to an embodiment of the present invention;

FIG. 79 is a sequence diagram for explaining an exemplary document selection operation according to an embodiment of the present invention;

FIG. 80 is a sequence diagram for explaining an exemplary print location search operation according to an embodiment of the present invention;

FIG. 81 is a schematic diagram showing exemplary HTML data corresponding to a print location selection result display screen according to an embodiment of the present invention;

FIG. 82 is a sequence diagram for explaining another exemplary print location search operation according to an embodiment of the present invention;

FIG. 83 is a sequence diagram for explaining an exemplary print location search operation according to an embodiment of the present invention;

FIG. 84 is a sequence diagram for explaining an exemplary print location search operation according to an embodiment of the present invention;

FIG. 85 is a schematic diagram showing an exemplary system structure according to an embodiment of the present invention;

FIG. 86 is a schematic diagram for explaining an exemplary print location map display operation according to an embodiment of the present invention;

FIG. 87 is a sequence diagram for explaining an exemplary print location map display operation according to an embodiment of the present invention;

FIG. 88 is a sequence diagram for explaining another exemplary print location search operation according to an embodiment of the present invention;

FIG. 89 is a sequence diagram for explaining an exemplary printer list acquisition operation according to an embodiment of the present invention;

FIG. 90 is a sequence diagram of an exemplary printer list acquisition operation according to an embodiment of the present invention;

FIG. 91 is a sequence diagram for explaining an exemplary printer capability information acquisition operation according to an embodiment of the present invention;

FIG. 92 is a sequence diagram for explaining an exemplary print reservation request and print start request operation according to an embodiment of the present invention;.

FIG. 93 is a schematic diagram showing another exemplary functional structure of a Web server according to an embodiment of the present invention;

FIG. 94 is a schematic diagram showing another exemplary functional structure of PDA according to an embodiment of the present invention;

FIG. 95 is a schematic diagram showing exemplary XML data involved in a screen according to an embodiment of the present invention; and

FIG. 96 is a network diagram showing a system according to another embodiment;

### DETAILED DESCRIPTION OF THE PREFERRED EMBODIMENTS

### First Embodiment

A service providing system and a service providing apparatus according to embodiments of the present description are described in detail below.

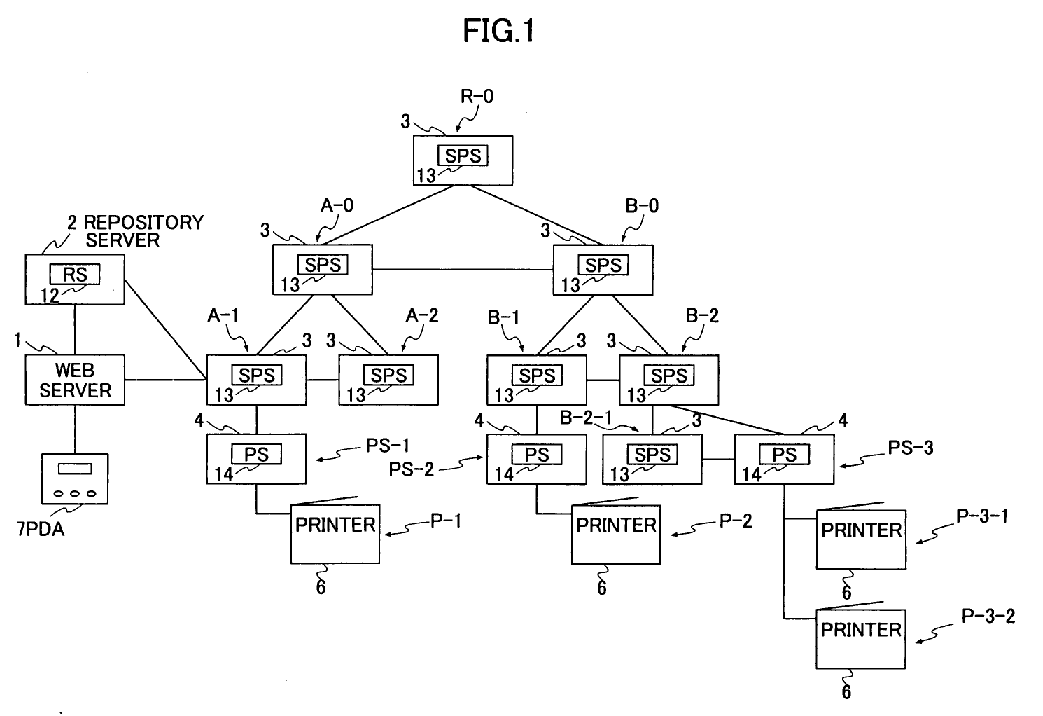

FIG. 1 is a schematic diagram showing a service providing system according to an embodiment of the present invention. The service providing system shown in FIG. 1 includes a Web server 1, a repository server 2, SPS servers 3, print servers 4, printers 6, and a personal digital assistant (PDA) 7.

As shown in FIG. 1, a repository service (RS) 12 is mounted on the repository server 2, a print environment sharing service 13 is mounted on the SPS servers 3, and a document print service (PS) 14 is mounted on the print server 4.

The services exchange messages in compliance with simple object access protocol (SOAP) as Web services, and can provide services to each other.

The Web server 1, the repository server 2, the SPS servers 3, the print servers 4, the printers 6, and the personal digital assistant (PDA) 7 are connected to each other via a network or the Internet.

If the service providing system corresponds to the entire organization of a firm, the SPS server R-0 corresponds to the top of the firm, and the SPS servers A-0 through A-2 and the SPS servers B-0 through B-2 correspond to a division A and a division B of the firm, respectively. It is assumed that each network under A-1, B-1, and B-2, for example, has a well-maintained print environment.

At first, a user inputs a user name and a password using a PDA 7, and logs in on the Web server 1. Using a service provided by the print environment sharing service 13, the user designates a print location (the SPS server 3, B-2, for example), a printer (the printer 6, P-3-1, for example), and print conditions (paper size, for example), and send a request for a print reservation to the print environment sharing service 13.

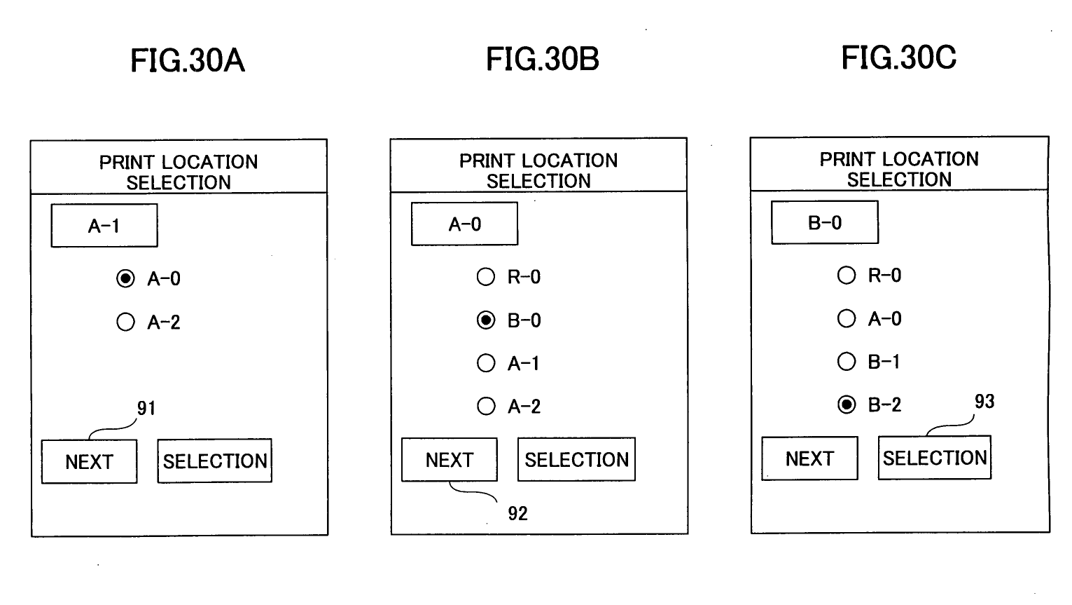

As shown in FIG. 30 (described below in detail), when the user designates the location to print, the print environment sharing service 13 acquires information of the communication route (route information) to the print location designated by the user (the print environment sharing service 13 of the SPS server 3 (B-2), for example). When selecting the print location, the user does not select the print environment sharing service 13 of the SPS server 3, but the user may select a name (city, plant, department, for example) assigned to the print environment sharing service 13 of the SPS server 3. In the following description, the user may select the print environment sharing service 13 of a SPS server 3 by referring to a name assigned thereto in the same manner.

For example, the print environment sharing service 13 of the SPS server 3 (A-1) acquires route information from the print environment sharing service 13 of the SPS server 3 (A-1) to the print environment sharing service 13 of the SPS server 3 (B-2) (the route information being (A-1)→(A-0)→(B-0)→(B-2)), and provides the route information to the Web server 1.

The route information is acquirable using a service list to be described below.

In response to receipt of a request for a print reservation from the user via the Web server 1, the print environment sharing service 13 of the SPS server 3 (A-1) requests the repository service 12 to acquire a document designated by the user, and acquires the document stored in the repository server 2 via the repository service 12.

The print environment sharing service 13 of the SPS server 3 (A-1) transfers the data of the acquired document (document data) to the print environment sharing service 13 of the SPS server 3 (A-0) based on the route information together with the route information, the print conditions, and the information of the printer, for example.

In response to receipt of the reservation information and the document data from the SPS server 3 (A-1), the print environment sharing service 13 of the SPS server 3 (A-0) transfers the reservation information and the document data to the print environment sharing service 13 of the SPS server 3 (B-0) based on the route information contained in the reservation information. The print environment sharing service 13 of the SPS server 3 (B-0) transfers the reservation information and the document data to the print environment sharing service 13 of the SPS server 3 (B-2) in the same manner.

In response to receipt of the transferred reservation information and the transferred document data, the print environment sharing service 13 of the SPS server 3 (B-2) of the print environment sharing service 13 stores the reservation information and the document data in the SPS server 3 (B-2).

When the document data arrives at the print location, the user can request the print environment sharing service 13 of the SPS server 3 (A-1) to print the document transferred thereto via the Web server 1.

As described above, the print environment sharing service 13 transfers the print reservation up to the print environment sharing service 13 of the SPS server 3 (B-2) at which the document is to be printed.

The print environment sharing service 13 of the SPS server 3 (B-2) requests a document print service 14 of the print server 4 (PS-3) to print the document data stored in the SPS server 3 (B-2) based on the information of the printer and the print conditions contained in the reservation information.

The document print service 14 of the print server 4 (PS-3) prints the document data using the printer 6 (P-3-1) under the designated print condition based on the request of the print environment sharing service 13 of the SPS server 3 (B-2).

As described above, the user can use a remote print environment of another department or another plant wherein the print environment is well-maintained and sharable, for example. The user can print a document quickly without building a new print environment by herself.

If the service providing system is divided into two portions (divisions A and B) as shown in FIG. 1, for example, and the security of the service providing system is managed by the division, a firewall may be provided between the division A and the division B. The firewall may improve the security of the service providing system compared with a conventional service providing system in which multiple printers are connected to a server via a network. In the case of a conventional system, a communication channel is established for each combination of a printer and a server. As a result, the security of each communication channel need to be secured.

The print environment sharing service 13 can build a tree-structured system as shown in FIG. 1 by using a service list described below.

The service list of a print environment sharing service 13 may be distributedly stored in the SPS servers 3 in which the print environment sharing service 13 is mounted. According to another embodiment, all service lists of the print environment sharing service 13 may be centrally stored in another apparatus.

In the following description, an assumption is made that each service list is stored in a SPS server 3 in which a print environment sharing service 13 is mounted to make the description easy and simple. This assumption does not limit the scope of the present invention.

According to another embodiment, the user may use another user terminal such as a mobile phone, instead of the PDA 7, to access the Web server 1.

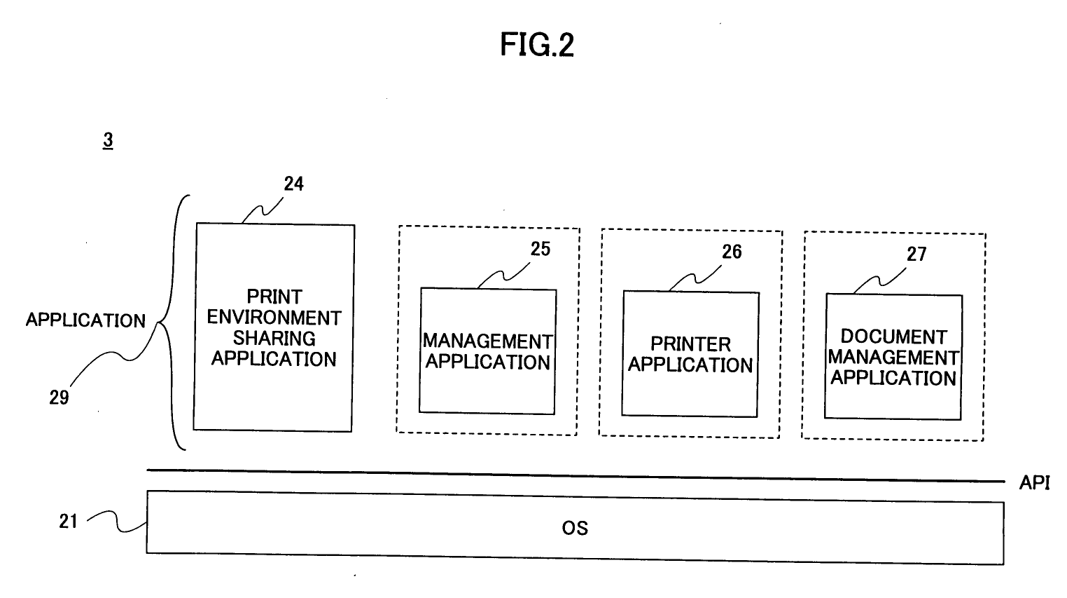

FIG. 2 is a schematic diagram showing the configuration of software mounted on the SPS server 3 according to an embodiment.

As shown in FIG. 2, the SPS server 3 includes an operating system (OS) 21 and an application 29.

The OS 21 is an operating system such as UNIX (trade mark) and Windows (trade mark) on which multiple items of the application 29 are executed as processes in parallel.

The application 29 includes a shared printer application 24 for reserving and/or printing a document. The print environment sharing service 13 shown in FIG. 1 is included in the shared printer application 24.

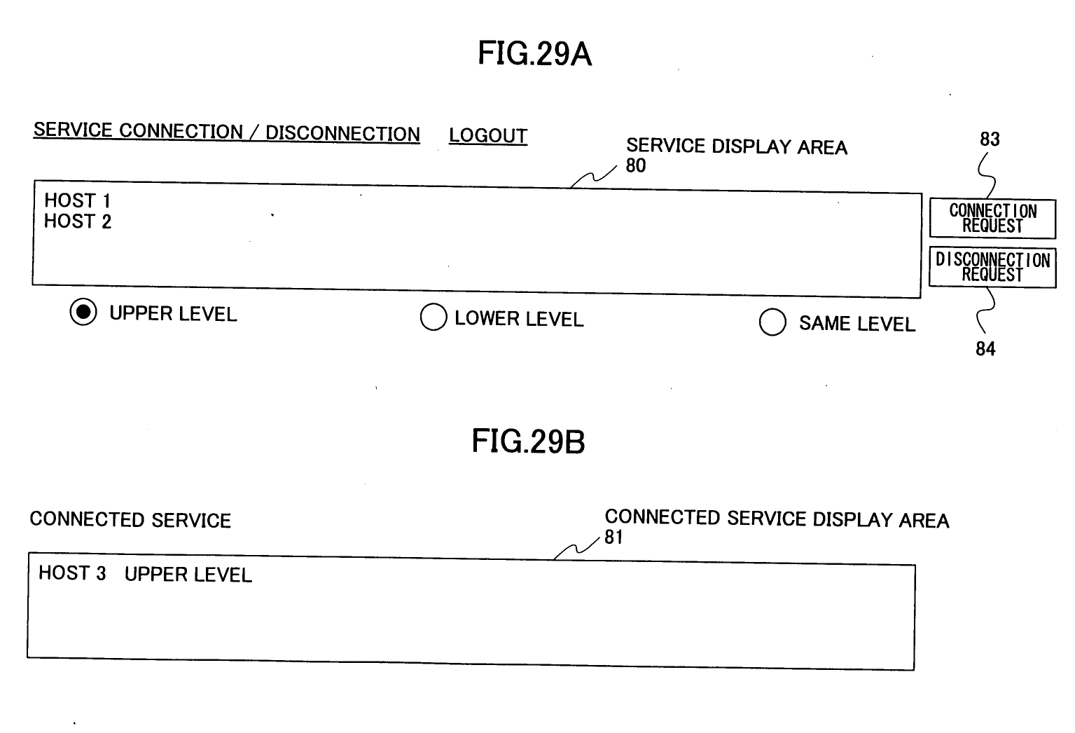

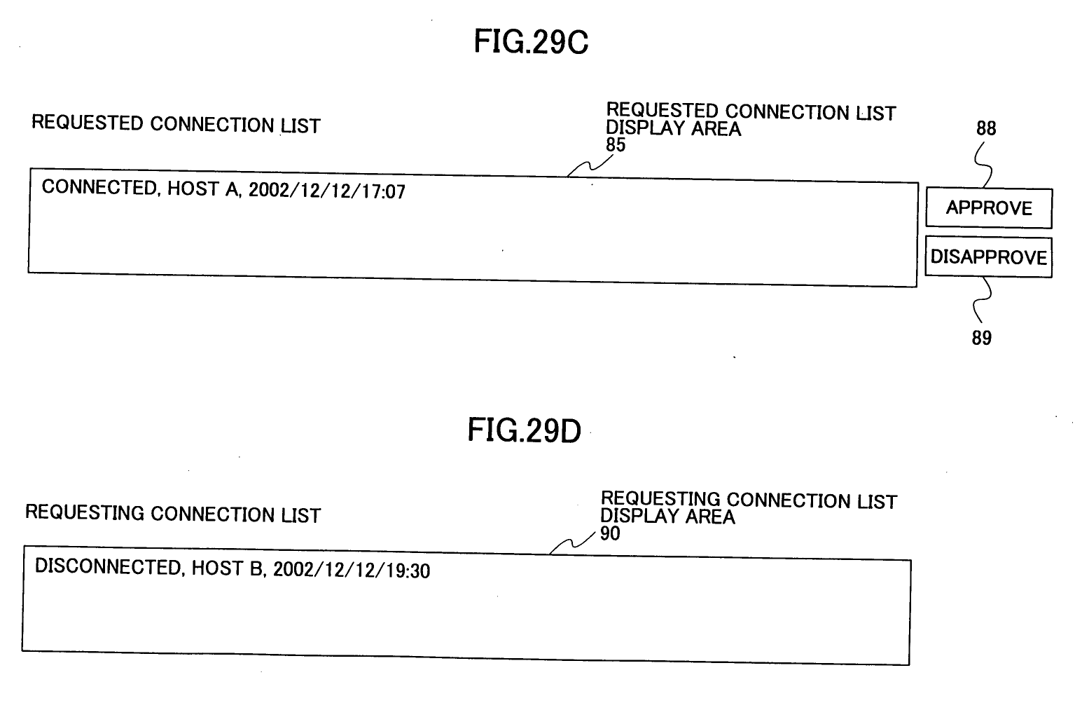

The application 29 may include a management application 25 that manages the shared printer application 24. As will be appreciated, the management application 25 provides a user interface (I/F) with which the print environment sharing services 13 of other SPS servers 3 can request to connect or display a screen as shown in FIG. 29, for example.

According to another embodiment, the management application 25 may be mounted in an apparatus other than the SPS server 3. In the following description, however, an assumption is made that the management application 25 is mounted in the SPS server 3 to make the description easy and simple.

Although the SPS server 3 shown in FIG. 1 includes only the print environment sharing service 13 included in the shared printer application 24, the application 29 may include a printer application 26 that is an application for a printer and a document management application 27 that is an application for managing documents.

The document print service 14 shown in FIG. 1 is included in the printer application 26. The repository service 12 shown in FIG. 1 is included in the document management application 27.

An assumption is made that the document print service 14 is mounted on the print server 4, and the repository service 12 is mounted in the repository server 2 to make the description easy and simple. The assumption does not limit the scope of the present invention.

The SPS server 3 is assumed to include the shared printer application 24 and the management application 25.

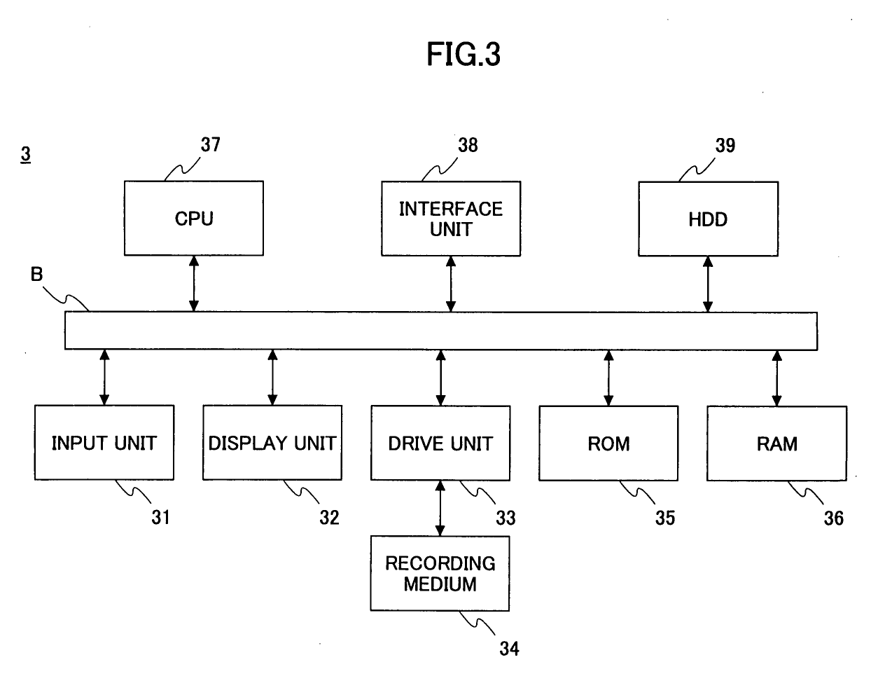

The hardware configuration of the SPS server 3 is described with reference to FIG. 3. FIG. 3 is a block diagram showing the configuration of the SPS server 3 according to an embodiment.

The SPS server 3 shown in FIG. 3 includes an input unit 31, a display unit 32, a drive unit 33, a read only memory (ROM) unit 35, a random access memory (RAM) unit 36, a central processing unit (CPU) 37, an interface unit 38, and a hard disk drive (HDD) 39, connected to each other via a bus B.

The input unit 31 is configured, for example, by a keyboard and a mouse with which an operator inputs various instructions and data to the SPS server 3.

The display unit 32 is configured, for example, by a display that displays various screens for the operator (described below).

The interface unit 38 interfaces the SPS server 3 with the network.

The entire system of the SPS server 3 is managed by a main program other than the application 29.

Programs of the shared printer application 24, the management application 25, and the main program may be provided via a recording medium 34 such as a CD-ROM, or may be downloaded from the network. The recording medium 34 is set in the drive unit 33. The programs stored in the recording medium 34 are installed on the HDD 39 via the drive unit 33.

The ROM 35 stores data, for example. When the SPS server 3 is turned on, the application programs and the main program are loaded from the HDD 39 to the RAM 36. The CPU 37 executes the application programs and the main program loaded in the RAM 36.

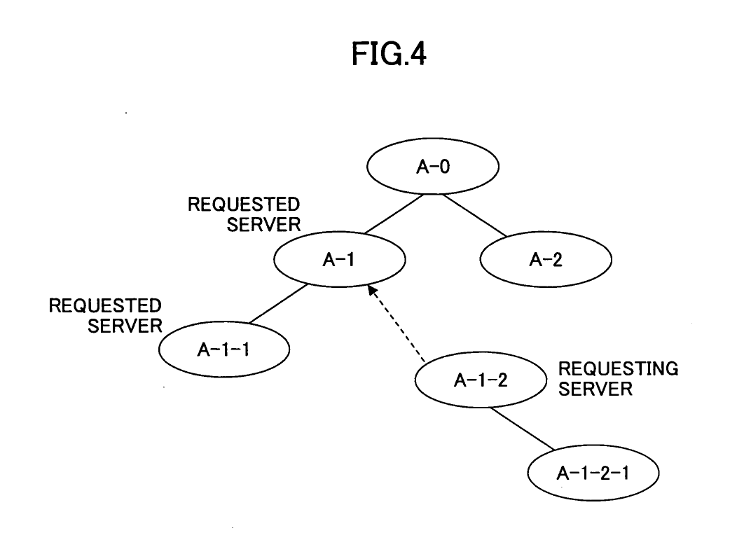

A description is made about an exemplary case in which the SPS server 3 (A-1-2) requests the SPS server 3 (A-1) for a connection with reference to FIG. 4.

FIG. 4 is a schematic diagram for explaining the request for a connection.

As shown in FIG. 4, the SPS server 3 (A-1-2) (a requesting server) sends a request to the SPS server 3 (A-1) (requested server) for connecting the SPS server 3 (A-1-2) at its lower level.

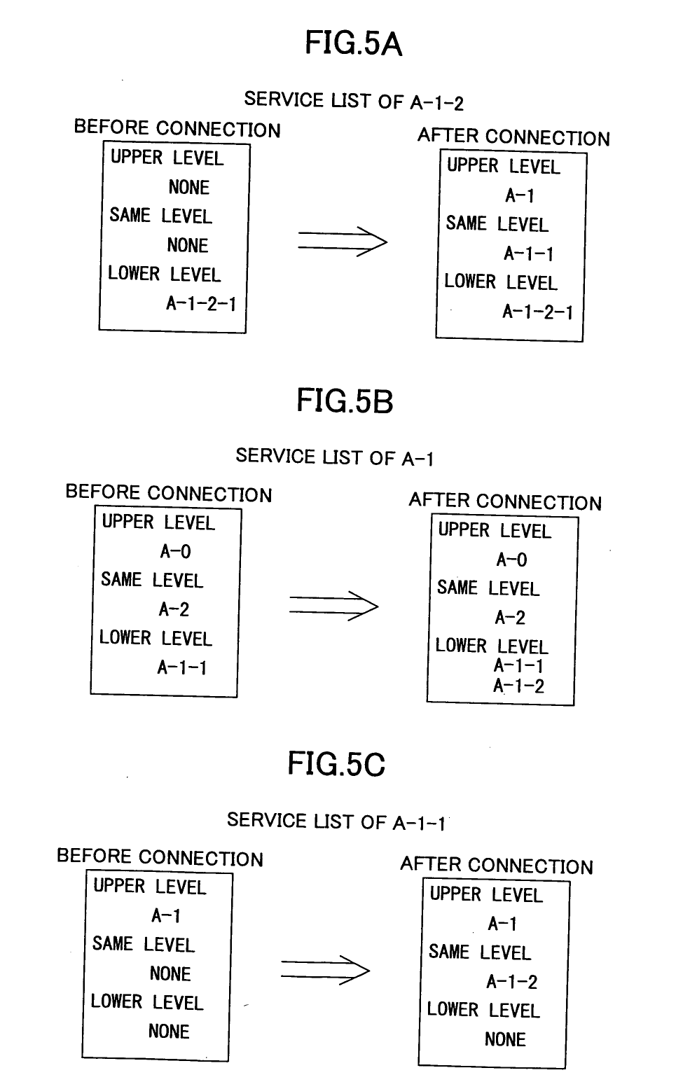

Exemplary data that have been added to a service list stored in each SPS server 3 by the connection shown in FIG. 4 are described with reference to FIG. 5A through 5C.

FIG. 5A through 5C are schematic diagrams for explaining the adding of data to the service list.

As shown in FIG. 5, the service list shown in FIG. 5 includes access information such as an IP address and a host name to access another print environment sharing service 13 that can be referred to by the print environment sharing service 13 mounted on the SPS server 3.

For example, the service list shown in FIG. 5 includes access information in an upper level, access information in the same level, and access information in a lower level to which the shared print service 13 can refer to.

If there is no print environment sharing service 13 in an upper level, the same level, or a lower level of the print environment sharing service 13, the access information is indicated as “none”.

In order to make the following description simple, the access information of the other print environment sharing service 13 that the present print environment sharing service 13 (A-1-2) can access is indicated as “A-0”, “A-1”, “A-1-1” as shown in FIG. 5A through 5C, for example.

FIG. 5A shows an exemplary service list stored in the SPS server 3 (A-1-2) before and after the connection.

As shown in FIG. 5A, when the SPS server 3 (A-1-2) is connected to the SPS server 3 (A-1) as a lower level entity, “A-1” and “A-1-1” are added to the upper level and the same level, respectively, of the service list stored in the SPS server 3 (A-1-2).

FIG. 5B shows exemplary data of the service list stored in the SPS server 3 (A-1) before and after the connection.

As shown in FIG. 5b, when the SPS server 3 (A-1-2) is connected to the SPS server 3 (A-1) as a lower level entity, “A-1-2” is added to the lower level in the service list stored in the SPS server 3 (A-1).

FIG. 5C shows exemplary data of the service list stored in the SPS server 3 (A-1-1) before and after the connection.

As shown in FIG. 5C, when the SPS server 3 (A-1=2) is connected to the SPS server 3 (A-1) as a lower level entity, “A-1-2” is added to the same level in the service list stored in the SPS server 3 (A-1-1).

The SPS server 3 (A-1-1) on the same level as the SPS server 3 (A-1-2) can be connected from the SPS server 3 (A-1) in the upper level or, although not shown in FIG. 4, can be connected from the SPS server 3 (A-1-2).

An exemplary embodiment has been described in which a lower SPS server 3 transmits a request for connection to an upper SPS server 3. According to another embodiment, the upper SPS server 3 may transmit a request for connection to the lower SPS server 3.

Using the service list as shown in FIG. 5, the SPS server 3 can build a system having a hierarchy as shown in FIG. 4.

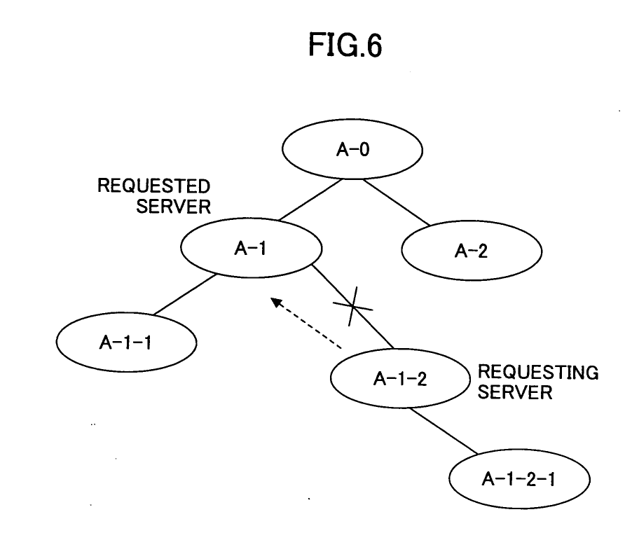

A description is given about a request for disconnecting the connection from the SPS server 3 (A-1-2) to the SPS server 3 (A-1) with reference to FIG. 6.

FIG. 6 is a schematic diagram for explaining a request for disconnecting the connection.

As shown in FIG. 6, the SPS server 3 (A-1-2) transmits a request for disconnection to the SPS server 3 (A-1) to which the disconnection request is transmitted.

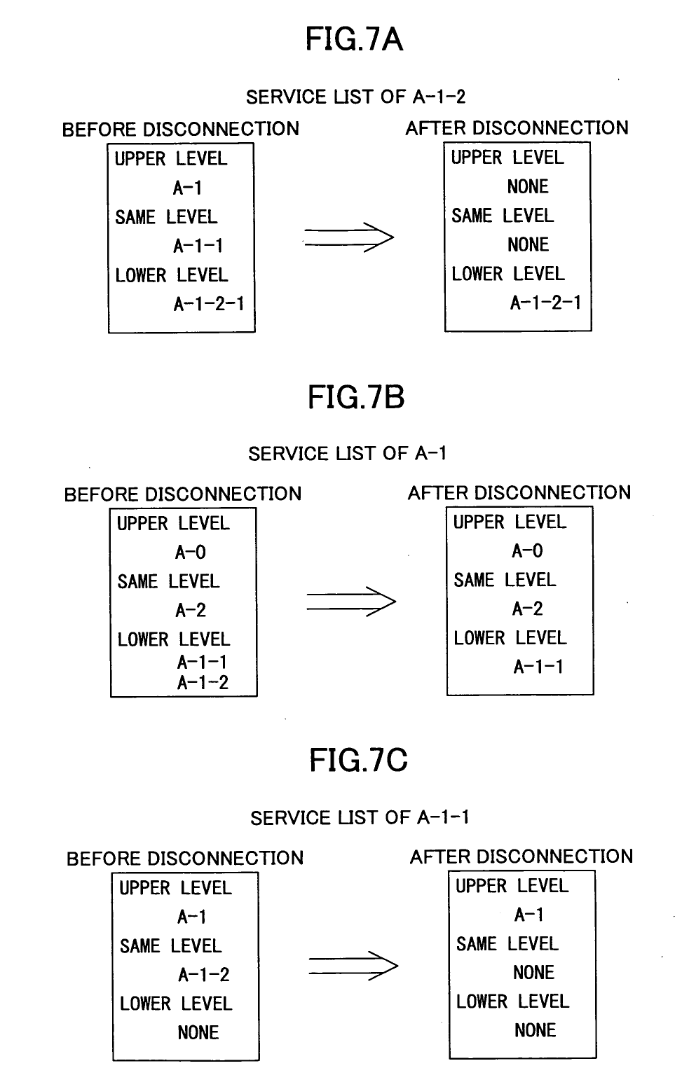

With reference to FIG. 7, exemplary data are shown that have been deleted from the service list stored in each SPS server 3 by the disconnection shown in FIG. 6.

FIG. 7A through 7C are schematic diagrams for explaining the deleting of data from the service list.

FIG. 7A shows the service list stored in the SPS server 3 (A-1-2) before and after the disconnection.

As shown in FIG. 7A, when the SPS server 3 (A-1-2) is disconnected from the SPS server 3 (A-1) as a lower level entity, “A-1” and “A-1-1” are deleted from the upper level and the same level, respectively, of the SPS server 3 (A-1-2).

FIG. 7B shows exemplary data of the service list stored in the SPS server 3 (A-1) before and after the disconnection.

As shown in FIG. 7B, when the SPS server 3 (A-1-2) is disconnected from the SPS server 3 (A-1) as a lower level entity, “A-1-2” is deleted from the lower level of the service list stored in the SPS server 3 (A-1).

FIG. 7C shows exemplary data of the service list stored in the SPS server 3 (A-1-1) before and after the disconnection.

As shown in FIG. 7C, when the SPS server 3 (A-1-2) is disconnected, “A-1-2” is deleted from the same level of the service list stored in the SPS server 3 (A-1-1).

According to an embodiment, the SPS server 3 (A-1) that is in the upper level service list of the SPS server 3 (A-1-1) may request the SPS server 3 (A-1-1) to disconnect the SPS server 3 (A-1-2). According to another embodiment, although not shown in FIG. 6, the SPS server 3 (A-1-2) may request the SPS server 3 (A-1-1) to disconnect the SPS 3 (A-1-2).

An exemplary embodiment has been described in which the lower SPS server 3 transmits a request for disconnection to the upper SPS server 3. According to another embodiment, the upper SPS server 3 may transmit a request for disconnection to the lower SPS server 3.

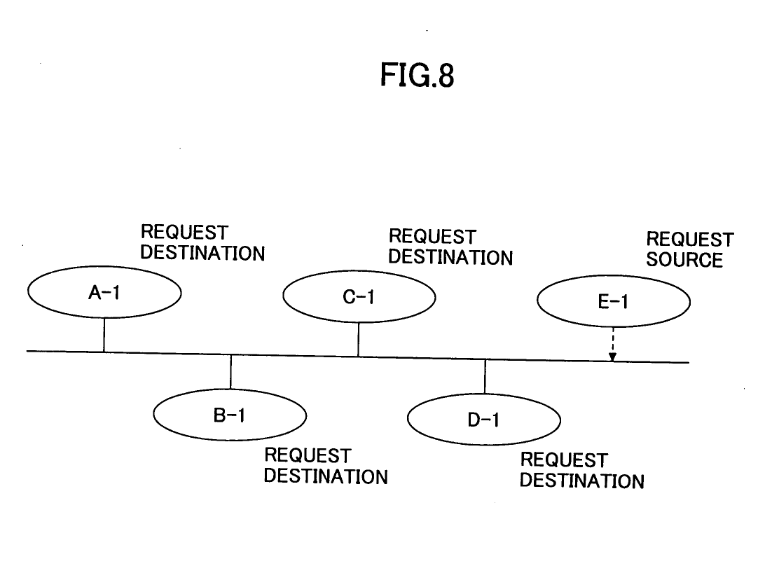

Referring to FIG. 8, a connection request from the SPS server 3 (E-1) to another SPS server 3 is described.

FIG. 8 is a schematic diagram for explaining the connection request.

As shown in FIG. 8, the requesting SPS server 3 (E-1) transmits the connection request to the other SPS servers 3.

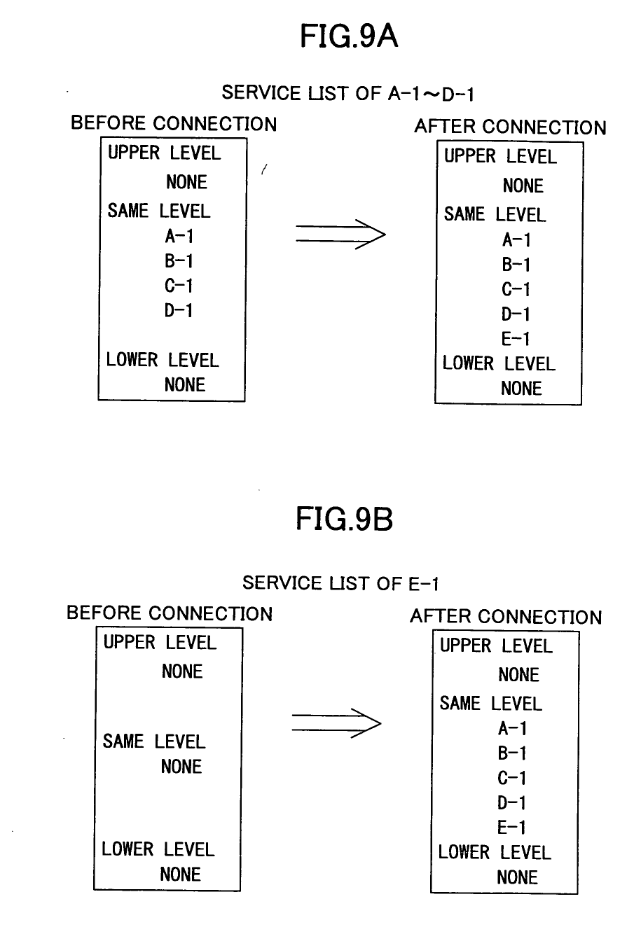

Exemplary data that are added to the service list stored in each SPS server 3 by the connection shown FIG. 8 are described with reference to FIGS. 9A and 9B.

FIG. 9A is a schematic diagram for explaining the adding of data to the service list.

FIG. 9A shows exemplary data of the service list stored in the SPS servers 3 (A-1 through D-1) before and after the connection.

As shown in FIG. 9A, when the SPS server 3 (E-1) is connected to the same level of the SPS server 3 (A-1 through D-1), “E-1” is newly added to the service list stored in the SPS servers 3 (A-1 through D-1).

In order to make the description of FIG. 9A simple, the access information of its own print environment sharing service 13 is stored in the same level. The access information may be stored or may not be stored in the same level of the print environment sharing service 13. In FIG. 9B, the access information may be stored or may not be stored in the same manner.

FIG. 9B shows exemplary data of the service list stored in the SPS server 3 (E-1) before and after the connection.

As shown in FIG. 9B, when the SPS server (E-1) is connected to the same level of the SPS servers 3 (A-1 through D-1), “A-1” through “E-1” is added to the same level of the service list stored in the SPS server 3 (E-1).

Using the service list as shown in FIG. 9, the SPS servers 3 can build a system having a parallel structure as shown in FIG. 8.

In FIGS. 8 and 9, the connection request is transmitted from the SPS server 3 (E-1) to the SPS servers 3 (A-1 through D-1). According to another embodiment, any one of the SPS servers 3 (A-1 through D-1) may transmit the connection request to the SPS server 3 (E-1).

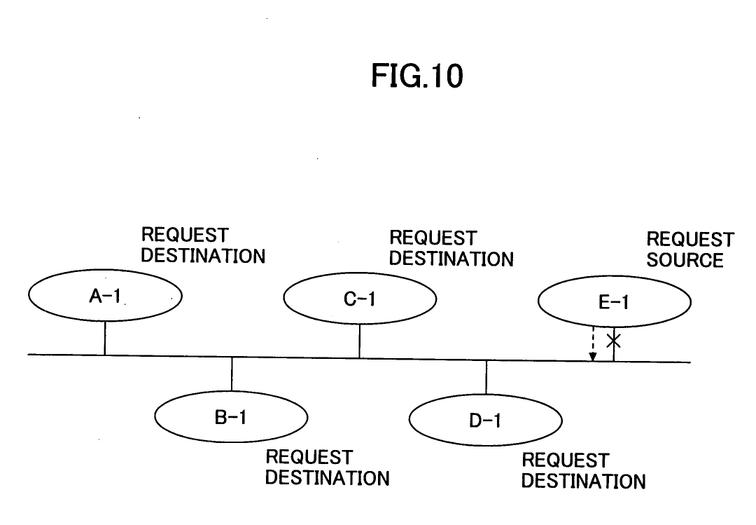

A disconnection request from the SPS server 3 (E-1) to another SPS server 3 is described with reference to FIG. 10.

FIG. 10 is a schematic diagram for explaining the disconnection request.

As shown in FIG. 10, the SPS server 3 (E-1) that is requesting disconnection transmits a disconnection request to the other SPS servers 3 that are requested to make the disconnection.

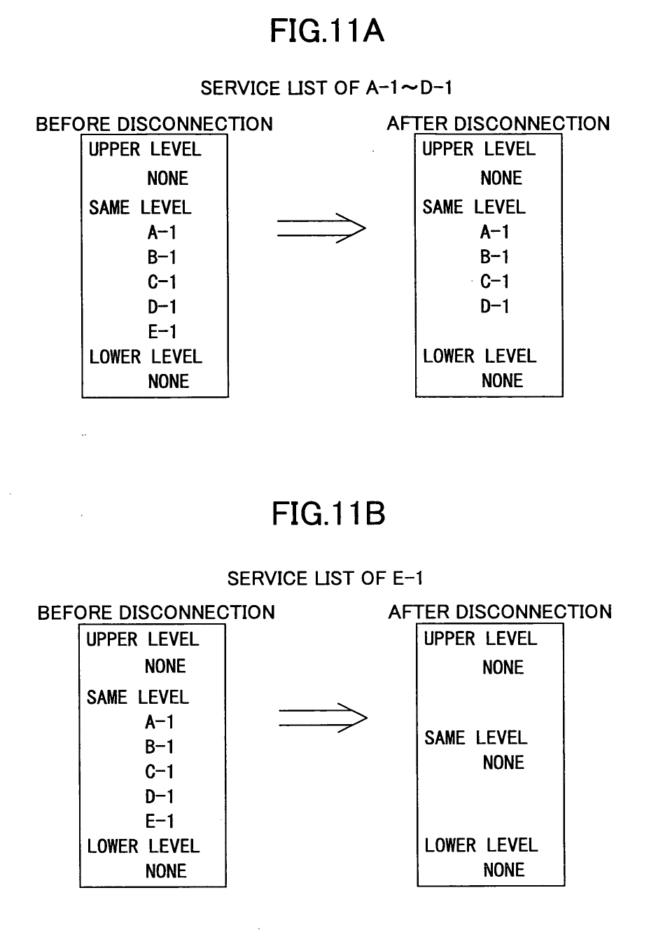

Referring to FIG. 11, exemplary data that are deleted from the service list stored in each SPS server 3 by the disconnection shown in FIG. 10 are described.

FIGS. 11A and 11B are schematic diagrams for explaining the deleting of data from the service list.

FIG. 11A shows exemplary data of the service list stored in the SPS servers 3 (A-1 through D-1) before and after the disconnection.

As shown in FIG. 11A, when the SPS server 3 (E-1) is disconnected from the SPS servers 3 (A-1 through D-1) as a same level entity, “E-1” is deleted from the service list stored in the SPS servers 3 (A-1 through D-1).

In order to make the description with reference to FIG. 11A simple, the SPS server E-1 stores “E-1” in the same level of the service list. The access information may not be included in the service list.

FIG. 11B shows exemplary data before and after the connection of the service list stored in the SPS server 3 (E-1).

As shown in FIG. 11B, when the SPS server (E-1) is disconnected from the SPS servers 3 (A-1 through D-1) as a same level entity, “A-1” through “D-1” in the same level are deleted from the service list stored in the SPS server 3 (E-1).

In FIGS. 10 and 11, an exemplary embodiment has been described in which the SPS server 3 (E-1) transmits the disconnection request to the SPS servers 3 (A-1 through D-1). According to another embodiment, the disconnection request may be transmitted from any one of the SPS servers 3 (A-1 through D-1) to the SPS server 3 (E-1).

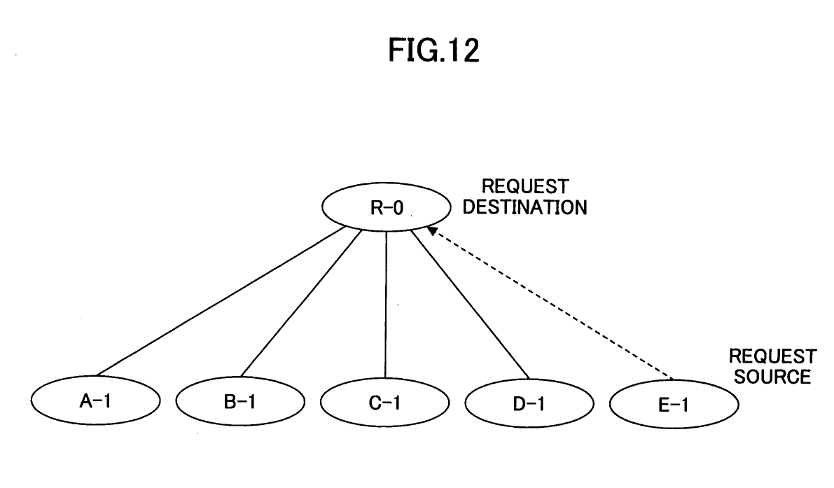

A connection request from the SPS server 3 (E-1) to the SPS server 3 (R-0) is described with reference to FIG. 12.

FIG. 12 is a schematic diagram for explaining a connection request.

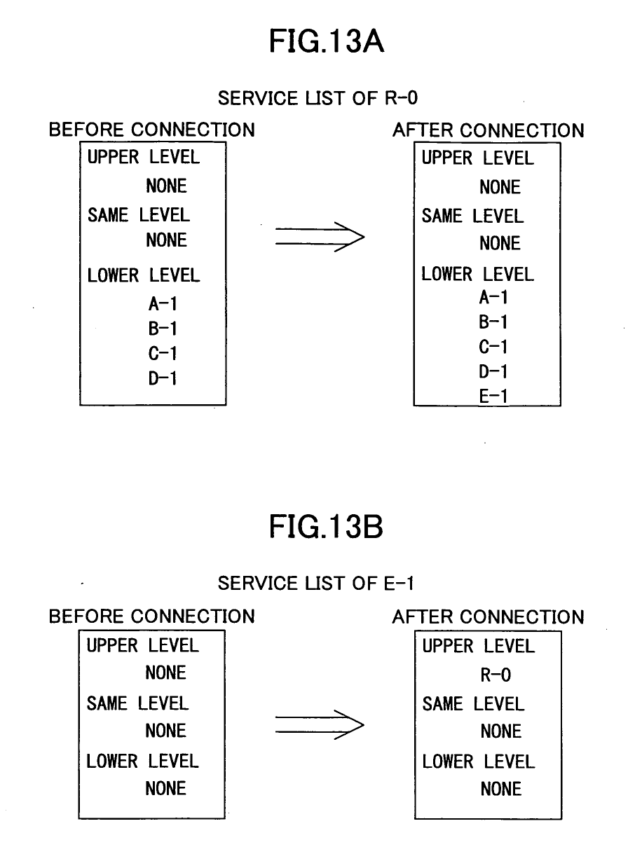

As shown in FIG. 12, the SPS server 3 (E-1) requesting for connection transmits a request for connection to the SPS server 3 (R-0). Exemplary data added to the service list stored in each SPS server 3 by the connection shown in FIG. 12 is described with reference FIGS. 13A and 13B.

FIGS. 13A and 13B are schematic diagrams for explaining the adding of data to the service list.

FIG. 13A shows exemplary data of the service list stored in the SPS server 3 (R-0) before and after the connection.

As shown in FIG. 13A, when the SPS server 3 (E-1) is connected to the SPS server 3 (R-0) as a lower level entity, “E-1” is added to the lower level of the service list stored in the SPS server 3 (R-0).

FIG. 13B shows exemplary data of the service list stored in the SPS server 3 (E-1) before and after the connection.

As shown in FIG. 13B, when the SPS server 3 (E-1) is connected to the SPS server 3 (R-0) as a lower level entity, “R-0” is added to the upper level of the service list stored in the SPS server 3 (E-1).

Using the service list as shown in FIGS. 13A and 13B, the SPS server 3 can build a system having a structure shown in FIG. 12.

An exemplary embodiment has been described in which the lower SPS server 3 (E-1) transmits a connection request to the upper SPS server 3 (R-0). According to another embodiment, the upper SPS server 3 (R-0) may transmit a connection request to the lower SPS server 3 (E-1).

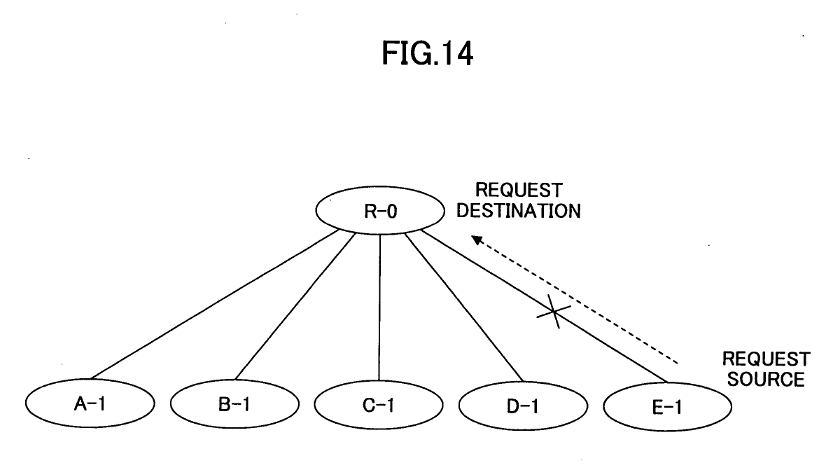

Referring to FIG. 14, a disconnection request from the SPS server 3 (E-1) to the SPS server (R-0) is described.

FIG. 14 is a schematic diagram for explaining the disconnection request.

As shown in FIG. 14, the SPS server 3 (E-1) requesting disconnection transmits the disconnection request to the SPS server 3 (R-0) that is requested to disconnect the connection.

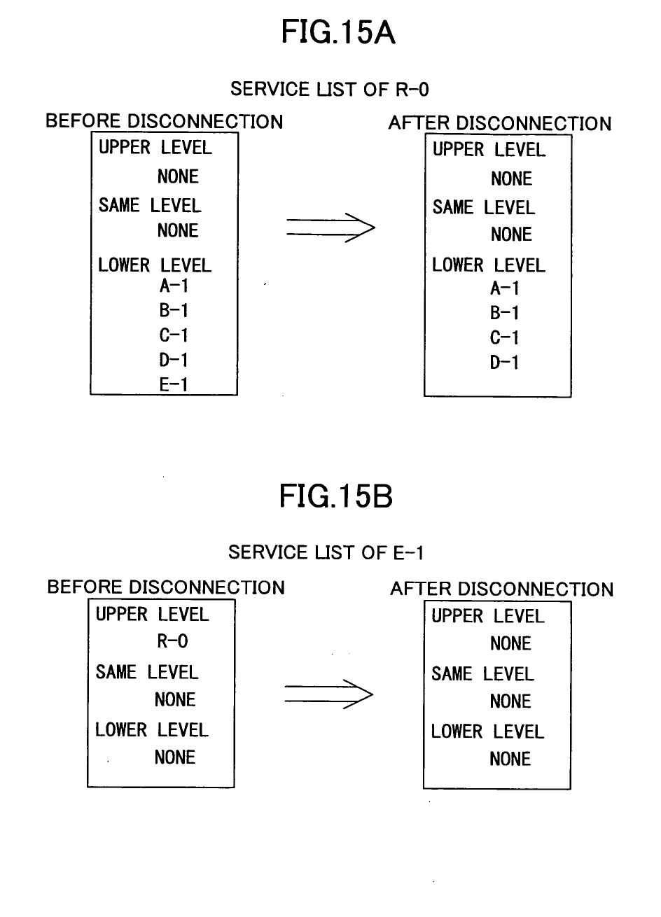

Exemplary data that are deleted by the disconnection shown in FIG. 14 from the service list stored in each SPS server 3 are described with reference to FIG. 15.

FIG. 15 is a schematic diagram for explaining the deleting of data from the service list.

FIG. 15A shows exemplary data of the service list stored in the SPS server 3 (R-0) before and after the disconnection.

As shown in FIG. 15A, when the SPS server 3 (E-1) is disconnected from the SPS server 3 (R-0) as a lower level entity, “E-1” in the lower level is deleted from the service list stored in the SPS server 3 (R-0).

FIG. 15B shows exemplary data of the service list stored in the SPS server 3 (E-1) before and after the connection.

As shown in FIG. 15B, when the SPS server 3 (E-1) is disconnected from the SPS server 3 (R-0) as a lower level entity, the “R-0” is removed from the upper level of the service list stored in the SPS server 3 (E-1).

An exemplary embodiment has been described in which the lower SPS server 3 (E-1) transmits the disconnection request to the upper SPS server 3 (R-0) in FIGS. 14 and 15. According to another embodiment, the disconnection request may be transmitted from the upper SPS server 3 (R-0) to the lower SPS server 3 (E-1).

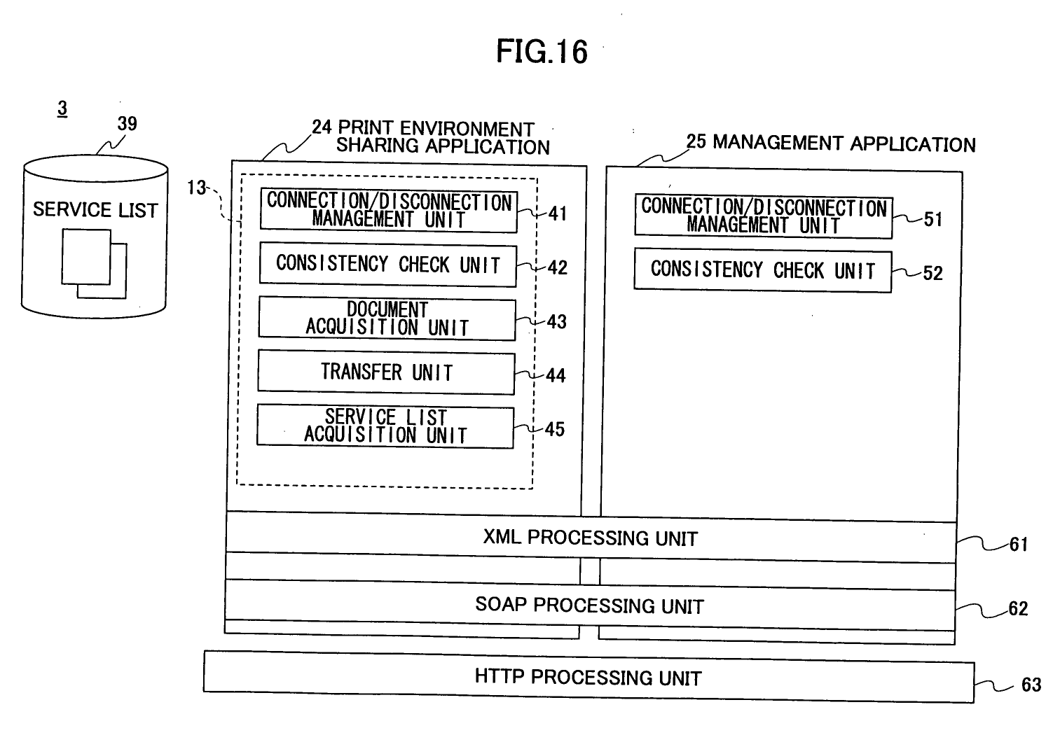

The functions of the SPS server 3 are described with reference to FIG. 16.

FIG. 16 is a schematic diagram for explaining the functions of the SPS server.

The SPS server 3 shown in FIG. 16 includes a HTTP processing unit 63 for communicating in compliance with HTTP, a HDD 39 for storing the service list, a shared printer application 24, and a management application 25, for example.

An XML processing unit 61 for processing messages written in XML and a SOAP processing unit 62 for exchanging message in compliance with SOAP are shared by the shared printer application 24 and the management application 25.

The print environment sharing service 13 included in the shared printer application 24 includes a connection/disconnection management unit 41, a consistency check unit 42, a document acquisition unit 43, a transfer unit 44, and a service list acquisition unit 45, for example.

The connection/disconnection unit 41 manages the connection and disconnection of the print environment sharing service 13 and another print environment sharing service 13.

The consistency check unit 42 checks the consistency of the system in the case of the print environment sharing service 13 and the other print environment sharing service 13.

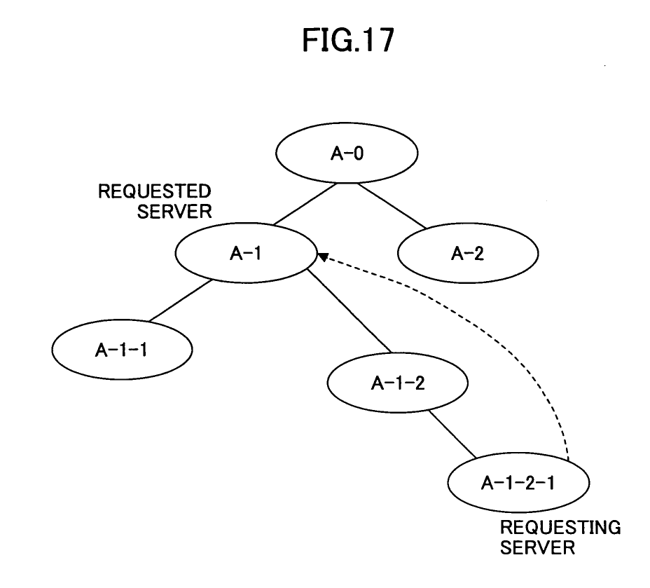

The checking of consistency is described with reference to FIG. 17. FIG. 17 is a schematic diagram for explaining the checking of consistency.

As shown in FIG. 17, when the SPS server 3 (A-1-2) is connected to the SPS server 3 (A-1) as a lower level entity, if the lower SPS server 3 (A-1-2-1) transmits a connection request to the SPS server 3 (A-1), and is connected, the route A-1, A-1-2, and A-1-2-1 is closed as a loop, which causes the system to fail.

The consistency check unit 42 shown in FIG. 16 checks, whether another print environment sharing service 13 is connected to the print environment sharing service 13, and the other print environment sharing service 13 is disconnected from the print environment sharing service 13, if the connection and disconnection form such a loop as shown in FIG. 17, for example.

The document acquisition unit 43 acquires a designated document from the repository server 2 via the repository service 12 based on a request from the Web server shown in FIG. 1.

The transfer unit 44 transfers reservation information and document data acquired by the document acquisition unit 43 to another print environment sharing service 13, wherein the reservation information includes the print condition, information of print location, route information to the print environment sharing service 13 of the print location, and printer information to be used for printing designated by the user via the Web server 1.

The service list acquisition unit 45 acquires the service list stored in another SPS server 3 from the other SPS server 3 via the print environment sharing service 13 mounted on the other SPS server 3.

On the other hand, the management application 25 includes a connection/disconnection management unit 51, and a consistency check unit 52.

The connection/disconnection management unit 51 manages the connecting and/or disconnecting between the print environment sharing service 13 mounted on the present SPS server 3 and another print environment sharing service 13 in the same manner as the connection/disconnection management unit 41. Additionally, the connection/disconnection management unit 51 provides a user interface for providing the user screens as shown in FIG. 29 to be described below.

The consistency check unit 52 checks the consistency of the system in the case where the print environment sharing service 13 mounted on the present SPS server 3 is connected to or disconnected from another print environment sharing service 13 in the same manner as the consistency check unit 42.

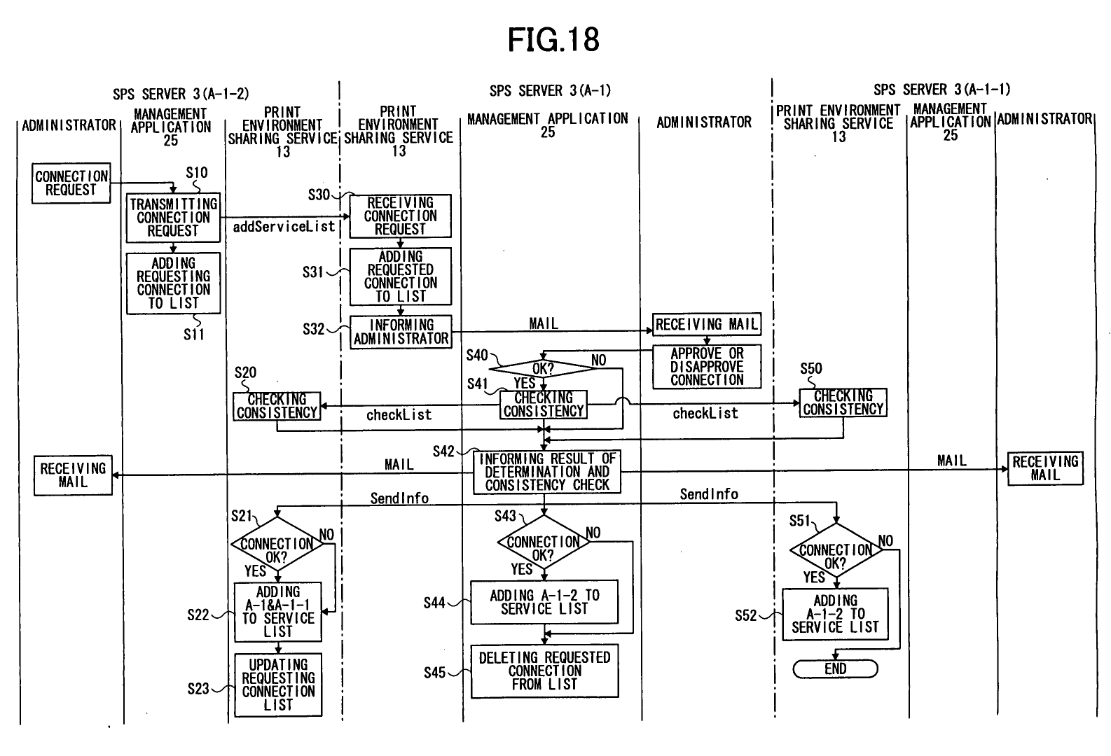

Connection processing performed by the SPS server 3 is described with reference to FIG. 18. FIG. 18 is a flow chart for explaining connection processing performed by the SPS server 3.

In FIG. 18, it is assumed that, as shown in FIG. 4, the SPS server 3 (A-1-2) transmits a connection request to the SPS server 3 (A-1).

The administrator of SPS server 3 (A-1-2) designates the requested SPS server 3, and gives an instruction to transmit a connection request using a service connection/disconnection screen provided by the connection/disconnection management unit 51 of the management application 25 as shown in FIG. 29 (to be described below).

In response to the instruction from the administrator of the SPS server 3 (A-1-2), the management application 25 performs as follows.

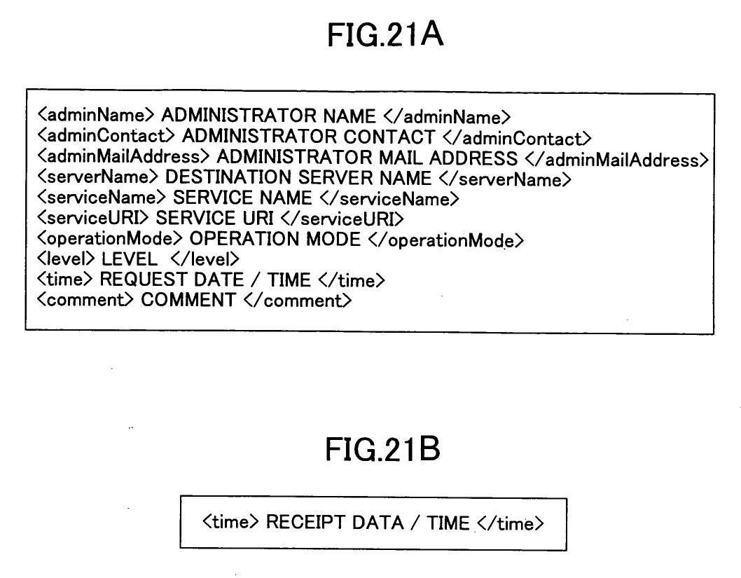

In step S10, the connection/disconnection management unit 51 of the management application 25 of the requesting SPS server 3 (A-1-2) issues and transmits a message including method (addServiceList) for requesting a connection to the print environment sharing service 13 of the requested SPS server 3 (A-1). Exemplary I/F of the addServiceList method is described with reference to FIG. 21.

In step S11 subsequent to step S10, the connection/disconnection management unit 51 of the management application 25 of the SPS server 3 (A-1-2) adds information of the requested SPS server 3 (URL, location, and address, for example) and information such as date and time at which the request is transmitted in the list of requesting connections including information of connection requests currently being requested.

On the other hand, in step S30, the connection/disconnection management unit 41 of the print environment sharing service 13 of the requested SPS server 3 (A-1) receives the message transmitted by the SPS server 3 (A-1-2) in step S10.

In step S31 subsequent to step S30, the connection/disconnection management unit 41 of the print environment sharing service 13 of the SPS server 3 (A-1) adds the information of the requesting SPS server 3 and information such as the date and time at which the connection request is transmitted to the list of requested connections including information of requested connections.

In step S32 subsequent to step S31, the connection/disconnection management unit 41 of the print environment sharing service 13 of the SPS server 3 (A-1) informs the administrator of the SPS server 3 (A-1) that the connection/disconnection management unit 41 has received a connection request via an e-mail message, for example.

In response to receipt of the e-mail message from the connection/disconnection management unit 41 of the print environment sharing service 13 of the SPS server 3 (A-1), the administrator of the SPS server 3 (A-1) activates the management application 25 of the SPS server 3 (A-1). As will be appreciated, the connection/disconnection management unit 51 of the management application of the SPS server 3 (A-1) provides the administrator the list of requested connection requests. The administrator selects a request in the list, determines whether the administrator approves the connection request, and clicks either an “APPROVE” button 88 or a “DISAPPROVE” button 89.

In step S40, in response to a determination that the administrator of the SPS server 3 (A-1) has approved the connection request (YES in step S40), the process proceeds to step S41. In response to a determination that the administrator of the SPS server 3 (A-1) has disapproved the connection request (NO in step S40), the process proceeds to step S42.

For example, in response to receipt of information that the “APPROVE” button 88 has been clicked in the service connection/disconnection screen shown in FIG. 29 (to be described below), the connection/disconnection management unit 51 of the management application 25 of the SPS server 3 (A-1) determines that the connection has been approved by the administrator of the SPS server 3 (A-1). In response to receipt of information that the “DISAPPROVE” button 89 has been clicked, the connection/disconnection management unit 51 of the management application 25 of the SPS server 3 (A-1) determines that the connection has been disapproved by the administrator of the SPS server 3 (A-1).

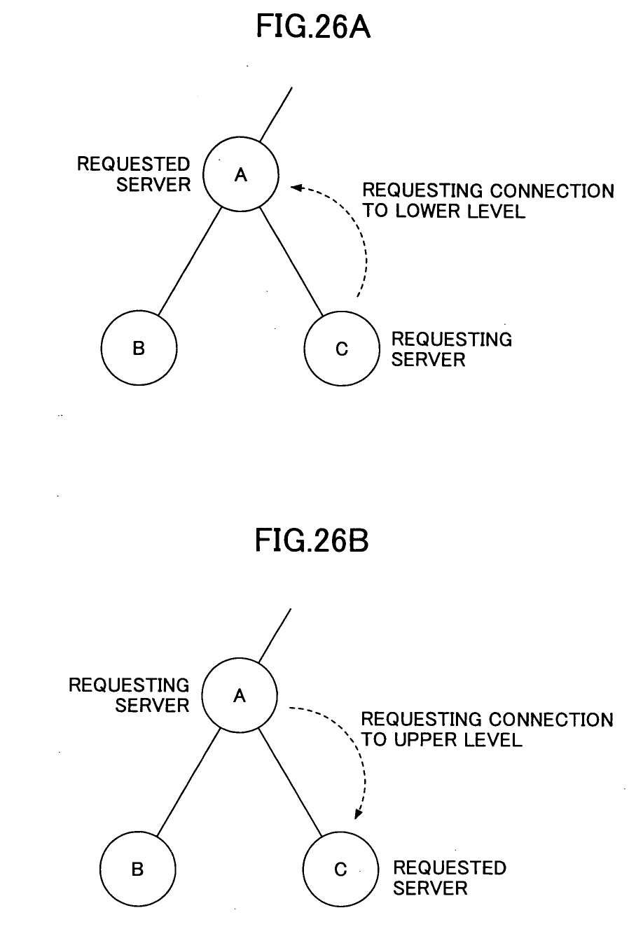

In step S41, the consistency check unit 52 of the management application 25 of the SPS server 3 (A-1) checks whether the system can maintain consistency even if the SPS server 3 (A-1-2) is connected to the SPS server 3 (A-1) as a lower level entity (that is, as shown in FIG. 5B, new data are added to the service list of the present SPS server 3 (A-1) as a result of connection as shown in FIG. 4), for example, based on the request from the requesting SPS server 3 (A-1-2). The checking of consistency is described in detail below with reference to FIGS. 26 through 28.

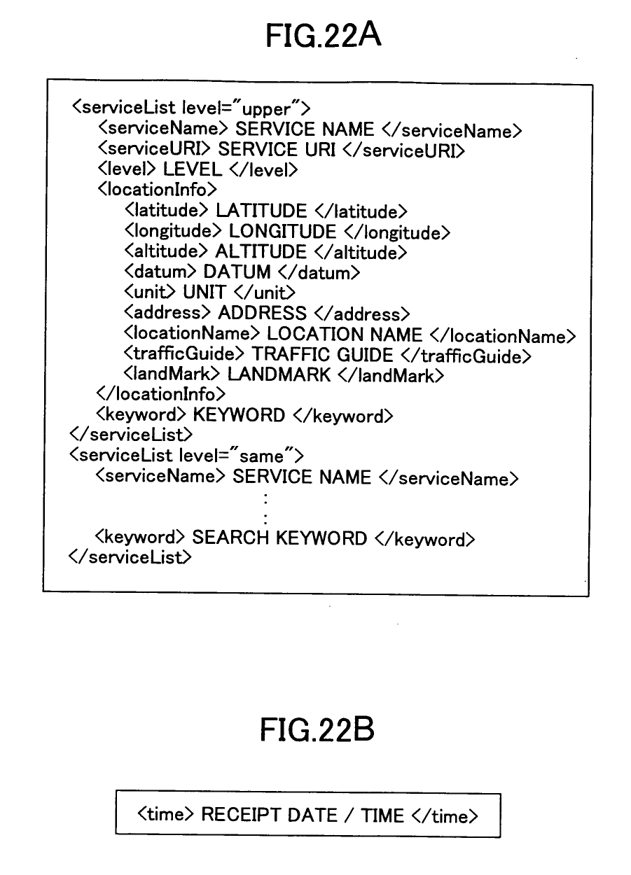

In step S41, the consistency check unit 52 of the management application 25 of the SPS server 3 (A-1) issues and transmits a message to the consistency check unit 42 of the print environment sharing service 13 of the requesting SPS server 3 (A-1-2), the message including a method (checklist) for requesting to check the consistency of the service list stored in the SPS server 3 (A-1-2). Exemplary I/F of checklist method is shown in FIG. 22.

In step S20, in response to receipt of the message, the consistency check unit 42 of the print environment sharing service 13 of the SPS server 3 (A-1-2) checks whether the system can maintain consistency even if, based on the request form the present SPS server 3 (A-1-2), the SPS server 3 (A-1) is connected to the SPS server 3 (A-1-2) as an upper level entity, (that is, new data are added to the service list of the present SPS server 3 (A-1-2) as shown in FIG. 5A as a result of a connection shown in FIG. 4).

In step S41, when the SPS server 3 (A-1-2) is connected, the consistency check unit 52 of the management application 25 of the SPS server 3 (A-1) issues and transmits a message to the consistency check unit 42 of the print environment sharing service 13 of the SPS server 3 (A-1-1) that is in the same level as the present SPS server 3 (A-1-2), the message including a method (checklist) requesting to check the consistency of the service list stored in the SPS server 3 (A-1-1).

In step S50, in response to the message, if new data are added to the service list of the present SPS server 3 (A-1-1) as shown in FIG. 5C as a result of connection shown in FIG. 4, the consistency check unit 42 of the print environment sharing service 13 of the SPS server 3 (A-1-1) checks whether the system can maintain consistency.

In step S42, the connection/disconnection management unit 51 of the management application 25 of the SPS server 3 (A-1) informs the administrator of the SPS server 3 (A-1-2) and the administrator of the SPS server 3 (A-1-1) via e-mail messages of the following: the result of determination in step S40, the result in step S41, the result in step S20, and the result in step S50.

In step S43 subsequent to step S42, the connection/disconnection management unit 51 of the management application 25 of the SPS server 3 (A-1) determines whether to connect based on the following: the result of determination in step S40, the result in step S41, the result in step S20, and the result in step S50.

In step S43, if the connection/disconnection management unit 51 of the management application 25 of the SPS server 3 (A-1) determines to approve the connection (YES in step S43), the process proceeds to step S44, otherwise proceeds to step S45.

In step S44, the connection/disconnection unit 51 of the management application 25 of the SPS server 3 (A-1) adds data such as access information of the requesting print environment sharing service 13 in the service list stored in the SPS server 3 (A-1).

In step S45, the connection/disconnection unit 51 of the management application 25 of the SPS server 3 (A-1) deletes information that has been added in step S31 from the list of requested connections.

The consistency of the system may be checked again between steps S44 and S45.

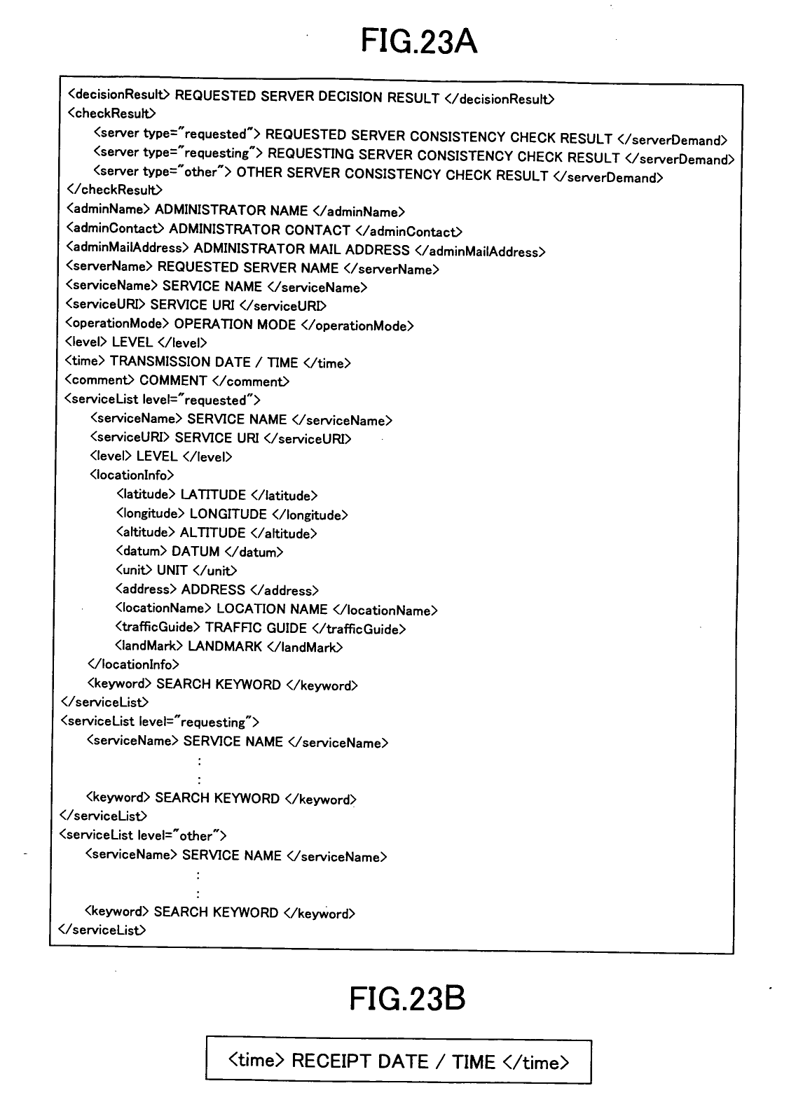

On the other hand, at the same time as the process proceeds from step S42 to step S43, the connection/disconnection management unit 51 of the management application 25 of the SPS server 3 (A-1) issues and transmits a message to the print environment sharing service 13 of the SPS server 3 (A-1-2) and the print environment sharing service 13 of the SPS server 3 (A-1-1), the message including a method (sendInfo) for requesting to determine whether to connect including the following: the result in step S40, the result in step S41, the result in step S20, and the result in step S50. Exemplary I/F of the sendInfo method is shown in FIG. 23 (to be described below).

In step S21, the print environment sharing service 13 of the SPS server 3 (A-1-2) determines whether to connect based on the following: the result of determination in step S40, the result in step S41, the result in step S20, and the result in step S50.

If the print environment sharing service 13 of the SPS server 3 (A-1-2) determines to connect (YES in step S20), the process proceeds to step S22, and otherwise, the process proceeds to step S23.

In step S22, the connection/disconnection management unit 41 of the print environment sharing service 13 of the SPS server 3 (A-1-2) adds data such as access information of the requested print environment sharing service 13 (A-1) and the print environment sharing service 13 (A-1-1) to the service list stored in the SPS server 3 (A-1-2).

In step S23, the connection/disconnection management unit 41 of the print environment sharing service 13 of the SPS server 3 (A-1-2) updates the list of requesting connections by deleting the information added in step S11 from the list.

The checking of consistency may be performed again between steps S22 and S23.

In step S51, the print environment sharing service 13 of the SPS server 3 (A-1-1) determines whether to connect based on the following: the result of determination in step S40, the result in step S41, the result in step S20, and the result in step S50.

If the print environment sharing service 13 of the SPS server 3 (A-1-1) determines to connect (YES in step S51), the process proceeds to S52, otherwise ends processing.

In step S52, the connection/disconnection management unit 41 of the print environment sharing service 13 of the SPS server 3 (A-1-1) adds data-such as access information of the requesting print environment sharing service 13 (A-1-2) to the service list stored in the SPS server 3 (A-1-1).

The checking may be performed again after step S52.

A connection and the adding of data to the service list described with reference to FIGS. 4 and 5 can be performed by processing as shown in FIG. 18. However, in FIG. 18, it is assumed that the SPS server 3 (A-1), which is in the upper level of the requesting SPS server 3 (A-1-2), is authorized to determine whether to approve or disapprove the connection of the requesting SPS server 3 (A-1-2) because the SPS server 3 (A-1) and the SPS server 3 (A-1-1) are already connected. This is the reason why the administrator of the SPS server 3 (A-1-1) is not requested to approve the connection.

The description of disconnection processing is omitted since disconnection processing can be described in the same manner as connection processing if “connection” is read as “disconnection” and the “addition of data” as “deletion of data” in the above description. In the case of disconnection, however, the checking of consistency may not be required.

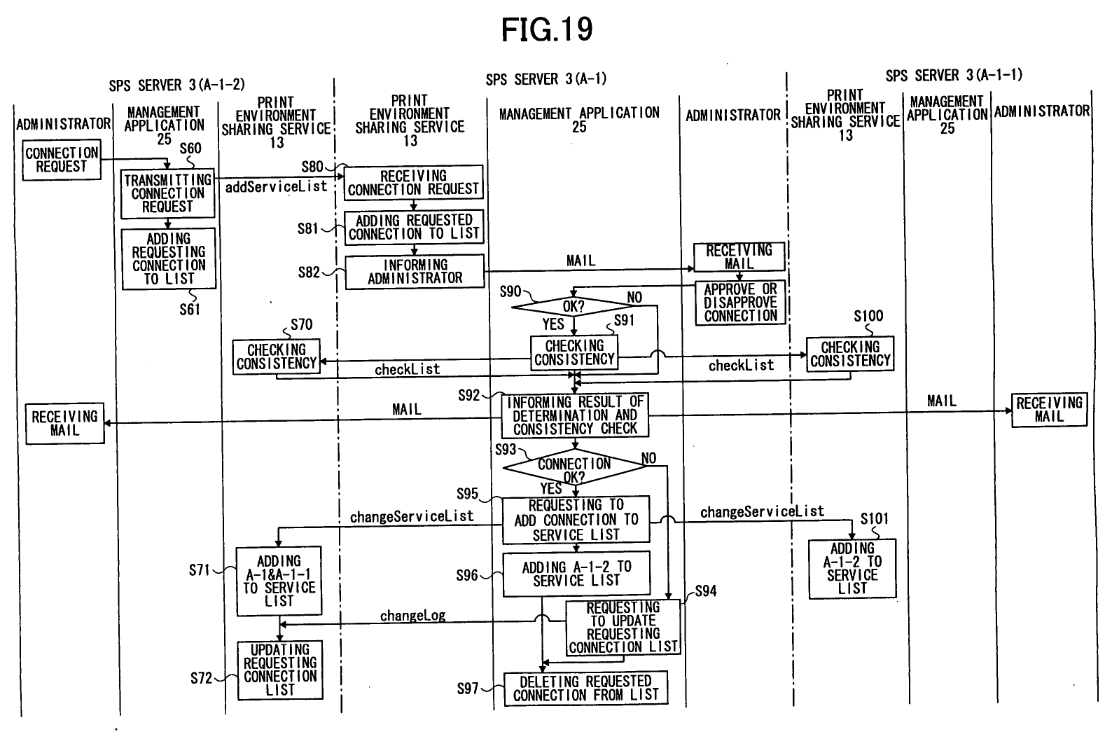

Referring to FIG. 19, another example of connection processing by the SPS server 3 is described below.

FIG. 19 is a flowchart for explaining connection processing by the SPS server.

In FIG. 19, it is assumed that the SPS server 3 (A-1-2) requests the SPS server 3 (A-1) for connection as in FIG. 4.

The administrator of the SPS server 3 (A-1-2), using the service connection/disconnection screen provided by the connection/disconnection management unit 51 of the management application 25 as shown in FIG. 29, designates the requested SPS server 3, and instructs to transmit a connection request.

In response to the instruction to transmit a connection request as described above by the administrator of the SPS server 3 (A-1-2), the management application 25 performs the following processing.

In step S60, the connection/disconnection management unit 51 of the management application 25 of the requesting SPS server 3 (A-1-2) issues and transmits a message to the print environment sharing service 13 of the requested SPS server 3 (A-1), the message including a method (addServiceList) for requesting connection.

In step S61 subsequent to step S60, the connection/disconnection management unit 51 of the management application 25 of the SPS server 3 (A-1-2) adds information of the requested SPS server 3 (for example, URL, location, and address), and information of the date and time of connection request to the list of requesting connections.

On the other hand, in step S80, the connection/disconnection management unit 41 of the print environment sharing service 13 of the requested SPS server 3 (A-1) receives the message transmitted by the SPS server 3 (A-1-2) in step S60.

In step S81 subsequent to step S80, the connection/disconnection unit 41 of the print environment sharing service 13 of the SPS server 3 (A-1) adds the information of the requesting SPS server 3 and the information of the date and time of connection request in the list of requested connections.

In step S82 subsequent to step S81, the connection/disconnection management unit 41 of the print environment sharing service 13 of the SPS server 3 (A-1) informs the administrator of the SPS server 3 (A-1) using an e-mail message, that it received a connection request.

In response to receipt of the e-mail message, the administrator of the SPS server 3 (A-1) activates the management application 25 of the SPS server 3 (A-1). As will be appreciated, the connection/disconnection management unit 51 of the management application of the SPS server 3 (A-1) provides the administrator the list of requested connection requests. The administrator selects a request in the list, determines whether the administrator approves the connection request, and clicks either an “APPROVE” button 88 or a “DISAPPROVE” button 89.

In step S90, in response to a determination that the administrator of the SPS server 3 (A-1) has approved the connection request (YES in step S90), the process proceeds to step S91. In response to a determination that the administrator of the SPS server 3 (A-1) has disapproved the connection request (NO in step S90), the process proceeds to step S92.

For example, in response to receipt of information that the “APPROVE” button 88 has been clicked in the service connection/disconnection screen shown in FIG. 29 (to be described below), the connection/disconnection management unit 51 of the management application 25 of the SPS server 3 (A-1) determines that the connection has been approved by the administrator of the SPS server 3 (A-1). In response to receipt of information that the “DISAPPROVE” button 89 has been clicked, the connection/disconnection management unit 51 of the management application 25 of the SPS server 3 (A-1) determines that the connection has been disapproved by the administrator of the SPS server 3 (A-1).

In step S91, the consistency check unit 52 of the management application 25 of the SPS server 3 (A-1) checks whether the system can maintain consistency even if the SPS server 3 (A-1-2) is connected to the lower level of the SPS server 3 (A-1) (that is, as shown in FIG. 5B, new data are added to the service list of the present SPS server 3 (A-1) as a result of connection as shown in FIG. 4), for example, based on the request from the requesting SPS server 3 (A-1-2). The checking of consistency is described in detail below with reference to FIGS. 26 through 28.

In step S41, the consistency check unit 52 of the management application 25 of the SPS server 3 (A-1) issues and transmits a message to the consistency check unit 42 of the print environment sharing service 13 of the requesting SPS server 3 (A-1-2), the message including a method (checklist) for requesting to check the consistency of the service list stored in the SPS server 3 (A-1-2).

In step S70, in response to receipt of the message, the consistency check unit 42 of the print environment sharing service 13 of the SPS server 3 (A-1-2) checks whether the system can maintain consistency even if, based on the request form the present SPS server 3 (A-1-2), the SPS server 3 (A-1) is connected to the upper level of the SPS server 3 (A-1-2), (that is, new data are added to the service list of the present SPS server 3 (A-1-2) as shown in FIG. 5A as a result of a connection shown in FIG. 4).

In step S91, when the SPS server 3 (A-1-2) is connected, the consistency check unit 52 of the management application 25 of the SPS server 3 (A-1) issues and transmits a message to the consistency check unit 42 of the print environment sharing service 13 of the SPS server 3 (A-1-1) that is in the same level as the present SPS server 3 (A-1-2), the message including a method (checklist) requesting to check the consistency of the service list stored in the SPS server 3 (A-1-1).

In step S100, in response to the message, if new data are added to the service list of the present SPS server 3 (A-1-1) as shown in FIG. 5C as a result of connection shown in FIG. 4, the consistency check unit 42 of the print environment sharing service 13 of the SPS server 3 (A-1-1) checks whether the system can maintain consistency.

In step S92, the connection/disconnection management unit 51 of the management application 25 of the SPS server 3 (A-1) informs the administrator of the SPS server 3 (A-1-2) and the administrator of the SPS server 3 (A-1-1) via e-mail messages of the following: the result of determination in step S90, the result in step S91, the result in step S70, and the result in step S100.

In step S93 subsequent to step S92, the connection/disconnection management unit 51 of the management application 25 of the SPS server 3 (A-1) determines whether to connect based on the following: the result of determination in step S90, the result in step S91, the result in step S70, and the result in step S100.

In step S93, if the connection/disconnection management unit 51 of the management application 25 of the SPS server 3 (A-1) determines to approve the connection (YES in step S93), the process proceeds to step S94, otherwise proceeds to step S95.

In step S94, the connection/disconnection unit 51 of the management application 25 of the SPS server 3 (A-1) issues and transmits a message to the shrad printer service 13 of the SPS server 3 (A-1-2), the message including a method (changeLog) requesting for updating the list of requested connections.

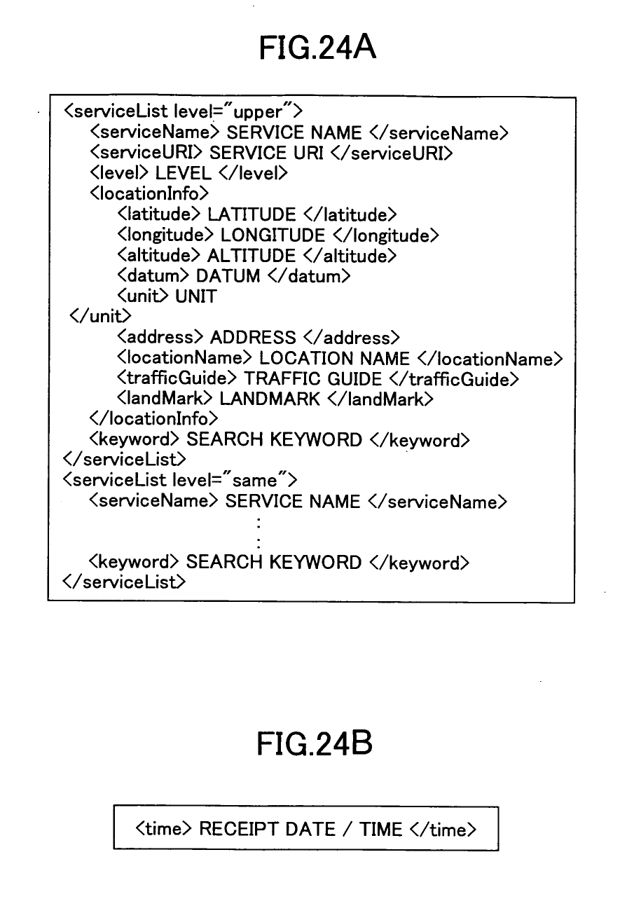

On the other hand, in step S95, the connection/disconnection management unit 51 of the management application 25 of the SPS server 3 (A-1) issues and transmits a message to the print environment sharing service 13 of the SPS server 3 (A-1-2) and the print environment sharing service 13 of the SPS server 3 (A-1-1), the message including a method (changeServiceList) for requesting to add data such as the access information of the requesting print environment sharing service 13 to the service list. Exemplary I/F of the changeServiceList method is shown in FIG. 24.

In step S71, in response to receipt of the message, the connection/disconnection management unit 41 of the print environment sharing service 13 of the SPS server 3 (A-1-2) adds data such as access information of the requested print environment sharing service 13 (A-1) and the print environment sharing service 13 (A-1-1), which is in the same level, in the service list stored in the SPS server 3 (A-1-2).

In step S72, the connection/disconnection unit 51 of the print environment sharing service 13 of the SPS server 3 (A-1-2) updates the list of requesting connections by deleting information added in step S61, for example.

The checking of consistency may be performed between steps S71 and S72 again.

In step S101, in response to receipt of the message, the connection/disconnection management unit 51 of the print environment sharing service 13 of the SPS server 3 (A-1-1) adds data such as access information of the requesting print environment sharing service 13 (A-1-2) in the service list stored in the SPS server 3 (A-1-1).

The checking of consistency may be performed again after step S101.

In step S96 subsequent to step S95, the connection/disconnection management unit 51 of the management application 25 of the SPS server 3 (A-1) adds data such as access information of the requesting print environment sharing service 13 in the service list stored in the SPS server 3 (A-1).

In step S97, the connection/disconnection management unit 51 of the management application 25 of the SPS server 3 (A-1) deletes information added in step S81 from the list of requested connections.

The checking of consistency may be performed again between step S96 and step S97.

Processing shown in FIG. 19 is different from processing shown in FIG. 18 only in that the management application 25 of the SPS server 3 (A-1) determines whether to approve the connection.

A connection and the adding of data to the service list can be realized by processing shown in FIG. 19 as described with reference to FIGS. 4 and 5.

If “connection” is read as “disconnection” and “addition of data” is read as “deletion of data”, disconnection processing can be described in the same manner as connection processing. Therefore, the description of disconnection processing is omitted. In the case of disconnection, the checking of consistency may not be required.

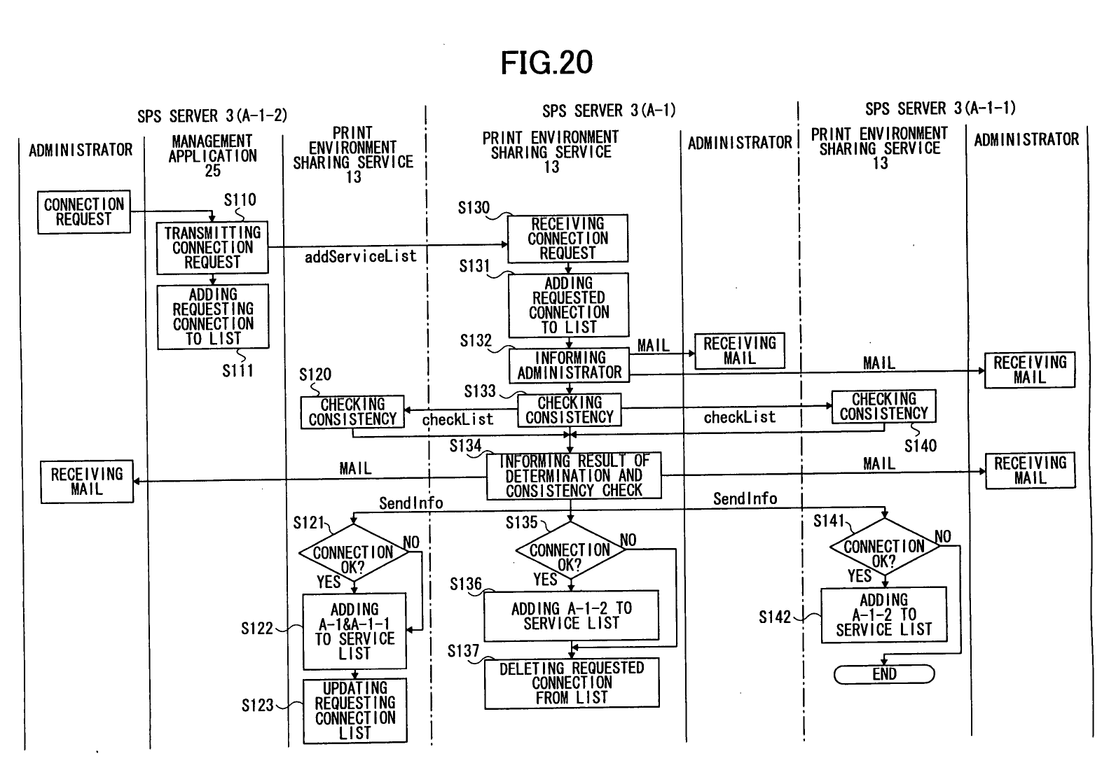

Connection processing of the SPS server 3 is further described below with reference to FIG. 20. FIG. 20 is a flowchart for explaining connection processing by the SPS server.

In FIG. 20, the print environment sharing service 13 of the requested SPS server 3 performs processing that is performed by the management application 25 of the requested SPS server 3.

If the print environment sharing service 13 is set to automatically approve a connection, the print environment sharing service 13 of the requested SPS server 3 can perform processing that is performed by the management application 25 of the requested SPS server 3 shown in FIG. 18.

A determination is made whether the automatic approval is set after step S132 of FIG. 20. If the automatic approval is set (if a flag of a specific file is set, for example), steps S133 through S137 shown in FIG. 20 may be executed. If the automatic approval is not set (if a flag of a specific file is not set), steps S40 through S45 shown in FIG. 18 may be executed.

According to the above arrangements, the administrator of the requested SPS server 3 automatically approves the connection, and if the consistency of the system is maintained, the administrator can add the counterpart in the service list of the SPS server 3.

If “connection” is read as “disconnection” and “addition of data” is read as “deletion of data”, for example, disconnection processing can be described in the same manner as connection processing. Accordingly, no description is given to disconnection processing. The checking of consistency may be not required.

Exemplary I/F of the addServiceList method is shown in FIGS. 21A and 21B. FIG. 21A and 21B are schematic diagrams showing an I/F of the addServiceList method.

The connection/disconnection management unit 51 of the management application 25 calls the addServiceList method with parameters as shown in FIG. 21A, and acquires a returned value as shown in FIG. 21B.

FIG. 22 shows exemplary I/F of the checklist method.

For example, the consistency check unit 52 of the management application 25 calls the checklist method with parameters as shown in FIG. 22A, and acquires a returned value as shown in FIG. 22B.

FIG. 23 shows exemplary I/F of the sendInfo method.

The connection/disconnection management unit 51 of the management application 25 calls the sendInfo method with parameters as shown in FIG. 23A, and acquires a returned value as shown in FIG. 23B.

FIG. 24 shows exemplary I/F of the changeServiceList method.

The connection/disconnection management unit 51 of the management application 25, for example, calls the changeServiceList method with parameters as shown in FIG. 24A, and acquires a returned value as shown in FIG. 24B.

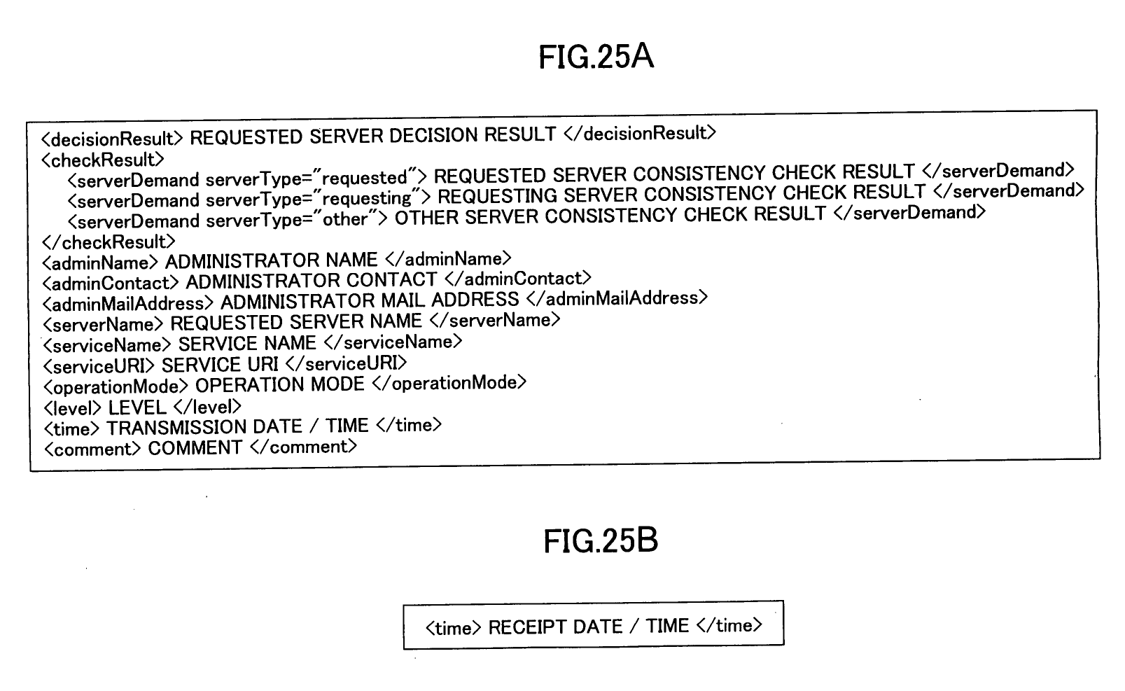

FIG. 25 shows exemplary I/F of the changeLog method.

The connection/disconnection management unit 51 of the management application 25, for example, calls the changeLog method with parameters as shown in FIG. 25A, and acquires a returned value as shown in FIG. 25B.

The checking of consistency is described in detail with reference to FIGS. 26 through 28. FIG. 26 is a schematic diagram for explaining the checking of consistency.

As shown in FIG. 26A, if a SPS server 3(C) that has been connected to the SPS server 3(A) as a lower level entity transmits a request that the SPS server 3(C) be connected to the SPS server 3(A) as a lower level entity, to the SPS server 3(A), the consistency check unit 42 or 52 of the SPS server 3(A) refers to the service list stored in the present SPS server 3(A), and determines whether the SPS server 3(C) has already been connected to the present SPS server 3(A) as a lower level entity.

If the consistency check unit 42 or 52 of the SPS server 3(A) determines that the SPS server 3(C) has been listed in the lower level of the service list retained by the present SPS server 3(A), the consistency check unit 42 or 52 disapproves the connection since the system cannot maintain consistency.

Similarly, the consistency check unit 42 or 52 of the SPS server 3(C) refers to the service list retained by the SPS server 3(C), and determines whether the SPS server 3(A) is connected to the SPS server 3(C) as an upper level entity.

If the consistency check unit 52 of the SPS server 3(C) determines that the SPS server 3(A) is already connected to the SPS server 3(C) as an upper level entity, the consistency check unit 52 of the SPS server 3(C) stops connecting, for example, since the system cannot be maintained consistent.

The consistency check unit 52 of the SPS server 3(B) refers to the service list retained by the SPS server 3(B), and determines whether the SPS server 3(C) is already connected to the SPS server 3(B) as a same level entity.

If the consistency check unit 52 of the SPS server 3(B) determines that the SPS server 3(C) is already listed in the same level of the SPS server 3(B) of the service list retained by the SPS server 3(B), the consistency check unit 52 of the SPS server 3(B) rejects connecting the SPS server 3(C) since the system cannot be maintained consistent.

The checking of consistency in the case in which the SPS server 3(C), which is already connected to the SPS server 3(A), requests the SPS server 3(A) for permission for connecting thereto as a lower level entity is described above with reference to FIG. 26A. The checking of consistency in the case in which the SPS server 3(C), which is already connected to the SPS server 3(A), requests the SPS server 3(A) for permission for connecting thereto as an upper level entity can be described with reference to FIG. 26B in the same manner as FIG. 26A.

In the case of exemplary embodiment shown in FIG. 26A, if the SPS server 3(A) and the SPS server 3(C) have not been connected, the SPS server 3(C) transmits a request to the SPS server 3(A), the request being for permission for connecting to the SPS server 3(A) as a lower level entity. If a determination is made about that the system remains consistent, the SPS server 3(A) registers the SPS server 3(C) in the service list of the SPS server 3(A) as a lower level entity, and the SPS server 3(C) registers the SPS server 3(A) in the service list of the SPS server 3(C) as an upper level entity. That is, the SPS server 3(C), for example, does not register the SPS server 3(A) in the service list of the SPS server 3(C) as a lower level entity. If the SPS server 3(C) requests the SPS server 3(A) for permission for connecting thereto as an upper level entity, the SPS server 3(C) does not register the SPS server 3(A) in the service list of the SPS server 3(C) as an upper level entity.

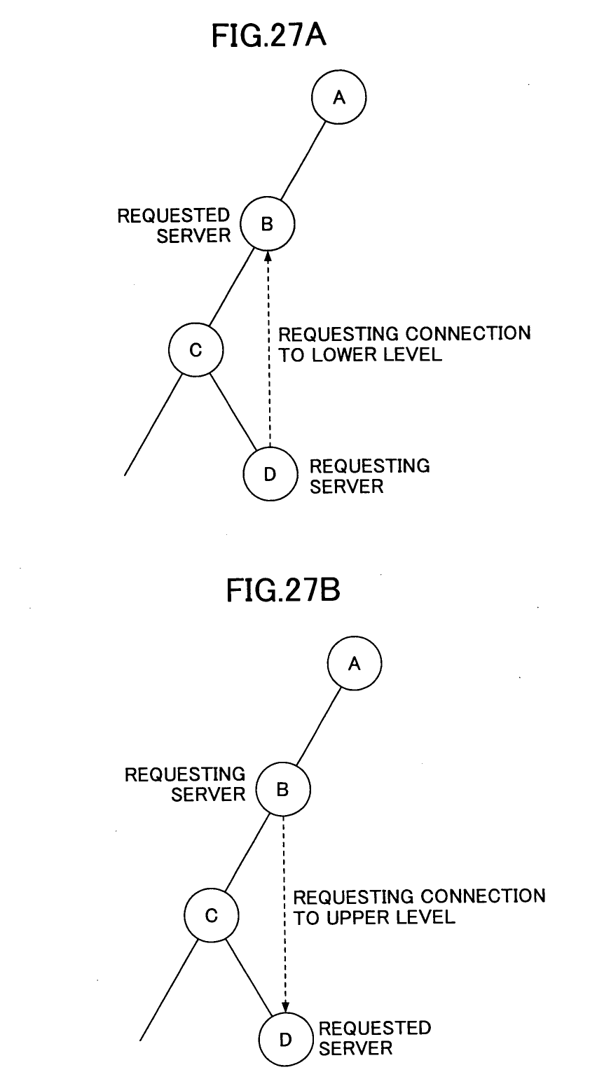

FIGS. 27A and 27B are schematic diagrams for explaining the checking of consistency.

As shown in FIG. 27A, the SPS server 3(D) is connected to the SPS server 3(C) as a lower level entity. If the SPS server 3(D) requests the SPS server 3(B) for permission for connecting thereto as a lower level entity, the consistency check unit 42 or 52 of the SPS server 3(D) refers to the service list retained by the SPS server 3(D), and determines whether there is any other SPS server 3 as an upper level entity.

As shown in FIG. 27A, if the consistency check unit 42 or 52 of the SPS server 3(D) determines that there is the SPS server 3(C) in the service list retained by the SPS server 3(D) as an upper level entity, the consistency check unit 52 of the SPS server 3(D) discontinues connecting, for example.

As shown in FIG. 27B, if the SPS server 3(B) requests the SPS server 3(D) for permission for connecting thereto as an upper entity, the consistency check unit 42 or 52 of the SPS server 3(D) refers to the service list retained by the SPS server 3(D), and determines whether there is any other SPS server 3 registered as an upper level entity in the service list.

As shown in FIG. 27B, if the consistency check unit 42 or 52 of the SPS server 3(D) determines that the SPS server 3(C) is already registered as an upper level entity in the service list retained by the SPS server 3(D), the consistency check unit 52 of the SPS server 3(D) rejects the request, for example, since the system can not be maintained consistent.

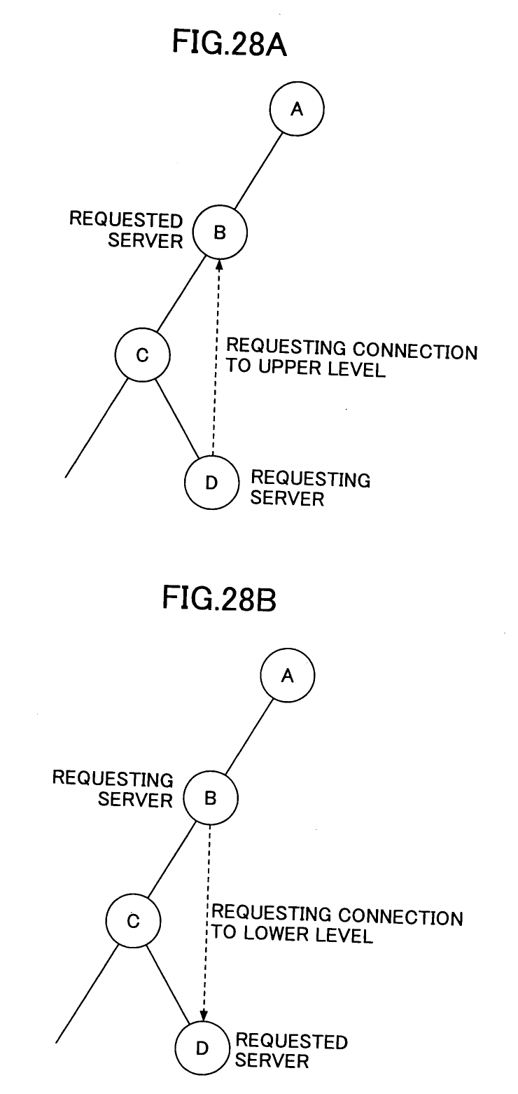

FIGS. 28A and 28B are schematic diagrams for explaining the checking of consistency according to an embodiment.

As shown in FIG. 28A, the SPS server 3(C) is connected to the SPS server 3(D) as a lower level entity thereof. If the SPS server 3(D) requests the SPS server 3(B) for permission for connecting thereto as an upper level entity, the consistency check unit 42 or 52 of the SPS server 3(B) refers to the service list retained by the SPS server (B), and determines whether there is any other SPS server 3 registered as an upper level entity in the service list.

As shown in FIG. 28A, if the consistency check unit 42 or 52 of the SPS server 3(B) determines that the SPS server 3(A) is already registered as an upper level entity in the service list retained by the SPS server 3(B), the consistency check unit 52 of the SPS server 3(B) rejects the request since the system can not be maintained consistent.

As shown in FIG. 28B, if the SPS server 3(B) requests the SPS server 3(D) for permission for connecting thereto as a lower level entity of the SPS server 3(D), the consistency check unit 42 or 52 of the SPS server 3(B) refers to the service list retained by the SPS server 3(B), and determines whether there is any other SPS server 3 registered as an upper level entity of the SPS server 3(B).

As shown in FIG. 28B, the consistency check unit 52 of the SPS server 3(B) determines that the SPS server 3(A) is already listed as an upper level entity in the service list retained by the SPS server 3(B), the consistency check unit 52 of the SPS server 3(B) stops connecting since the system can not be maintained consistent.

FIGS. 29A through 29D are schematic diagrams for explaining service connection/disconnection screens according to an embodiment.

The administrator of the SPS server 3 activates the management application 25. The management application 25 displays screens as shown in FIGS. 29A through 29D. If the administrator wants to connect one of print environment sharing services 13 displayed in the service display area 80, for example, the administrator selects the print environment sharing service 13 to which she wants to connect, one of radio buttons indicating the upper level, the same level, and the lower level, and clicks a connection request button 83 thereby to make a connection request.

In response to the administrator's selecting the print environment sharing service 13 and clicking the connection request button 83, step S10 of FIG. 18, step S60 of FIG. 19, step S110 of FIG. 20, for example, are executed.

The connection/disconnection management unit 51 of the management application 25 displays information added in step S11 of FIG. 18, step S61 of FIG. 19, and step S111 of FIG. 20 in a requesting connection display area 90.

If the connection/disconnection management unit 51 of the print environment sharing service 13 adds data such as the access information of the print environment sharing service 13 of the requested SPS server 3 in the service list in step S22 of FIG. 18, step S71 of FIG. 19, and step S122 of FIG. 20, the connection/disconnection management unit 51 of the print environment sharing service 13 displays the print environment sharing service 13 of the connection-requested SPS server 3 in a connected service display area 81.

The connection/disconnection management unit 51 of the print environment sharing service 13 displays the list of requesting connections updated in step S23 of FIG. 18, step S72 of FIG. 19, and step S123 of FIG. 20 in the requesting connection list display area 90.

On the other hand, the connection/disconnection management unit 51 of the print environment sharing service 13 of the connection-requested SPS server 3 displays information in a requested connection list display area 85, the information added in the list of requested connections in step S31 of FIG. 18, step S81 of FIG. 19, and step S131 of FIG. 20.

In response to receipt of a connection request from another SPS server 3, the connection/disconnection management unit 41 of the print environment sharing service 13 of the connection-requested SPS server 3 informs the administrator thereof of the connection request via e-mail, for example. The administrator activates the management application 25, selects the requested connection displayed in the requested connection list display area 85, and clicks either the “approve” button 88 or the “disapprove” button 89 thereby to approve or disapprove the connection request.

When the connection/disconnection management unit 51 of the print environment sharing service 13 of the connection-requested SPS server 3 adds data of the access information of the print environment sharing service 13 of the connection-requesting SPS server 3 in the service list in step S44 of FIG. 18, step S96 of FIG. 19, and step S136 of FIG. 20, the connection/disconnection management unit 41 of the print environment sharing service 13 of the connection-requested SPS server 3 displays the print environment sharing service 13 of the connection-requesting SPS server 3 in a connected service display area 81.

The connection/disconnection management unit 41 of the print environment sharing service 13 of the connection-requested SPS server 3 deletes the list of requested connections from which information has been deleted in step S45 of FIG. 18, step S97 of FIG. 19, and step S137 of FIG. 20 in a requested connection list display area 85.

The administrator of the SPS server 3 can request connection or disconnection to another SPS server 3, and approve or disapprove a connection request from another SPS server 3 using the screens shown in FIGS. 29A through 29D.

FIG. 30 is a schematic diagram for explaining the selecting of print location.

In the case of the system shown in FIG. 1, the Web server 1 requests the print environment sharing service 13 of the SPS server 3 (A-1) to acquire the service list, and acquires the service list stored in the SPS server 3 (A-1) based on a request from the user.

The Web server 1 creates a screen as shown in FIG. 30A based on the service list of the SPS server 3 (A-1), and provides the screen to the user.

FIG. 30A shows the print environment sharing services 13 of another SPS server 3 that the print environment sharing service 13 of the SPS server 3 (A-1) can use.

When the user selects A-0, and clicks a “Next” button 91; for example, the Web server 1 requests the print environment sharing service 13 of the SPS server 3 (A-1) to acquire the service list stored in the SPS server 3 (A-0).

In response to receipt of the request, the print environment sharing service 13 of the SPS server 3 (A-1) acquires the service list stored in the SPS server 3 (A-0) from the print environment sharing service 13 of the SPS server 3 (A-0), and provides the service list to the Web server 1.

The Web server 1 creates a screen as shown in FIG. 30B based on the service list acquired from the SPS server 3 (A-0), and provides the screen to the user.

When the user selects B-0 and clicks the “NEXT” button 92, the Web server 1 requests the print environment sharing service 13 of the SPS server 3 (A-1) to acquire the service list stored in the SPS server 3 (B-0).

In response to receipt of the request, the service list acquisition unit 45 of the print environment sharing service 13 of the SPS server (A-1) requests the print environment sharing service 13 of the SPS server 3 (A-0) to acquire the service list stored in the SPS server 3 (B-0).

In response to receipt of the request, the service list acquisition unit 45 of the print environment sharing service 13 of the SPS server 3 (A-0) acquires the service list stored in the SPS server 3 (B-0) from the print environment sharing service 13 thereof, and provides the acquired service list to the service list acquisition unit 45 of the print environment sharing service 13 of the SPS server 3 (A-1). In response to the acquisition of the service list stored in the SPS server 3 (B-0), the service list acquisition unit 45 of the print environment sharing service 13 of the SPS server 3 (A-1) provides the service list to the Web server 1.

The Web server 1 creates a screen as shown in FIG. 30C based on the acquired service list of the SPS server 3 (B-0), and provides the screen to the user.

When the user selects B-2 and clicks a “SELECT” button 93, for example, the print environment sharing service 13 of the SPS server 3 (B-2) is selected as the print location.

As described above with reference to FIGS. 30A through 30C, the user can select the print environment sharing service 13 of the SPS server 3 that is selected as a print location using the service list. As described above, when the user selects a print location, the user can select prefecture name, city name, division name, or department name, which correspond to the SPS server 3 and the print environment sharing service 13 and easy to understand, instead of directly selecting the the SPS server 3 and the print environment sharing service 13.

The route information to the print environment sharing service 13 of the SPS server 3 of the print location can be obtained.

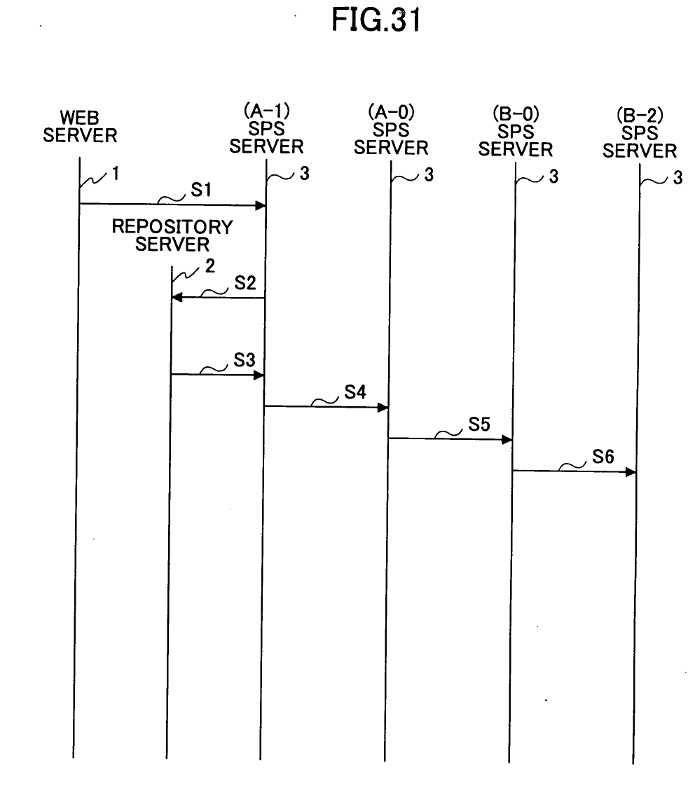

FIG. 31 is a sequence chart for explaining the transferring of document data and reservation information related to a print reservation.

In step S1, as described with reference to FIG. 1, the Web server 1 makes a print reservation to the print environment sharing service 13 of the SPS server 3 (A-1) using the following information: print location (the print environment sharing service 13 of the SPS server 3 (B-2)), the printer, print conditions, route information to the print location, reservation information, access information to the repository server 2 in which the document to be printed is stored, document ID of the document, and document ticket for obtaining permission to use the document, for example.

In step S2 subsequent to step S1, the document acquisition unit 43 of the print environment sharing service 13 of the SPS server 3 (A-1) requests the designated depository server 2 to acquire the document using the document ticket.

In step S3 subsequent to step S2, the repository server 2 determines whether the document ticket is valid based on the above request, and provides the document to the print environment sharing service 13 of the SPS server 3 (A-1).

In step S4 subsequent to step S3, the transfer unit 44 of the print environment sharing service of the SPS server 3 (A-1) transfers the reservation information and the acquired document data to the print environment sharing service 13 of the SPS server 3 (A-0) based on the route information included in the reservation information. In step S5 subsequent to step S4, the transfer unit 44 of the print environment sharing service 13 of the SPS server 3 (A-0) transfers the acquired reservation information and the document data to the print environment sharing service 13 of the SPS server 3 (B-0) based on the route information included in the reservation information.

In step S6 subsequent to step S5, the transfer unit 44 of the print environment sharing service 13 of the SPS server 3 (B-0) transfers the acquired reservation information and the document data to the print environment sharing service 13 of the SPS server 3 (B-2) based on the route information included in the reservation information.

As shown in FIG. 31, the print environment sharing service 13 can transfer the reservation information and/or the document data acquired from the repository server 2 to the print environment sharing service 13 in the print location using the route information.

An exemplary embodiment has been described in which the repository server 2 is connected to the SPS server 3 (A-1). According to another embodiment, the repository server 2 may not be connected to the SPS server 3 (A-1).

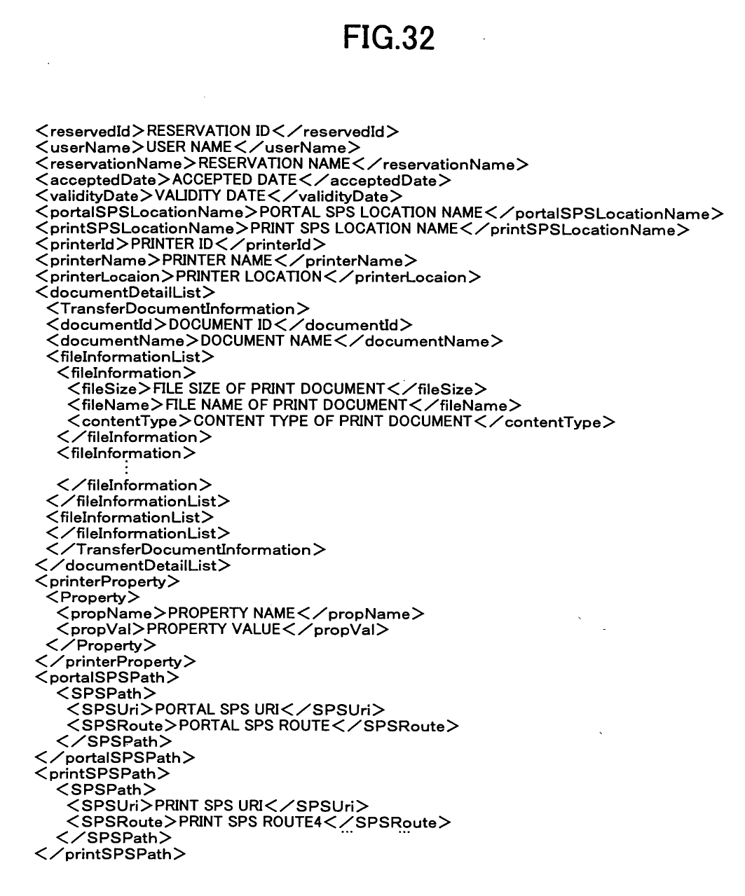

FIG. 32 is a schematic diagram for explaining the I/F of reserved information transfer method.

The print environment sharing service 13 may call the reservation information transfer method of another with parameters as shown in FIG. 32, and transfer the reservation information and a document to the print environment sharing service 13 in the print location/

### Second Embodiment

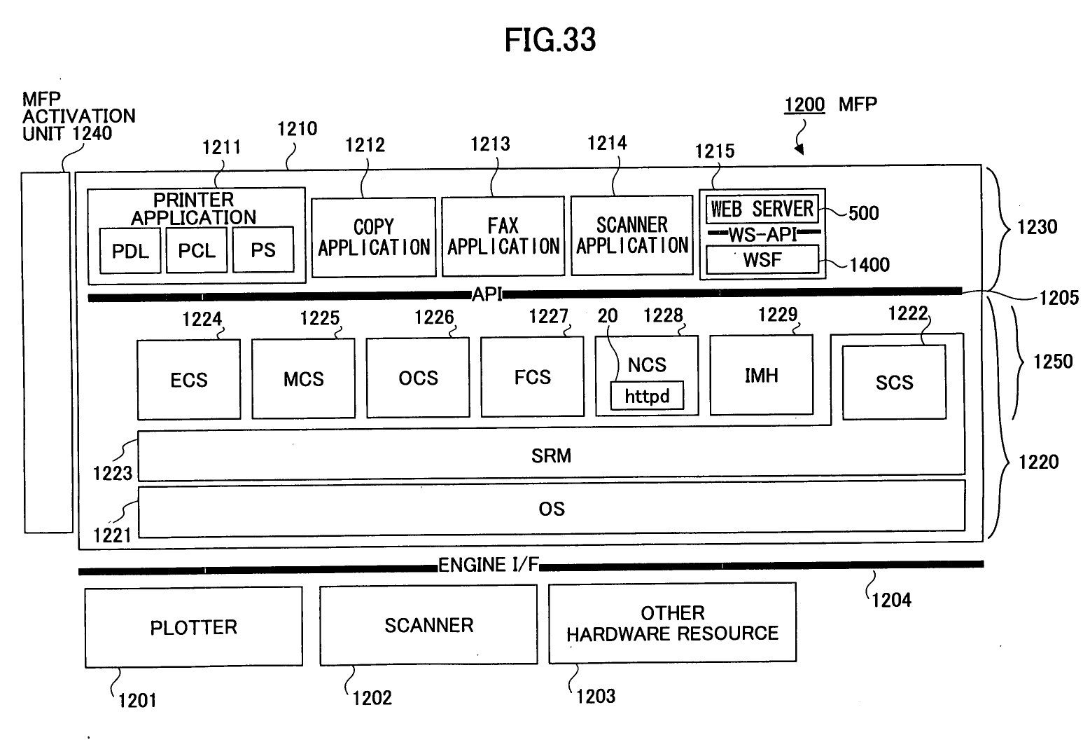

FIG. 33 is a block diagram showing the functional configuration a multifunctional peripheral (MFP) according to an embodiment. In FIG. 33, the MFP 1200 includes a plotter 1201, a scanner 1202, and hardware resource 1203 such as a facsimile unit. The MFP 1200 also includes software 1210 including a platform 1220 and applications 1230, and a MFP activation unit 1240.

When the MFP is turned on, the MFP activation unit 1240 is activated first, and activates the platform 1220 and the applications 1230.

The platform 1220 includes control services 1250, a system resource manager (SRM) 1223, and an operating system (OS) 1221. The control services interpret processing requests from the applications 1230, and generates acquisition requests for hardware resources. The SRM 1223 manages one or more items of software resource and arbitrates the acquisition requests from the control services 1250.

The control services 1250 include multiple service modules, specifically, a system control service (SCS) 1222, an engine control service (ECS) 1224, a memory control service (MCS) 1225, an Operations panel Control service ) 1226, a Fax control service (FCS) 1227, a Network Control Service (NCS) 1228, and Imaging Memory Handler (IMH) 1229. The platform 1220 has an application program interface (API) that can receive processing requests from the applications using predefined functions.

The OS 1221 is an operating system such as UNIX (trade mark) on which programs of the platform 1220 and the applications 1230 can be executed as multiple processes. Because the source code of UNIX (trade mark) is generally available, the security of programs can be secured. UNIX (trade mark) supports networking. The OS and TCP/IP are loyalty free, and easy to outsource.

SRM 1223 controls the system and manages the resource with SCS 1222, and arbitrates processing requests from the upper level modules that use hardware resource such as an engine unit (scanner and plotter, for example), memory, HDD file, host I/O (Centronics I/F, network I/F, IEEE 1394 I/F, and RS 232C I/F) and controls the executing of the processing requests.

Specifically, the SRM 1223 determines whether the requested item of hardware resource is available (whether it is used by another module), and if the requested item of hardware resource is available, the SRM 1223 informs the upper layer of the availability. In response to requests from the upper layer, the SRM 1223 may schedule the use of the hardware resource, and may directly perform the request (for example, paper transportation and image forming by the printer engine, memory reservation, and file creation).

The SCS 1222 performs the following functions: application management (function 1), operations unit control (function 2), system screen display such as job list screen and counter display screen (function 3), LED display (function 4), resource management (function 5), and interrupt application control (function 6), for example. Specifically, the SCS 1222 registers applications, and informs other applications of the new registration (application management, function 1). The SCS 1222 controls the exclusivity of use right of the operations unit by the application (operations unit control, function 2). The SCS 1222 displays warning screens corresponding to the state of the engine unit in response to a request from the application that has the use right of the operations unit (system screen control, function 3). The SCS 1222 controls the display of the system LEDs such as warning LED and application keys (LED display, function 4). The SCS 1222, when the application (ECS) executes a job, controls the exclusivity of the engine resource (scanner and stapler, for example) that needs to be used exclusively (resource management, function 5). The SCS 1222 manages the priority of specific applications (interrupt application control, function 6).

The ECS 1224 controls the engine units such as the plotter 1201, the scanner 1202, and other hardware resource 1203. The ECS 1224 performs image reading, printing operation, state information, and jam recovery, for example.

The MCS 1225 performs memory control, and specifically, acquires and discharge image memory, uses the hard disk drive (HDD), and compresses and decompresses the image data.

The OCS 1226 is a module that controls the operations panel that interfaces the operator with the system. The OCS 1226 informs the system of the operator's key operation events, provides library functions for building a GUI for the applications, controls the built GUI information by the application, and displays it on the operations panel.

The FCS 1227 provides an application program interface (API) for performing the following: transmission and reception of facsimile message via PSTN/ISDN network, registration and reference of facsimile data managed by a backup SRAM (BKM), reading of facsimile documents, printing of received facsimile messages, and integrated transmission and reception, for example.

The NCS 1228 is a group of modules for providing services that can be commonly used by the application that requires network I/O. The NCS 1228 distributes data received in accordance with a protocol from the network to the application, and mediates the transmission of data from the application to the network.

For example, the NCS 1228 may be configured in a manner in which a Hypertext Transfer Protocol Daemon (httpd) 20 controls data communication with a network device connected via the Internet in accordance with HypterText Transfer Protocol (HTTP), activates processing unit corresponding to the Web service designated in the HTTP request header using a function call, and informs the network device of the result of processing by the Web service by HTTP response. The Web service may be provided in accordance with a message described in extensible Markup Language (XML), for example.

The IMH 1229 maps the image data in a virtual memory region (user virtual space) to a physical memory. For example, in response to the activation of a process, the IMH 1229 issues a system call, maps a virtual memory region for a process, and discharges, when the process is terminated, the mapped virtual memory region.

The application 1230 includes the following: a printer application 1211 that is an application for printer that has page description language (PDL), PCL, and Postscript (PS); a copy application 1212 that is an application for a copier; a scanner application 1214 that is an application for a scanner; and a Web service processing application 1215 that is a Web service application. Since each application 1211 through 1215 is executable using each process on the platform 1220, the main part of the application 1211 through 1215 is a program for controlling the screen, key operations, and job generations. A new application may be downloaded from the network via the NCS 1228. Each application can be added or deleted by the application.

The Web service processing application 1215 includes a Web server 500 and a Web service function (WSF) 1400. The Web server 500 provides Web service by receiving a HTTP request requesting for Web service and transmitting a HTTP response. The WSF 1400 performs predetermined processing using the control service 1250 via the application program interface (API), and provides the result of the predetermined process as Web service via the Web Service Application Program Interface (WS-API) The print environment sharing service 13 and the repository service 12, for example, are mounted on the Web service function 1400. The function provided by the management application 25 may be provided as a Web service by mounting a management service in the WSF 1400. In such a case, the function of the Web service is realized via the Web server 500.

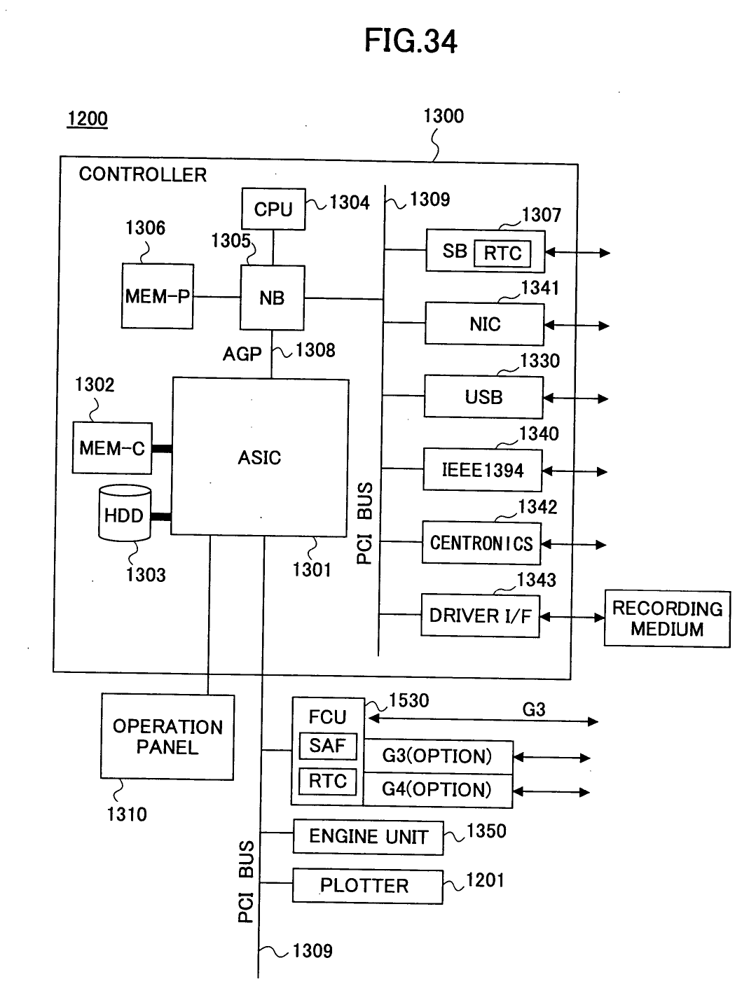

In the case where the function provided by the management application 25 described as the first embodiment is mounted on the MFP 1200, the screen shown in FIG. 29 may be displayed on the operations panel 1310 shown in FIG. 34 (to be described below), for example.

The service list, documents, and reservation information are stored in a HDD 1303 (to be described below).

The platform 1220 of the MFP 1200 centrally performs processing that is commonly needed by each application.

FIG. 34 is a block diagram showing the hardware configuration of the MFP 1200. As shown in FIG. 34, the MFP 1200 includes an operations panel 1310, a facsimile control unit (FCU) 1530, an engine unit 1350 (to which a scanner 1202 is connected, for example), a plotter 1201, and an ASIC 1301 of a controller 1300, which are connected via a Peripheral Component Interconnect (PCI) bus 1309, for example.

In the controller 1300, a MEM-C 1302 and a HDD 1303 are connected to the ASIC 1301, and the ASIC 1301 and a CPU 1304 are connected via a CPU chipset NB 1305. The ASIC 1301 and the CPU 1304 are connected via the NB 1305 since the interface of the CPU 1304 is not available.

The ASIC 1301 and the NB 1305 are not connected via the PCI bus, but via AGP 1308. The ASIC 1301 and the NB 1305 is connected via the AGP 1308, which is faster than the PCI bus, since the platform 1220 and the application 1230 need to be executed as multiple processes so as not to degrade the performance of the system.

The CPU 1304 controls the entire system of the MFP 1200. Specifically, the CPU 1304 executes the SCS 1222, SRM 1223, ECS 1224, MCS 1225, OCS 1226, FCS 1227, and NCS 1228 that form the platform 1220 on the OS 1221 as processes, and also executes the printer application 1211, copy application 1212, facsimile application 1213, a scanner application 1214, Web service processing application 1215 that form the application 1230.

The NB 1305 is a bridge for connecting the CPU 1304 with the MEM-P 1306, SB 1307, NIC (Network Interface Card) 1341, USB (Universal Serial Bus) 1330, IEEE 1394 1340, Centronics 1342, driver I/F 1343, and ASIC 1301.

The MEM-P 1306 is system memory that is used as imaging memory of the MFP 1200. The SB 1307 is a bridge for connecting the NB 1305 with ROM, PCI devices, and peripheral devices. The MEM-C 1302 is a local memory used for image buffer for copy and a code buffer. The ASIC 1301 is an application specific IC that contains hardware elements for image processing.

The driver I/F 1343 is an I/F used for reading programs and applications, for example for inserting recording media storing the programs and applications, and mounting them in the MFP 1200. The recording medium may be a SD memory card, a smart medium, a multimedia card, and a compact flash (registered trade mark), for example.

The HDD 1303 is a storage device for storing image data, programs, font data, forms, and documents. The HDD 1303 also stores the service list and the reservation information, for example. The operations panel 1310 is an operations unit for receiving instructions from the operator and displaying screens for the operator.

Accordingly, the ASIC 1301 has a RAM interface to which the MEM-C 1302 is connected, and a hard disk interface to which the HDD 1303 is connected. When image data are input and output to and from the storage units, the RAM interface and the hard disk interface are switched.

The AGP 1308 is a bus interface for a graphics accelerator card proposed for increasing the speed of graphic processing. The graphics accelerator card can access the high throughput system memory directly, and operate faster.

As shown in FIGS. 33 and 34, since the print environment sharing service 13 is mounted in the MFP 1200, as described as the first embodiment, reservation information and the document data can be transferred between the MFPs 1200, and can be stored by the MFP 1200 in the designated location. When the user requests the MFP 1200 at the designated location to print the document, the MFP can print the transferred document.

An exemplary embodiment has been described in which the print location and the print conditions are designated before making the print reservation. According to another embodiment, when the user makes a print reservation, the user can designate only the document to be printed, and may designate the print location and the print conditions when the user makes the print request.

According to yet another embodiment, when the print reservation is made, only the document and the print location may be designated. The print conditions may be designated when the print request is made to the MFP 1200 in the print location.

### Third Embodiment

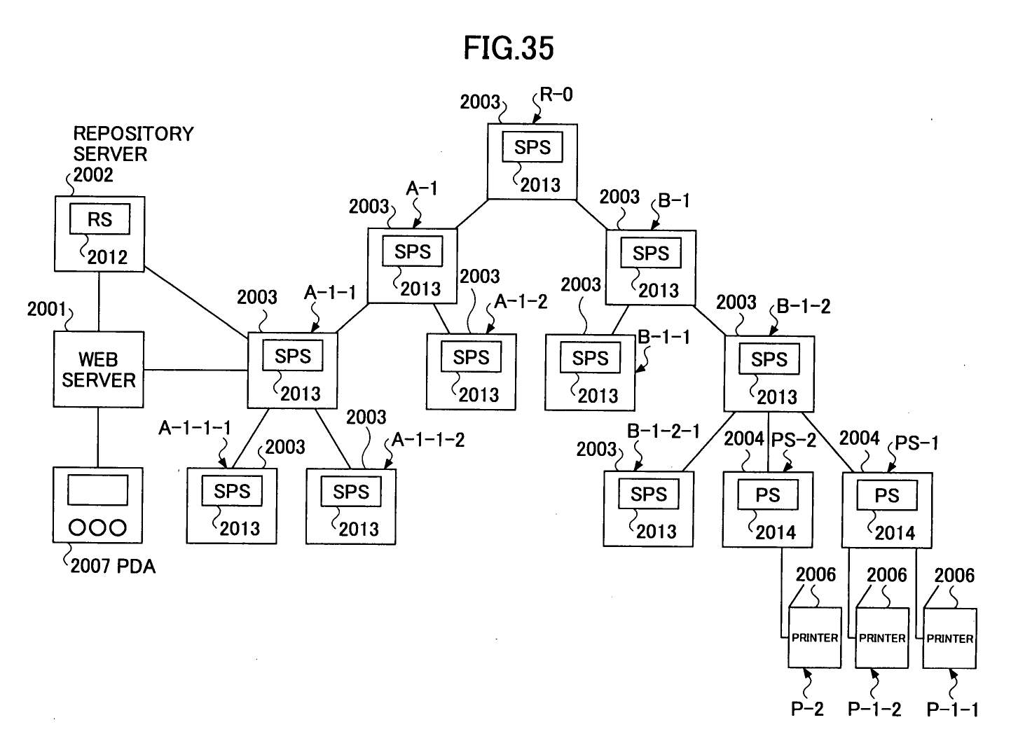

FIG. 35 is a schematic diagram showing the structure of the system according to an embodiment of the present invention. Since FIG. 35 is similar to FIG. 1, differences between them are mainly described below. Elements having the same function are referred to by the same reference numerals, and their description may be omitted.

FIG. 35 is a schematic diagram showing a service providing system according to another embodiment of the present invention. The service providing system shown in FIG. 35 includes a Web server 2001, a repository server 2002, SPS servers 2003, print servers 2004, printers 2006, and a personal digital assistant (PDA) 2007.

As shown in FIG. 35, a repository service (RS) 2012 is mounted on the repository server 2002, a print environment sharing service 2013 is mounted on the SPS servers 2003, and a document print service (PS) 2014 is mounted on the print server 2004.

The services exchange messages in compliance with simple object access protocol (SOAP) as Web services, and can provide services to each other.

The Web server 2001, the repository server 2002, the SPS servers 2003, the print servers 2004, the printers 2006, and the personal digital assistant (PDA) 2007 are connected to each other via a network or the Internet.

If the service providing system corresponds to the entire organization of a firm, the SPS server R-0 corresponds to the top of the firm, and the SPS servers A-0 through A-2 and the SPS servers B-0 through B-2 correspond to a division A and a division B of the firm, respectively. In the exemplary system shown in FIG. 35, the print environment under B-1-2 is well-maintained. If a print server 2004 and a printer 2006 on which the document print service 2014 is mounted are provided under A-1-1-1, for example, the print environment under A-1-1-1 is also well-maintained.

At first, a user inputs a user name and a password using a PDA 2007, and log-in the Web server 2001. Using a service provided by the print environment sharing service 2013, the user designates a print location (the SPS server 2003, B-2, for example), a printer (the printer 2006, P-3-1, for example), and print conditions (paper size, for example), and requests for a print reservation to the print environment sharing service 2013.

As will be appreciated, when the user designates a print location, the print environment sharing service 2013 acquires route information to the designated print location (the print environment sharing service 2013 (B-1-2), for example).

For example, in response to a request from the Web server 2001 for searching for the route to the designated print location, the print environment sharing service 2013 of the SPS server 2003 (A-1-1) acquires route information from the print environment sharing service 2013 of the SPS server 2003 (A-1-1) to the print environment sharing service 2013 of the SPS server 2003 (B-1-2) (the route information being (A-1-1)→(A-1)→(R-0)→(B-1)→(B-1-2)), and provides the route information to the Web server 2001.

The route information can be acquired using the service list 71.

The print environment sharing service 2013 (A-1-1), in response to receipt of a request for a print reservation from a user via the Web server 2001, using a document ID and a document ticket for using the document included in the reservation request, transmits a request for acquiring the document designated by the document ID to the repository service 2012 mounted on the repository server 2002, and acquires the document data stored in the repository server 2002 via the repository service 2012.

The print environment sharing service 2013 (A-1-1) transmits the following information to the sharing printer service 2013 (A-1) based on the route information included in the request for print reservation: identification information for identifying the route information and the print location (for example, the uniform resource identifier (URI) of the print sharing service 2013 (B-1-2)), identification information for identifying the printer with which the user is willing to print the document (for example, printer name and/or printer ID), reservation information containing the print conditions, and the acquired document data.

In response to receipt of the reservation information and the document data from the print environment sharing service 2013 (A-1-1), the print environment sharing service 2013 (A-1) transfers the reservation information and the document data to the print environment sharing service 2013 (R-0) based on the route information contained in the reservation information.

In response to receipt of the reservation information and the document data from the print environment sharing service 2013 (A-1), the print environment sharing service 2013 (R-0) transfers the reservation information and the document data to the print environment sharing service 2013 (B-1) based on the route information contained in the reservation information.

In response to receipt of the reservation information and the document data from the print environment sharing service 2013 (R-0), the print environment sharing service 2013 (B-1) transfers the reservation information and the document data to the print environment sharing service 2013 (B-1-2) based on the route information contained in the reservation information.

In response to receipt of the reservation information and the document data, the print environment sharing service 2013 (B-1-2) stores them.

On the other hand, the user visits the print location and requests, via the Web server 2001, the print environment sharing service 2013 (A-1-1) to print the designated document.

In response to receipt of the request to print the designated document, the print environment sharing service 2013 (A-1-1) transmits the request to print the document to the print environment sharing service 2013 (A-1) based on the route information contained in the print request.

In response to receipt of the request to print the designated document from the print environment sharing service 2013 (A-1-1), the print environment sharing service 2013 (A-1) transmits the request to print the document to the print environment sharing service 2013 (R-0) based on the route information contained in the print request.

In response to receipt of the request to print the designated document from the print environment sharing service 2013 (A-1), the print environment sharing service 2013 (R-0) transmits the request to print the document to the print environment sharing service 2013 (B-1) based on the route information contained in the print request.

In response to receipt of the request to print the designated document from the print environment sharing service 2013 (R-0), the print environment sharing service 2013 (B-1) transmits the request to print the document to the print environment sharing service 2013 (B-1-2) based on the route information contained in the print request.

In response to receipt of the print request, the print environment sharing service 2013 (B-1-2) transmits the stored reservation information and the document data to the document print service 2014 (PS-1), and request to print the document data under the print condition contained in the reservation information.

In response to receipt of the print request to print the document data, the document print service 2014 (PS-1) converts the document data into print data that the printer 2006 (P-1-2) can print, and requests the printer 2006 (P-1-2) that is identified by the reservation information to print the print data.

In response to receipt of print request to print the print data, the printer 2006 (P-1-2) prints the print data.

As described above, while visiting another office or plant, the user can use a well-maintained print environment of the other office or plant that the user is allowed to access, and accordingly, the user can make a print reservation, transfer the reservation information and the document data via the print environment sharing services 2013, and print the document at the print location. Since the user does not need to establish a new print environment, the user can print even in a different user environment quickly and easily.

If the service providing system is divided into two portions (divisions A and B, for example) as shown in FIG. 35, for example, and the security of the service providing system is managed by the division independently, a firewall may be provided between the division A and the division B. Even in the case where a user of the A division uses the printer 2006 in the B division, the firewall may improve the security of the service providing system compared with a conventional service providing system in which multiple printers are connected to a server via a network. In the case of a conventional system, a communication channel is established for each combination of a printer and a server. As a result, the security of each communication channel need to be secured.

The print environment sharing service 2013 can establish a tree-structured system as shown in FIG. 35, for example, using a service list 2071.

According to an embodiment, the service list 2071 of each print environment sharing service 2013 may be stored in the SPS server 2003 on which the print environment sharing service 2013 is mounted. According to another embodiment, all of the service lists 2071 may be stored in another server together by the print environment sharing service 2013.

In the following description, an assumption is made that each service list is stored in a SPS server 2003 in which a print environment sharing service 2013 is mounted to make the description easy and simple.

According to another embodiment, the user may use another user terminal such as a mobile phone, instead of the PDA 2007, to access the Web server 2001.

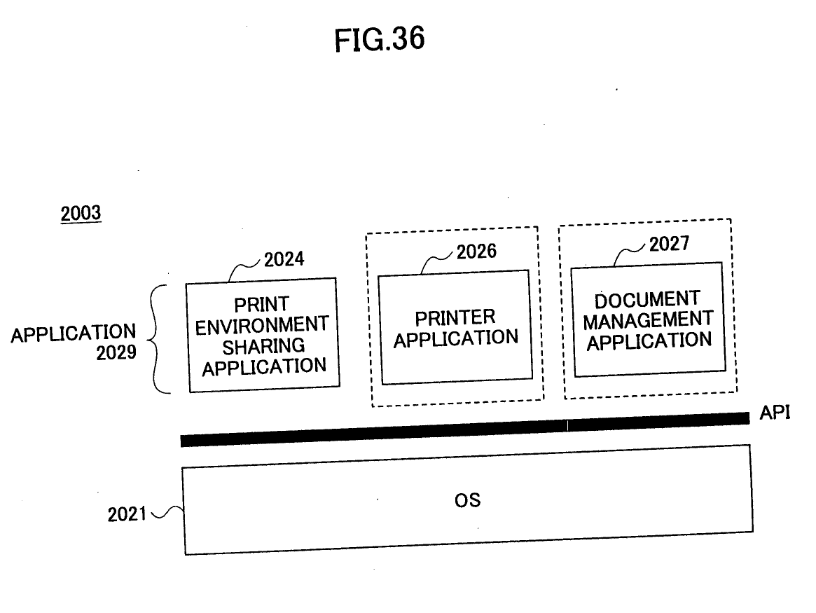

FIG. 36 is a schematic diagram showing the configuration of software mounted on the SPS server 2003 according to an embodiment.

As shown in FIG. 36, the SPS server 2003 includes an operating system (OS) 2021 and an application 2029.

The OS 2021 is an operating system such as UNIX (registered trade mark) and Windows (registered trade mark) on which multiple items of the application 2029 are executed as processes in parallel.

The application 2029 includes a shared printer application 2024 for reserving and/or printing a document. The print environment sharing service 2013 shown in FIG. 35 is included in the shared printer application 2024.

Although the SPS server 2003 shown in FIG. 35 includes only the print environment sharing service 2013 that is included in the shared printer application 2024, the application 2029 may include a printer application 2026 that is an application for the printer and a document management application 2027 that is an application for managing documents as shown in FIG. 36.

The document print service 2014 shown in FIG. 35 is included in the printer application 2026. The repository service 2012 is included in the document management application 2027.

As shown in FIG. 35, an assumption is made in the following description that the document print service 2014 is mounted on the print server 2004, and the repository service 2012 is mounted on the repository server 2002. This assumption does not limit the scope of the present invention.

The hardware structure of the SPS server 2003 according to the third embodiment is the same as that of the SPS server 2003 according to the first embodiment described with reference to FIG. 3.

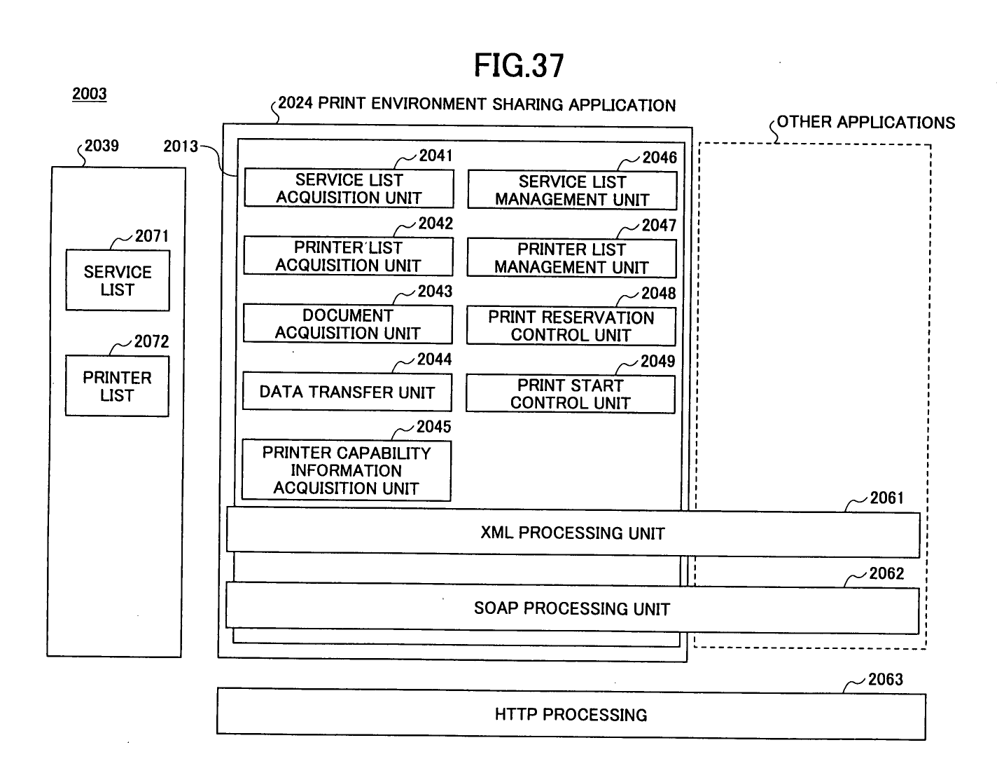

The functional configuration of the SPS server 2003 according to the third embodiment is described with reference to FIG. 37.

FIG. 37 is a schematic diagram showing the functional configuration of the SPS server 2003.

As shown in FIG. 37, the SPS server 2003 includes HTTP processing unit 2063, a HDD 2039, and a shared printer application 2024. The HTTP processing unit 2063 controls communications in compliance with HTTP. The HDD 2039 stores the service list 2071 and a printer list 2072, for example.

An XML processing unit 2061 for processing messages written in XML (extensible Markup Language) and a SOAP processing unit 2062 for exchanging message in compliance with SOAP are shared by the shared printer application 2024 and applications other than the shared printer application 2024.

The print environment sharing service 2013 included in the shared printer application 2024 includes a service list acquisition unit 2041, a printer list acquisition unit 2042, a document acquisition unit 2043, a data transfer unit 2044, a printer capability information acquisition unit 2045, a service list management unit 2046, a printer list management unit 2047, print reservation control unit 2048, and print start control unit 2049, for example.

The service list acquisition unit 2041 acquires the service list from another SPS server 2003 via the print environment sharing service 2013 of the other SPS server 2003, the service list being stored in the other SPS server 2003, and acquires the service list from its own SPS server 2003 via the print environment sharing service 2013, the service list being stored in its own SPS server 2003.

The printer list acquisition unit 2042 acquires a printer list 2072 from the other SPS server 2003 or the print server 2004 via the print environment sharing service 2013 mounted on the other SPS server 2003 and/or the document print service 2014 mounted on the print server 2004, the printer list 2072 being stored in the other SPS server 2003 or the print server 2004. The printer list acquisition unit 2042 further acquires the printer list 2072 from its own SPS server 2003 via the print environment sharing service 2013 mounted on its own SPS server 2003.

The document acquisition unit 2043 acquires the document data of a designated document from the repository server 2002 via the repository service 2012 based on the Web server 2001 shown in FIG. 35.

The data transfer unit 2044 transfers to another print environment sharing service 2013 the following: route information to the print environment sharing service 2013 in the print location, identification information for identifying the print location, identification information for identifying a designated printer, reservation information such as print conditions, and document data acquired by the document acquisition unit 43, for example.

The printer capability information acquisition unit 2045 acquires capability information of a printer via the print environment sharing service 2013 mounted on the other SPS server 3 and/or the document print service 2014 mounted on the print server 2004, the capability information being stored in the printer server 2004, and indicating whether the printer supports color printing, and supports double sided printing, for example.

The service list management unit 2046 refers to the service list 2071 stored in the HDD 2039 of the SPS server 2003, and sends data of SPS servers 2003 to which the present SPS server 2003 is accessible, to the service list acquisition unit 2041, the print list acquisition unit 2042, the data transfer unit 2044, and the printer capability information acquisition unit 2045. The service list management unit 2046 further adds data to the service list 2071 or deletes data from the service list 2071.

Referring to the printer list 2072 stored in the HDD 2039 of the present SPS server 2003, the printer list management unit 2047 sends data about the print server 2004 and/or the printer 2006 which the SPS server 2003 can access to the printer list acquisition unit 2042, for example, it adds data to the printer list 2072, and deletes data from the printer list 2072 based on a request.

The print reservation control unit 2048 performs control related to a request for print reservation. For example, the print reservation control unit 2048, in response to receipt of a request for print reservation from the Web server 2001 connected to the present SPS server 2003 via the Internet and/or a network, requests the document acquisition unit 2043 to acquire the document data, and requests the data transfer unit 2044 to transmit the document data acquired by the document acquisition unit 2043 and the reservation information contained in the print reservation request to the other print environment sharing services 2013.

The print start request control unit 2044 performs control related to a request for print start. For example, in response to receipt of a request for starting printing from the Web server 2001 and/or the other print environment sharing services 2013 connected to the SPS server 2003 via the Internet and/or a network, transmits the request for starting printing to the other print environment sharing service 2013 or the document print service 2014 based on the route information contained in the request for starting to print.

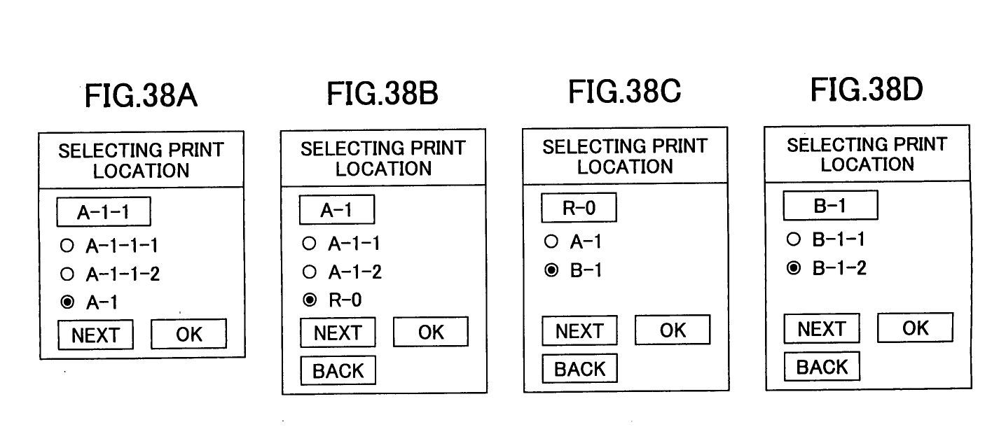

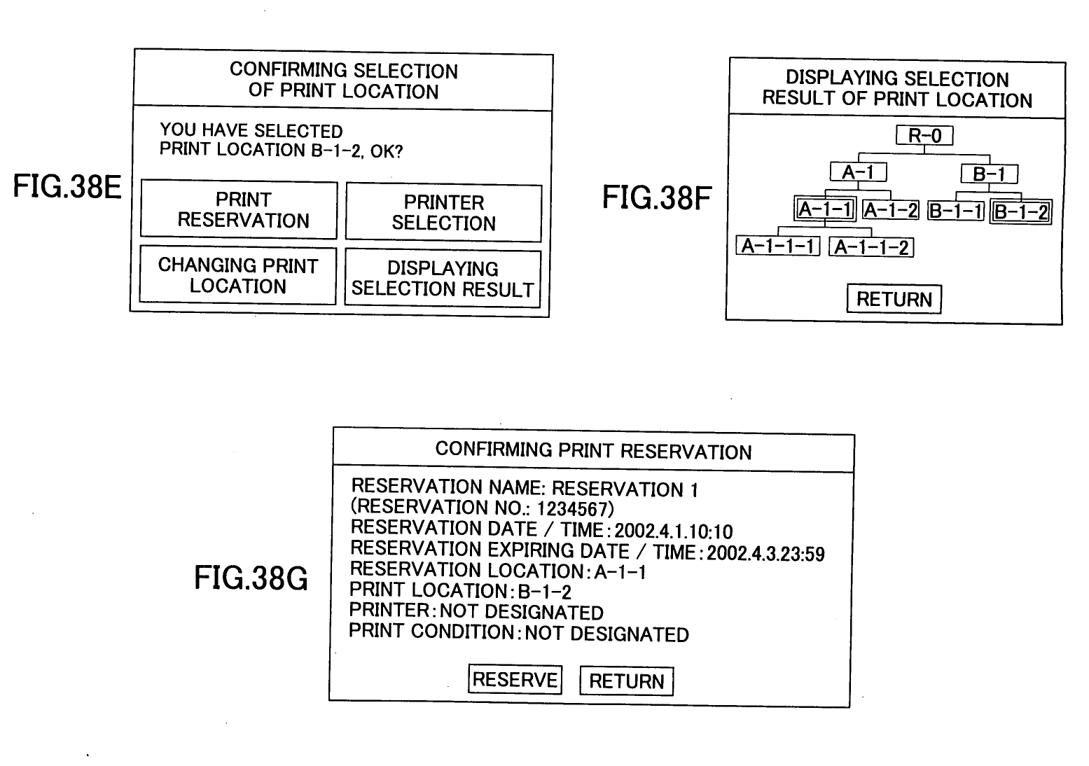

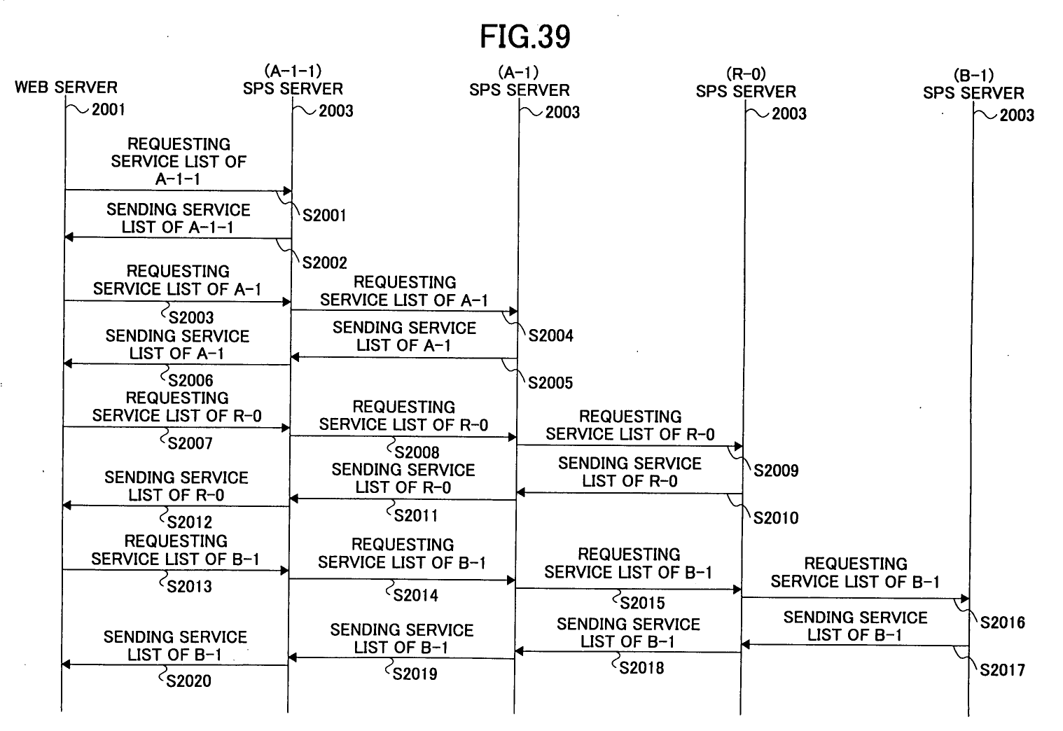

An exemplary embodiment of searching for a print location is described with reference to FIGS. 38 and 39.

FIGS. 38A through 38G are schematic diagrams for explaining searching for a print location.

FIG. 39 is a sequence diagram for explaining the searching for a print location.

For example, in the case of a system configuration as shown in FIG. 35, in response to the request from the user, the Web server 2001 transmits a request for the service list 2071 of the print environment sharing service 2013 (A-1-1) including information related to the location of other print environment sharing services which the print environment sharing service 2013 (A-1-1) can access, to the print environment sharing service 2013 (A-1-1) (sequence S2001 of FIG. 39). The request for the service list 2071 contains the route information to the print environment sharing service 2013 (A-1-1).

In response to receipt of the request for acquiring the service list 2071 of the print environment sharing service 2013 (A-1-1) from the Web server 2001, the service list acquisition unit 2041 of the print environment sharing service 2013 (A-1-1) acquires the service list 2071 stored in the HDD 2039 of the SPS server 2003 (A-1-1), and transmits the service list 2071 to the Web server 2001 (sequence S2002 of FIG. 39). The route information to the print environment sharing service 2013 (A-1-1) is transmitted to the Web server 2001 with the service list 2071.

The Web server 2001 generates a print location selection screen as shown in FIG. 38A based on the service list 2071 of the print environment sharing service 2013 (A-1-1), and provides the screen to the user.

Other print environment sharing services 2013 to which the print environment sharing service 2013 (A-1-1) can refer are displayed in FIG. 38A. The other print environment sharing services 2013 are simply indicated as “A-1-1-1”, “A-1-1-2”, and “A-1”, for example, in FIGS. 38A through 38G, to make the description simple. A department name or a division name, for example, corresponding to the print environment sharing service 2013 may be indicated instead. In the following description, the print environment sharing service 2013 may be referred to by the corresponding department name or division name, for example, in the same manner.

For example, when the user selects “A-1” and taps “next” button, the Web server 2001 transmits a request for acquiring the service list 2071 of the print environment sharing service 2013 (A-1) to the print environment sharing service 2013 (A-1-1) (sequence S2003 of FIG. 39). When the user selects “A-1”, the Web server 2001 can know from the service list 2071 of the acquired print environment sharing service 2013 (A-1-1) that the print environment sharing service 2013 (A-1) is connected to the print environment sharing service 2013 (A-1-1) as an upper level entity, and obtains information to the print environment sharing service 2013 (A-1) (access information, for example, to be described below) from the print environment sharing service 2013 (A-1-1). Accordingly, the Web server 2001 adds the route information from the print environment sharing service 2013 (A-1) to the print environment sharing service 2013 (A-1) to the route information, and includes the route information to the request for acquiring the service list 2071. In the case of the following embodiments described below, the Web server 2001 and the print environment sharing service 2013 can acquire the route information to the print location selected by the user, for example, by obtaining the service list 2071.

In response to receipt of the request for acquiring, the service list acquisition unit 2041 of the print environment sharing service 2013 (A-1-1) transmits the acquisition request to the print environment sharing service 2013 (A-1) based on the route information (sequence S2004 of FIG. 39).

In response to receipt of the acquisition request, the service list acquisition unit 2041 acquires the service list 2071 stored in the SPS server 2003 (A-1), and transmits the service list 2071 and the route information to the print environment sharing service 2013 (A-1-1) based on the route information (sequence S2005 of FIG. 39).

The service list acquisition unit 2041 of the print environment sharing service unit 2013 (A-1-1) transmits the received service list 2071 of the print environment sharing service 2013 (A-1) and the route information to the Web server 2001 (sequence S2006 of FIG. 39).

As described above, whenever the user selects a print location, the route information is added and is sent to the print environment sharing service 2013 with the acquisition request for the service list 2071. According to the above arrangement, the print environment sharing service 2013 can transfer the acquisition request for the service list 2071 in accordance with the route information. The print environment sharing service 2013 can transfer the acquired service list 2071 to the other print environment sharing service 2013 that has requested the service list 2071 in accordance with the route information. It is assumed herein that the route information is included in the acquisition request for the service list 2071 and in the response to the acquisition request, and the service list 2071 is acquired using the route information.

The Web server 2001 generates a print location selection screen as shown in FIG. 38B based on the received service list 2071 of the print environment sharing service 2013 (A-1), and provides the print location selection screen to the user.

The print environment sharing services 2013 to which the print environment sharing service 2013 (A-1) can refer are displayed in FIG. 38B.

For example, when the user selects “R-0”, and taps “next” button, the Web server 2001 transmits the acquisition request of the service list 2071 of the print environment sharing service 2013 (R-0) to the print environment sharing service 2013 (A-1-1) (sequence S2007 of FIG. 39).

In response to receipt of the acquisition request, the service list acquisition unit 2041 of the print environment sharing service 2013 (A-1-1) transmits the acquisition request to the print environment sharing service 2013 (A-1) (sequence S2008 of FIG. 39).

In response to receipt of the acquisition request, the service list acquisition unit 2041 of the print environment sharing service 2013 (A-1) transmits the acquisition request to the print environment sharing service 2013 (R-0) (sequence S2009 of FIG. 39).

In response to receipt of the acquisition request, the service list acquisition unit 2041 of the print environment sharing service 2013 (R-0) acquires the service list 2071 stored in the SPS server 2003 (R-0), and transmits the service list 2071 to the print environment sharing service 2013 (A-1) (sequence S2010 of FIG. 39).

The service list acquisition unit 2041 of the print environment sharing service 2013 (A-1) transmits the received service list 2071 of the print environment sharing service 2013 (R-0) to the print environment sharing service 2013 (A-1-1) (sequence S2011 of FIG. 39).

The service list acquisition unit 2041 of the print environment sharing service 2013 (A-1-1) transmits the received service list 2071 of the print environment sharing service 2013 (R-0) to the Web server 2001 (sequence S2012 of FIG. 39).

The Web server 2001 generates a print location selection screen as shown in FIG. 38C based on the received service list 2071 of the print environment sharing service 2013 (R-0), and provides the print location selection screen to the user.

For example, when the user selects “B-1”, and taps “next” button, the Web server 2001 transmits the acquisition request of the service list 2071 of the print environment sharing service 2013 (B-1) to the print environment sharing service 2013 (A-1-1) (sequence S2013 of FIG. 39).

In response to receipt of the acquisition request, the service list acquisition unit 2041 of the print environment sharing service 2013 (A-1-1) transmits the acquisition request to the print environment sharing service 2013 (A-1) (sequence S2014 of FIG. 39).

In response to receipt of the acquisition request, the service list acquisition unit 2041 of the print environment sharing service 2013 (A-1) transmits the acquisition request to the print environment sharing service 2013 (R-0) (sequence S2015 of FIG. 39).

In response to receipt of the acquisition request, the service list acquisition unit 2041 of the print environment sharing service 2013 (R-0) transmits the acquisition request to the print environment sharing service list 2013 (B-1) (sequence S2016 of FIG. 39).

In response to receipt of the acquisition request, the service list acquisition unit 2041 of the print environment sharing service 2013 (B-1) acquires the service list 2071 stored in the SPS server 2003 (B-1), and transmits the service list 2071 to the print environment sharing service 2013 (R-0) (sequence S2017 of FIG. 39).

The service list acquisition unit 2041 of the print environment sharing service 2013 (R-0) transmits the received service list 2071 of the print environment sharing service 2013 (B-1) to the print environment sharing service 2013 (A-1) (sequence S2018 of FIG. 39).

The service list acquisition unit 2041 of the print environment sharing service 2013 (A-1) transmits the received service list 2071 of the print environment sharing service 2013 (B-1) to the print environment sharing service 2013 (A-1-1) (sequence S2019 of FIG. 39).

The service list acquisition unit 2041 of the print environment sharing service 2013 (A-1-1) transmits the received service list 2071 of the print environment sharing service 2013 (B-1) to the Web server 2001 (sequence S2020 of FIG. 39).

The Web server 2001 generates a print location selection screen as shown in FIG. 38D based on the received service list 2071 of the print environment sharing service 2013 (B-1), and provides the print location selection screen to the user.

For example, when the user selects “B-1-2” and taps “OK” button, the Web server 2001 generates a print location selection confirmation screen as shown in FIG. 38E, and provides it to the user.

For example, when the user taps “selection result display” in the print location selection confirmation screen shown in FIG. 38E, the Web server 2001 generates a print location selection result display screen as shown in FIG. 38F, and provides it to the user.

As shown in FIGS. 38A through 38G and FIG. 39, the SPS server 2003 (A-1-1) and/or the Web server 2001 can search print location by acquiring the service lists 20071.

The SPS server 2003 (A-1-1) and/or the Web server 2001 can further acquire the route information to the print location by performing processing shown in FIGS. 38A through 38G and FIG. 39.

By processing as shown in FIGS. 38A through 38G and FIG. 39, the SPS server 2003 (A-1-1) and/or the Web server 2001 can acquire the route information from the print environment sharing service 2001 (A-1-1) to the print environment sharing service 2013 (B-1-2) selected by the user, such as “(A-1-1)→(A-1) →(R-0)→(B-1)→(B-1-2).

For example, when the user taps “print reservation” button in the print location selection confirmation screen shown in FIG. 38E, the Web server 2001 generates a print reservation confirmation screen as shown in FIG. 38G, and provides it to the user.

For example, the user may not set a printer and print conditions but set only the print location. If the user taps “reserve” button in the print reservation confirmation screen shown in FIG. 38G, the user can make a print reservation. In such a case, when the user visits the print location after the print reservation, the user can check the use state and performance of printers in the print location, and set a printer and the print conditions, and print the designated document.

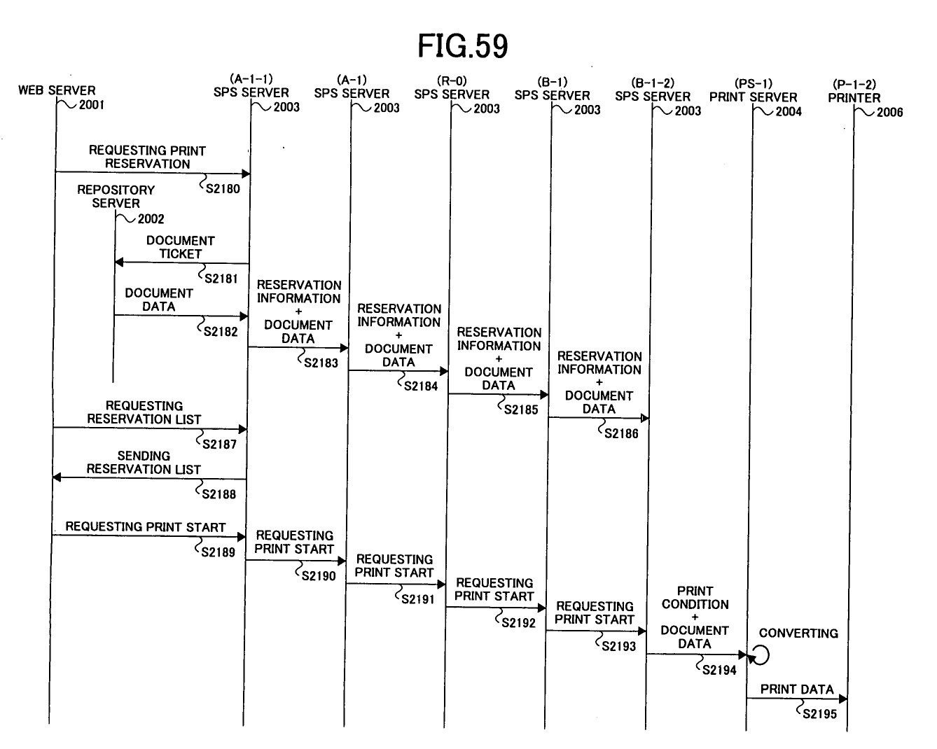

In such a case, the request for print reservation (to be described with reference to FIG. 59) may include the following: the document ID of the designated document, the document ticket that permits using the document, identification information for identifying the print location, and the route information to the print location.

Although not shown, the user can make a print reservation by designating only a document to be printed without setting any print location. In such a case, after the place of a meeting is set, the user can set a print location, a printer, and print conditions.

In such a case, a request for print reservation shown in FIG. 59 (to be described below) includes the document ID of a user-selected document and a document ticket that permits the using of the document.

The service list 2071 is the service list described with reference to FIG. 5, for example. A service list 2071 corresponding to a print environment sharing service 2013 includes the URIs of other print environment sharing services 2013 which the corresponding print environment sharing service 2013 can directly access.

For example, a service list (after connection) shown in FIG. 5A includes the URI of a print environment sharing service 2013 as an upper level entity, the URI of another print environment sharing service 2013 as a same level entity, and the URI of yet other print environment sharing service 2013 as a low level entitiy, to which the print environment sharing service 2013 is mounted on the SPS server 2003 in which the service list 2071 is stored.

However, the share printer services 2013 in the service list 2071 are indicated as “A-1” and “A-1-1-1”, for example, instead of the URIs to make the description easy to understand.

Although not shown, the service list 2071 may further include the location names, latitudes, longitudes, altitudes, and addresses of the print environment sharing services in addition to the URIs thereof.

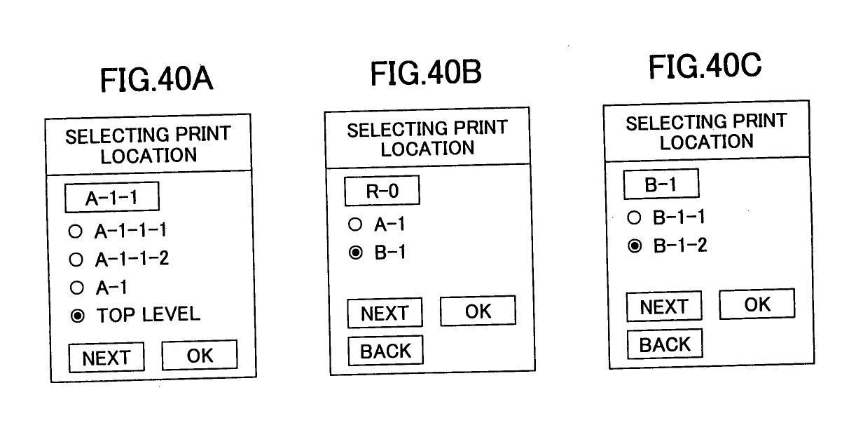

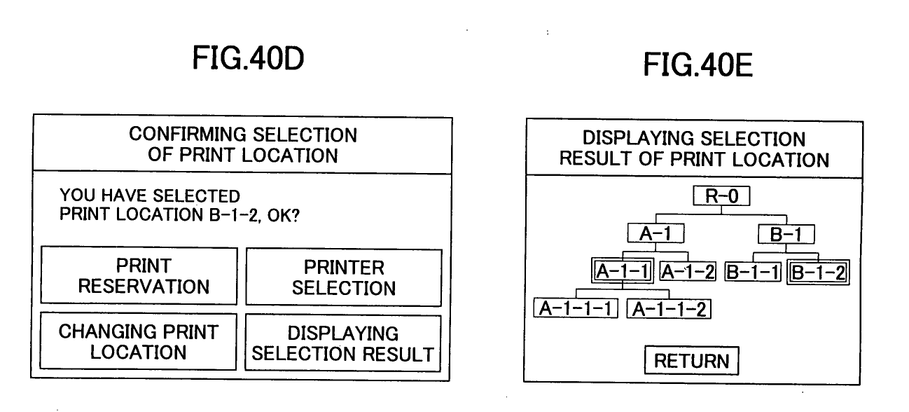

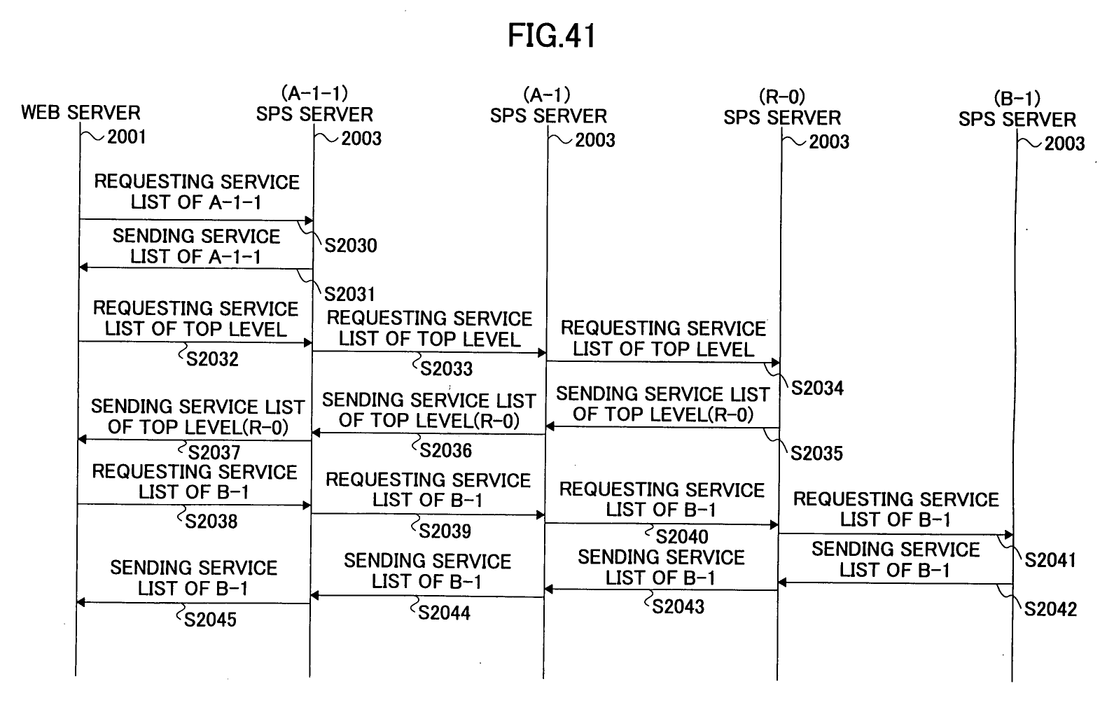

Another exemplary embodiment in which a print location is searched is described with reference to FIGS. 40A through 40E and FIG. 41.

FIGS. 40A through 40E are schematic diagrams for explaining the searching for a print location.

FIG. 41 is a sequence chart for explaining the searching for a print location.

For example, in the case of the system configuration as shown in FIG. 35, the Web server 2001 transmits an acquisition request for the service list 2071 of the print environment sharing service 2013 (A-1-1) to the print environment sharing service 2013 (A-1-1) based on a request from the user (sequence S2030 of FIG. 41).

In response to receipt of the acquisition request for the service list 2071 of the print environment sharing service 2013 (A-1-1) from the Web server 2001, the service list acquisition unit 2041 of the print environment sharing service 2013 (A-1-1) acquires the service list 2071 stored in the HDD 2039 of the SPS server 2003 (A-1-1), and transmits it to the Web server 1 (sequence S2031 of FIG. 41).

The Web server 2001 generates a print location selection screen as shown in FIG. 40A based on the received service list of the print environment sharing service 2013 (A-1-1), and provides the print location selection screen to the user.

It is noted that, compared with the print location selection screen shown in FIG. 38A, a new selection “top level” is added in the print location selection screen shown in FIG. 40A.

As shown in FIG. 40A, the Web server 2001 includes the print environment sharing service 2013 at the top level in selections in addition to other print environment sharing services 2013 which the print environment sharing service 2013 (A-1-1) can directly access.

For example, when the user selects the “top level” and taps the “next” button, the Web server 2001 transmits an acquisition request for the service list 2071 of the print environment sharing service 2013 at the top level to the print environment sharing service 2013 (A-1-1) (sequence S2032 of FIG. 41).

In response to receipt of the acquisition request, the service list acquisition unit 2041 of the print environment sharing service 2013 (A-1-1) refers to the service list 2071 stored in the SPS server 2003 (A-1-1), and transmits the acquisition request to the print environment sharing service 2013 (A-1) that is an upper level entity of the print environment sharing service 2013 (A-1-1) (sequence S2033 of FIG. 41).

In response to receipt of the acquisition request, the service list acquisition unit 2041 of the print environment sharing service 2013 (A-1) refers to the service list 2071 stored in the SPS server 2003 (A-1), and transmits the acquisition request to the print environment sharing service 2013 (R-0) that is an upper level entity of the print environment sharing service 2013 (A-1) (sequence S2034 of FIG. 41).

In response to receipt of the acquisition request, the service list acquisition unit 2041 of the print environment sharing service 2013 (R-0) refers to the service list 2071 stored in the SPS server 2003 (R-0) and, if confirming that there is no upper level entity of the print environment sharing service 2013 (R-0), acquires and transmits the service list 2071 to the print environment sharing service 2013 (A-1) (sequence S2035 of FIG. 41).

The service list acquisition unit 2041 of the print environment sharing service 2013 (A-1) transmits the received service list 2071 of the print environment sharing service 2013 (R-0) to the print environment sharing service 2013 (A-1-1) (sequence S2036 of FIG. 41).

The service list acquisition unit 2041 of the print environment sharing service 2013 (A-1-1) transmits the received service list 2071 of the print environment sharing service 2013 (R-0) to the Web server 2001 (sequence S2037 of FIG. 41).

The Web server 2001 generates a print location selection screen as shown in FIG. 40B based on the received service list 2071 of the print environment sharing service 2013 (R-0), and provides the print location selection screen to the user.

FIG. 40B shows print environment sharing services 2013 to which the print environment sharing service 2013 (R-0) can refer.

For example, when the user selects “B-1” and taps the “next” button, the Web server 2001 transmits an acquisition request of the service list 2071 of the print environment sharing service 2013 (B-1) to the print environment sharing service 2013 (A-1-1) (sequence S2038 of FIG. 41).

In response to receipt of the acquisition request, the service list acquisition unit 2041 of the print environment sharing service 2013 (A-1-1) transmits the acquisition request to the print environment sharing service 2013 (A-1) (sequence S2039 of FIG. 41).

In response to receipt of the acquisition request, the service list acquisition unit 2041 of the print environment sharing service 2013 (A-1) transmits the acquisition request to the print environment sharing service 2013 (R-0) (sequence S2040 of FIG. 41).

In response to receipt of the acquisition request, the service list acquisition unit 2041 of the print environment sharing service 2013 (R-0) transmits the acquisition request to the print environment sharing service 2013 (B-1) (sequence S2041 of FIG. 41).

In response to receipt of the acquisition request, the service list acquisition unit 2041 of the print environment sharing service 2013 (B-1) acquires the service list 2071 stored in the SPS server 2003 (B-1), and transmits the service list 2071 to the print environment sharing service 2013 (R-0) (sequence S2042 of FIG. 41).

The service list acquisition unit 2041 of the print environment sharing service 2013 (R-0) transmits the received service list 2071 of the print environment sharing service 2013 (B-1) to the print environment sharing service 2013 (A-1) (sequence S2043 of FIG. 41).

The service list acquisition unit 2041 of the print environment sharing service 2013 (A-1) transmits the received service list 2071 of the print environment sharing service 2013 (B-1) to the print environment sharing service 2013 (A-1-1) (sequence S2044 of FIG. 41).

The service list acquisition unit 2041 of the print environment sharing service 2013 (A-1-1) transmits the received service list 2071 of the print environment sharing service 2013 (B-1) to the Web server 2001 (sequence S2045 of FIG. 41).

The Web server 2001 generates a print location selection screen as shown in FIG. 40C based on the received service list 2071 of the print environment sharing service 2013 (B-1), and provides the print location selection screen to the user.

For example, when the user selects “B-1-2” and taps the “ok” button, the Web server 2001 generates a print location selection confirmation screen as shown in FIG. 40D, and provide the print location selection confirmation screen to the user.

For example, when the user taps the “selection result display” button in the print location selection confirmation screen shown in FIG. 41D, the Web server 2001 generates a print location selection result display screen as shown in FIG. 40E, and provides it to the user.

As described above with reference to FIGS. 40A through 40E and FIG. 41, the SPS server 2003 (A-1-1) and/or the Web server 2001 can search for a print location starting with the print environment sharing service 2013 at the top level.

The SPS server 2003 (A-1-1) and/or the Web server 2001 can acquire the route information to the print location by performing processing shown in FIGS. 40A through 40E and FIG. 41.

For example, by processing as shown in FIGS. 40A through 40E and FIG. 41, the SPS server 2003 (A-1-1) and/or the Web server 2001 can acquire the route information from the print environment sharing service 2001 (A-1-1) to the print environment sharing service 2013 (B-1-2) selected by the user, such as “(A-1-1)→(A-1)→(R-0)→(B-1)→(B-1-2).

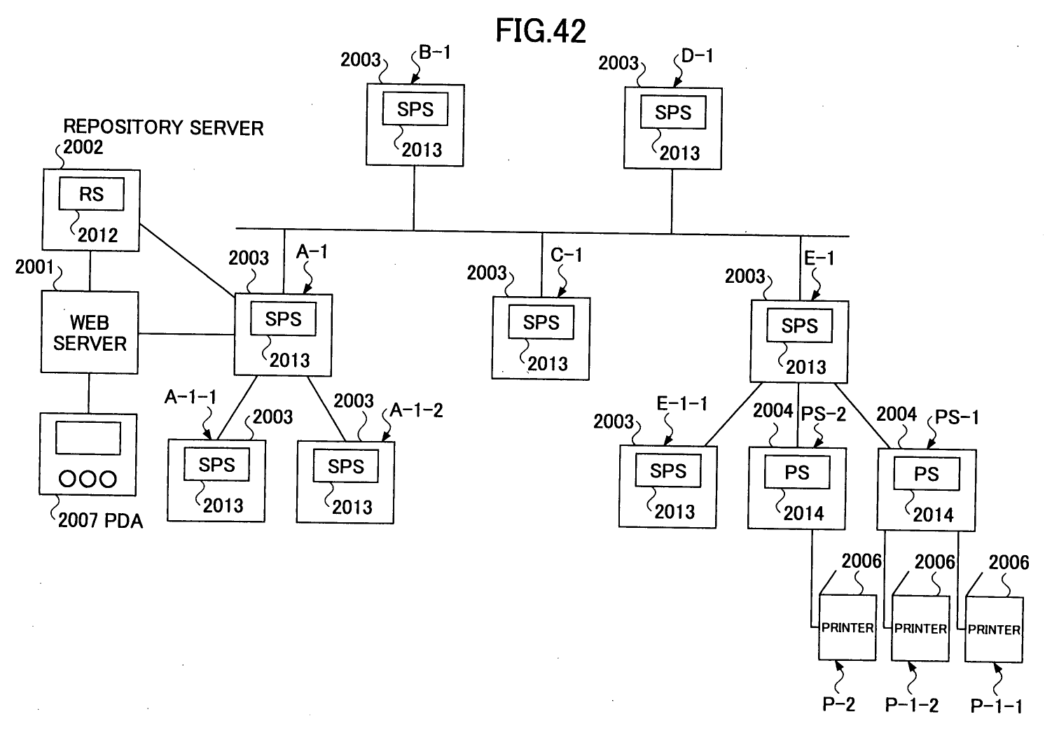

A system configuration according to another embodiment of the present invention is described with reference to FIG. 42.

FIG. 42 is a schematic diagram for explaining a system configuration according to another embodiment.

The system configuration shown in FIG. 42 is flatter than that shown in FIG. 35.

If the service list 2071 stored in a SPS server 2003 includes the URIs of other print environment sharing services to which the print environment sharing service 2013 can refer as the same level entities, instead of the upper level entity or the lower level entity, a flat system configuration can be established as shown in FIG. 42. The same level means, for example, the relation between A-1-1 and A-1-2 shown in FIG. 35, and the relation among A-1, B-1, C-1, D-1, and E-1 shown in FIG. 42.

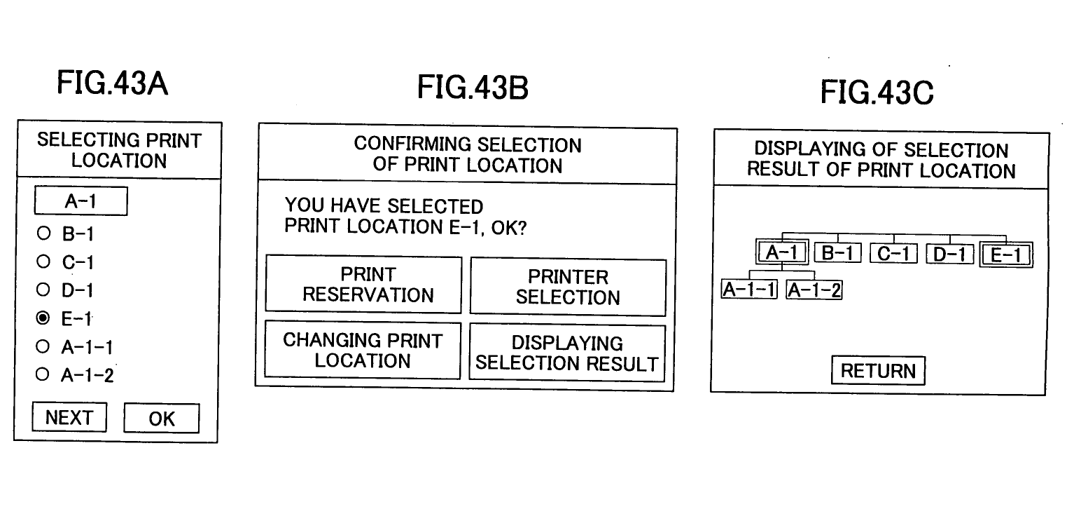

An exemplary embodiment of the searching for a print location using the system configuration shown in FIG. 42 is described with reference to FIGS. 43 through 45.

FIGS. 43A through 43C are schematic diagrams for explaining the searching for a print location.

FIG. 44 is a sequence chart for explaining the searching for a print location.

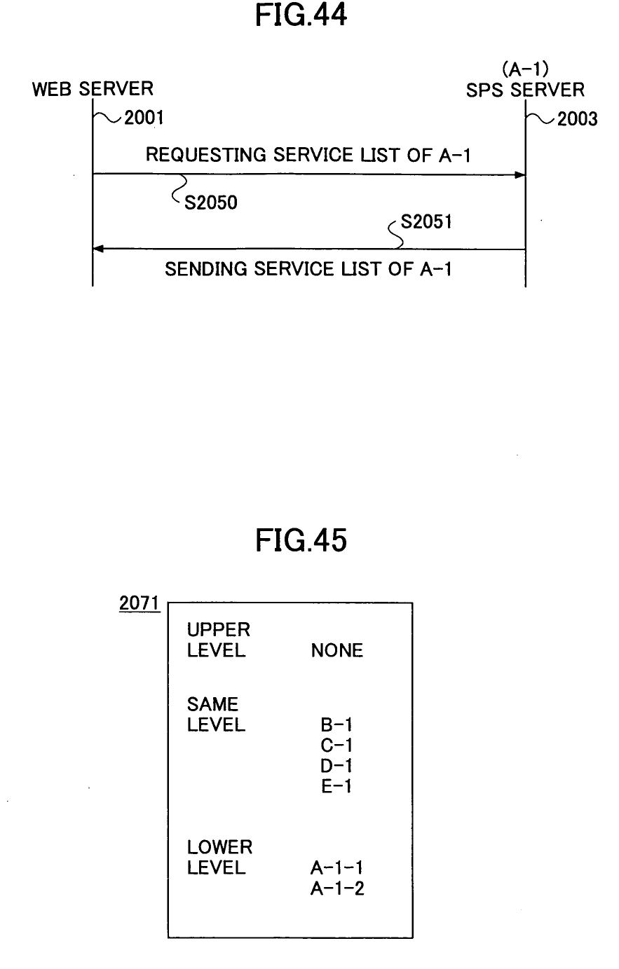

FIG. 45 is an exemplary service list of the print environment sharing service 2013 (A-1).

For example, in the case of the system configuration shown in FIG. 42, the Web server 2001 transmits an acquisition request for the service list 2071 of the print environment sharing service 2013 (A-1) to the print environment sharing service 2013 (A-1) based on a request from the user (sequence S2050 of FIG. 44). In response to the acquisition request for the service list 2071 of the print environment sharing service 2013 (A-1) from the Web server 2001, the service list acquisition unit 2041 of the print environment sharing service 2013 (A-1) acquires the service list 2071 stored in the HDD 2039 of the SPS server 2003 (A-1), and transmits the service list 2071 to the Web server 2001 (sequence S2051 of FIG. 44).

The Web server 2001 generates a print location selection screen as shown in FIG. 43A based on the acquired service list 2071 of the print environment sharing service 2013 as shown in FIG. 45, and provides the print location selection screen to the user.

FIG. 43A shows print environment sharing services 2013 to which the print environment sharing service 2013 (A-1) can refer.

As shown in FIG. 43A, the print environment sharing service 2013 (A-1) can refer to the following: the print environment sharing services 2013 (A-1-1) and (A-1-2) as the lower level entities, and the print environment sharing services 2013 (B-1), (C-1), (D-1), and (E-1) as the same level entities.

For example, when the user selects “E-1” and taps a “OK” button, the Web server 2001 generates a print location selection confirmation screen as shown in FIG. 43B, and provides the print location selection confirmation screen to the user.

Additionally, for example, if the user taps a “selection result display” button in the print location selection confirmation screen of FIG. 43B, the Web server 2001 generates a print location selection result display screen as shown in FIG. 43C, and provides it to the user.

As shown in FIGS. 43A through 43C and FIG. 44, in the case of the system configuration as shown in FIG. 42, the SPS server 2003 (A-1) and the Web server 2001 can search for a print location by acquiring the service list.

For example, the SPS server 2003 (A-1) and/or the Web server 2001 can acquire the route information to the print location by processing as shown in FIGS. 43A through 43C and FIG. 44.

By processing as shown in FIGS. 43A through 43c and FIG. 44, the SPS server 2003 (A-1) and/or the Web server 2001 can acquire the route information from the print environment sharing service 2001 (A-1) to the print environment sharing service 2013 (E-1) selected by the user, such as “(A-1)→(E-1)”.

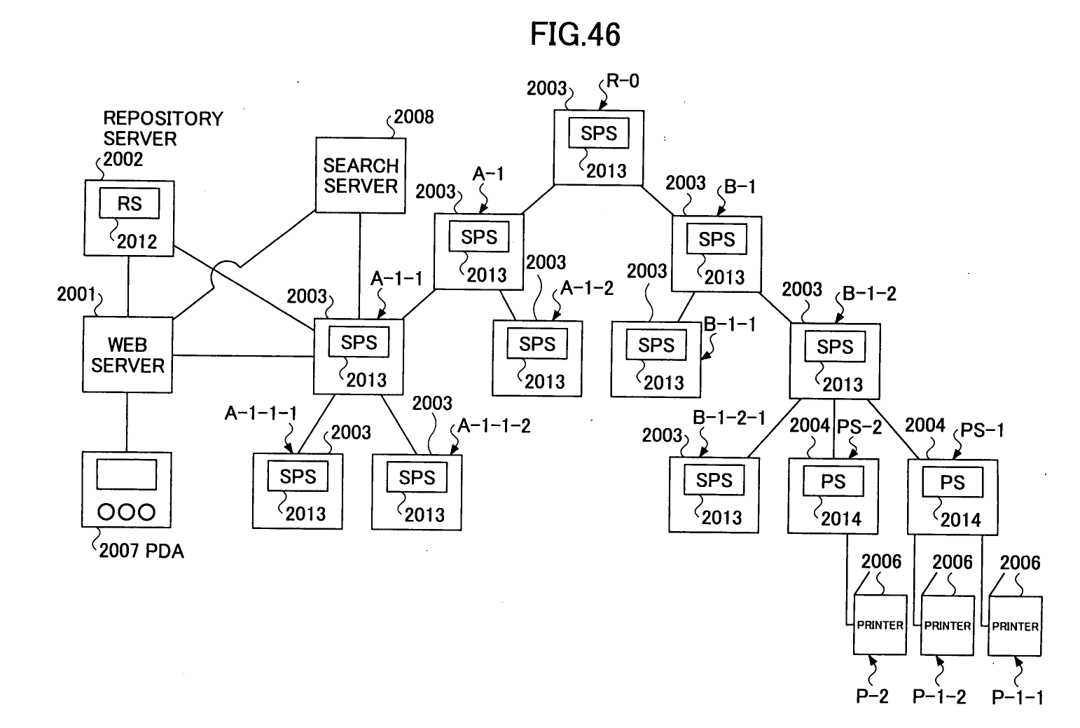

A system configuration according to another embodiment is described with reference to FIG. 46.

FIG. 46 is a schematic diagram for explaining a system configuration according to another embodiment.

Compared with the system configuration shown in FIG. 35, the system configuration shown inf FIG. 46 is different in that a search server 2008 for searching for a print location is added.

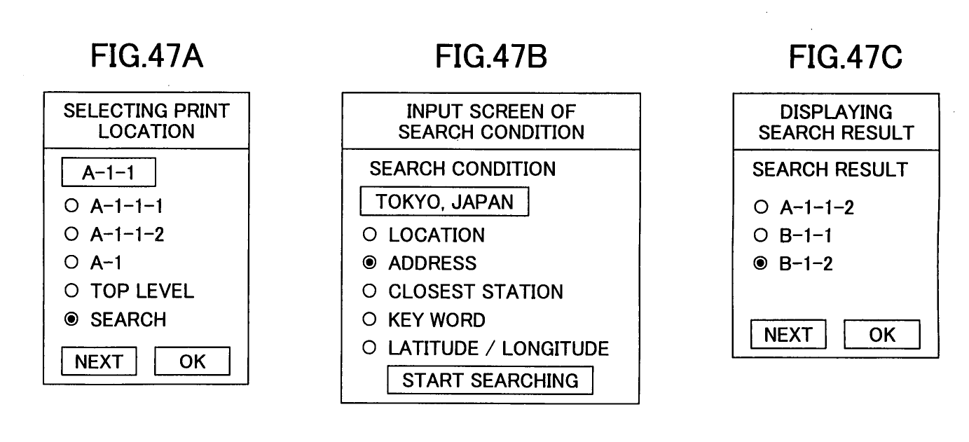

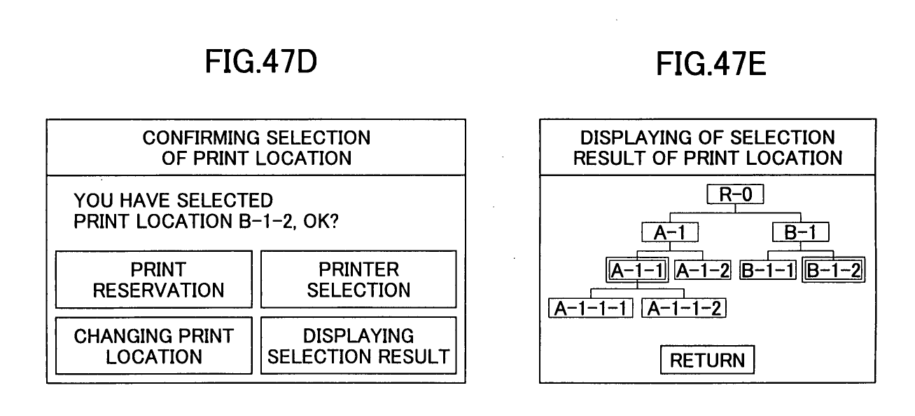

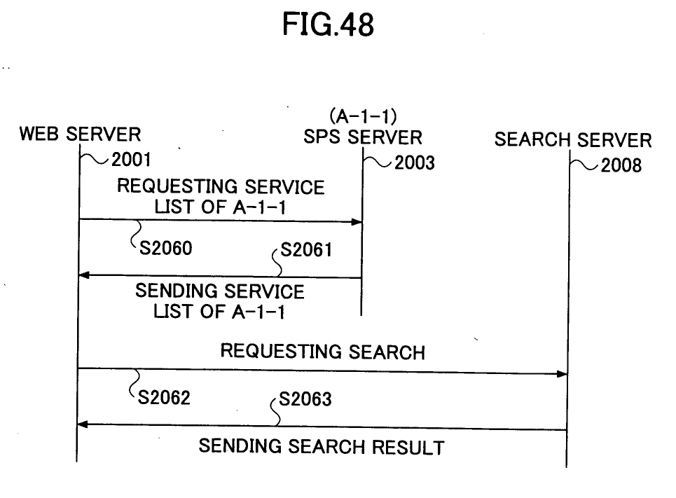

The searching for a print location using the system configuration as shown in FIG. 46 is described with reference to FIGS. 47A-47E and FIG. 48.

FIGS. 47A-47E are schematic diagrams for explaining the searching for a print location.

FIG. 48 is a sequence chart for explaining the searching for a print location.

For example, in the case of a system as shown in FIG. 46, the Web server 2001 transmits an acquisition request for the service list 2071 of the print environment sharing service 2013 (A-1-1) to the print environment sharing service 2013 (A-1-1) based on a request from the user (sequence S2060 of FIG. 48).

In response to receipt of the acquisition request for the service list 2071 of the print environment sharing service 2013 (A-1-1) from the Web server 2001, the service list acquisition unit 2041 of the print environment sharing service 2013 (A-1-1) acquires the service list 2071 stored in the HDD 2039 of the SPS server 2003 (A-1-1), and transmits the service list 2071 to the Web server 2001 (sequence S2061 of FIG. 48).

The Web server 2001 generates a print location selection screen as shown in FIG. 47A based on the received service list of the print environment sharing service 2013 (A-1-1) and provides the print location selection screen to the user.

The print location selection screen shown in FIG. 47A includes an additional selection “search” compared to the print location selection screen shown in FIG. 40A.

For example, when the user selects “search” and taps the “next” button, the Web server 1 generates a search condition input screen as shown in FIG. 47B, and provides it to the user.

For example, when the user inputs the search conditions and taps a “search start” button, the Web server 1 transmits a search request to the search server 2008 (sequence S2062 of FIG. 48). As shown in FIG. 47B, the address is used as the search condition. However, any data included in the service list 2071 may be used as a search condition, such as the latitude, longitude, altitude, and location name.

In response to receipt of the search request, the search server 2008 searches print environment sharing services that satisfies the search condition using information related to the print location included in the service list 2071 of the print environment sharing services 2013 with the search range of the search server 2008, the information being location name, longitude, latitude, altitude, and address of the print environment sharing service 2013, for example, and transmits the search result to the Web server 2001 (sequence S2063 of FIG. 48).

The Web server 2001 generates a search result display screen as shown in FIG. 47C based on the received search result, and provides the search result display screen to the user.

In step S2062, the Web server 2001 makes a search request directly to the search server 2008. According to another embodiment, the Web server 2001 may transmit the search request to the search server 2008 via the SPS server 2003 (A-1-1), and the search server 2008 may transmit the search result to the Web server 2001 via the SPS server 2003 (A-1-1).

For example, when the user selects “B-1-2” and taps a “OK” button, the Web server 2001 generates a print location selection confirmation screen as shown in FIG. 47D, and provides the generated print location selection confirmation screen to the user.

Additionally, for example, when the user taps a “selection result display” button in the print location selection confirmation screen shown in FIG. 47D, the Web server 2001 generates a print location selection result display screen as shown in FIG. 47E, and provides the generated print location selection result display screen to the user.

As shown in FIGS. 47A-47E and FIG. 48, for example, the SPS server 2003 (A-1-1) and/or the Web server 2001 can search for a print location using the search server 2008.

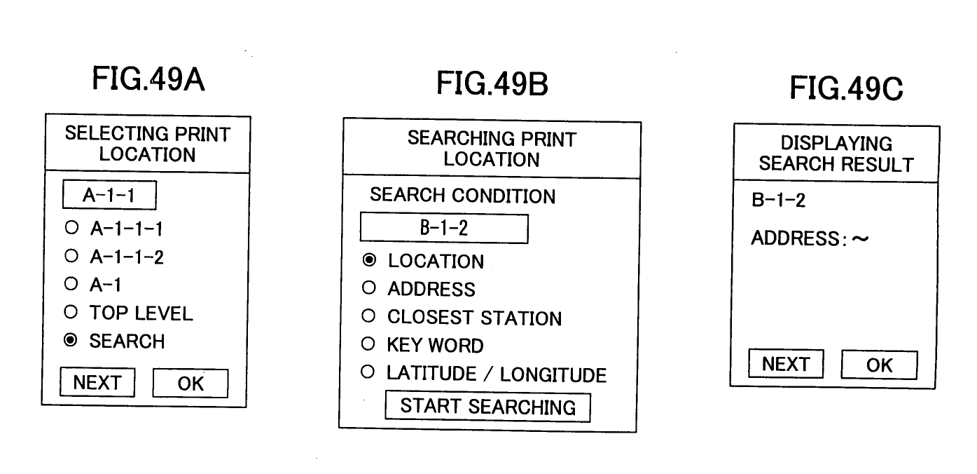

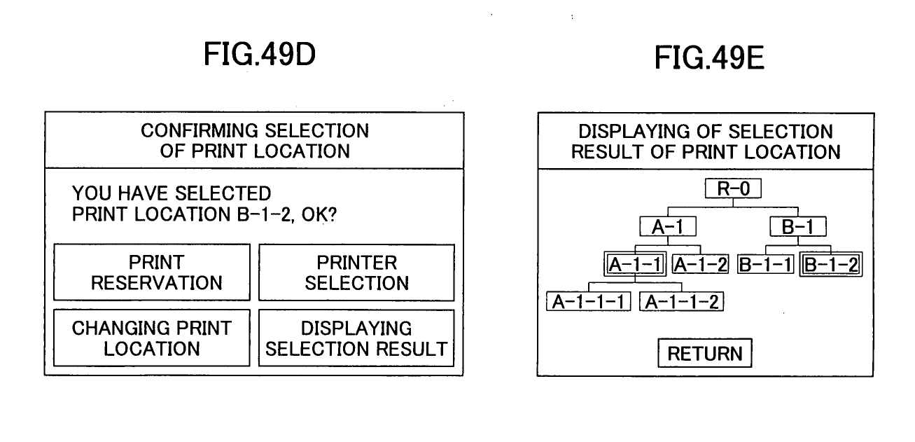

The searching for a print location in the system structure as shown in FIG. 35 is described with reference to FIGS. 49 through 51.

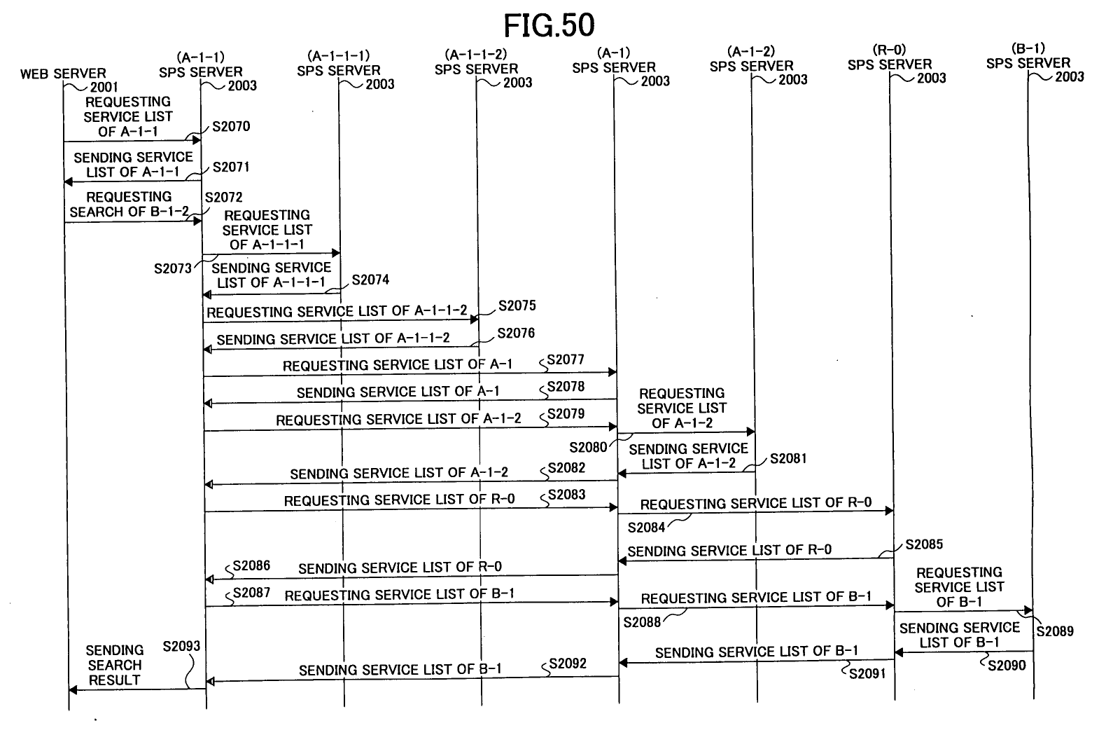

The searching for a print location according to another embodiment is described with reference to FIGS. 49 and 50 first.

FIG. 49A-49E are schematic diagrams for explaining the searching for a print location.

FIG. 50 is a sequence chart for explaining the searching for a print location.

For example, in the case of the system configuration shown in FIG. 35, the Web server 2001 transmits an acquisition request for the service list 2071 of the print environment sharing service 2013 (A-1-1) to the print environment sharing service 2013 (A-1-1) based on a request from the user (sequence S2070 of FIG. 50).

In response to receipt of an acquisition request for the service list 2071 of the print environment sharing service 2013 (A-1-1) from the Web server 2001, the service list acquisition unit 2041 of the print environment sharing service 2013 (A-1-1) acquires the service list 2071 stored in the HDD 2039 of the SPS server 2003 (A-1-1), and transmits the acquired service list 2071 to the Web server 2001 (sequence S2071 of FIG. 49). The route information to the print environment sharing service 2013 (A-1-1) is transmitted to the Web server 2001 with the service list 2071.

The Web server 2001 generates a print location selection screen as shown in FIG. 49A based on the service list 2071 of the print environment sharing service 2013 (A-1-1), and provides the print location selection screen to the user.

There is a additional selection “search” in the print location selection screen shown in FIG. 49A in the same manner as the print location selection screen shown in FIG. 47A.

For example, when the user selects “search” and taps a “next” button, the Web server 2001 generates a search condition input screen as shown in FIG. 49B, and provides the search condition input screen to the user.

For example, if the user selects “location name”, inputs “B-1-2” as a search condition, and taps a “search start” button, the Web server 2001 transmits a search request to the print environment sharing service 2013 (B-1-2) (sequence S2072 of FIG. 50).

In response to receipt of the search request of the print environment sharing service 2013 (B-1-2), the service list acquisition unit 2041 of the print environment sharing service (A-1-1) transmits the acquisition request of the service list 2071 of the print environment sharing service 2013 (A-1-1-1) to the print environment sharing service 2013 (A-1-1-1) (sequence S2073 of FIG. 50). As described above, the service list 2071 includes information of the other print environment sharing services 2013 to which the print environment sharing service 2013 corresponding to the service list 2071 refer, the information being the location name, latitude, longitude, altitude, and address, for example. Since the system according to the present embodiment searches for a print location using the information, the service list 2071 is acquired first. The service list may be acquired in the other embodiments to be described below for the same reason.

In response to receipt of the acquisition request, the service list acquisition unit 2041 of the print environment sharing service 2013 (A-1-1-1) acquires the service list 2071 stored in the SPS server 2003 (A-1-1-1), and transmits it to the print environment sharing service 2013 (A-1-1) (sequence S2074 of FIG. 50).

In response to acquisition of the service list 2071 of the print environment sharing service 2013 (A-1-1-1), the print environment sharing service 2013 (A-1-1) determines whether the service list 2071 includes the search condition such as the URI of the print environment sharing service 2013 (B-1-2) to be searched for. If the print environment sharing service 2013 (A-1-1) determines that the service list 2071 does not include the search condition, the print environment sharing service 2013 (A-1-1) transmits an acquisition request for the service list 2071 of the print environment sharing service 2013 (A-1-1-2) to the print environment sharing service 2013 (A-1-1-2) (sequence S2075 of FIG. 50).

In response to receipt of the acquisition request, the service list acquisition unit 2041 of the print environment sharing service 2013 (A-1-1-2) acquires the service list 2071 stored in the SPS server 2003 (A-1-1-2), and transmits the acquired service list 2071 to the print environment sharing service 2013 (A-1-1) (sequence S2076 of FIG. 50).

The print environment sharing service 2013 (A-1-1) sends an acquisition request for the service list 2071 to the print environment sharing services 2013 one by one until the print environment sharing service 2013 (A-1-1) acquires a service list 2071 containing the search condition (the URI of the print environment sharing service 2013 (B-1-2), in this case) (sequences S2077 through S2092 of FIG. 50).

If the print environment sharing service 2013 (A-1-1) acquires the service list 2071 including the search condition (the URI of the print environment sharing service 2013 (B-1-2), in this case), the print environment sharing service 2013 (A-1-1) transmits the search result including the service list 2071 and the route information to the print environment sharing service 2013 (B-1-2) to be searched for to the Web server 2001 (sequence 2093 of FIG. 50).

The Web server 2001 generates a search result display screen as shown in FIG. 49C based on the received search result, and provides the generated search result display screen to the user.

For example, if the user taps the ”OK” button, the Web server 2001 generates a print location selection confirmation screen as shown in FIG. 49D, and provides the generated print location selection confirmation screen to the user.

Additionally, for example, if the user taps a “selection result display” button in the print location selection confirmation screen shown in FIG. 49D, the Web server 2001 generates a print location selection result screen as shown in FIG. 49E, and provides the generated print location selection result screen to the user.

As shown in FIGS. 49 and 50, since the service list 2071 is acquired, the SPS server 2003 (A-1-1) can search for a print environment sharing service 2013 to be searched for independently.

Additionally, the SPS server 2003 (A-1-1) and/or the Web server 2001 can acquire the route information to the print location by performing processing shown in FIGS. 49 and 50.

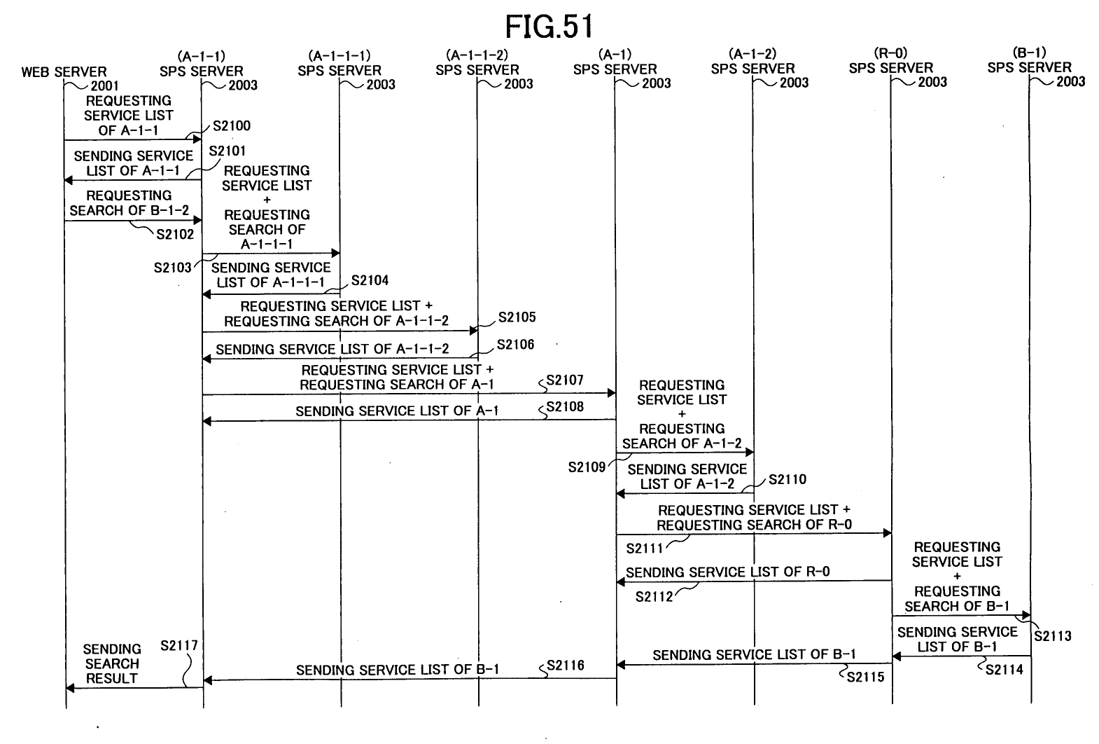

The independent searching for a print location according to another embodiment is described with reference to FIG. 51.

FIG. 51 is a sequence chart for explaining the searching for a print location according to an embodiment.

In the case of FIG. 50, the print environment sharing service 2013 (A-1-1) continues sending an acquisition request for the service list to the print environment sharing services 2013 until the print environment sharing service 2013 (A-1-1) acquires the service list 2071 that contains the search condition (the URI of the print environment sharing service 2013 (B-1-2), in this case). However, in the case of FIG. 51, in response to receipt of a search request from the Web server 2001, the print environment sharing service 2013 (A-1-1) transmits the acquisition request for the service list 2071 and a search request for the print environment sharing service 2013 (B-1-2) to the other print environment sharing services 2013 to which the print environment sharing service 2013 (A-1-1) can refer. In response to receipt of the search request for the print environment sharing service 2013 (B-1-2), the receiving print environment sharing service 2013 independently transmits the acquisition request for the service list and a search request for the print environment sharing service 2013 (B-1-2) to other print environment sharing services 2013.

In FIG. 51, when a print environment sharing service 2013 transmits a search request to another print environment sharing service 2013, the print environment sharing service 2013 adds information about the source of the search request. A print environment sharing service 2013 that receives a service list 2071 including the URI of the print environment sharing service 2013 (B-1-2) to be searched can send the received service list to the source of the search request.

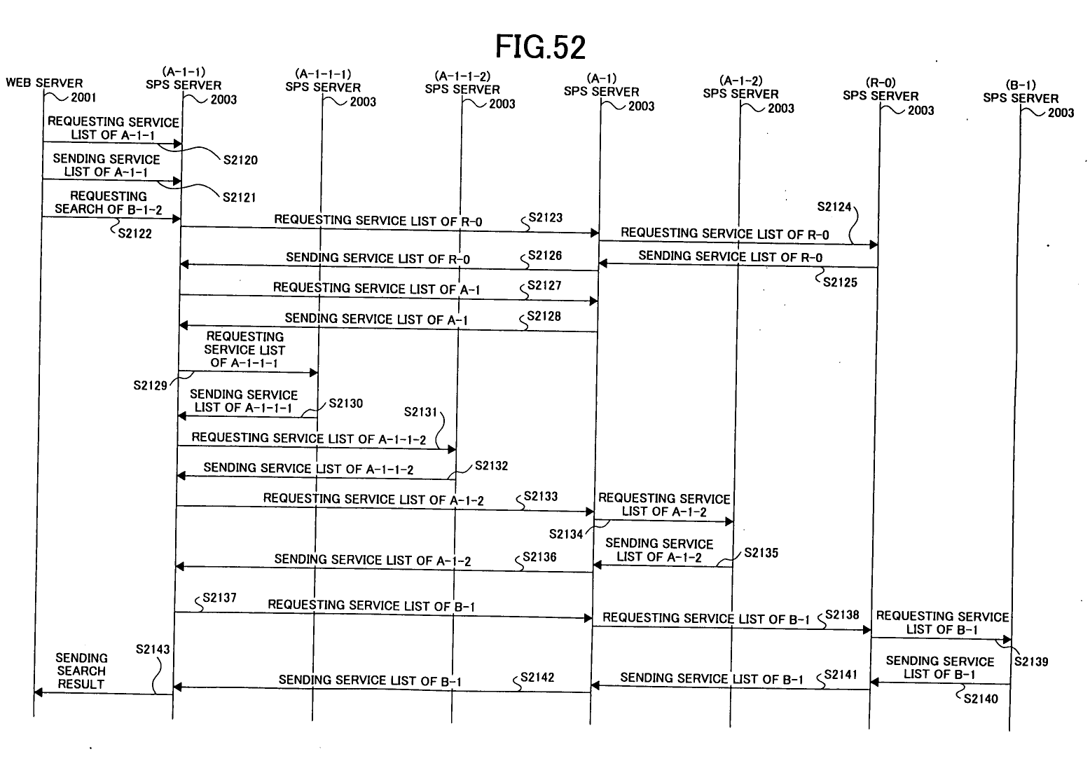

Independently searching for a print location according to another embodiment is described with reference to FIG. 52.

FIG. 52 is a sequence chart for explaining the searching for a print location.

In the case of FIG. 52, in response to receipt of a search request from the Web server 2001, the print environment sharing service 2013 (A-1-1) continues sending an acquisition request for the service list to the print environment sharing services 2013 exhaustively until the print environment sharing service 2013 (A-1-1) acquires a service list 2071 that contains the search condition (the URI of the print environment sharing service 2013 (B-1-2), in this case).

In the case of FIG. 50, the print environment sharing service 2013 (A-1-1) sends an acquisition request to other print environment sharing services 2013 sequentially. However, in the case of FIG. 52, the print environment sharing service 2013 (A-1-1) transmits an acquisition request to print environment sharing services 2013 starting with the top level sequentially.

As shown in FIG. 52, for example, the SPS server 2003 (A-1-1) and/or the Web server 2001 acquires the service list 2071 serially starting with the top level print environment sharing service 2013, and can search the print environment sharing service 2013 to be searched independently.

The SPS server 2003 (A-1-1) and/or the Web server 2001, for example, can acquire the route information to the print location by processing shown in FIG. 52.

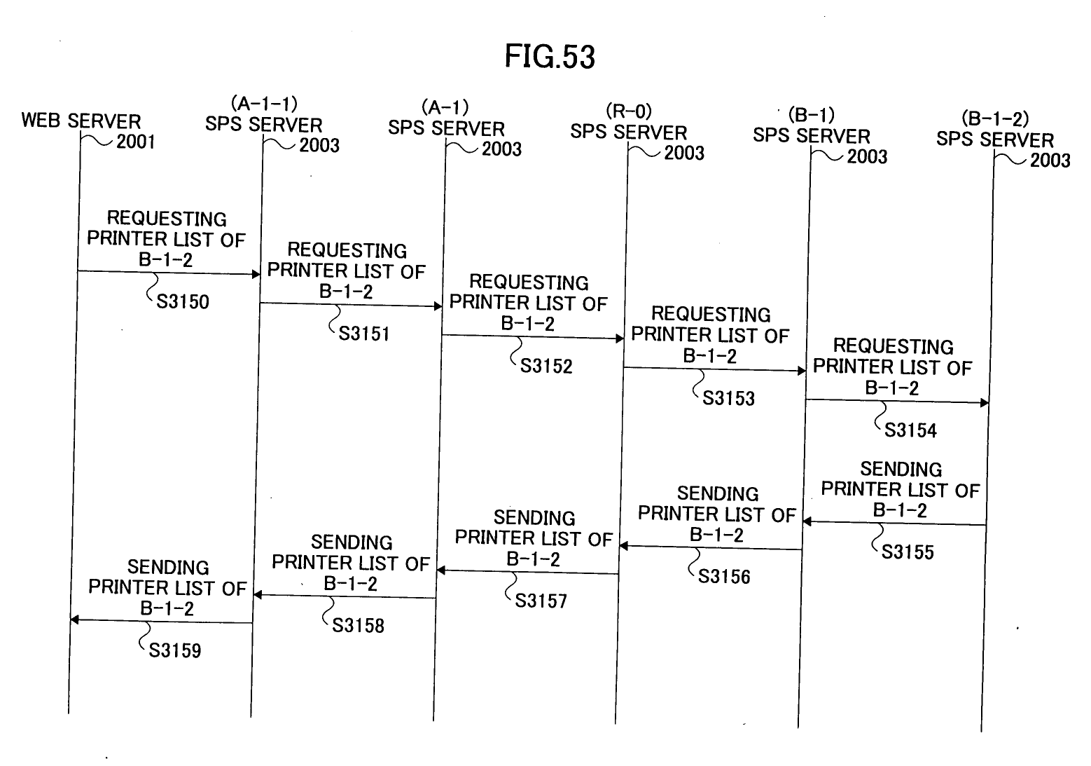

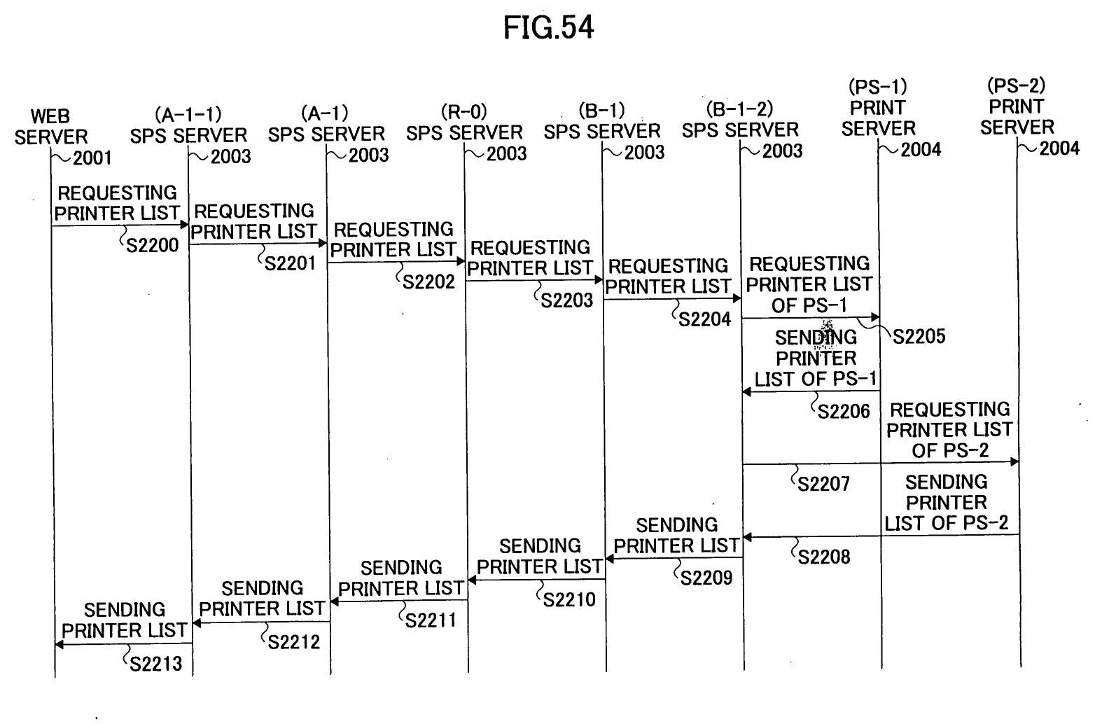

The acquiring of printer list 2072 is described below with reference to FIGS. 53 and 54.

The printer list 2072 may be stored in a SPS server 2003 on which a print environment sharing service 2013 is mounted. According to another embodiment, the printer list 2072 may be stored in a print server 2004 on which a document print service 2014 is mounted.

An exemplary embodiment in which a printer list 2072 is stored in the SPS server 2003 is described below with reference to FIG. 53. FIG. 53 is a sequence chart for explaining the acquiring of a printer list 2072.

As described with reference to FIGS. 38 and 41, when the searching for a print location (print environment sharing service 2013 (B-1-2)) is completed, and the user taps a “printer selection” button in the print location selection confirmation screen as shown in FIG. 38E, the Web server 2001 transmits an acquisition request for the printer list 2072 of the print environment sharing service 2013 (B-1-2) to the print environment sharing service 2013 (A-1-1) (sequence S2150 of FIG. 53).

As described above, when the print location is searched for, the Web server 2001 acquires the route information to the print location (print environment sharing service 2013), the route information being (A-1-1)→(A-1)→(R-0)→(B-1)→(B-1-2), for example. The Web server 2001 transmits the route information together with the acquisition request for the printer list 2072.

In response to receipt of the acquisition request for the printer list 2072 of the print environment sharing service 2013 (B-1-2), the printer list acquisition unit 2042 of the print environment sharing service 2013 (A-1-1) transmits the acquisition request to the print environment sharing service 2013 (A-1) (sequence S2151 of FIG. 53).

In response to receipt of the acquisition request, the printer list acquisition unit 2042 of the print environment sharing service 2013 (A-1) transmits the acquisition request to the print environment sharing service 2013 (R-0) (sequence S2152 of FIG. 53).

In response to receipt of the acquisition request, the printer list acquisition unit 2042 of the print environment sharing service 2013 (R-0) transmits the acquisition request to the print environment sharing service 2013 (B-1) (sequence S2153 of FIG. 53).

In response to receipt of the acquisition request, the printer list acquisition unit 2042 of the print environment sharing service 2013 (B-1) transmits the acquisition request to the print environment sharing service 2013 (B-1-2) (sequence S2154 of FIG. 53).

In response to receipt of the acquisition request, the printer list acquisition unit 2042 of the print environment sharing service 2013 (B-1-2) acquires the printer list 2072 stored in the SPS server 2003 (B-1-2), and transmits the acquired printer list 2072 to the print environment sharing service 2013 (B-1) based on the route information (sequence S2155 of FIG. 53).

The printer list acquisition unit 2042 of the print environment sharing service 2013 (B-1) transmits the received printer list 2072 of the print environment sharing service 2013 (B-1-2) to the print environment sharing service 2013 (R-0) based on the route information (sequence S2156 of FIG. 53).

The printer list acquisition unit 2042 of the print environment sharing service 2013 (R-0) transmits the received printer list 2072 of the print environment sharing service 2013 (B-1-2) to the print environment sharing service 2013 (A-1) based on the route information (sequence S2157 of FIG. 53).

The printer list acquisition unit 2042 of the print environment sharing service 2013 (A-1) transmits the received printer list 2072 of the print environment sharing service 2013 (B-1-2) to the print environment sharing service 2013 (A-1-1) based on the route information (sequence S2158 of FIG. 53).

The printer list acquisition unit 2042 of the print environment sharing service 2013 (A-1-1) transmits the received printer list 2072 of the print environment sharing service 2013 (B-1-2) to the Web server 2001 based on the route information (sequence S2159 of FIG. 53).

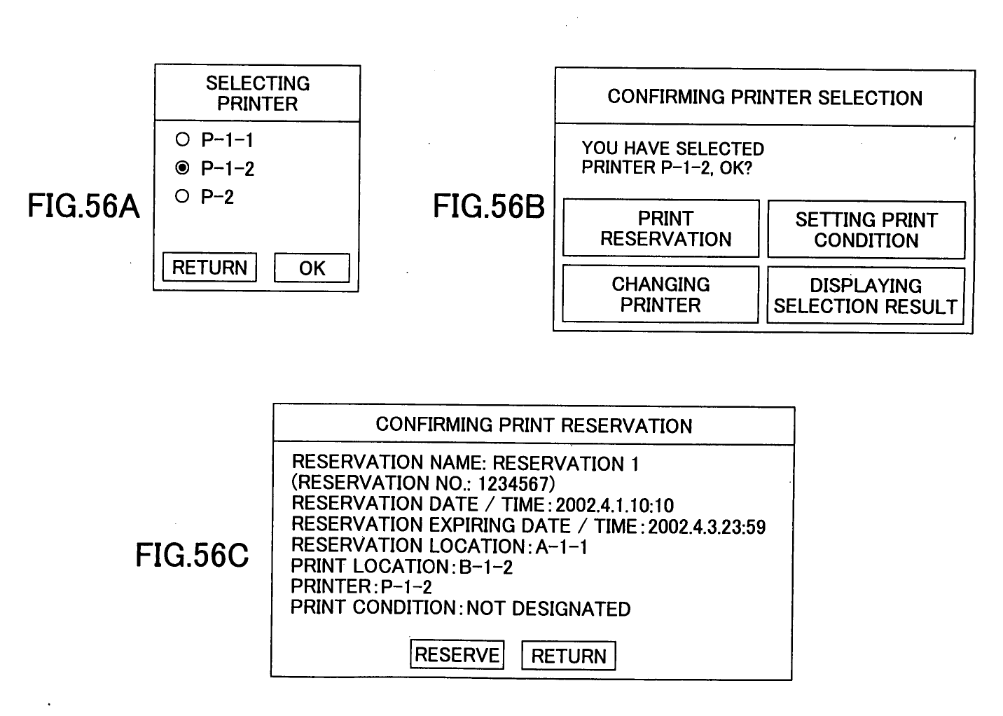

The Web server 2001 generates a printer selection screen as shown in FIG. 56A (described below) based on the received printer list 2072 of the print environment sharing service 2013 (B-1-2), and provides the generated printer selection screen to the user.

An exemplary embodiment in which the printer list 2072 is stored in the print server 2004 is described below with reference to FIG. 54. FIG. 54 is a sequence chart for explaining the acquiring of a printer list according to another embodiment.

As described with reference to FIGS. 38 and 41, when the searching for a print location (print environment sharing service 2013 (B-1-2)) is completed, and the user taps a “printer selection” button in the print location selection confirmation screen as shown in FIG. 38E, the Web server 2001 transmits an acquisition request for the printer list 2072 of the document print service 2014 to which the print environment sharing service 2013 (B-1-2) can refer (sequence S2200 of FIG. 53).

In response to the acquisition request for the printer list 2072 of the document print service 2014 to which the print environment sharing service 2013 (B-1-2) can refer, the printer list acquisition unit 2042 of the print environment sharing service 2013 (A-1-1) transmits the acquisition request to the print environment sharing service 2013 (A-1) based on the route information (sequence S2201).

In response to the acquisition request, the printer list acquisition unit 2042 of the print environment sharing service 2013 (A-1) transmits the acquisition request to the print environment sharing service 2013 (R-0) based on the route information (sequence S2202).

In response to the acquisition request, the printer list acquisition unit 2042 of the print environment sharing service 2013 (R-0) transmits the acquisition request to the print environment sharing service 2013 (B-1) based on the route information (sequence S2203)

In response to the acquisition request, the printer list acquisition unit 2042 of the print environment sharing service 2013 (B-1) transmits the acquisition request to the print environment sharing service 2013 (B-1-2) based on the route information (sequence S2204).

In response to the acquisition request for the printer list 2072 of the document print service 2014 to which the print environment sharing service 2013 (B-1-2) can refer, the printer list acquisition unit 2042 of the print environment sharing service 2013 (B-1-2) transmits the acquisition request for the printer list 2072 of the document print service 2014 (PS-1) to the document print service 2071 (sequence S2205).

In response to receipt of the acquisition request, the document print service 2014 (PS-1) acquires the printer list 2072 stored in the print server 2004 (PS-1), for example, and transmits the acquired printer list 2072 to the print environment sharing service 2013 (B-1-2) (sequence S2206).

In response to receipt of the acquisition request for the printer list 2072 of the document print service 2014, the printer list acquisition unit 2042 of the print environment sharing service 2013 (B-1-2) transmits the acquisition request for the printer list 2072 of the document print service 2014 (PS-2) to the document print service 2014 (PS-2) (sequence S2207).

In response to receipt of the acquisition request, the document print service 2014 (PS-2) acquires the printer list 2072 stored in the print server 2004 (PS-2), for example, and transmits the acquired printer list 2072 to the print environment sharing service 2013 (B-1-2) (sequence S2208).

The printer list acquisition unit 2042 of the print environment sharing service 2013 (B-1-2) transmits the received printer list 2072 of the document print service 2014 (PS-1) and the received printer list 2072 of the document print service 2014 (PS-2) to the print environment sharing service 2013 (B-1) based on the route information (sequence S2209).

The printer list acquisition unit 2042 of the print environment sharing service 2013 (B-1) transmits the received printer list 2072 to the print environment sharing service 2013 (R-0) based on the route information (sequence S2210).

The printer list acquisition unit 2042 of the print environment sharing service 2013 (R-0) transmits the received printer list 2072 to the print environment sharing service 2013 (A-1) based on the route information (sequence S2211).

The printer list acquisition unit 2042 of the print environment sharing service 2013 (A-1) transmits the received printer list 2072 to the print environment sharing service 2013 (A-1-1) based on the route information (sequence S2212).

The printer list acquisition unit 2042 of the print environment sharing service 2013 (A-1-1) transmits the received printer list 2072 to the Web server 2001 (sequence S2213).

The Web server 2001 generates a printer selection screen as shown in FIG. 56A based on the received printer list 2072, and provides the generated print selection screen to the user.

In the following description, it is assumed that the printer list 2072 is stored in the SPS server 2003 on which the print environment sharing service 2013 is mounted in order to make the description easy to understand.

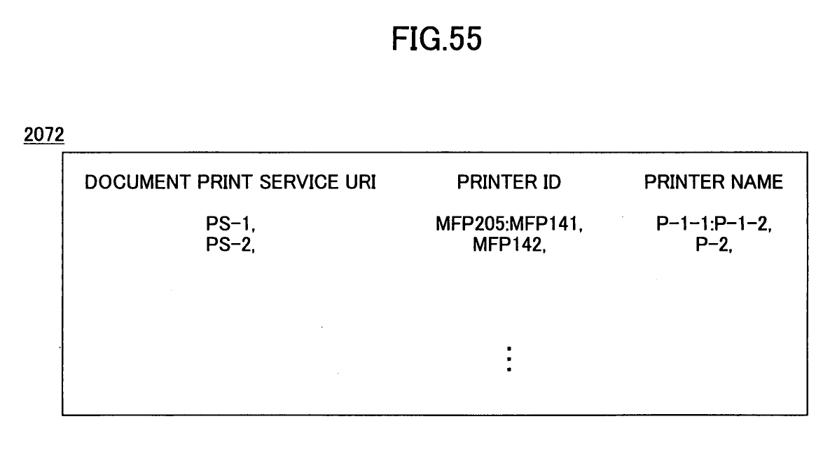

An exemplary printer list 2072 is described below with reference to FIG. 55. FIG. 55 is a schematic diagram for explaining the printer list.

The printer list 2072 includes the URI of the document print service 2014, the printer ID of a printer that the document print service 2014 manages, and a printer name, to which the corresponding print environment sharing service 2013 can refer. For example, the printer list 2072 shown in FIG. 55 includes the URI of the document print service 2014, the printer ID of the printer that the document print service 2014 manages, and its printer name, to which print environment sharing service 2013 mounted on the SPS server 2003 in which the printer list 2072 is stored can refer.

It is noted that, for example, “PS-1” and “PS-2”, instead of the URI, are included in FIG. 55 for identifying the document print services 2014.

FIGS. 56A-56C are schematic diagrams for explaining the selecting of a printer.

As described above, in the case in which the user taps the “printer selection” button in the print location selection confirmation screen as shown in FIGS. 38 and 40, for example, the Web server 2001 sends an acquisition request and acquires the printer list 2072 of the print environment sharing service 2013 selected as a print location.

The Web server 2001 generates a printer selection screen as shown in FIG. 56A based on the acquired printer list 2072 and provides the generated printer selection screen to the user.

If the user selects “P-1-2” and taps an “OK” button in the printer selection screen shown in FIG. 56A, for example, the Web server 2001 generates and provides a printer selection confirmation screen as shown in 56B to the user.

As described above with reference to FIGS. 53 through 56, since the SPS server 2003 (A-1-1) and/or the Web server 2001 acquires the printer list 2072, the user can selects a printer as well as the print location, and make a print reservation.

For example, if the user taps a “print reservation” button in the printer selection confirmation screen shown in FIG. 56B, the Web server 2001 generates a print reservation confirmation screen as shown in FIG. 56C, and provides the generated print reservation confirmation screen to the user.

The selected printer is indicated in FIG. 56C, but is not indicated in FIG. 38G.

The user may select a document, a print location, and a printer, and taps a “reservation” button using the print reservation confirmation screen shown in FIG. 56C thereby to make a print reservation without setting print conditions.

As will be appreciated with reference to FIG. 59, a request for print reservation includes the following: the document ID of the document the user has selected, a document ticket for permission to use the document, identification information for identifying the print location, the route information to the print location, and identification information for identifying the selected printer.

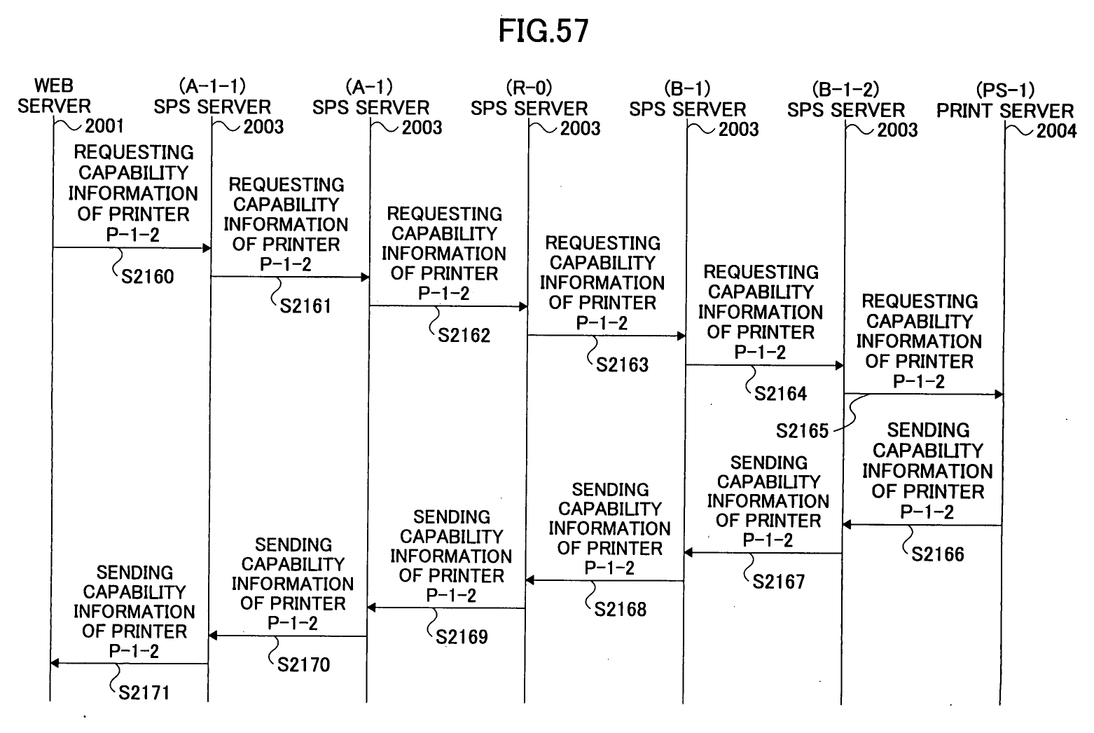

The acquiring of printer capability is described with reference to FIG. 57.

FIG. 57 is a sequence chart for explaining the acquiring of printer capability.

For example, if the user finishes selecting a printer, and taps the “print condition setting” in the printer selection confirmation screen as shown in FIG. 56B, the Web server 2001 transmits an acquisition request for the capability information of the printer 2006 (P-1-2) to the print environment sharing service 2013 (A-1-1) (sequence S2160).

It is noted that, in the following description, the capability information of a printer is information related to the function and processing capacity of the printer, the information retained by the document print service 2014 managing the printer, of whether the printer supports color printing and double sided printing, for example.

In response to receipt of an acquisition request for the capability information of the printer 2006 (P-1-2), the printer capability information acquisition unit 2045 of the print environment sharing service 2013 (A-1-1) transmits the acquisition request to the print environment sharing service 2013 (A-1) based on the route information (sequence S2161).

In response to receipt of an acquisition request, the printer capability information acquisition unit 2045 of the print environment sharing service 2013 (A-1) transmits the acquisition request to the print environment sharing service 2013 (R-0) based on the route information (sequence S2162) In response to receipt of an acquisition request, the printer capability information acquisition unit 2045 of the print environment sharing service 2013 (R-0) transmits the acquisition request to the print environment sharing service 2013 (B-1) based on the route information (sequence S2163) In response to receipt of an acquisition request, the printer capability information acquisition unit 2045 of the print environment sharing service 2013 (B-1) transmits the acquisition request to the print environment sharing service 2013 (B-1-1) based on the route information (sequence S2164).

In response to receipt of an acquisition request, the printer capability information acquisition unit 2045 of the print environment sharing service 2013 (B-1-2) transmits the acquisition request to the document print service 2014 (PS-1) (sequence S2165).

In response to receipt of an acquisition request, the document print service 2014 (PS-1) acquires the capability information of the printer 2006 (P-1-2) stored in the print server 2004 (PS-1), for example, and transmits the acquired capability information to the print environment sharing service 2013 (B-1-2) (sequence S2166).

According to the present embodiment, the capability information of printers 2006 is distributedly stored in the print servers 2004. According to another embodiment, the capability information of printers 2006 may be centrally stored in one server.

The printer capability information acquisition unit 2045 of the print environment sharing service 2013 (B-1-2) transmits the received capability information of the printer 2006 (P-1-2) to the print environment sharing service 2013 (B-1) based on the route information (sequence S2167).

The printer capability information acquisition unit 2045 of the print environment sharing service 2013 (B-1) transmits the received capability information of the printer 2006 (P-1-2) to the print environment sharing service 2013 (R-0) based on the route information (sequence S2168).

The printer capability information acquisition unit 2045 of the print environment sharing service 2013 (R-0) transmits the received capability information of the printer 2006 (P-1-2) to the print environment sharing service 2013 (A-1) based on the route information (sequence S2169).

The printer capability information acquisition unit 2045 of the print environment sharing service 2013 (A-1) transmits the received capability information of the printer 2006 (P-1-2) to the print environment sharing service 2013 (A-1-1) based on the route information (sequence S2170).

The printer capability information acquisition unit 2045 of the print environment sharing service 2013 (A-1-1) transmits the received capability information of the printer 2006 (P-1-2) to the Web server 2001 (sequence S2171).

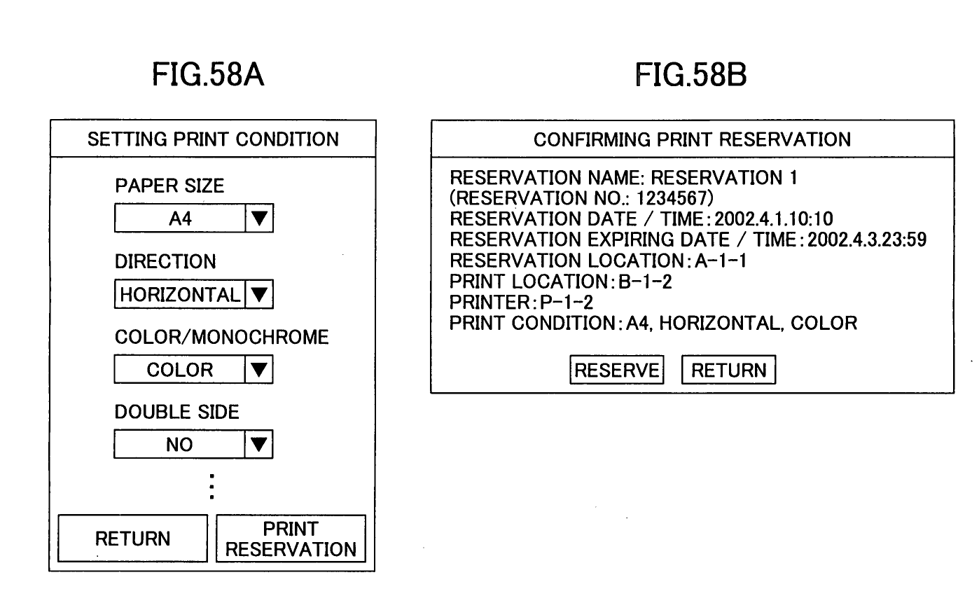

The Web server 2001 generates a print condition setting screen as shown in FIG. 58A based on the received capability information of the printer 2006 (P-1-2), and provides the generated print condition setting screen to the user.

FIGS. 58A and 58b are schematic diagrams for explaining the setting of print condition.

As described above, if the user taps a “print condition setting” button in the printer selection confirmation screen shown in FIG. 56B, the Web server 2001 sends an acquisition request for the capability information of the selected printer 2006, and acquires the capability information of the selected printer 2006.

The Web server 2001 generates a print condition setting screen as shown in FIG. 58A based on the acquired capability information of the printer 2006, and provides the print condition setting screen to the user.

For example, if the user taps a “print reservation” button in the printer selection confirmation screen shown in FIG. 58A, the Web server 2001 generates a print reservation confirmation screen as shown in FIG. 58B, and provides the generated print reservation confirmation screen to the user.

It is noted that the print condition is set in the print reservation confirmation screen of FIG. 58B, but is not in the print reservation confirmation screen of FIG. 56C.

The user can set a document to be printed, a printer, and the print condition, and taps the “reservation” button in the print reservation confirmation screen shown in FIG. 58B, for example, thereby to make a print reservation.

As will be appreciated with reference to FIG. 59, the print reservation includes the document ID of the selected document, the document ticket used for getting permission to use the document, identification information for identifying the print location, the route information to the print location, identification information for identifying the printer, and the print condition.

As described above with reference to FIGS. 57 and 58, since the SPS server 2003 (A-1-1) and/or the Web server 2001 acquires the capability information of the printer, the user can set the print condition as well as the print location and the printer, and make a print reservation.

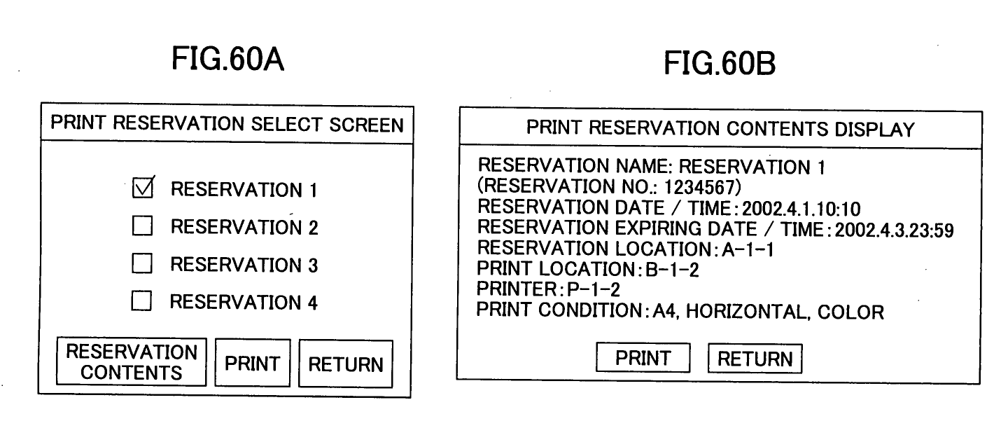

The requesting of a print reservation and a printing are described with reference to FIGS. 59 and 60.

FIG. 59 is a sequence chart for explaining an exemplary embodiment of the requesting of a print reservation and printing.

FIG. 60 is a schematic diagram for explaining the starting of printing.

If the user taps a “reserve” button in the print reservation confirmation screen as shown in FIG. 58B, the Web server 2001 transmits a request for a print reservation to the print environment sharing service 2013 (A-1-1) (sequence S2180 of FIG. 59).

In receipt of the reservation request, the print reservation control unit 2048 of the print environment sharing service 2013 (A-1-1) transfers the document ID and the document ticket, for example, included in the reservation request to the document acquisition unit 2043, and requests the document acquisition unit 2043 to acquire document data.

The document acquisition unit 2043 of the print environment sharing service 2013 (A-1-1) transmits the acquisition request for the document data to the repository service 2012, the acquisition request including the document ID and the document ticket. (sequence S2181 of FIG. 59).

In response to the acquisition request for the document data, the repository service 2012 determines whether the document ticket contained in the acquisition request is authentic and, if the document ticket is determined to be authentic, acquires the document data corresponding to the document ID from the repository server 2002, and transmits the document data to the print environment sharing service 2013 (A-1-1) (sequence S2182 of FIG. 59).

When the document acquisition unit 2043 acquires the document data, the print reservation control unit 2048 of the print environment sharing service 2013 (A-1-1) requests the data transfer unit 2044 to transfer reservation information contained in the reservation request received from the Web server 2001 and the acquired document data. The reservation information contains identification information for identifying the print location, identification information for identifying the printer, the print condition, and the route information to the print location, for example. The print reservation control unit 2048 also stores the reservation information in the HDD 2039, for example, of the SPS server 2003 on which the print environment sharing service 2013 (A-1-1) is mounted.

In response to receipt of the transfer request, the data transfer unit 2044 of the print environment sharing service 2013 (A-1-1) transfers the reservation information and the document data to the print environment sharing service 2013 (A-1) based on the route information to the print location contained in the reservation request (sequence S2183 of FIG. 59).

In response to acquisition of the reservation information and the document data, the data transfer unit 2044 of the print environment sharing service 2013 (A-1) transmits the reservation information and the document data to the print environment sharing service 2013 (R-0) based on the route information to the print location contained in the reservation information (sequence S2184 of FIG. 59).

In response to acquisition of the reservation information and the document data, the data transfer unit 2044 of the print environment sharing service 2013 (R-0) transmits the reservation information and the document data to the print environment sharing service 2013 (B-1) based on the route information to the print location contained in the reservation information (sequence S2185 of FIG. 59).

In response to acquisition of the reservation information and the document data, the data transfer unit 2044 of the print environment sharing service 2013 (B-1) transmits the reservation information and the document data to the print environment sharing service 2013 (B-1-2) based on the route information to the print location contained in the reservation information (sequence S2186 of FIG. 59).

In response to acquisition of the reservation information and the document data, the print environment sharing service 2013 (B-1-2) stores the reservation information and the document data in the HDD 2039 of the SPS server 2003 (B-1-2).

On the other hand, the Web server 2001 transmits an acquisition request for the reservation information stored, user by user, in the HDD 2039 of the SPS server 2003 (A-1-1) based on a user's request (sequence S2187 of FIG. 59).

In response to the acquisition request for the reservation information, the print environment sharing service 2013 (A-1-1) acquires the reservation information designated by the user from the HDD 2039 of the SPS server 2003 (A-1-1), and transmits the reservation information to the Web server 2001 (sequence S2188 of FIG. 59).

The Web server 2001 generates a print reservation selection screen with which the user can select a print reservation as shown in FIG. 60A based on the reservation information, and provides the print reservation selection screen to the user.

If the user selects “reservation 1” and taps a “reservation content” button in the print reservation selection screen shown in FIG. 60A, the Web server 2001 generates a print reservation content display screen as shown in FIG. 60B, and provides the print reservation content display screen to the user.

If the user checks the reservation content and taps the “print” button in the print reservation content display screen as shown in FIG. 60B, or the user taps a “print” button in the print reservation selection screen as shown in FIG. 60A, the Web server 2001 transmits a start request for starting printing to the print environment sharing service 2013 (A-1-1) (sequence S2189 of FIG. 59).

In response to receipt of the start request for starting printing, the print start control unit 2049 of the print environment sharing service 2013 (A-1-1) transmits the start request to the print environment sharing service 2013 (A-1) based on the route information to the print location contained in the start request (sequence S2190 of FIG. 59).

In response to receipt of the start request for starting printing, the print start control unit 2049 of the print environment sharing service 2013 (A-1) transmits the start request to the print environment sharing service 2013 (R-0) based on the route information to the print location contained in the start request (sequence S2191 of FIG. 59).

In response to receipt the start request for starting printing, the print start control unit 2049 of the print environment sharing service 2013 (R-0) transmits the start request to the print environment sharing service 2013 (B-1) based on the route information to the print location contained in the start request (sequence S2192 of FIG. 59).

In response to receipt the start request for starting printing, the print start control unit 2049 of the print environment sharing service 2013 (B-1) transmits the start request to the print environment sharing service 2013 (B-1-2) based on the route information to the print location contained in the start request (sequence S2193 of FIG. 59).

In response to the start request, the print start control unit 2049 of the print environment sharing service 2013 (B-1-2) acquires the reservation information and the document data stored in the HDD 2039 of the SPS server 2003 (B-1-2), and transmits a start request for starting printing containing the print condition and the document data to the document print service 2014 (PS-1) (sequence S2194 of FIG. 59).

In response to receipt of the start request for starting printing the document data under the print condition, the document print service 2014 (PS-1) converts the document data into print data that the designated printer 2006 (P-1-2) can print, and transmits a start request containing the print data to the printer 2006 (P-1-2) (sequence S2195 of FIG. 59).

In response to receipt of the start request, the printer 2006 (P-1-2) prints the print data.

As shown in FIGS. 59 and 60, the print environment sharing service 2013 acquires the route information to the print location using the service list 2071. The print environment sharing service 2013 can transfer the reservation information and the document data to the print environment sharing service 2013 of the print location based on the acquired route information, and make a print reservation.

Additionally, the print environment sharing service 2013 can transmit the start request for starting printing to the SPS server 2003 of the print location storing the reservation information and the document data based on the acquired route information, and request the document print service 2014 managing the designated printer 2006 to start printing the document.

### Fourth Embodiment

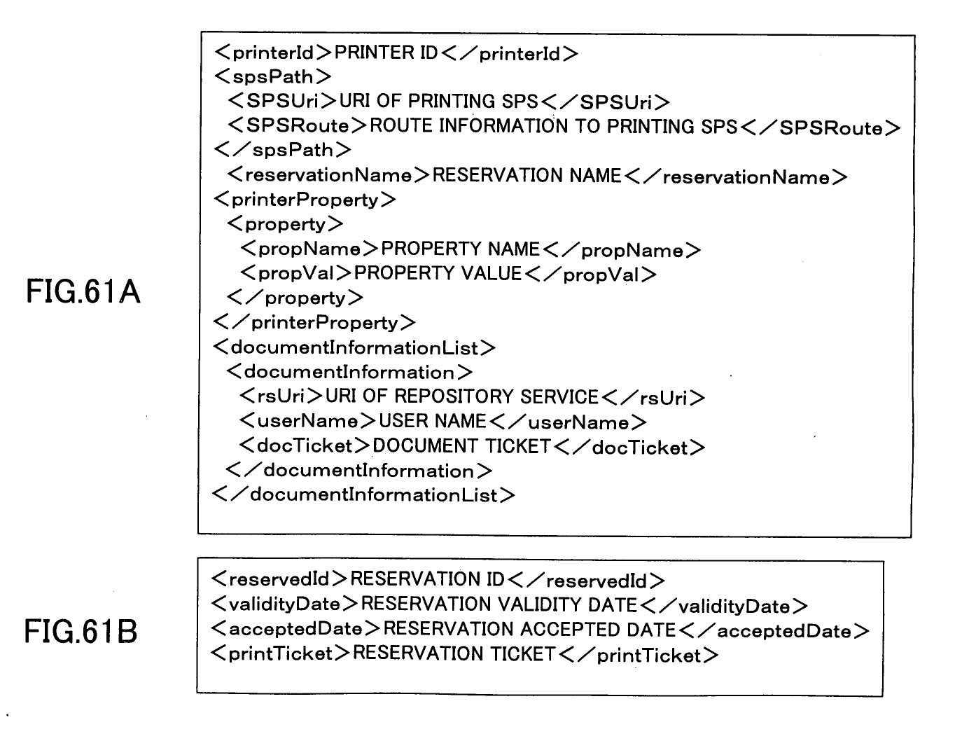

Exemplary I/F of the SOAP method of the print environment sharing service 2013 is described with reference to FIGS. 61 through 69. FIG. 61 is a schematic diagram for explaining the I/F of a print reservation method according to an embodiment.

The print reservation method is a method for transmitting document data to the designated print environment sharing service 2013 or the designated document print service 2014.

The print environment sharing service 2013 or the Web server 2001, for example, calls the print reservation method of another print environment sharing service 2013 or the print environment sharing service 2013 with providing parameters as shown in FIG. 61A, and acquires data as shown in FIG. 61B as returned values.

Only one item of “property” is shown in FIG. 61A. However, if there are multiple print conditions that the user has designated, items of “property” as many as the number of the designated print conditions are to be provided. If the user has designated multiple documents, items of “documentInformation” as many as the number of designated documents are to be provided in FIG. 61A.

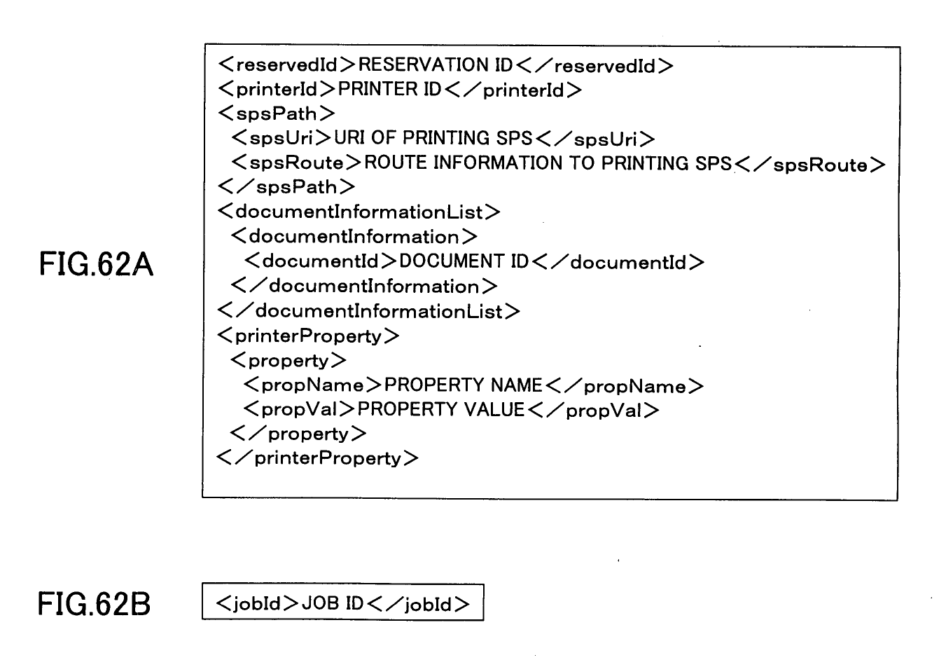

An exemplary I/F of a print start method is shown in FIG. 62. FIGS. 62A and 62B are schematic diagrams for explaining the I/F of the print start method.

The print start method is a method to start printing a designated print-reserved document.

The print environment sharing service 2013 or the Web server 2001 calls the print start method of the other print environment sharing service 2013 or the print environment sharing service 2013 with providing parameters shown in FIG. 62A, and acquires data shown in FIG. 62B as the returned value.

Items of “documentInformation” as many as the number of documents are to be provided in FIG. 62A. However, if only the document that the user has designated at the same time as the print reservation is to be printed, no “documentInformation” is provided to FIG. 62A. Similarly, items of “property” as many as the print conditions are to be provided in FIG. 62A. However, if only the print condition that the user has set at the same time as the print reservation is to be used, no “property” is designated.

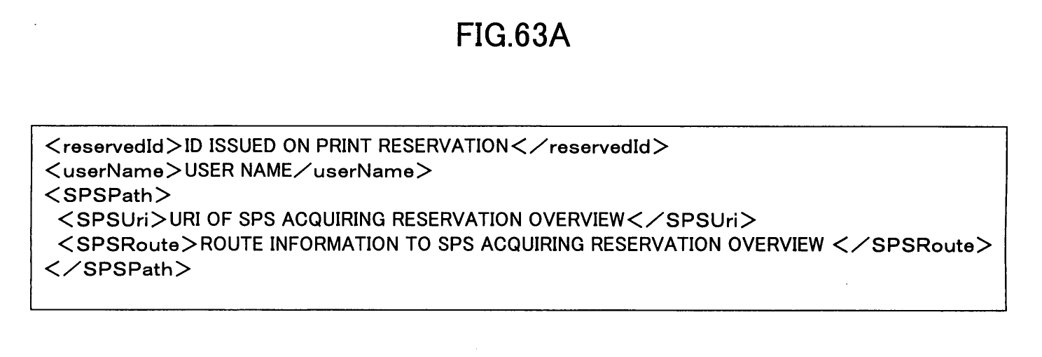

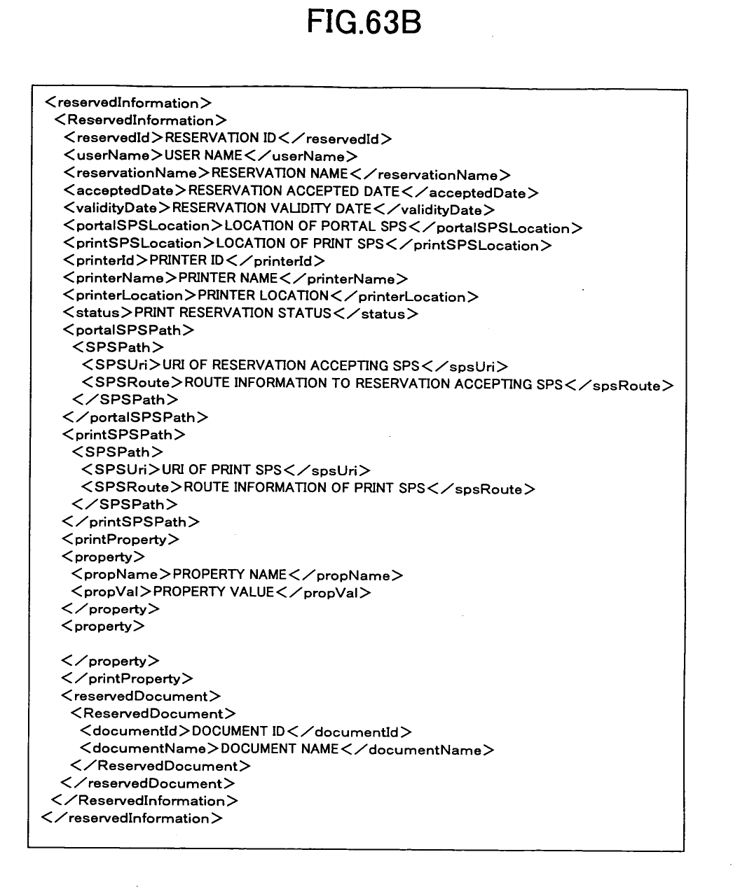

An exemplary I/F of a reservation overview acquisition method is shown in FIG. 63. FIG. 63A and 63B are schematic diagrams for explaining the I/F of the reservation overview acquisition method.

The reservation overview acquisition method is a method for acquiring reservation information of a designated reservation ID and a designated user.

For example, the Web server 2001 calls the reservation overview acquisition method of the print environment sharing service 2013 by providing parameters as shown in FIG. 63A, and acquires data as shown in FIG. 63B as returned values.

Items of “printerProperty” as many as the number of print conditions are to be provided in FIG. 63B. Items of “reservedDocument” as many as the number of reserved documents are to be provided in FIG. 63B.

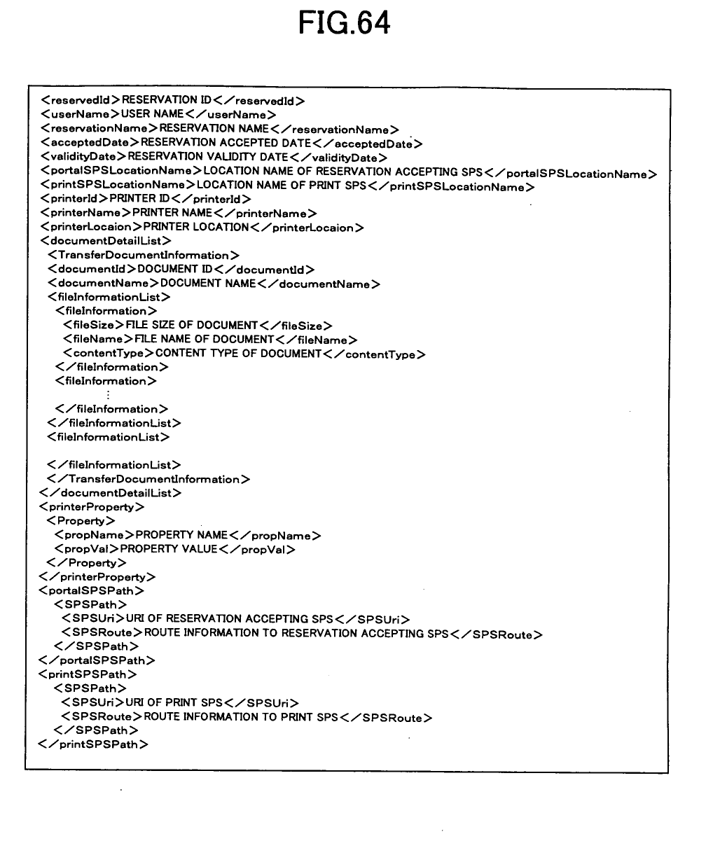

An exemplary I/F of a reservation information transfer method is shown in FIG. 64. FIG. 64 is a schematic diagram showing the I/F of a reservation information transfer method.

The reservation information transfer method transfers the reservation information or the document retained by the print environment sharing service 2013 to another print environment sharing service 2013.

For example, the print environment sharing service 2013 or the Web server 2001 calls the reservation information transfer method of another print environment sharing service 2013 with providing parameters as shown in FIG. 64A.

Items of “TransferDocumentInformation” shown as many as the number of documents are to be provided in FIG. 64. Items of “fileInformation” as many as the number of files contained in the document are to be provided in FIG. 64.

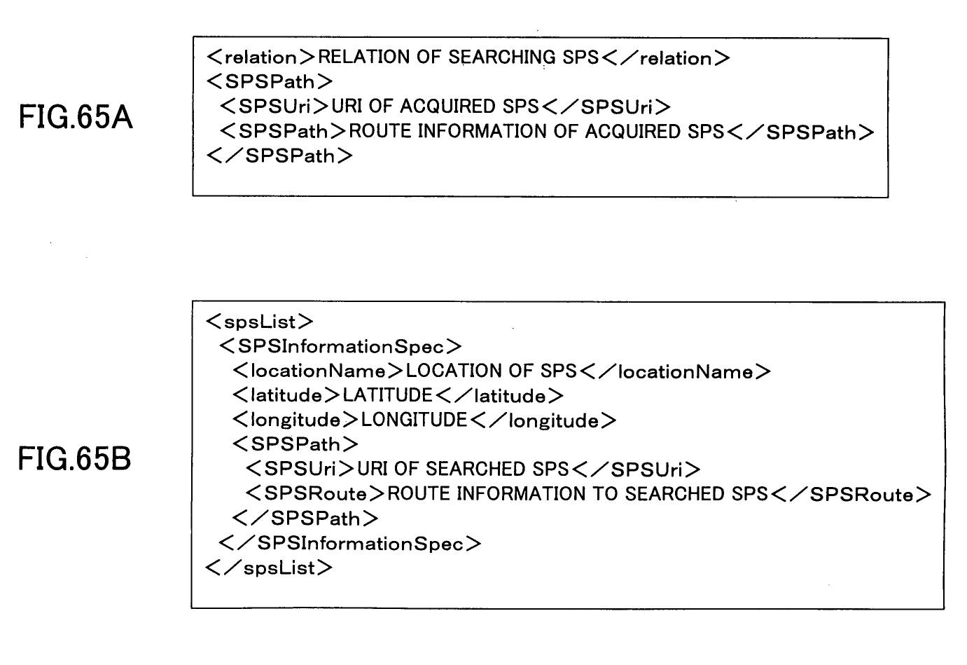

An exemplary I/F of a SPS overview acquisition method is shown in FIG. 65. FIGS. 65A and 65B are schematic diagrams showing the I/F of the SPS overview acquisition method.

The SPS overview acquisition method returns its own service list 2071.

For example, the print environment sharing service 2013 or the Web server 2001 provides parameters as shown in FIG. 65A, calls the SPS overview acquisition method of another print environment sharing service 2013 or the print environment sharing service 2013, and acquires data as shown in FIG. 65B as returned values.

Items of “SPSInformationSpec” as many as the print environment sharing service 2013 contained in the service list 2071 to be acquired are to be provided in FIG. 65B.

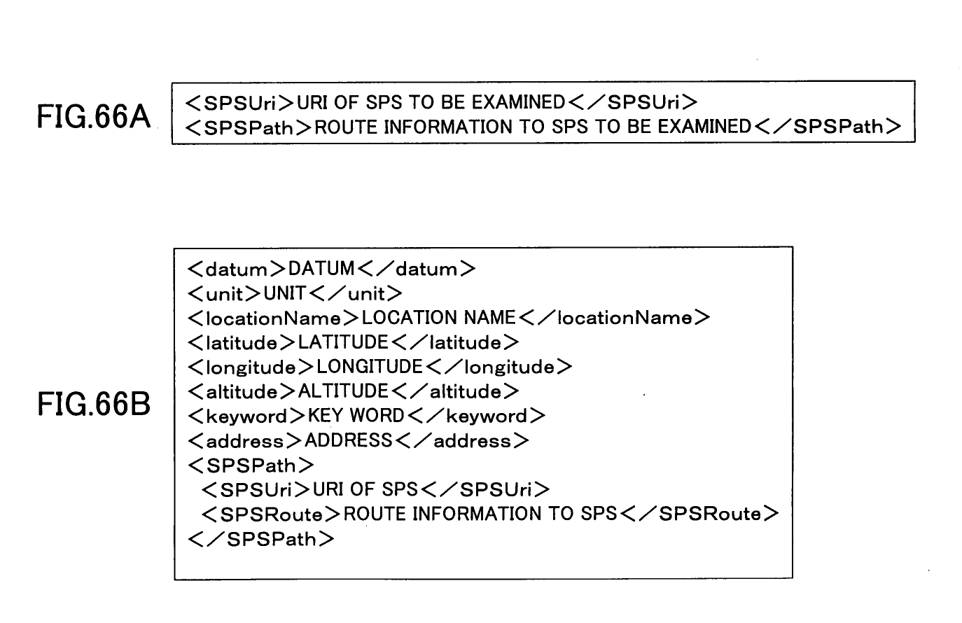

An exemplary I/F of a SPS information acquisition method is shown in FIG. 66. FIGS. 66A and 66B are schematic diagrams showing the I/F of the SPS information acquisition method.

The SPS information acquisition method acquires information of a designated print environment sharing service 2013.

For example, the print environment sharing service 2013 or the Web server 2001 provides parameters as shown in FIG. 66A, calls the SPS information acquisition method of print environment sharing services 2013, and acquires data as shown in FIG. 66B as returned values.

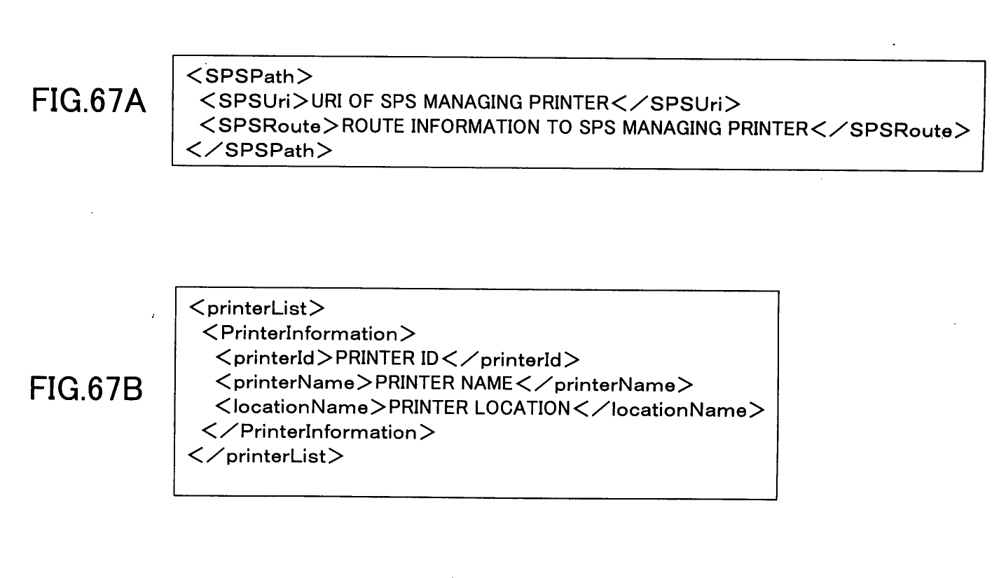

An exemplary I/F of a printer overview acquisition method is shown in FIG. 67. FIGS. 67A and 67B are schematic diagrams showing the I/F of the printer overview acquisition method.

The printer overview acquisition method is a method for acquiring the overview of printers.

For example, the print environment sharing service 2013 or the Web server 2001 provides parameters as shown in FIG. 67A, calls the printer overview acquisition method of the print environment sharing service 2013 or another print environment sharing service 2013, and acquires data as shown in FIG. 67B as returned values.

Items of “PrinterInformation” as many as the number of printers are to be provided in FIG. 67B.

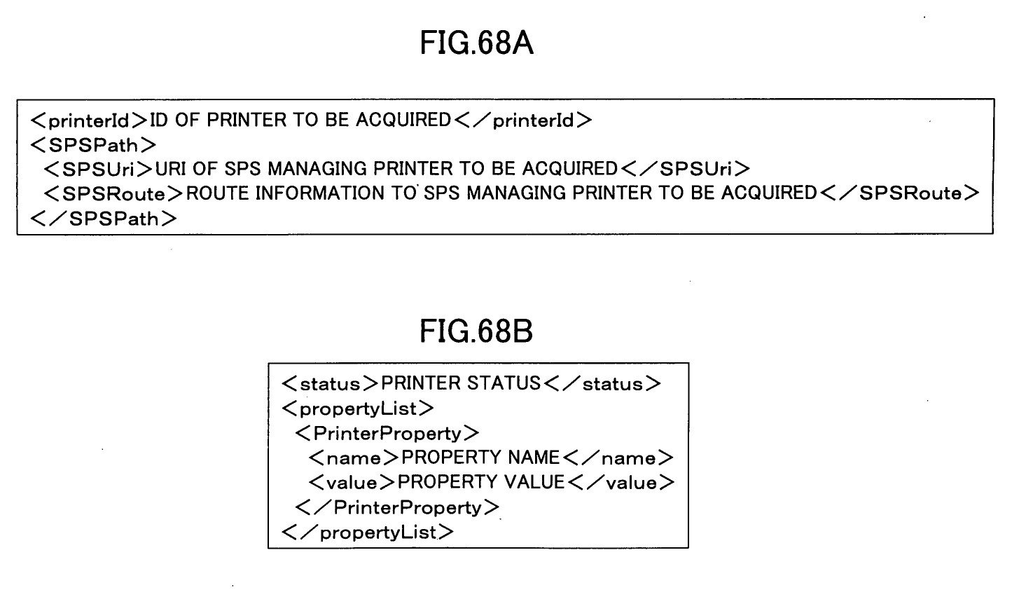

An exemplary I/F of a printer property acquisition method is shown in FIG. 68. FIGS. 68A and 68B are schematic diagrams showing the I/F of the printer property acquisition method.

The printer property acquisition method is a method for acquiring the property of a printer 2006 under a designated print environment sharing service 2013.

For example, the print environment sharing service 2013 or the Web server 2001 provides parameters as shown in FIG. 68A, calls the printer property acquisition method of the print environment sharing service 2013 or another print environment sharing service 2013, and acquires data as shown in FIG. 68B as returned values.

Items of “PrinterProperty” as many as the number of properties are to be provided in FIG. 68B.

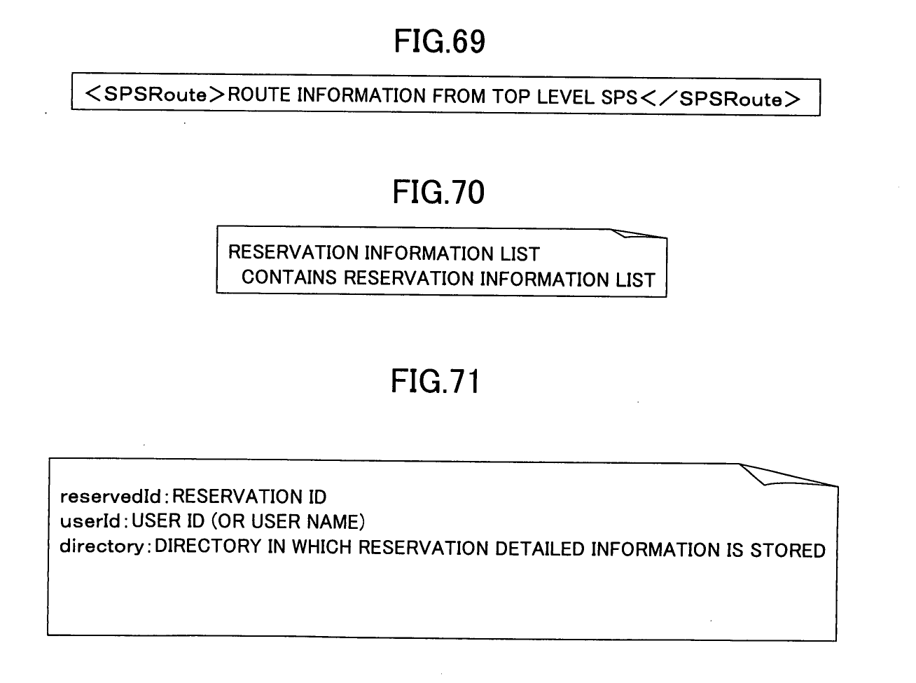

An exemplary I/F of a route information acquisition method is shown in FIG. 69. FIG. 69 is a schematic diagram showing the I/F of the route information acquisition method.

The route information acquisition method is a method for acquiring the route information of the print environment sharing services 2013.

For example, the print environment sharing service 2013 or the Web server 2001 calls the route information acquisition method of the print environment sharing service 2013 or another print environment sharing service 2013, and acquires data as shown in FIG. 69 as a returned value. When the route information acquisition method is called, no parameter is provided.

A description is given on exemplary data related to the reservation information managed by a print environment sharing service 2013 with reference to FIGS. 70 through 72.

FIG. 70 is a schematic diagram showing a reservation information list. As shown in FIG. 70, the print environment sharing service 2013 retains a reservation information list including user's reservations, the reservation information including a reservation ID, a user ID (or user name), and a directory in which the reservation detailed information is stored.

FIG. 71 is a schematic diagram showing an exemplary reservation information list. As shown in FIG. 71, the print environment sharing service 2013 retains the reservation information list including a reservation ID, a user ID (or a user name), and a directory in which the reservation information is stored.

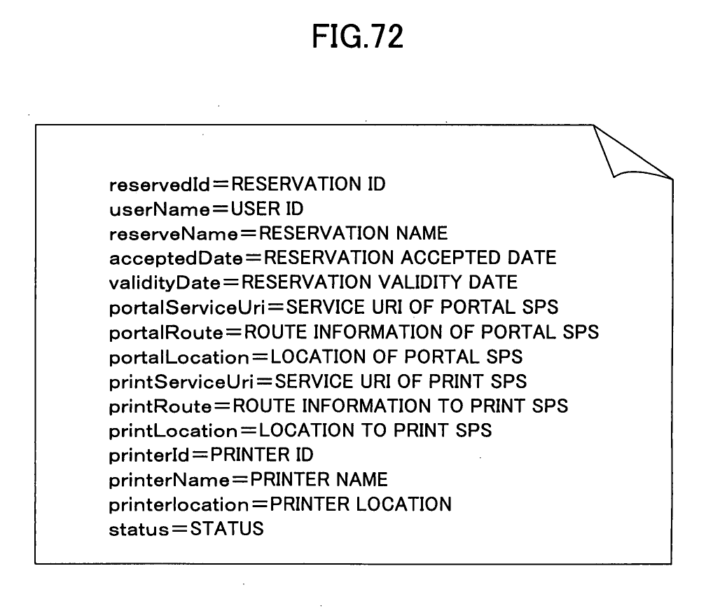

FIG. 72 is a schematic diagram showing exemplary reservation detailed information. As shown in FIG. 72, the print environment sharing service 2013 retains detailed information of reservation information that the print environment sharing service 2013 has accepted and detailed information of reservation information in which the print environment sharing service 2013 is designated.

### Fifth Embodiment]

The establishing of a system as shown in FIG. 35 is described below.

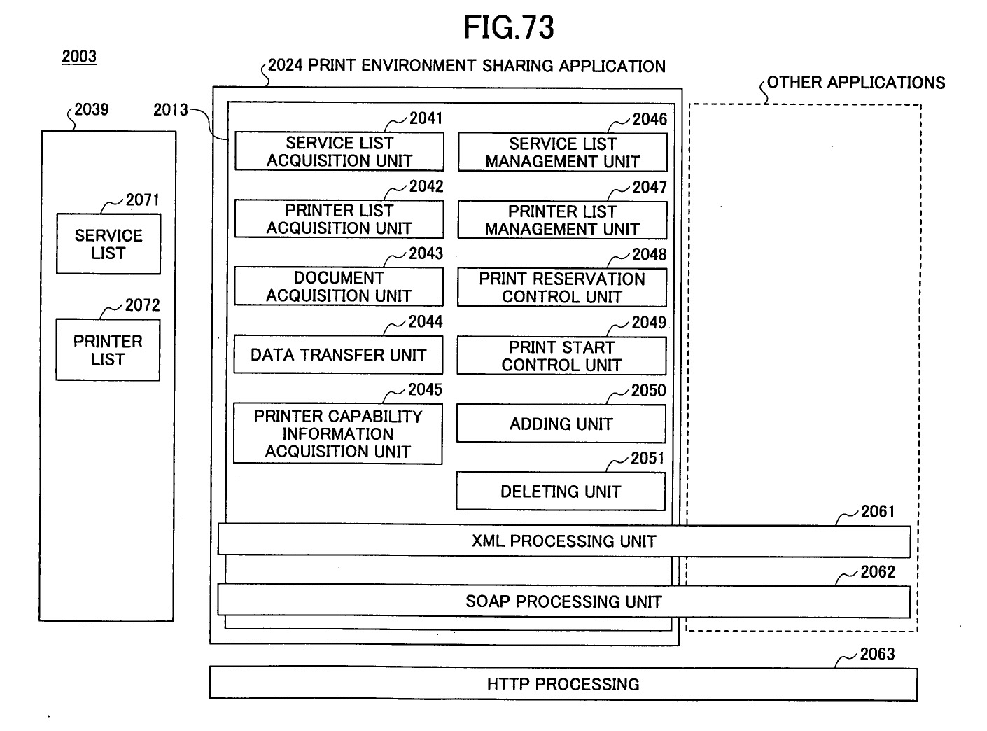

The functional structure of the SPS server 2003 is described with reference to FIG. 73. FIG. 73 is a schematic diagram showing the functional structure of the SPS server 2003.

The functional structure of the SPS server 2003 has been described above with reference to FIG. 37. However, the SPS server 2003 may be functionally structured as shown in FIG. 73. The functional structure of the SPS server 2003 shown in FIG. 73 is different from that of FIG. 37 in that an adding unit 2050 and a deleting unit 2051 are added in the print environment sharing service 2013.

In response to a connection request from another print environment sharing service 2013, the adding unit 2050 adds data such as access information of the requesting print environment sharing service 2013 to the service list 2071 stored in the SPS server 2003. The access information may include a location name, latitude, longitude, altitude, address, and URI, for example, of a print location.

In response to a disconnection request from another print environment sharing service 2013, the deleting unit 2051 deletes data such as access information of the requesting print environment sharing service 2013 from the service list 2071 stored in the SPS server 2003.

The adding unit 2050 and the deleting unit 2051 together function as the connection/disconnection management unit 41 shown in FIG. 16. The SPS server 2003 can establish a system as shown in FIG. 35 in the same manner as the SPS server 3 shown in FIG. 16 establishes the system as shown in FIG. 1. Since the operations of the SPS server 2003 is almost the same as that of the SPS server 3 described with reference to FIGS. 4 through 15, the description of the operations of the SPS server 2003 is omitted.

### Sixth Embodiment]

A MFP 1200 has been described with reference to FIGS. 33 and 34. It is noted that the print environment sharing service 2013 and/or the repository service 2012 may be applied to the Web service function 1400 of the MFP 1200.

The service list 2071, the printer list 2072, the reservation information and the document data transferred from another MFP 1200 may be stored in the HDD 1303 shown in FIG. 55.

As described above with reference to FIGS. 54 and 55, if the print environment sharing service 2013 according to the third embodiment is mounted on the MFP 1200, the user can transfer the reservation information and document data to the MFP 1200 at the print location designated by the user, and can store the reservation information and the document data therein. In response to receipt of a start request for printing, the MFP 1200 at the print location can start printing the document.

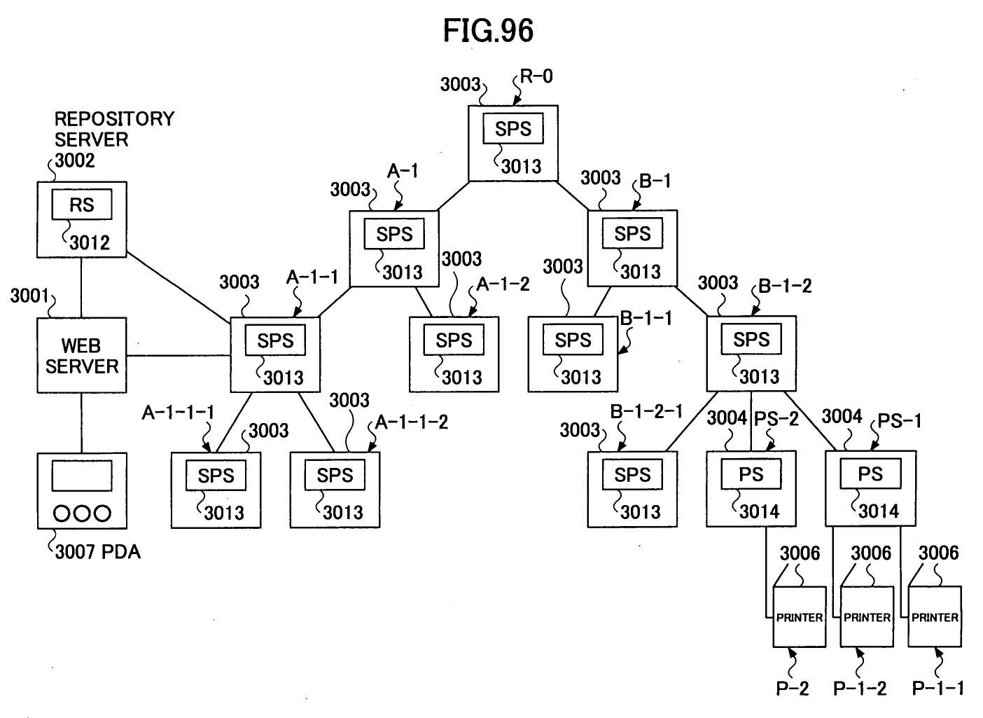

FIG. 96 is a schematic diagram showing an exemplary structure of a system to implement the present invention.

Referring to FIG. 96, the system includes a Web server 3001, a repository server 3002, a SPS server 3003, a print server 3004, a printer 3006, and PDA (Personal Digital Assistant) 3007.

In FIG. 96, a repository service 3012, a shared print environment service 3013 and a document print service 3014 are mounted to the repository server 3002, the SPS server 3003 and the print server 3004, respectively.

Individual services exchange SOAP messages with each other as Web services to make use of respective functions. Similarly, a Web page service 3015, which is described below, also communicates SOAP messages as Web services with the individual services to make use of respective functions.

The Web server 3001, the repository server 3002, the SPS server 3003, the print server 3004, the printer 3006 and PDA 3007 are connected to each other via a network and/or the Internet.

For example, if it is considered that the system structure shown in FIG. 96 represents a company organization, the illustration represents that the item “R-0” is the top of the company, and an A business office and a B business office, each of which has a proper print environment, are placed below the “R-0” in the company. Without particular references, individual SPS servers 3003 (or shared print environment services 3013) are referred to as “A-1”, “B-1” and so on herein.

At first, a user uses PDA 2007 to input a user name, a password or the like and logs in the Web server 3001. Then, the user uses various screens provided by the Web server 3001, which are described below, to select and/or designate a document that the user wants to reserve for printing, a print location such as the shared print environment service 3013 (B-1-2), a target printer such as the printer 3006 (P-1-2), a print condition such as the A4 size and color printing, and other selection items. Here, if the user selects a print location, the system may be configured to allow the user to select selection items that the user can easily recognize, such as prefecture names, city names, office names and division names, associated with the SPS servers 3003 or the shared print environment services 3013 instead of directly selecting the SPS servers 3003 or the shared print environment services 3013. In the following description, the same discussion is available.

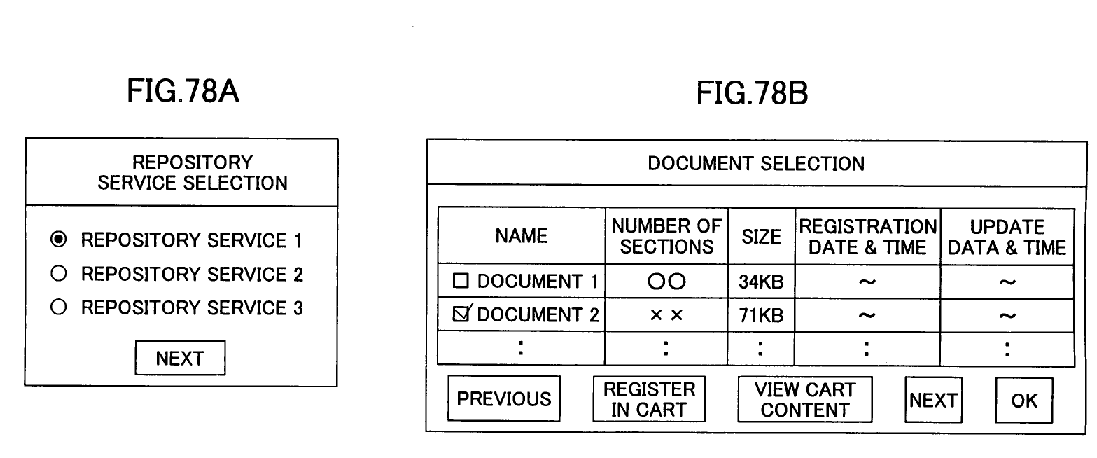

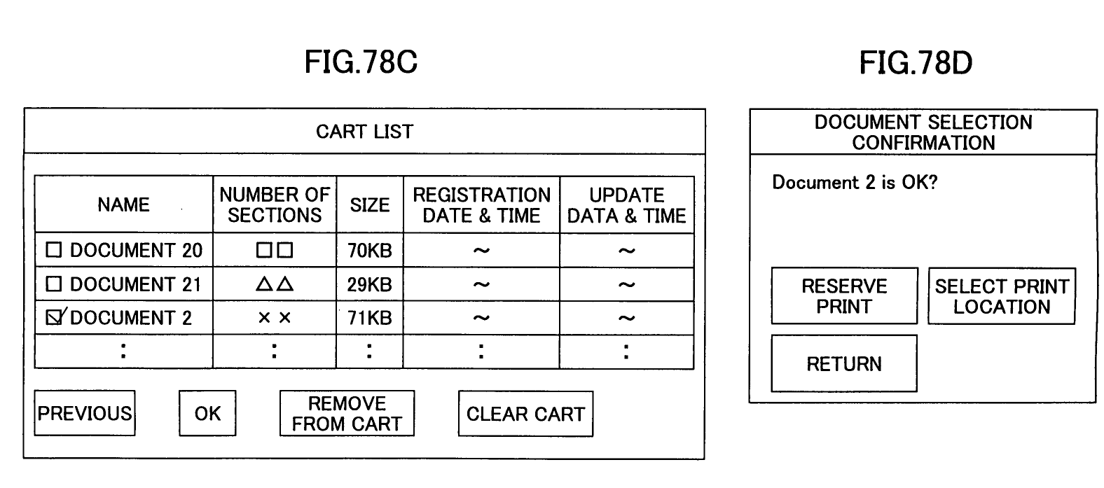

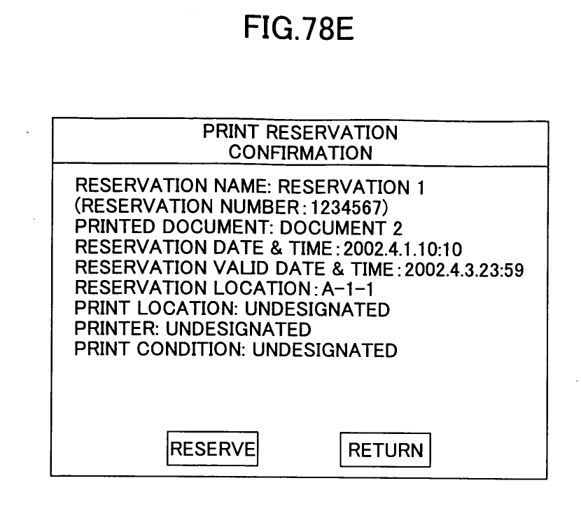

For example, the Web server 3001 provides the user with a document selection screen as illustrated in FIG. 78, and when the user selects a document, the Web server 2001 acquires a document ID of the selected document.

In addition, as described below, when the user designates a print location, the Web server 3001 acquires communication path information (hereinafter which is simply referred to as path information) on a communication path to the designated print location, for example, to the shared print environment service 3013 (B-1-2).

For example, the Web server 3001, in response to a search request from the user, acquires path information on a path from the shared print environment service 3013 (A-1-1) to the shared print environment service 3013 designated as the print location by the user, such as (A-1-1)→(A-1)→(R-0)→(B-1)→(B-1-2).

Such path information can be acquired by using a service list 3071 described below.

When receiving a print reservation request from the Web server 3001, the shared print environment service 3013 (A-1-1) uses a document ID and a document ticket included in the print reservation request to send-a document acquisition request for a document corresponding to the document ID to the repository service 3012 of the repository server 3002, and then acquires the document data from the repository server 3002 via the repository service 3012.

Based upon the path information included in the print reservation request, the shared print environment service 3013 (A-1-1) sends the path information, identification information to identify the target printer, such as URI (Uniform Resource Identifier) of the shared print environment service 3013 (B-1-2), the acquired document data together with reservation information including the print condition, and others to the shared print environment service 3013 (A-1).

The shared print environment service 3013 (A-1), in response to receipt of the reservation information and the document data from the shared print environment service 3013 (A-1-1), forwards the reservation information and the document data to the shared print environment service 3013 (R-0) based on the path information in the reservation information.

The shared print environment service 3013 (R-0), in response to receipt of the reservation information and the document data from the shared print environment service 3013 (A-1), forwards the reservation information and the document data to the shared print environment service 3013 (B-1) based on the path information in the reservation information.

Similarly, the shared print environment service 3013 (B-1), in response to receipt of the reservation information and the document data from the shared print environment service 3013 (R-0), forwards the reservation information and the document data to the shared print environment service 3013 (B-1-2) based on the path information in the reservation information.

When receiving the forwarded reservation information and the document data, the shared print environment service 3013 (B-1-2) stores the reservation information and the document data in the SPS server 3003 (B-1-2).

On the other hand, the user visits the print location, and requests the shared print environment service 3013 (A-1-1) to start to print the reserved document via the Web server 3001. The shared print environment service 3013 (A-1-1), in response to receipt of the print start request, sends the print start request to the shared print environment service 3013 (A-1) based on the path information, which is included in the print start request, indicative of the path to the target shared print environment service 3013.

The shared print environment service 3013 (A-1), in response to receipt of the print start request from the shared print environment service 3013 (A-1-1), sends the print start request to the shared print environment service 3013 (R-0) based on the path information included in the print start request.

The shared print environment service 3013 (R-0), in response to receipt of the print start request from the shared print environment service 3013 (A-1), sends the print start request to the shared print environment service 3013 (B-1) based on the path information included in the print start request.

Similarly, the shared print environment service 3013 (B-1), in response to receipt of the print start request from the shared print environment service 3013 (R-0), sends the print start request to the shared print environment service 3013 (B-1-2) based on the path information included in the print start request.

When receiving the print start request, the shared print environment service 3013 (B-1-2) sends the stored reservation information and the document data to a document print service 3014 (PS-1), and requests the document print service 3014 to print the document data under the print condition in the print information.

The document print service 3014 (PS-1), in response to receipt of the print request for the document data, converts the document data into print data printable in the printer 3006 (P-1-2), and requests the printer 3006 (P-1-2) included in the reservation information to print the print data under the print condition.

The printer 3006 (P-1-2), in response to receipt of the print data print request, prints the print data based on the print request from the document print service 3014 (PS-1).

As described above, by making the print reservation through a screen provided by the Web server 3001, transferring reservation information and document data among shared print environment services 3013, and printing a desired document based on a print request, a user can employ orderly shared print environments in different divisions and different offices. As a result, it is possible to print the document easily and speedily even in different print environments without construction of a new print environment.

Also, for example, it is supposed that interiors of the business offices A and B are independently security-managed in the system structure as illustrated in FIG. 96. Here, if a firewall between the A business office and the B business office is introduced for use of a printer 3006 in the B business office from the A business office, the system can ensure stronger security than a conventional system in~which a plurality of printers are connected to a single server via a network.

Here, each shared print environment service 3013 can construct the tree-structured system as illustrated in FIG. 96 by using the service list 3071 described below.

Also, the service list 3071 may be stored in the SPS server 3003 having the shared print environment service 3013. Alternatively, a collection of individual service lists 3071 may be stored in a device.

For simplicity, it is supposed hereinafter that each service list 3071 is stored in the SPS server 3003 having the corresponding shared print environment service 3013.

Here, although a user uses PDA 3007 as a user terminal, the present invention is not limited to the structure. Other types of mobile terminals such as a cellar phone may be used.

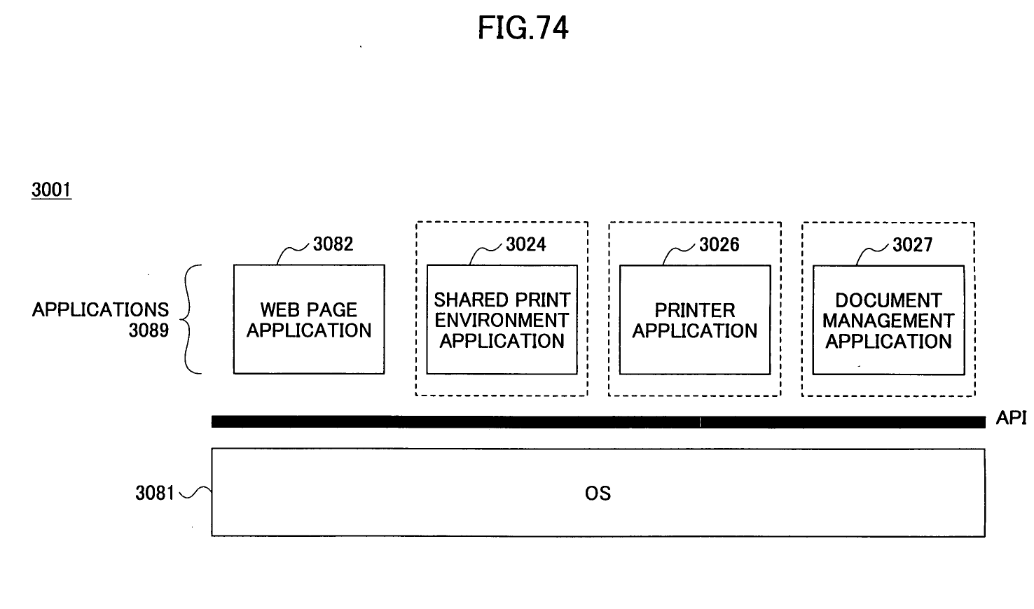

A description is given, with reference FIG. 74, of an exemplary software structure of the Web server 3001.

FIG. 74 is a schematic diagram showing an exemplary software structure of the Web server 3001 according to an embodiment of the present invention.

Referring to FIG. 74, the Web server 3001 includes OS (Operating System) 3081 and applications 3089.

OS 3081, which is an operating system such as UNIX (registered trademark) and Windows (registered trademark), for example, executes individual software items of the applications 3089 as respective processes in parallel.

The applications 3089 include a Web page application 3082 to provide Web pages. A Web page service 3015, which is described below, is included in the Web page application 3082.

Also, as shown in FIG. 74, the applications 3089 may include a shared print environment application 3024 to make print reservation and/or print documents, a printer application 3026 for a printer, and a document management application 3027 to manage documents.

The shared print environment service 3013 shown in FIG. 96 is included in the shared print environment application 3024. Also, the document print service 3014 is included in the printer application 3026. Also, the repository service 3012 is included in the document management application 3027.

In this embodiment, for simplicity, it is supposed that the shared print environment service 3013, the document print service 3014 and the repository service 3012 are mounted to the SPS server 3003, the print server 3004 and the repository server 3002, respectively, as illustrated in FIG. 96. However, this supposition is not intended to limit the present invention.

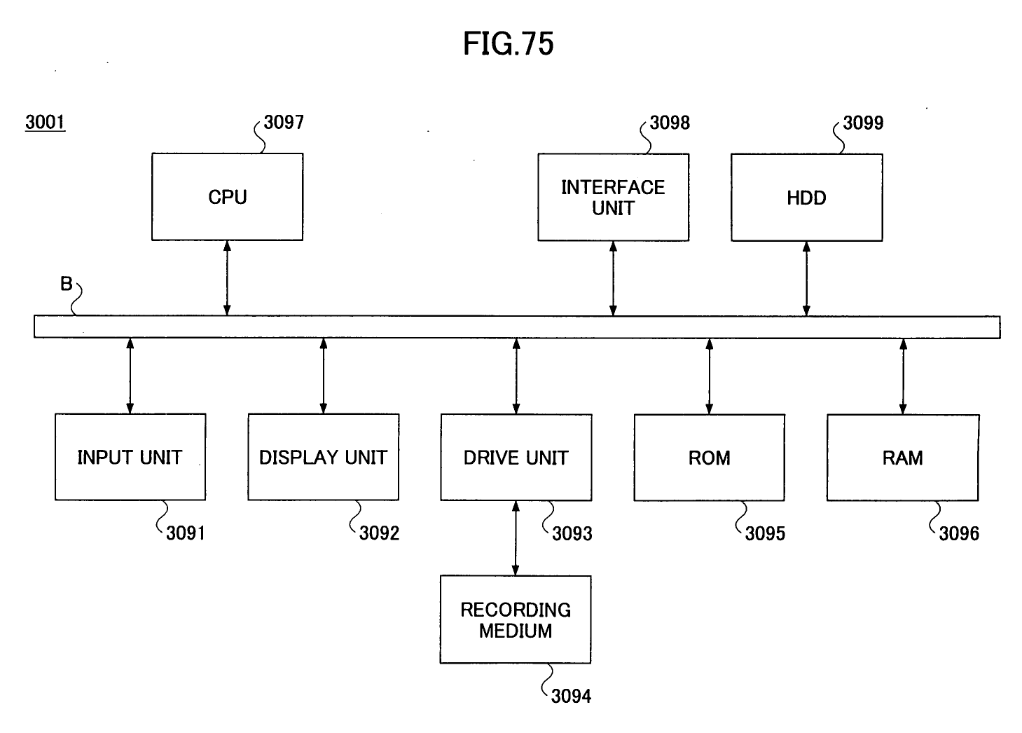

A description is given, with reference to FIG. 75, of an exemplary hardware configuration of the Web server 3001.

FIG. 75 is a schematic diagram showing an exemplary hardware configuration of the Web server 3001 according to an embodiment of the present invention.

Referring to FIG. 75, the Web server 3001 has a hardware configuration comprised of an input unit 3091, a display unit 3092, a drive unit 3093, ROM (Read Only Memory) 3095, RAM (Random Access Memory) 3096, CPU (Central Processing Unit) 3097, an interface unit 3098, and a HDD (Hard Disk Drive) 3099, which are connected to each other via a bus B.

The input unit 3091, which is configured from a keyboard and a mouse manipulated by a user of the Web server 3001, is used to input various operation signals to the Web server 3001.

The display unit 3092, which is configured from a display used by a user of the Web server 3001, displays various information items.

The interface unit 3098 is an interface to connect the Web server 3001 to a network.

Application programs corresponding to the Web page application 3082 in the applications 3089 shown in FIG. 74 and main programs to control overall operations of the Web server 3001 are provided to the Web server 3001, for example, via a recording medium 3094 such as CD-ROM or downloaded via a network. The recording medium 3094 is set to the drive unit 3093, and then the application programs and the main programs are installed in the HDD 3099 from the recording medium 3094 via the drive unit 3093.

ROM 3095 is used to store data and others. RAM 3096 is used to hold the application programs and the main programs read from HDD 3099 at activation time of the Web server 3001. CPU 3097 executes operations in accordance with the application programs and the main programs read from RAM 3096.

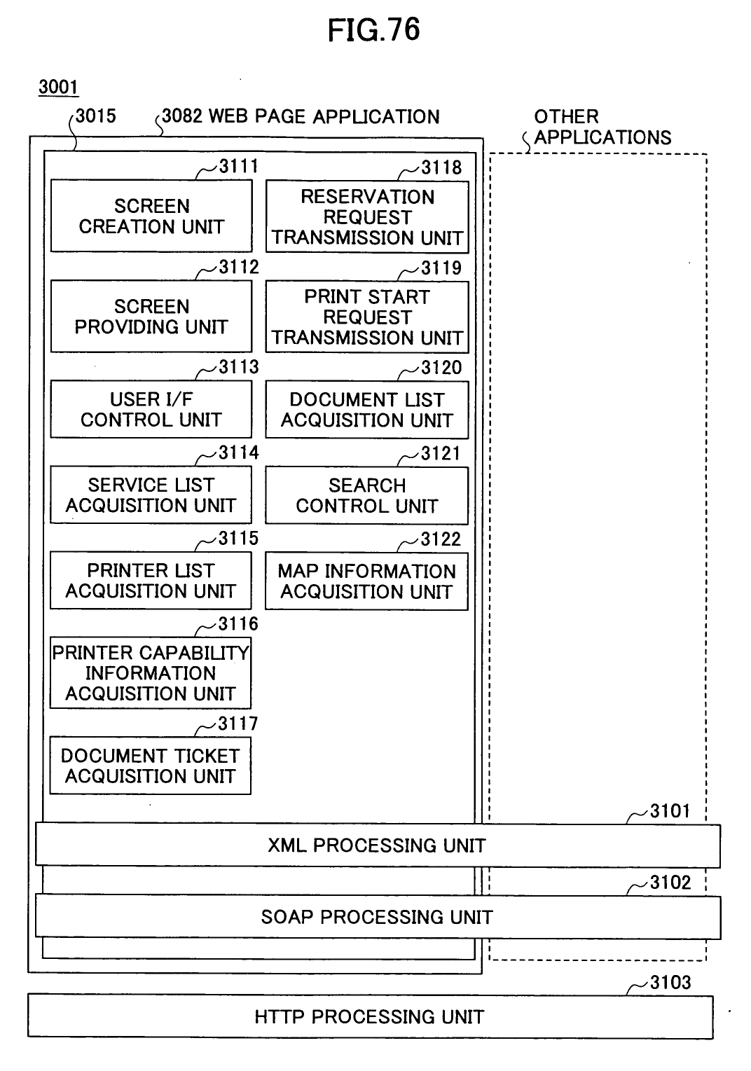

A description is given, with reference to FIG. 76, of an exemplary functional structure of the Web server 3001.

FIG. 76 is a schematic diagram showing an exemplary functional structure of the Web server 3001 according to an embodiment of the present invention.

Referring to FIG. 76, the Web server 3001 includes an HTTP processing part 3103 to control communication in accordance with HTTP and the Web page application 3082.

Also, an XML processing part 3101 for processing messages described in XML (eXtensible Markup Language) and a SOAP processing part 3102 for communicating messages in accordance with SOAP are shared by the Web page application 3082 and applications other than the Web page application 3082.

A Web page service 3015 in the Web page application 3082 includes a screen creation unit 3111, a screen providing unit 3112, a user I/F control unit 3113, a service list acquisition unit 3114, a printer list acquisition unit 3115, a printer capability information acquisition unit 3116, a document ticket acquisition unit 3117, a reservation request transmission unit 3118, a print start request transmission unit 3119 and a document list acquisition unit 3120.

Here, as described below, the Web page service 3015 may include a search control unit 3121 and a map information acquisition unit 3122 depending on system structures.

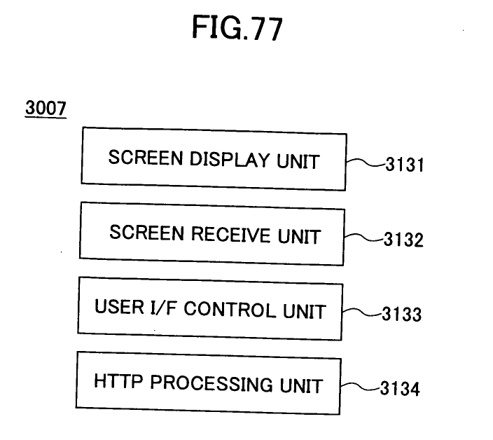

The screen creation unit 3111 creates a variety of Web pages (screens) described below. The screen providing unit 3112 provides Web pages (screens) created by the screen creation unit 3111, for example, to user terminals such as a PDA 3007 (FIG. 77).

Hereinafter, a Web page may be simply referred to as a screen for simplicity.

The user I/F control unit 3113, for example, receives input information from screens provided to user terminals such as PDA 3007 by the screen providing unit 3112.

The service list acquisition unit 3114 acquires a service list 3071, which is described in detail below, in the SPS server 3003 from the shared print environment service 3013 (FIG. 96).

The printer list acquisition unit 3115 acquires a printer list 3072, which is described in detail below, in the SPS server 3003 from the shared print environment service 3013.

The printer capability information acquisition unit 3116 acquires printer capability information, for example, indicative of color print availability or both-side print availability of the printer, from the shared print environment service 3013.

The document ticket acquisition unit 3117 acquires document tickets from the repository service 3012 (FIG. 96).

The reservation request transmission unit 3118 sends print reservation requests to the shared print environment service 3013, for example, based on requests from user terminals such as PDA 3007.

The print start request transmission unit 3119 sends print start requests to the shared print environment service 3013, for example, based on requests from user terminals such as PDA 3007.

The document list acquisition unit 3120 acquires document list information from the repository service 3012 (FIG. 96).

The search control unit 3121 sends search requests including a search condition to a search server 3008, which is described in detail below, and acquires search results from the search server 3008.

The map information acquisition unit 3122 acquires map information from a map DB 3009, which is described in detail below.

A description is given, with reference to FIG. 77, of an exemplary functional structure of the PDA 3007.

FIG. 77 is a schematic diagram showing an exemplary functional structure of PDA 3007 according to an embodiment of the present invention.

Referring to FIG. 77, PDA 3007 includes a screen display unit 3131, a screen receive unit 3132, a user I/F control unit 3133 and an HTTP processing unit 3134.

The HTTP processing unit 3134 serves as a communication control unit to control communication in accordance with HTTP. The screen receive unit 3132 serves as a receive unit to receive screens (HTML data) delivered from the Web server 3001. The screen display unit 3131 serves as a display unit to display screens (HTML data) received at the screen receive unit 3132. The user I/F control unit 3133, for example, may send input information from screens to the Web server 3001.

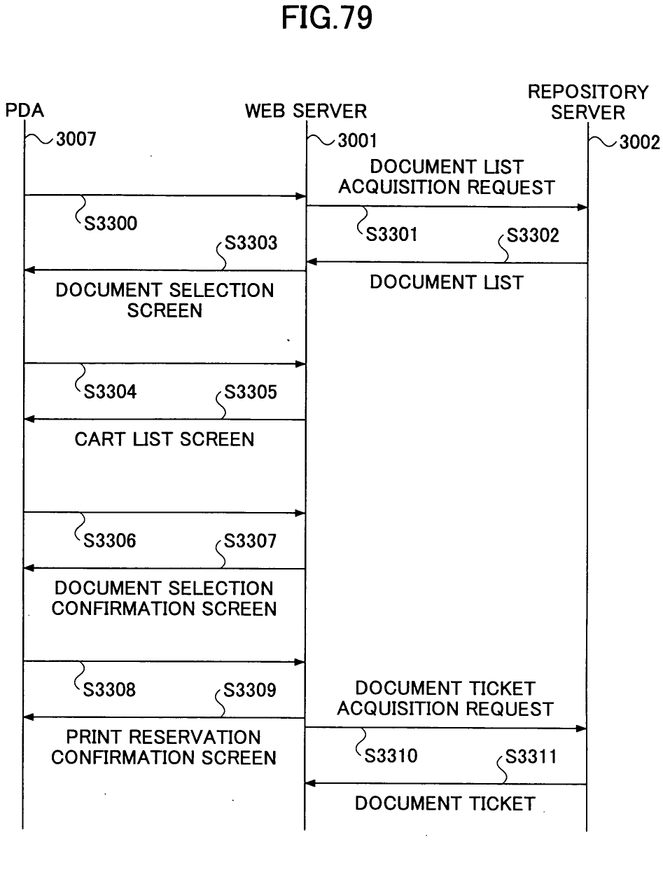

A description is given, with reference to FIG. 78 and FIG. 79, of an exemplary document selection operation.

FIGS. 78A through 78E are schematic diagrams for explaining an exemplary document selection operation according to an embodiment of the present invention. FIG. 79 is a sequence diagram for explaining an exemplary document selection operation according to an embodiment of the present invention.

For example, in the case of the system structure shown in FIG. 96, the screen creation unit 3111 of the Web server 3001, in response to receipt of a user's request from PDA 3007, creates a repository service selection screen, as illustrated in FIG. 78A, to prompt the user to choose one or more repository services 3012. Although the user is prompted to select a repository service 3012 in this embodiment, the screen creation unit 3111 of the Web server 3001, for example, may create a selection screen to enable the user to choose a selection item recognized by the user more easily, such as business office names and division names, associated with the repository server 3002 or the repository service 3012 in another embodiment of the present invention.

The screen providing unit 3112 of the Web server 3001 provides the created repository service selection screens to PDA 3007.

In this embodiment, users can use repository service selection screen, as illustrated in FIG. 78A, to select one or more desired repository services 3012.

It is noted that one repository service 3012 is illustrated in FIG. 96 for simplicity.

In this case, users do not have to select a repository service 3012 through screens as illustrated in FIG. 78A.

Referring to FIG. 78 and FIG. 79, when a user selects a repository service 3012 in a repository service selection screen as illustrated in FIG. 78A and pushes “NEXT” button, the user I/F control unit 3113 of the Web server 3001 acquires information on the repository service 3012 selected by the user via PDA 3007 and information to indicate that the user pushed the “NEXT” button (S3300 in FIG. 79).

Based upon the information on the repository service 3012 selected by the user, the document list acquisition unit 3120 of the Web server 3001 sends a document list acquisition request to the selected repository service 3012 (S3301 in FIG. 79).

The repository service 3012, in response to receipt of the document list acquisition request, sends document list information to the document list acquisition unit 3120 of the Web server 3001 (S3302 in FIG. 79).

Based upon the acquired document list information, the screen creation unit 3111 of the Web server 3001 creates a document selection screen as illustrated in FIG. 78B.

The screen providing unit 3112 of the Web server 3001 provides the created document selection screen to PDA 3007 (S3303 in FIG. 79).

The user uses the document selection screen as illustrated in FIG. 78B to be able to select a print-reserved document. Alternatively, as described in detail below, each selected document is registered in a cart, and a different repository service 3012 manages one or more selected documents, for example. Then, the managed documents may be collectively print-reserved later.

For example, when the user selects one or more documents in the document selection screen as illustrated in FIG. 78B and pushes the “REGISTER IN CART” button, the user I/F control unit 3113 of the Web server 3001 acquires information on the documents selected by the user (for example, document IDs) and information to indicate that the user has pushed the “REGISTER IN CART” button (S3304 in FIG. 79).

When acquiring the information, the screen creation unit 3111 of the Web server 3001 creates a cart list screen, as illustrated in FIG. 78C, based on the acquired information and cart document list information on the user.

The screen providing unit 3112 of the Web server 3001 provides the created cart list screen to PDA 3007 (S3305 in FIG. 79).

By using the cart list screen as illustrated in FIG. 79C, the user can check the registered documents and select one or more documents that the user wants to reserve to print.

When the user selects a document in the screen as illustrated in FIG. 78B or FIG. 78C and pushes the “OK” button, the user I/F control unit 3113 of the Web server 3001 acquires information on the document selected by the user (for example, the document ID) and information to indicate that the user has pushed the “OK” button (S3306 in FIG. 79).

When acquiring the information, the screen creation unit 3111 of the Web server 3001 creates a, document selection confirmation screen, as illustrated in FIG. 78D, based on the acquired information.

The screen providing unit 3112 of the Web server 3001 provides the created document selection confirmation screen to PDA 3007 (S3307 in FIG. 79).

By using the document selection confirmation screen as illustrated in FIG. 78D, the user can not only confirm the selected document but also make print reservation-for the document and designate a print location.

When the user pushes, for example, the “RESERVE PRINT” button in the document selection confirmation screen as illustrated in FIG. 78D, the user I/F control unit 3113 of the Web server 3001 acquires information to indicate that the user has pushed the “RESERVE PRINT” button (S3308 in FIG. 78).

When acquiring the information, the screen creation unit 3111 of the Web server 3001 creates a print reservation confirmation screen as illustrated in FIG. 78E.

The screen providing unit 3112 of the Web server 3001 provides the created print reservation confirmation screen to PDA 3007 (S3309 in FIG. 78).

In this embodiment, for example, the user can make a print reservation by designating a document that the user wants to print and pushing the “RESERVE” button in a print reservation confirmation screen, as illustrated in FIG. 78E, without setting a print location, a printer and a print condition. In this case, after the print reservation is made, for example, when the user decides a meeting place, the user can print the reserved document by setting the print location, the printer and the print condition, which are described in detail below.

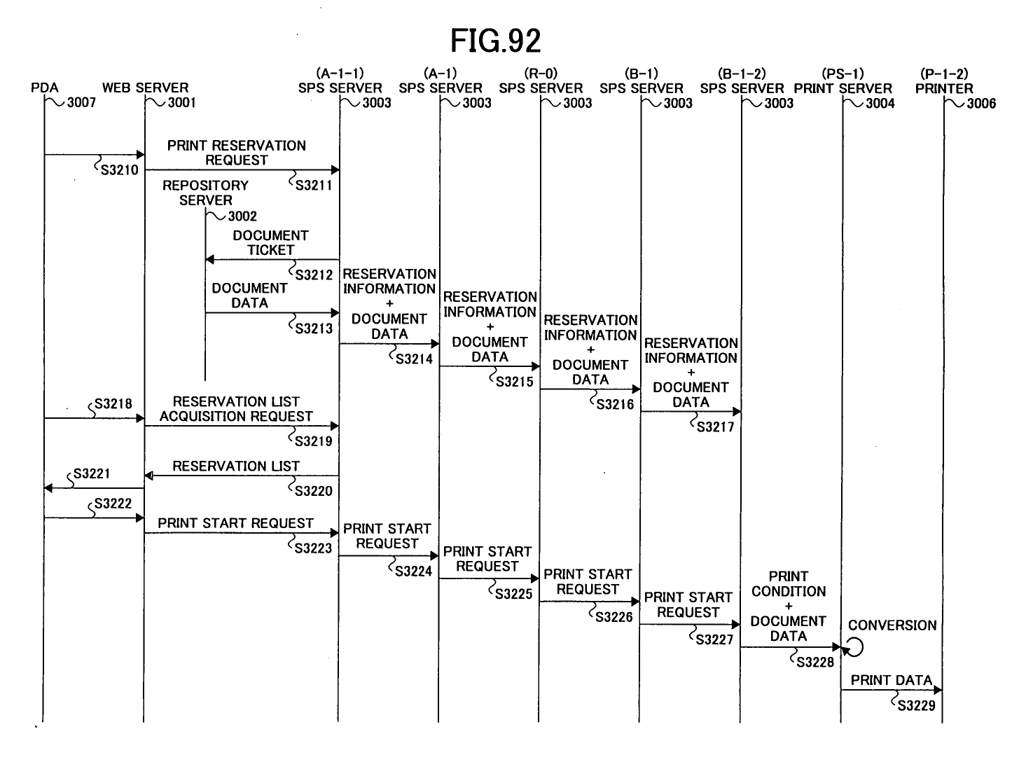

Also, in such a case, a print reservation request, as described with reference to FIG. 92, includes a document ID of a document selected as a print-reserved document by the user and a document ticket to give permission to use the document.

Also, when acquiring the information to indicate that the user has pushed the “RESERVE PRINT” button, the Web server 3001 creates the above-mentioned print reservation confirmation screen, and uses the document ticket acquisition unit 3117 to send a document ticket acquisition request to the repository service 3012 (S3310 in FIG. 79).

The repository service 3012, in response to receipt of the document ticket acquisition request, determines whether to give the user the permission to use the document, for example, based on user information included in the document ticket acquisition request. Then, if the repository service 3012 determines that the user is qualified, the repository service 3012 issues a document ticket and sends the document ticket to the document ticket acquisition unit 3117 of the Web server 3001 (S3311 in FIG. 79).

Through S3310 and S3311, the Web server 3001 can acquire the document ticket from the repository service 3012.

As shown in FIG. 78 and FIG. 79, the Web server can provide the screens, as illustrated in FIGS. 78A through 78E, to PDA 3007 based on the request from PDA 3007.

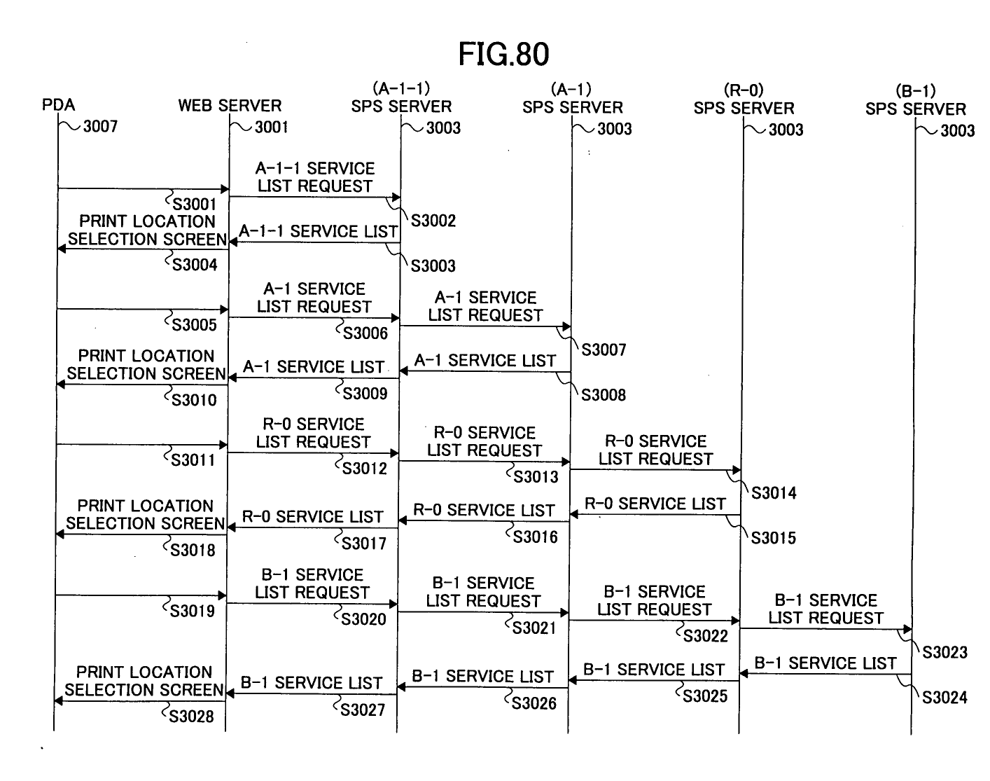

A description is given, with reference to FIG. 38 and FIG. 80, of an exemplary print location search operation according to an embodiment of the present invention.

FIG. 80 is a sequence diagram for explaining an exemplary print location search operation according to an embodiment of the present invention.

Referring to FIG. 38 and FIG. 80, in the case of the system structure shown in FIG. 96, when a user pushed the “SELECT PRINT LOCATION” in the document selection confirmation screen shown in FIG. 78D, the user I/F control unit 3113 of the Web server 3001 acquires information to indicate that the user has pushed the “SELECT PRINT LOCATION” button via PDA 3007 (S3001 in FIG. 80).

When acquiring the information, the service list acquisition unit 3114 of the Web server 3001 sends to the shared print environment service 3013 (A-1-1) a service list acquisition request, which includes information on locations of one or more other shared print environment services 3013 that the shared print environment service 3013 (A-1-1) can refer to, for a service list 3071 on the shared print environment service 3013 (A-1-1) (S3002 in FIG. 80).

It is noted that the service list acquisition request includes path information on a path to the shared print environment service 3013 (A-1-1).

The shared print environment service 3013 (A-1-1), in response to receipt of the service list acquisition request for the shared print environment service 3013 (A-1-1) from the service list acquisition unit 3114 of the Web server 3001, acquires the service list 3071 in HDD 3099 of the SPS server 3003 (A-1-1), and sends the service list 3071 to the service list acquisition unit 3114 of the Web server 3001 (S3003 in FIG. 80). It is noted that the path information to the shared print environment service 3013 (A-1-1) together with the service list 3071 is sent to the Web server 3001.

Based upon the acquired service list 3071 for the shared print environment service 3013 (A-1-1), the screen creation unit 3111 of the Web server 3001 creates a print location selection screen as illustrated in FIG. 38A.

The screen providing unity 3112 of the Web server 3001 provides the created print location selection screen to PDA 3007 (S3004 in FIG. 80).

In the print location selection screen shown in FIG. 38A, other shared print environment services 3013 that the shared print environment service 3013 (A-1-1) can refer to are displayed.

For simplicity, such other shared print environment services 3013 are displayed in the form of identifiers such as “A-1-1-1”, “A-1-1-2” and “A-1” in FIG. 38. For example, these identifiers may represent business office names or division names. Throughout FIG. 38A through FIG. 38G, the same notation is used.

When the user selects “A-1” in the print location selection screen shown in FIG. 38A and pushes the “NEXT” button, the user I/F control unit 3113 of the Web server 3001 acquires information to indicate that the user has selected “A-1” via PDA 3007 and pushed the “NEXT” button (S3005 in FIG. 80).

When acquiring the information, the service list acquisition unit 3114 of the Web server 3001 sends a service list acquisition request for a service list 3071 of the shared print environment service 3013 (A-1) to the shared print environment service 3013 (A-1-1) (S3006 in FIG. 80). It is noted that the Web server 3001, which has the information to indicate that the user has selected “A-1”, knows that the shared print environment service 3013 (A-1) is connected to the shared print environment service 3013 (A-1-1) as an upper level entity, and obtains information from the shared print environment service 3013 (A-1-1) to the shared print environment service 3013 (A-1) (access information, for example). The Web server 3001 adds path information from the shared print environment service 3013 (A-1-1) to the shared print environment service 3013 (A-1) to the above-mentioned path information and contains the updated path information in the service list acquisition request. In the following embodiments, the Web server 3001 and the shared print environment service 3013 can obtains the path information to the print location selected by the user, for example, by acquiring the service list in the same manner.

The shared print environment service 3013 (A-1-1), in response to receipt of the service list acquisition request, sends the service list acquisition request to the shared print environment service 3013 (A-1) based on the path information (S3007 in FIG. 80).

The shared print environment service 3013 (A-1), in response to receipt of the service list acquisition request, acquires the service list 3071 from the SPS server 3003 (A-1), and sends the service list 3071 and the path information to the shared print environment service 3013 (A-1-1) based on the path information (S3008 in FIG. 80).

The shared print environment service 3013 (A-1-1) forwards the received service list 3071 for the shared print environment service 3013 (A-1) and the path information to the service list acquisition unit 3114 of the Web server 3001 (S3009 in FIG. 80).

In this fashion, whenever a user selects a printer location, the shared print environment service 3013 can forward a service list acquisition request to other shared print environment services 3013 based on the path information by adding the corresponding path information, including the path information in the service list acquisition request, and delivering the updated service list acquisition request to other shared print environment services 3013. It is noted that a service list acquisition request and a service list acquisition response corresponding to the service list acquisition request include path information, although the description thereof is omitted for simplicity. The service list 3071 can be acquired using the path information.

Based upon the acquired service list 3071 for the shared print environment services 3013 (A-1), the screen creation unit 3111 of the Web server 3001 creates a print location selection screen as illustrated in FIG. 38B.

The screen providing unit 3112 of the Web server 3001 provides the created print location selection screen to PDA 3007 (S3010 in FIG. 80).

As shown in FIG. 38B, shared print environment services 3013 that the shared print environment service 3013 can refer to are displayed in the print location selection screen.

When the user, for example, selects “R-0” in the print location selection screen shown in FIG. 38B and pushes the “NEXT” button, the user I/F control unit 3113 of the Web server 3001 acquires information to indicate that the user has selected “R-0” via PDA 3007 and pushed the “NEXT” button (S3011 in FIG. 80).

When acquiring the information, the service list acquisition unit 3114 of the Web server 3001 sends a service list acquisition request for a service list 3071 of the shared print environment service 3013 (R-0) to the shared print environment service 3013 (A-1-1) (S3012 in FIG. 80).

The shared print environment service 3013 (A-1-1), in response to receipt of the service list acquisition request, forwards the service list acquisition request to the shared print environment service 3013 (A-1) (S3013 in FIG. 80).

The shared print environment service 3013 (A-1), in response to receipt of the service list acquisition request, forwards the service list acquisition request to the shared print environment service 3013 (R-0) (S3014 in FIG. 80).

The shared print environment service 3013 (R-0), in response to receipt of the service list acquisition request, acquires the service list from the SPS server 3003 (R-0), and sends the service list to the shared print environment service 3013 (A-1) (S3015 in FIG. 80).

The shared print environment service 3013 (A-1) forwards the received service list 3017 of the shared print environment service 3013 (R-0) to the shared print environment service 3013 (A-1-1) (S3016 in FIG. 80).

The shared print environment service 3013 (A-1-1) forwards the received service list 3017 of the shared print environment service 3013 (R-0) to the service list acquisition unit 3114 of the Web server 3001 (S3017 in FIG. 80).

Based upon the acquired service list 3017 of the shared print environment service 3013 (R-0), the screen creation unit 3111 of the Web server 3001 creates a print location selection screen as illustrated in FIG. 38C.

The screen providing unit 3112 of the Web server 3001 provides the created print location selection screen to PDA 3007 (S3018 in FIG. 80).

As shown in FIG. 38C, shared print environment services 3013 that the shared print environment service 3013 (R-0) can refer to are displayed in the print location selection screen.

For example, when the user selects “B-1” in the print location selection screen shown in FIG. 38C and pushes the “NEXT” button, the user I/F control part 3113 of the Web server 3001 acquires information to indicate that the user has selected “B-1” via PDA 3007 and pushed the “NEXT” button (S3019 in FIG. 80).

When acquiring the information, the service list acquisition unit 3114 of the Web server 3001 sends a service list acquisition request for a service list 3017 of the shared print environment service 3013 (B-1) to the shared print environment service 3013 (A-1-1) (S3020 in FIG. 80).

The shared print environment service 3013 (A-1-1), in response to receipt of the service list acquisition request, forwards the service list acquisition request to the shared print environment service 3013 (A-1) (S3021 in FIG. 80.).

The shared print environment service 3013 (A-1), in response to receipt of the service list acquisition request, forwards the service list acquisition request to the shared print environment service 3013 (R-0) (S3022 in FIG. 80).

The shared print environment service 3013 (R-0), in response to receipt of the service list acquisition request, forwards the service list acquisition request to the shared print environment service 3013 (B-1) (S3023 in FIG. 80).

The shared print environment service 3013 (B-1), in response to receipt of the service list acquisition request, acquires the service list 3071 from the SPS server 3003 (B-1), and sends the service list 3071 to the shared print environment service 3013 (R-0) (S3024 in FIG. 80).

The shared print environment service 3013 (R-0) forwards the received service list of the shared print environment service 3013 (B-1) to the shared print environment service 3013 (A-1) (S3025 in FIG. 80).

The shared print environment service 3013 (A-1) forwards the received service list of the shared print environment service 3013 (B-1) to the shared print environment service 3013 (A-1-1) (S3026 in FIG. 80).

The shared print environment service 3013 (A-1-1) forwards the received service list of the shared print environment service 3013 (B-1) to the service list acquisition unit 3114 of the Web server 3001 (S3027 in FIG. 80).

Based upon the acquired service list 3071 of the shared print environment service 3013 (B-1), the screen creation unit 3111 of the Web server 3001 creates a print location selection screen as illustrated in FIG. 38D.

The screen providing unit 3112 of the Web server 3001 provides the created print location selection screen to PDA 3007 (S3028 in FIG. 80).

As shown in FIG. 38D, shared print environment services 3013 that the shared print environment service 3013 (B-1) can refer to are displayed in the print location selection screen.

For example, when the user selects “B-1-2” in the print location selection screen shown in FIG. 38D and pushes the “OK” button, the user I/F control unit 3113 of the Web server 3001 acquires information to indicate that the user has selected “B-1-2” via PDA 3007 and pushed the “OK” button (not illustrated).

When acquiring the information, the screen creation unit 3111 of the Web server 3001 creates a print location selection confirmation screen, as illustrated in FIG. 38E, based on the acquired information.

The screen providing unit 3112 of the Web server 3001 provides the created print location selection confirmation screen to PDA 3007 (not illustrated).

For example, when the user pushes the “DISPLAY SELECTION RESULT” button in the print location selection confirmation screen shown in FIG. 38E, the user I/F control unit 3113 of the Web server 3001 acquires information to indicate that the user has pushed the “DISPLAY SELECTION RESULT” button via PDA 3007 (not illustrated).

When acquiring the information, the screen creation unit 3111 of the Web server 3001 creates a print location selection result display screen, as illustrated in FIG. 38F, based on the acquired information.

The screen providing unit 3112 of the Web server 3001 provides the created print location selection result display screen to PDA 3007 (not illustrated).

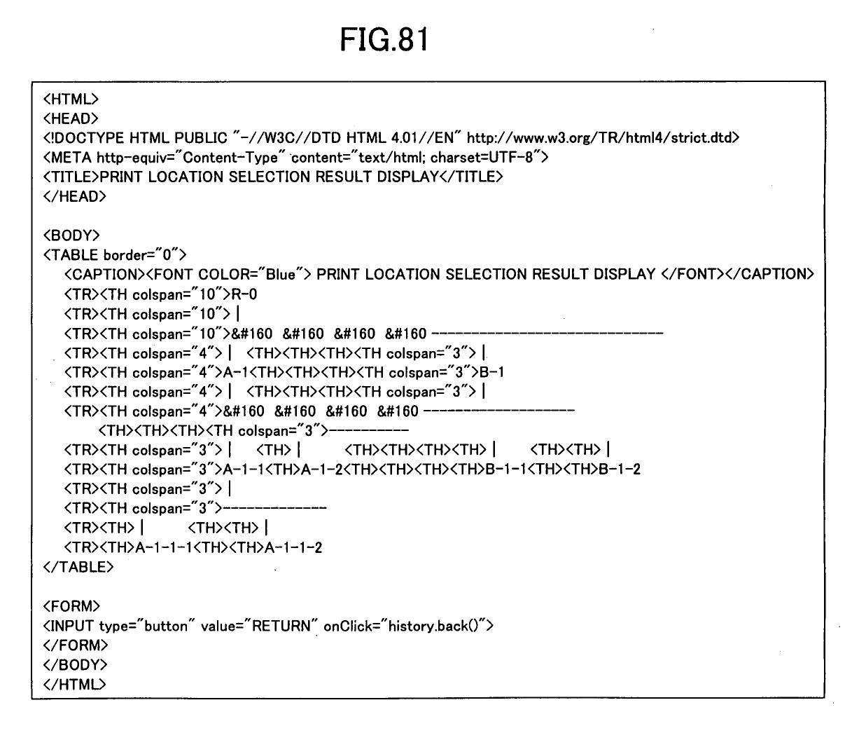

In FIG. 81, an exemplary screen (HTML data) created and provided to PDA 3007 by the Web server 3001 is illustrated by using the print location selection result display screen as an example.

On the other hand, for example, when the user pushes the “RESERVE PRINT” button in the print location selection confirmation screen shown in FIG. 38E, the user I/F control unit 3113 of the Web server 3001 acquires information to indicate that the user has pushed the “RESERVE PRINT” button via PDA 3007 (not illustrated).

When acquiring the information, the screen creation unit 3111 of the Web server 3001 creates a print reservation confirmation screen, as illustrated in FIG. 38G, based on the acquired information.

The screen providing unit 3112 of the Web server 3001 provides the created print reservation confirmation screen to PDA 3007 (not illustrated).

As shown in FIG. 38G, compared to the print reservation confirmation screen shown in FIG. 78E, the print location is set in the print reservation confirmation screen.

In this embodiment, for example, the user can make print reservation by designating a desired document and a desired print location and pushing the “RESERVE” button in the print reservation confirmation screen shown in FIG. 38G without setting a printer and a print condition. In this case, after the print reservation is made, for example, the user visits the print location, confirms the current status and performance of a printer near the print location, sets a printer and a print condition, which are described in detail below, and prints the document.

In such a case, a print reservation request, which is described with reference to FIG. 92, includes the document ID of the document selected by the user as a document to be print-reserved, a document ticket to give the user permission to use the document, identification information to identify the print location, and path information on a path to the print location.

As described with reference to FIG. 38 and FIG. 80, the Web server 3001 can search for a print location by acquiring a service list 3071.

Also, the Web server 3001 can acquire path information to the print location through the operation shown in FIG. 38 and FIG. 80.

In the operation shown in FIG. 38 and FIG. 80, the Web server 3001 can acquire path information on a path from the shared print environment service 3013 (A-1-1) to the shared print environment service 3013 (B-1-2), which is the print location selected by the user, such as (A-1-1)→(A-1)→(R-0)→(B-1)→(B-1-2)

FIG. 81 is a schematic diagram showing exemplary HTML data corresponding to a print location selection result display screen according to an embodiment of the present invention.

The Web server 3001 creates a screen, as illustrated in FIG. 81, and sends the screen to PDA 3007.

The service list has been described above. A service list may be referred to by a reference numeral 3071 in the following description.

A service list 3071 includes one or more shared print environment services 3013 that the corresponding shared print environment service 3013 can refer to.

For example, the service list 3071 shown in FIG. 39 includes URI of an upper-level shared print environment service 3013 and URIs of lower-level shared print environment services 3013, relative to the shared print environment service 3013 mounted to the SPS server 3003 having the service list 3071, all of which the shared print environment service 3013 of interest can refer to.

In FIG. 39, “A-1”, “A-1-1-1” and “A-1-1-2”, which are may represent division names or business office names, are included instead of URIs for simplicity.

Also, although not illustrated in FIG. 39, the service list 3071 may include not only URIs of one or more other shared print environment services 3013 that the shared print environment service 3013 mounted to the SPS server 3003 having the service list 3071 can refer to, but also location names of these shared print environment services 3013 and print location related information items such as latitude, longitude, altitude and address of the print location.

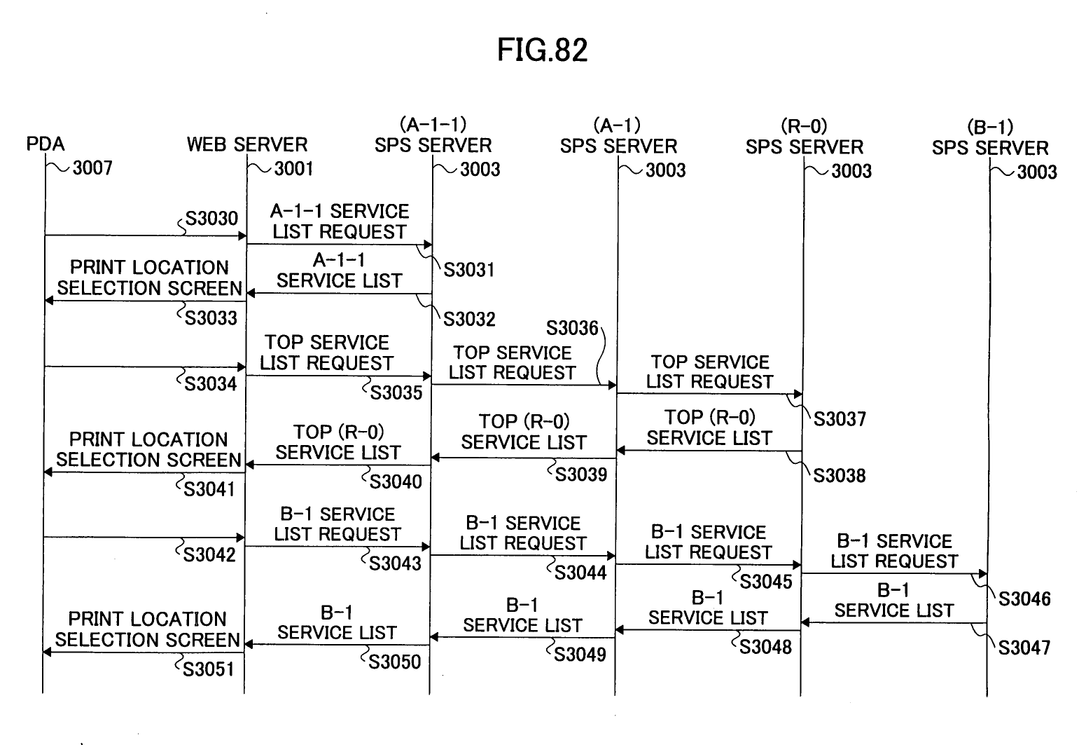

A description is given, with reference to FIG. 40 and FIG. 82, of another exemplary print location search operation.

FIG. 82 is a sequence diagram for explaining another exemplary print location search operation according to an embodiment of the present invention.

Referring to FIG. 40 and FIG. 82, in the case of the system structure shown in FIG. 96, when a user pushes the “SELECT PRINT LOCATION” button in the document selection confirmation screen shown in FIG. 78D, the user I/F control unit 3113 of the Web server 3001 acquires information to indicate that the user has pushed the “SELECT PRINT LOCATION” button via PDA 3007 (S3030 in FIG. 82).

When acquiring the information, the service list acquisition unit 3114 of the Web server 3001 sends a service list acquisition request for a service list 3071 of the shared print environment service 3013 (A-1-1) to the shared print environment service 3013 (A-1-1) (S3031 in FIG. 82).

The shared print environment service 3013 (A-1-1), in response to receipt of the service list acquisition request from the service list acquisition unit 3114 of the Web server 3001, acquires the service list 3017 from HDD 3099 of the SPS server 3003 (A-1-1), and sends the service list 3071 to the service list acquisition unit 3114 (S3032 in FIG. 82).

Based upon the acquired service list 3071 of the shared print environment service 3013 (A-1-1), the screen creation unit 3111 of the Web server 3001 creates a print location selection screen as illustrated in FIG. 40A.

The screen providing unit 3112 of the Web server 3001 provides the created print location selection screen to PDA 3007 (S3033 in FIG. 82).

It is noted that the print location selection screen shown in FIG. 40A additionally includes an option “TOP”, compared to the print location selection screen shown in FIG. 38A.

For example, when the user selects “TOP” in the print location selection screen shown in FIG. 40A and pushes the “NEXT” button, the user I/F control unit 3113 of the Web server 3001 acquires information to indicate that the user has selected “TOP” via PDA 3007 and pushed the “NEXT” button (S3034 in FIG. 82).

When acquiring the information, the service list acquisition unit 3114 of the Web server 3001 sends a service list acquisition request for a service list 3071 of the top shared print environment service 3013 to the shared print environment service 3013 (A-1-1) (S3035 in FIG. 82).

The shared print environment service 3013 (A-1-1), in response to receipt of the service list acquisition request, refers to a service list 3071 stored in the SPS server 3003 (A-1-1), and sends the service list acquisition request to the shared print environment service 3013 (A-1) located at the upper level of the shared print environment service 3013 (A-1-1) (S3036 in FIG. 82).

The shared print environment service 3013 (A-1), in response to receipt of the service list acquisition request, refers to a service list 3071 stored in the SPS server 3003 (A-1), and sends the service list acquisition request to the shared print environment service 3013 (R-0) located at the upper level of the shared print environment service 3013 (A-1) (S3037 in FIG. 82).

The shared print environment service 3013 (R-0), in response to receipt of the service list acquisition request, refers to a service list 3071 stored in the SPS server 3003 (R-0). Then, after checking that there is no shared print environment service 3013 located at the upper level of the shared print environment service 3013 (R-0), the shared print environment service 3013 (R-0) acquires the service list 3071 and sends the service list 3071 to the shared print environment service 3013 (A-1) (S3038 in FIG. 82).

The shared print environment service 3013 (A-1) forwards the received service list 3071 of the shared print environment service 3013 (R-0) to the shared print environment service 3013 (A-1-1) (S3039 in FIG. 82).

The shared print environment service 3013 (A-1-1) forwards the received service list 3071 of the shared print environment service 3013 (R-0) to the the service list acquisition unit 3114 of the Web server 3001 (S3040 in FIG. 82).

Based upon the acquired service list 3071 of the shared print environment service 3013 (R-0), the screen creation unit 3111 of the Web server 3001 creates a print location selection screen as illustrated in FIG. 40B.

The screen providing unit 3112 of the Web server 3001 provides the created print location selection screen to PDA 3007 (S3041 in FIG. 82).

As shown in FIG. 40B, shared print environment services 3013 that the shared print environment service 3013 (R-0) can refer to are displayed in the print location selection screen.

For example, when the user selects “B-1” in the print location selection screen shown in FIG. 40B and pushes the “NEXT” button, the user I/F control unit 3113 of the Web server 3001 acquires information to indicate that the user has selected “B-1” via PDA 3007 and pushed the “NEXT” button (S3042 in FIG. 82).

When acquiring the information, the service list acquisition unit 3114 of the Web server 3001 sends a service list acquisition request for a service list 3017 of the shared print environment service 3013 (B-1) to the shared print environment service 3013 (A-1-1) (S3043 in FIG. 82).

The shared print environment service 3013 (A-1-1), in response to receipt of the service list acquisition request, forwards the service list acquisition request to the shared print environment service 3013 (A-1) (S3044 in FIG. 82).

The shared print environment service 3013 (A-1), in response to receipt of the service list acquisition request, forwards the service list acquisition request to the shared print environment service 3013 (R-0) (S3045 in FIG. 82).

The shared print environment service 3013 (R-0), in response to receipt of the service list acquisition request, forwards the service list acquisition request to the shared print environment service 3013 (B-1) (S3046 in FIG. 82).

The shared print environment service 3013 (B-1), in response to receipt of the service list acquisition request, acquires a service list 3071 from the SPS server 3003 (B-1), and sends the service list 3071 to the shared print environment service 3013 (R-0) (S3047 in FIG. 82).

The shared print environment service 3013 (R-0) forwards the received service list 3071 of the shared print environment service 3013 (B-1) to the shared print environment service 3013 (A-1) (S3048 in FIG. 82).

The shared print environment service 3013 (A-1) forwards the received service list 3071 of the shared print environment service 3013 (B-1) to the shared print environment service 3013 (A-1-1) (S3049 in FIG. 82).

The shared print environment service 3013 (A-1-1) forwards the received service list 3071 of the shared print environment service 3013 (B-1) to the service list acquisition unit 3114 of the Web server 3001 (S3050 in FIG. 82).

Based upon the acquired service list 3071 of the shared print environment service 3013 (B-1), the screen creation unit 3111 of the Web server 3001 creates a print location selection screen as illustrated in FIG. 40C.

The screen providing unit 3112 of the Web server 3001 provides the created print location selection screen to PDA 3007 (S3051 in FIG. 82).

As shown in FIG. 40C, shared print environment services 3013 that the shared print environment service 3013 (B-1) can refer to are displayed in the print location selection screen.

For example, when the user selects “B-1-2” in the print location selection screen shown in FIG. 40C and pushes the “OK” button, the user I/F control unit 3113 of the Web server 3001 acquires information to indicate that the user has selected “B-1-2” via PDA 3007 and pushed the “OK” button (not illustrated).

When acquiring the information, the screen creation unit 3111 of the Web server 3001 creates a print location selection confirmation screen, as illustrated in FIG. 40D, based on the acquired information.

The screen providing unit 3112 of the Web server 3001 provides the created print location selection confirmation screen to PDA 3007 (not illustrated).

For example, when the user pushes the “DISPLAY SELECTION RESULT” button in the print location selection confirmation screen shown in FIG. 40D, the user I/F control unit 3113 of the Web server 3001 acquires information to indicate that the user has pushed the “DISPLAY SELECTION RESULT” button via PDA 3007 (not illustrated).

When acquiring the information, the screen creation unit 3111 of the Web server 3001 creates a print location selection result display screen, as illustrated in FIG. 40E, based on the acquired information.

The screen providing unit 3112 of the Web server 3001 provides the created print location selection result display screen to PDA 3007 (not illustrated).

As described with reference to FIG. 40 and FIG. 82, the Web server 3001 can search for a print location in the order from the top level shared print environment service 3013.

Also, the Web server 3001 can acquire path information on a path to a print location in accordance with the operation shown in FIG. 40 and FIG. 82.

For example, the Web server 3001 can acquire path information on the path from the shared print environment service 3013 (A-1-1) to the shared print environment service 3013 (B-1-2), which is the print location selected by the user, such as (A-1-1)→(A-1)→(R-0)→(B-1)→(B-1-2).

A description is given, with reference to FIG. 42, of another exemplary structure of a system according to an embodiment of the present invention.

The system shown in FIG. 42 has a parallel structure compared to the system structure shown in FIG. 96.

The system shown in FIG. 42 can be configured by including URIs located at the same level, that is, URIs free from upper and lower relationship, in a service list 3071 as URIs of one or more other shared print environment services 3013 that the shared print environment service 3013 mounted to the SPS server 3003 having the service list 3071 can refer to.

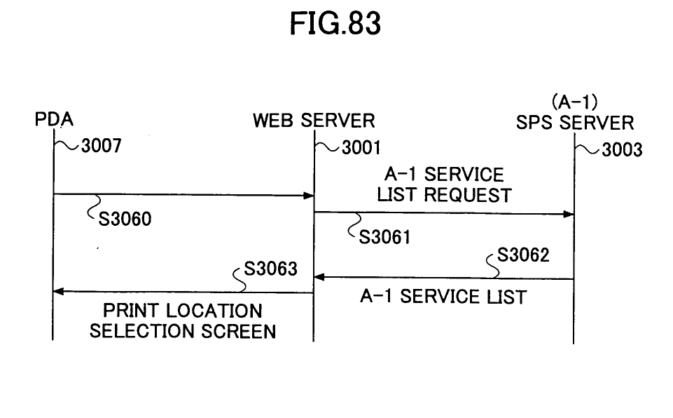

A description is given, with reference to FIG. 43, FIG. 45 and FIG. 83, of an exemplary print location search operation of the system having the structure shown in FIG. 42.

FIG. 83 is a sequence diagram for explaining an exemplary print location search operation according to an embodiment of the present invention.

Referring to FIG. 43, FIG. 45 and FIG. 83, in the case of the system structure as illustrated in FIG. 42, for example, when a user pushes the “SELECT PRINT LOCATION” button in the document selection confirmation screen as illustrated in FIG. 78D, the user I/F control unit 3113 of the Web server 3001 acquires information to indicate that the user has pushed the “SELECT PRINT LOCATION” button via PDA 3007 (S3060 in FIG. 83).

When acquiring the information, the service list acquisition unit 3114 of the Web server 3001 sends a service list acquisition request for a service list of the shared print environment service 3013 (A-1) to the shared print environment service 3013 (A-1) (S3061 in FIG. 82).

The shared print environment service 3013 (A-1), in response to receipt of the service list acquisition request from the service list acquisition unit 3114 of the Web server 3001, acquires the service list from HDD 3099 of the SPS server 3003 (A-1), and sends the service list 3071 to the service list acquisition unit 3114 of the Web server 3001 (S3062 in FIG. 82).

Based upon the acquired service list 3071 of the shared print environment service 3013 (A-1), the screen creation unit 3114 of the Web server 3001 creates a print location selection screen as illustrated FIG. 43A.

The screen providing unit 3112 of the Web server 3001 provides the created print location selection screen to PDA 3007 (S3063 in FIG. 82).

As shown in FIG. 43A, shared print environment services 3013 that the shared print environment service 3013 (A-1) can refer to are displayed in the print location selection screen.

As shown in FIG. 43A, the shared print environment service 3013 (A-1) can refer to the shared print environment services 3013 (A-1-1) and (A-1-2), which are located at the lower level of the shared print environment service 3013 (A-1), as well as the shared print environment services 3013 (B-1), (C-1), (D-1) and (E-1), which are located at the same level as the shared print environment service 3013 (A-1).

For example, when the user selects “E-1” in the print location selection screen shown in FIG. 43A and pushes the “OK” button, the user I/F control unit 3113 of the Web server 3001 acquires information to indicate that the user has selected “E-1” via PDA 3007 and pushed the “OK” button (not illustrated).

When acquiring the information, the screen creation unit 3111 of the Web server 3001 creates a print location selection confirmation screen, as illustrated in FIG. 43B, based on the acquired information.

The screen providing unit 3112 of the Web server 3001 provides the created print location selection confirmation screen to PDA 3007 (not illustrated).

For example, when the user pushes the “DISPLAY SELECTION RESULT” button in the print location selection confirmation screen shown in FIG. 43B, the user I/F control unit 3113 of the Web server 3001 acquires information to indicate that the user has pushed the “DISPLAY SELECTION RESULT” button via PDA 3007 (not illustrated).

When acquiring the information, the screen creation unit 3111 of the Web server 3001 creates a print location selection result display screen, as illustrated in FIG. 43C, based on the acquired information.

The screen providing unit 3112 of the Web server 3001 provides the created print location selection result display screen to PDA 3007 (not illustrated).

As described with reference to FIG. 43 and FIG. 82, in the system structure as illustrated in FIG. 42, the Web server 3001 can search for a print location by acquiring a service list 3071.

Also, the Web server 3001 can acquire path information on a path to a print location through the operation shown in FIG. 43 and FIG. 82.

In the operation described with reference to FIG. 43 and FIG. 82, the Web server 3001 can acquire the path information on the path-from the shared print environment service 3013 (A-1) to the shared print environment service 3013 (E-1), which is the print location selected by the user, such as (A-1)→(E-1) A description is given, with reference to FIG. 46, of another exemplary system structure according to an embodiment of the present invention.

The system having the structure shown in FIG. 46 additionally includes a search server 3008 to search for a print location, compared to the system structure shown in FIG. 96.

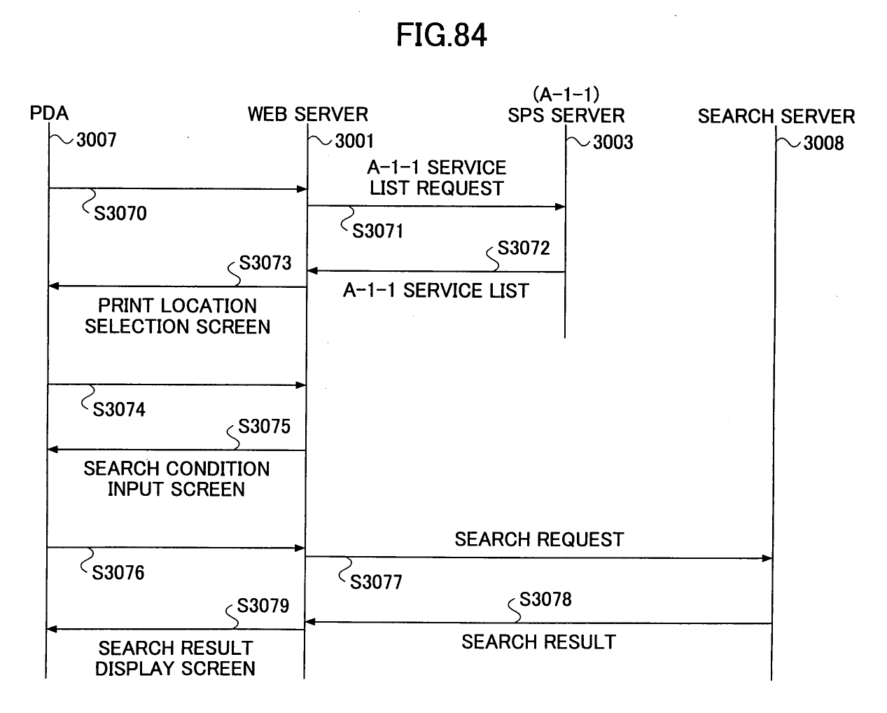

A description is given, with reference to FIG. 47 and FIG. 84, of an exemplary print location search operation of a system having the structure as illustrated in FIG. 46.

FIG. 84 is a sequence diagram for explaining an exemplary print location search operation according to an embodiment of the present invention.

Referring to FIG. 47 and FIG. 84, in the case of the system structure shown in FIG. 46, for example, when a user pushes the “SELECT PRINT LOCATION” button in the document selection confirmation screen shown in FIG. 78D, the user I/F control unit 3113 of the Web server 3001 acquires information to indicate that the user has pushed the “SELECT PRINT LOCATION” button via PDA 3007 (S3070 in FIG. 84).

When acquiring the information, the service list acquisition unit 3114 of the Web server 3001 sends a service list acquisition request for a service list 3071 of the shared print environment service 3013 (A-1-1) to the shared print environment service 3013 (A-1-1) (S3071 in FIG. 84).

The shared print environment service 3013 (A-1-1), in response to receipt of the service list acquisition request from the service list acquisition unit 3114 of the Web server 3001, acquires the service list 3071 from HDD 3099 of the SPS server 3003 (A-1-1), and sends the service list 3071 to the service list acquisition unit 3114 of the Web server 3001 (S3072 in FIG. 84).

Based upon the acquired service list of the shared print environment service 3013 (A-1-1), the screen creation unit 3111 of the Web server 3001 creates a print location selection screen as illustrated in FIG. 47A.

The screen providing unit 3112 of the Web server 3001 provides the created print location selection screen to PDA 3007 (S3073 in FIG. 84).

As shown in FIG. 47A, the print location selection screen additionally includes an option “SEARCH”, compared to the print location selection screen shown in FIG. 40A.

For example, when a user selects “SEARCH” in the print location selection screen shown in FIG. 47A and pushes the “NEXT” button, the user I/F control unit 3113 of the Web server 3001 acquires information to indicate that the user has selected “SEARCH” via PDA 3007 and pushed the “NEXT” button (S3074 in FIG. 84).

When acquiring the information, the screen creation unit 3111 of the Web server 3001 creates a search condition input screen, as illustrated in FIG. 47B, based on the acquired information.

The screen providing unit 3112 of the Web server 3001 provides the created search condition input screen to PDA 3007 (S3075 in FIG. 84).

For example, when the user inputs a search condition in the search condition input screen shown FIG. 47B and pushes the “SEARCH START” button, the user I/F control unit 3113 of the Web server 3001 acquires information to indicate that the user has input the search condition and pushed the “SEARCH START” via PDA 3007 (S3076 in FIG. 84). In this embodiment, the print location name is set as the search condition, as illustrated in FIG. 47B. However, the search condition can be set as arbitrary data that can be included in the service list 3071, such as latitude, longitude, altitude and address of the print location. The same discussion is held hereinafter.

When acquiring the information, the search control unit 3121 of the Web server 3001 sends a search request including the search condition input by the user to the search server 3008 (S3077 in FIG. 84).

The search server 3008, in response to receipt of the search request, for example, uses possessed information on one or more print locations included in a service list 3071 of a shared print environment service 3013 to be managed, such as the name, the latitude, the longitude, the altitude and the address of the location of the shared print environment service 3013, to find a shared print environment service 3013 meeting the search condition, and sends the search result to the Web server 3001 (S3078 in FIG. 84).

Based upon the search result acquired by the search control unit 3121, the screen creation unit 3111 of the Web server 3001 creates a search result display screen as illustrated in FIG. 47C.

The screen providing unit 3112 of the Web server 3001 provides the created search result display screen to PDA 3007 (S3079 in FIG. 84).

For example, when the user selects “B-1-2” in the search result display screen shown in FIG. 47C and pushes the “OK” button, the user I/F control unit 3113 of the Web server 3001 acquires information to indicate that the user has selected “B-1-2” and pushed the “OK” button via PDA 3007 (not illustrated).

When acquiring the information, the screen creation unit 3111 of the Web server 3001 creates a print location selection confirmation screen, as illustrated in FIG. 47D, based on the acquired information.

The screen providing unit 3112 of the Web server 3001 provides the created print location selection confirmation screen to PDA 3007 (not illustrated).

For example, when the user pushes the “DISPLAY SELECTION RESULT” button in the print location selection confirmation screen shown in FIG. 47D, the user I/F control unit 3113 of the Web server 3001 acquires information to indicate that the user has pushed the “DISPLAY SELECTION RESULT” button via PDA 3007 (not illustrated).

When acquiring the information, the screen creation unit 3111 of the Web server 3001 creates a print location selection result display screen, as illustrated in FIG. 47E, based on the acquired information.

The screen providing unit 3112 of the Web server 3001 provides the created print location selection result display screen to PDA 3007 (not illustrated).

As described with reference to FIG. 47 and FIG. 84, the Web server 3001 can use the search server 3008 to search for a print location.

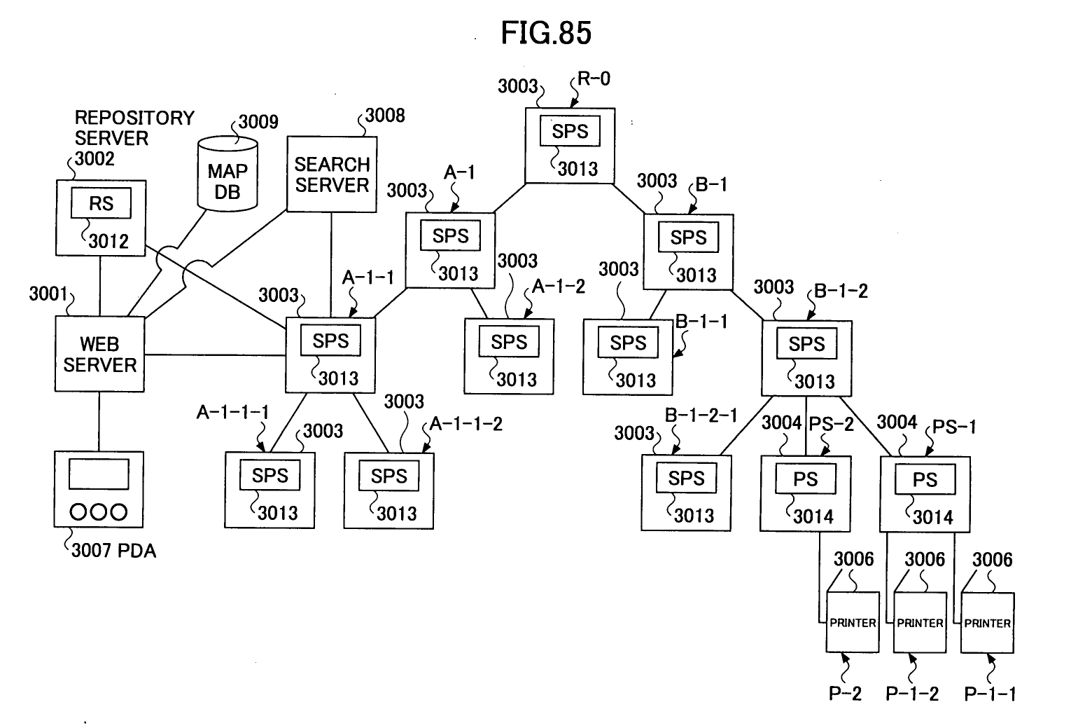

A description is given, with reference to FIG. 85, of an exemplary structure of a system according to an embodiment of the present invention.

FIG. 85 is a schematic diagram showing an exemplary system structure according to an embodiment of the present invention.

The system shown in FIG. 85 is configured to additionally include a map DB 3009 compared to the system structure shown in FIG. 46.

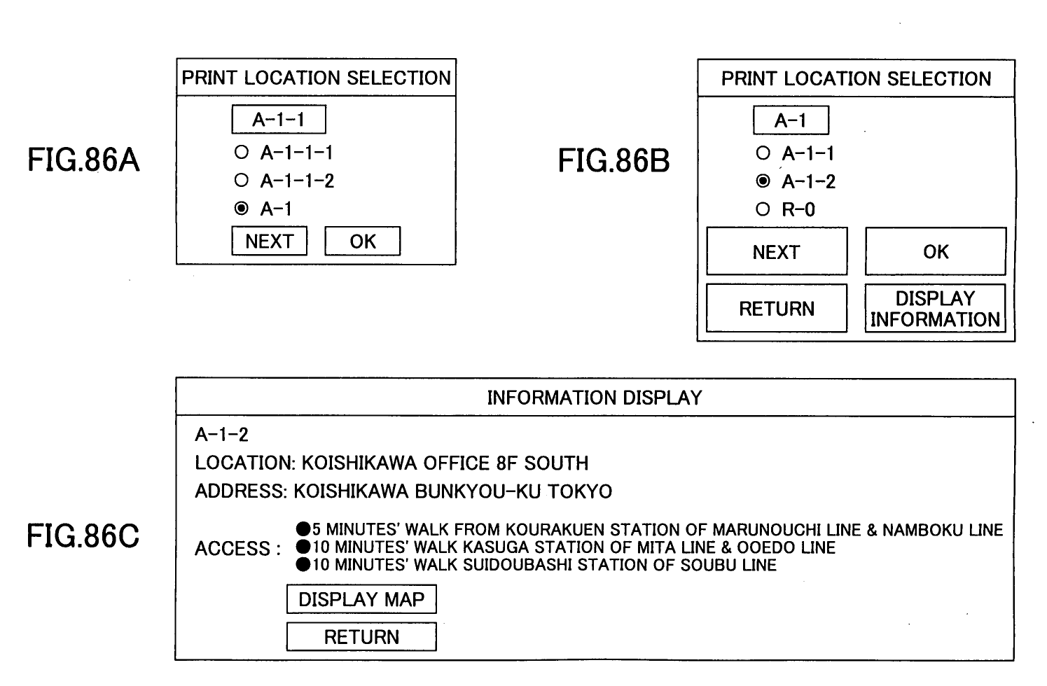

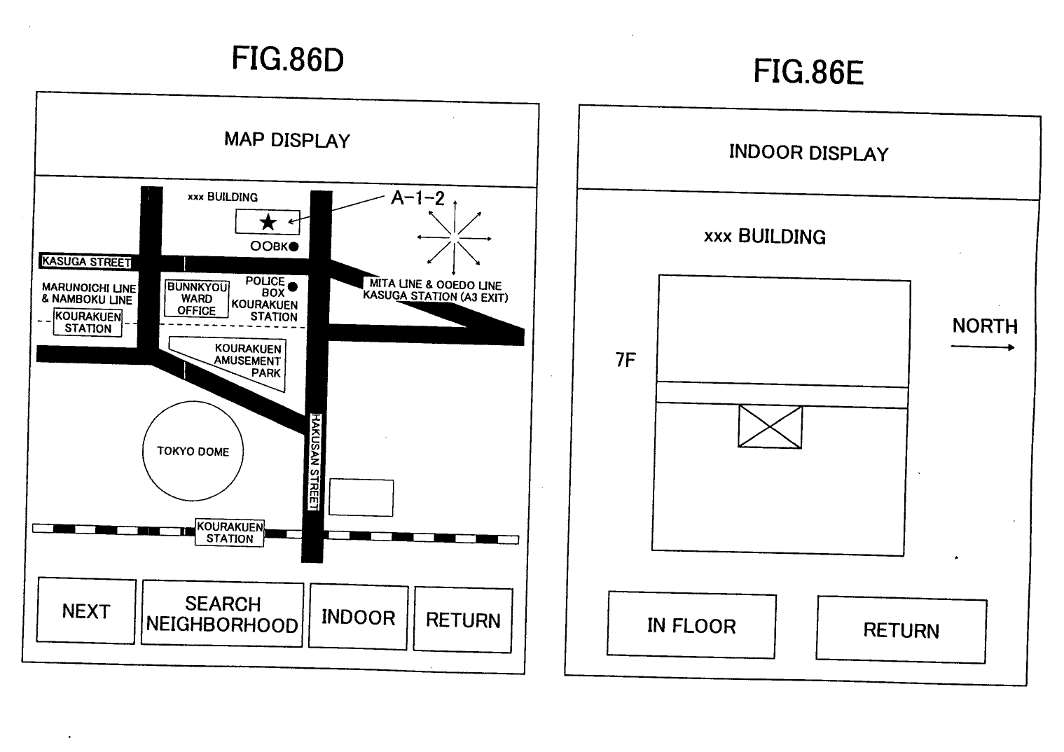

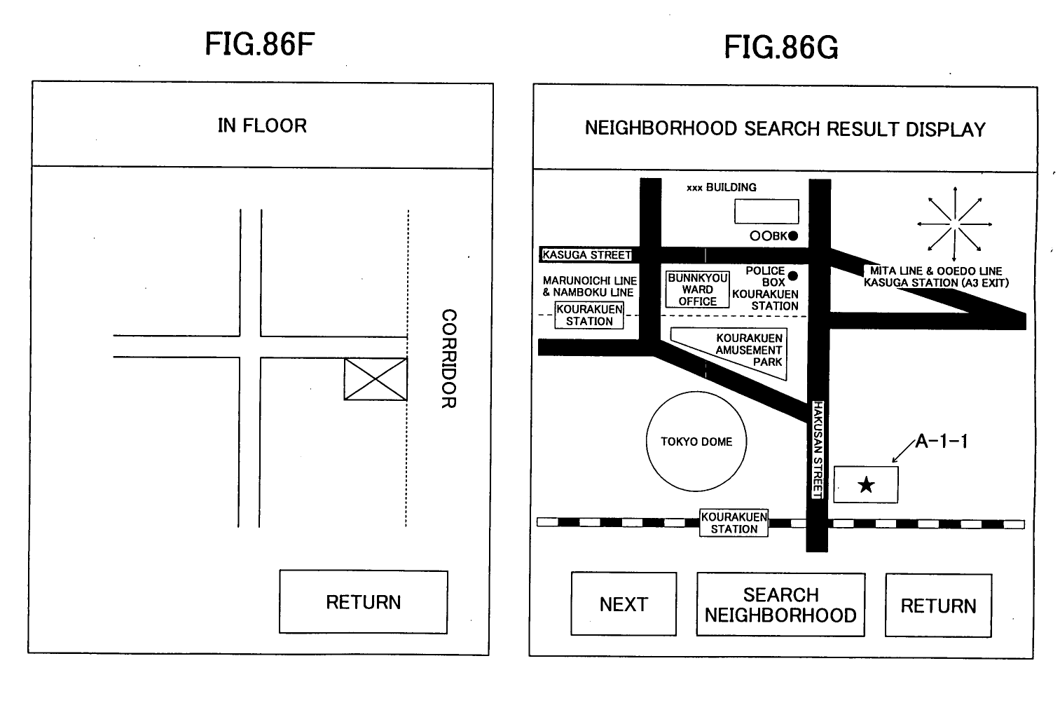

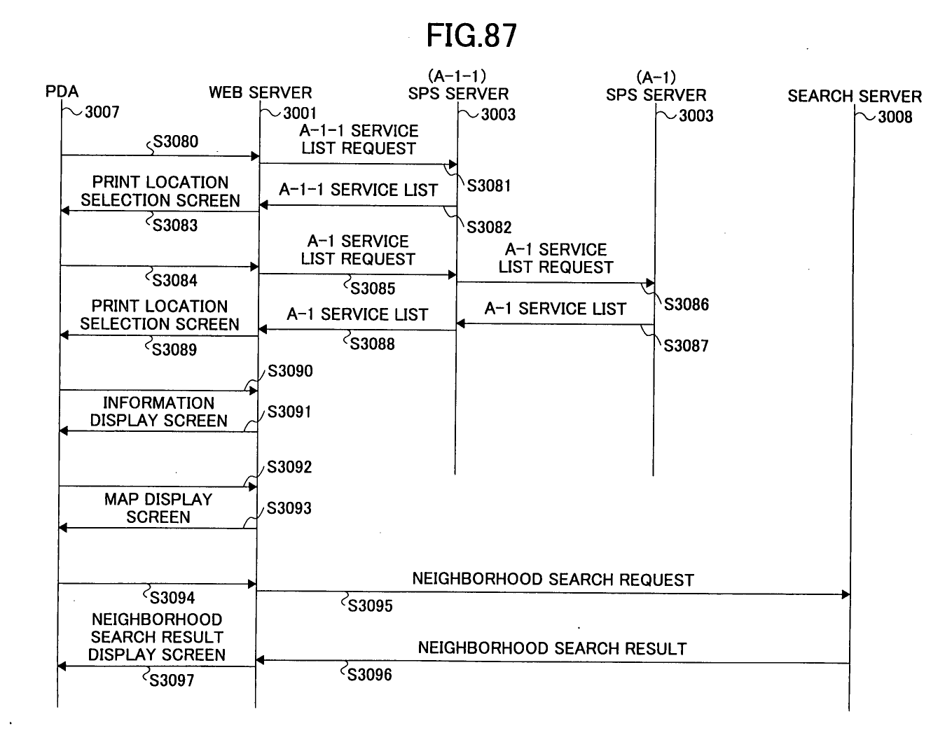

A description is given, with reference to FIG. 86 and FIG. 87, of an exemplary print location map display operation of a system having the structure shown in FIG. 85.

FIG. 86 is a schematic diagram for explaining an exemplary print location map display operation according to an embodiment of the present invention. FIG. 87 is a sequence diagram for explaining an exemplary print location map display operation according to an embodiment of the present invention.

Referring to FIG. 86 and FIG. 87, in the case of the system structure shown in FIG. 85, for example, when a user pushes the “SELECT PRINT LOCATION” button in the document selection confirmation screen shown in FIG. 78D, the user I/F control unit 3113 of the Web server 3001 acquires information to indicate that the user has pushed the “SELECT PRINT LOCATION” button via PDA 3007 (S3080 in FIG. 87).

When acquiring the information, the service list acquisition unit 3114 of the Web server 3001 sends a service list acquisition request for a service list 3071 of the shared print environment service 3013 (A-1-1) to the shared print environment service 3013 (A-1-1) (S3081 in FIG. 87).

The shared print environment service 3013 (A-1-1), in response to receipt of the service list acquisition request from the service list acquisition unit 3114 of the Web server 3001, acquires the service list 3071 from HDD 3099 of the SPS server 3003 (A-1-1), and sends the service list 3114 to the service list acquisition unit 3114 of the Web server 3001 (S3082 in FIG. 87).

Based upon the acquired service list 3071 of the shared print environment service 3013 (A-1-1), the screen creation unit 3111 of the Web server 3001 creates a print location selection screen as illustrated in FIG. 86A.

The screen providing unit 3112 of the Web server 3001 provides the created print location selection screen to PDA 3007 (S3083 in FIG. 87).

For example, when the user selects “A-1” in the print location selection screen shown in FIG. 86A and pushes the “NEXT” button, the user I/F control unit 3113 of the Web server 3001 acquires information to indicate that the user has selected “A-1” and pushed the “NEXT” button via PDA 3007 (S3084 in FIG. 87).

When acquiring the information, the service list acquisition unit 3114 of the Web server 3001 sends a service list acquisition request for a service list 3071 of the shared print environment service 3013 (A-1) to the shared print environment service 3013 (A-1-1) (S3085 in FIG. 87).

The shared print environment service 3013 (A-1-1), in response to receipt of the service list acquisition request, forwards the service list acquisition request to the shared print environment service 3013 (A-1) (S3086 in FIG. 87).

The shared print environment service 3013 (A-1), in response to receipt of the service list acquisition request, acquires the service list 3071 from the SPS server 3003 (A-1), and the service list 3071 to the shared print environment service 3013 (A-1-1) (S3087 in FIG. 87).

The shared print environment service 3013 (A-1-1) sends the received service list 3071 to the service list acquisition unit 3114 of the Web server 3001 (S3088 in FIG. 87).

Based upon the acquired service list 3071 of the shared print environment service 3013 (A-1), the screen creation unit 3111 of the Web server 3001 creates a print location selection screen as illustrated in FIG. 86B.

The screen providing unit 3112 of the Web server 3001 provides the created print location selection screen to PDA 3007 (S3089 in FIG. 87).

As shown in FIG. 86B, shared print environment services 3013 that the shared print environment service 3013 (A-1) can refer to are displayed in the print location selection screen. Also, the “DISPLAY INFORMATION” button is added to the print location selection screen compared to the print location selection screen shown in FIG. 38B.

For example, when the user selects “A-1-2” in the print location selection screen shown in FIG. 86B and pushes the “DISPLAY INFORMATION” button, the user I/F control unit 3113 of the Web server 3001 acquires information to indicate that the user has selected “A-1-2” and pushed the “DISPLAY INFORMATION” button via PDA 3007 (S3090 in FIG. 87).

When acquiring the information, the screen creation unit 311 of the Web server 3001 creates an information display screen as illustrated in FIG. 86C.

The screen providing unit 3112 of the Web server 3001 provides the created information display screen to PDA 3007 (S3091 in FIG. 87).

For example, when the user pushes the “DISPLAY MAP” button in the information display screen shown in FIG. 86C, the user I/F control unit 3113 of the Web server 3001 acquires information to indicate that the user has pushed the “DISPLAY MAP” button via PDA 3007 (S3092 in FIG. 87).

When acquiring the information, the map information acquisition unit 3122 of the Web server 3001 acquires map information associated with a print location selected by the user from the map DB 3009.

Based upon the map information acquired by the map information acquisition unit 3122 and information of the service list 3071 associated with the print location (for example, the name, the latitude, the longitude, the altitude and the address of the location of the shared print environment service 3013), the screen creation unit 3111 of the Web server 3001 creates a map display screen as illustrated in FIG. 86D.

The screen providing unit 3112 of the Web server 3001 provides the created map display screen to PDA 3007 (S3093 in FIG. 87).

For example, when the user pushes the “SEARCH NEIGHBORHOOD” button in the map display screen shown in FIG. 86D, the user I/F control unit 3113 of the Web server 3001 acquires information to indicate that the user has pushed the “SEARCH NEIGHBORHOOD” button via PDA 3007 (S3094 in FIG. 87).

When acquiring the information, the search control unit 3121 of the Web server 3001 sends a search request for one or more other print locations located in the vicinity of the print location selected by the user to the search server 3008 (S3095 in FIG. 87).

The search server 3008, in response to receipt of the search request, uses the possessed information associated with the print location included in the service list 3071 of the managed shared print environment service 3013 (for example, the name, the latitude; the longitude, the altitude and the address of the location of the shared print environment service 3013) to search for the print locations, and sends the search result to the Web server 3001 (S3096 in FIG. 87).

Based upon the search result by the search control unit 3121, the map information acquisition unit 3122 of the Web server 3001 acquires map information associated with one or more print locations given in the search result from the map DB 3009.

Based upon the map information acquired by the map information acquisition unit 3122 and information associated with one or more print locations given in the service list 3071 (for example, the name, the latitude, the longitude, the altitude and the address of the location of the shared print environment service 3013), the screen creation unit 3111 of the Web server 3001 creates a neighborhood search result screen as illustrated in FIG. 86G.

The screen providing unit 3112 of the Web server 3001 provides the created neighborhood search result screen to PDA 3007 (S3097 in FIG. 87).

For example, when the user pushes the “INDOOR” button in the map display screen shown in FIG. 86D, the user I/F control unit 3113 of the Web server 3001 acquires information to indicate that the user has pushed the “INDOOR” button via PDA 3007 (not illustrated).

When acquiring the information, the screen creation unit 3111 of the Web server 3001 creates an indoor display screen as illustrated in FIG. 86E based on the map information acquired by the map information acquisition unit 3122 and the information related to the print location in the service list 3071 (for example, location name, latitude, longitude, altitude, and address where the shared print environment service 3013 is located).

The screen providing unit 3112 of the Web server 3001 provides the created indoor display screen to PDA 3007 (not illustrated).

For example, when the user pushes the “IN FLOOR” button in the indoor display screen shown in FIG. 86E, the user I/F control unit 3113 of the Web server 3001 acquires information to indicate that the user has pushed the “IN FLOOR” button via PDA 3007 (not illustrated).

When acquiring the information, the screen creation unit 3111 of the Web server 3001 creates an in-floor screen as illustrated in FIG. 86F based on the map information acquired by the map information acquisition unit 3122 and the information related to the print location in the service list 3071 (for example, location name, latitude, longitude, altitude, and address where the shared print environment service 3013 is located).

The screen providing unit 3112 of the Web server 3001 provides the created in-floor screen to PDA 3007 (not illustrated).

As described with reference to FIG. 86 and FIG. 87, the Web server 3001 can create screens including map information by using the search server 3008 and/or the map DB 3009 and provide the screens to PDA 3007.

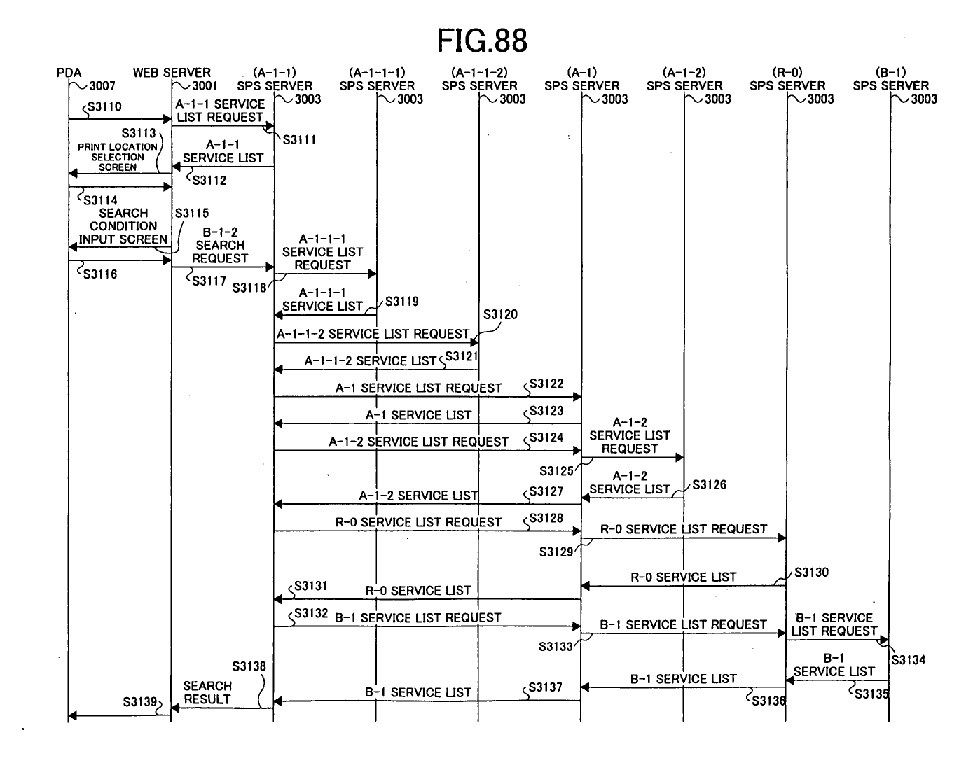

A description is given, with reference to FIG. 49 and FIG. 88, of another exemplary print location search operation of the system having the structure shown in FIG. 96.

FIG. 88 is a sequence diagram for explaining another exemplary print location search operation according to an embodiment of the present invention.

Referring to FIG. 49 and FIG. 88, in the case of the system structure shown in FIG. 96, for example, when a user pushes the “SELECT PRINT LOCATION” button in the document selection confirmation screen shown in FIG. 78D, the user I/F control unit 3113 of the Web server 3001 acquires information to indicate that the user has pushed the “SELECT PRINT LOCATION” button via PDA 3007 (S3110 in FIG. 88).

When acquiring the information, the service list acquisition unit 3114 of the Web server 3001 sends a service list acquisition request for a service list 3071 of the shared print environment service 3013 (A-1-1) to the shared print environment service 3013 (A-1-1) (S3111 in FIG. 88).

The shared print environment service 3013 (A-1-1), in response to receipt of the service list acquisition request from the service list acquisition unit 3114 of the Web server 3001, acquires the service list 3071 from HDD 3099 of the SPS server 3003 (A-1-1), and sends the service list 3071 to the service list acquisition unit 3114 of the Web server 3001 (S3112 of FIG. 88).

Based upon the acquired service list 3071 of the shared print environment service 3013 (A-1-1), the screen creation unit 3111 of the Web server 3001 creates a print location selection screen as illustrated in FIG. 49A.

The screen providing unit 3112 of the Web server 3001 provides the created print location selection screen to PDA 3007 (S3113 in FIG. 88).

As shown in FIG. 49A, the “SEARCH” button is displayed in the print location selection screen as in the print location selection screen shown in FIG. 47A.

For example, when the user selects the “SEARCH” button in the print location selection screen shown in FIG. 49A and pushes the “NEXT” button, the user I/F control unit 3113 of the Web server 3001 acquires information to indicate that the user has selected the “SEARCH” button and pushed the “NEXT” button via PDA 3007 (S3114 in FIG. 88).

When acquiring the information, the screen creation unit 3111 of the Web server 3001 creates a search condition input screen as illustrated in FIG. 49B.

The screen providing unit 3112 of the Web server 3001 provides the created search condition input screen to PDA 3007 (S3115 in FIG. 88).

For example, when the user inputs a search condition in the search condition input screen shown in FIG. 49B and pushes the “START SEARCH” button, the user I/F control unit 3113 of the Web server 3001 acquires information to indicate that the user has input the search condition (the shared print environment service 3013 (B-1-2) in the illustration) and pushed the “START SEARCH” button via PDA 3007 (S3116 in FIG. 88).

When acquiring the information, the search control unit 3121 of the Web server 3001 sends a search request for the shared print environment service 3013 (B-1-2) to the shared print environment service 3013 (A-1-1) (S3117 in FIG. 88).

The shared print environment service 3013 (A-1-1), in response to receipt of the search request, sends a service list acquisition request for a service list 3071 of the shared print environment service 3013 (A-1-1-1) to the shared print environment service 3013 (A-1-1-1) (S3118 in FIG. 88). It is noted that the acquisition of the service list 3071 is for the reason that the service list 3071 includes information, such as the names, the latitudes, the longitudes, the altitudes and the addresses of one or more other shared print environment services 3013 that the shared print environment service 3013 having the service list 3071 can refer to, and the information is used as the search condition to search for the shared print environment service 3013 (B-1-2). Hereinafter, the same discussion is held.

The shared print environment service 3013 (A-1-1-1), in response to receipt of the service list acquisition request, acquires the service list 3071 from the SPS server 3003 (A-1-1-1), and sends the service list 3071 to the shared print environment service 3013 (A-1-1) (S3119 in FIG. 88).

The shared print environment service 3013 (A-1-1), in response to receipt of the service list 3071 of the shared print environment service 3013 (A-1-1-1), determines whether the service list 3071 includes the search condition, that is, URI of the shared print environment service 3013 (B-1-2) here. If the shared print environment service 3013 (A-1-1) determines that the service list 3071 does not include the search condition, the shared print environment service 3013 (A-1-1) sends a service list acquisition request for a service list 3071 of the shared print environment service 3013 (A-1-1-2) to the shared print environment service 3013 (A-1-1-2) (S3120 in FIG. 88).

The shared print environment service 3013 (A-1-1-2), in response to receipt of the service list acquisition request, acquires the service list 3071 from the SPS server 3003 (A-1-1-2), and sends the service list 3071 to the shared print environment service 3013 (A-1-1) (S3121 in FIG. 88).

Subsequently, the shared print environment service 3013 (A-1-1) exhaustively sends service list acquisition requests to all shared print environment services 3013 and acquires service lists 3071, until the shared print environment service 3013 (A-1-1) acquires a service list 3071 having the search condition, that is, the URI of the shared print environment service 3013 (B-1-2) here, similarly to the above operation (S3122 through S3137 in FIG. 88).

When acquiring the service list 3071 having the search condition, that is, the URI of the shared print environment service 3013 (B-1-2), the shared print environment service 3013 (A-1-1) sends the search result having the service list 3071 and path information on a path to the target shared print environment service 3013 (B-1-2) to the Web server 3001 (S3138 in FIG. 88).

Based upon the search result acquired by the search control unit 3121, the screen creation unit 3111 of the Web server 3001 creates a search result display screen as illustrated in FIG. 49C.

The screen providing unit 3112 of the Web server 3001 provides the created search result display screen to PDA 3007 (S3139 in FIG. 88).

For example, when the user pushes the “OK” button in the search result display screen shown in FIG. 49C, the user I/F control unit 3113 of the Web server 3001 acquires information to indicate that the user has pushed the “OK” button via PDA 3007 (not illustrated).

When acquiring the information, the screen creation unit 3111 of the Web server 3001 creates a print location selection confirmation screen as illustrated in FIG. 49D.

The screen providing unit 3112 of the Web server 3001 provides the created print location selection confirmation screen to PDA 3007 (not illustrated).

For example, when the user pushes the “DISPLAY SELECTION RESULT” button in the print location selection confirmation screen shown in FIG. 49D, the user I/F control unit 3113 of the Web server 3001 acquires information to indicate that the user has pushed the “DISPLAY SELECTION RESULT” button via PDA 3007 (not illustrated).

When acquiring the information, the screen creation unit 3111 of the Web server 3001 creates a print location selection result display screen as illustrated in FIG. 49E.

The screen providing unit 3112 of the Web server 3001 provides the created print location selection result display screen to PDA 3007 (not illustrated).

As described with reference to FIG. 49 and FIG. 88, the Web server 3001 having the structure shown in FIG. 96 can search a print location by acquiring a service list 3071.

In addition, the Web server 3001 can acquire path information to a print location through the operation shown in FIG. 49 and FIG. 88.

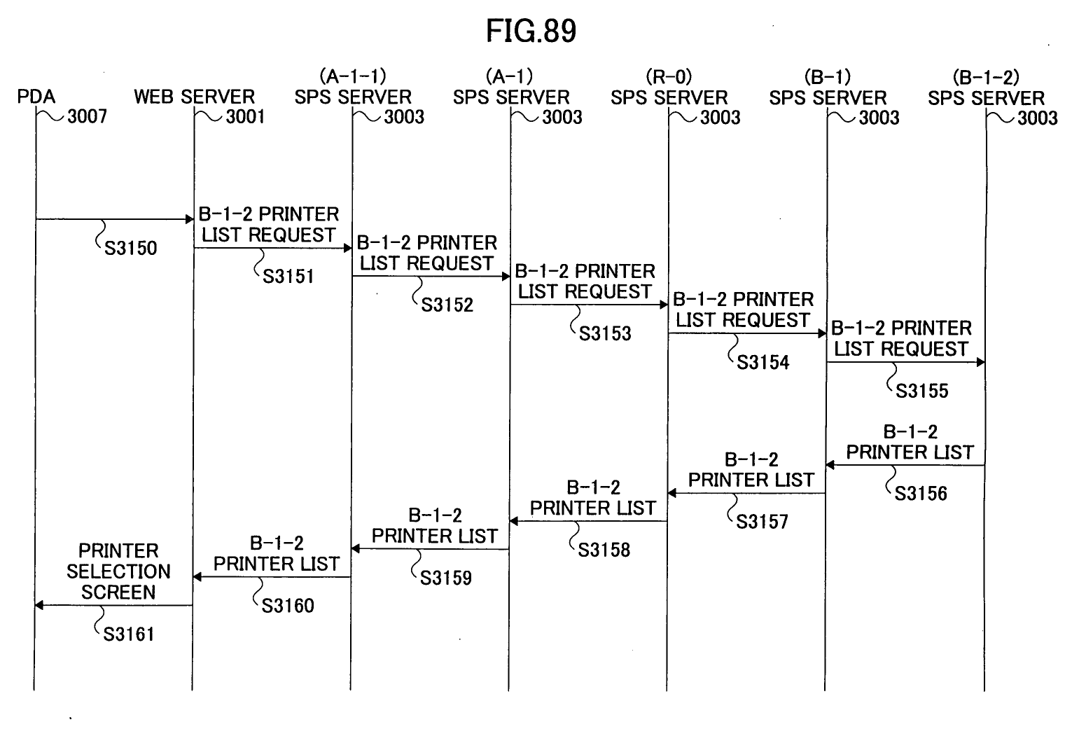

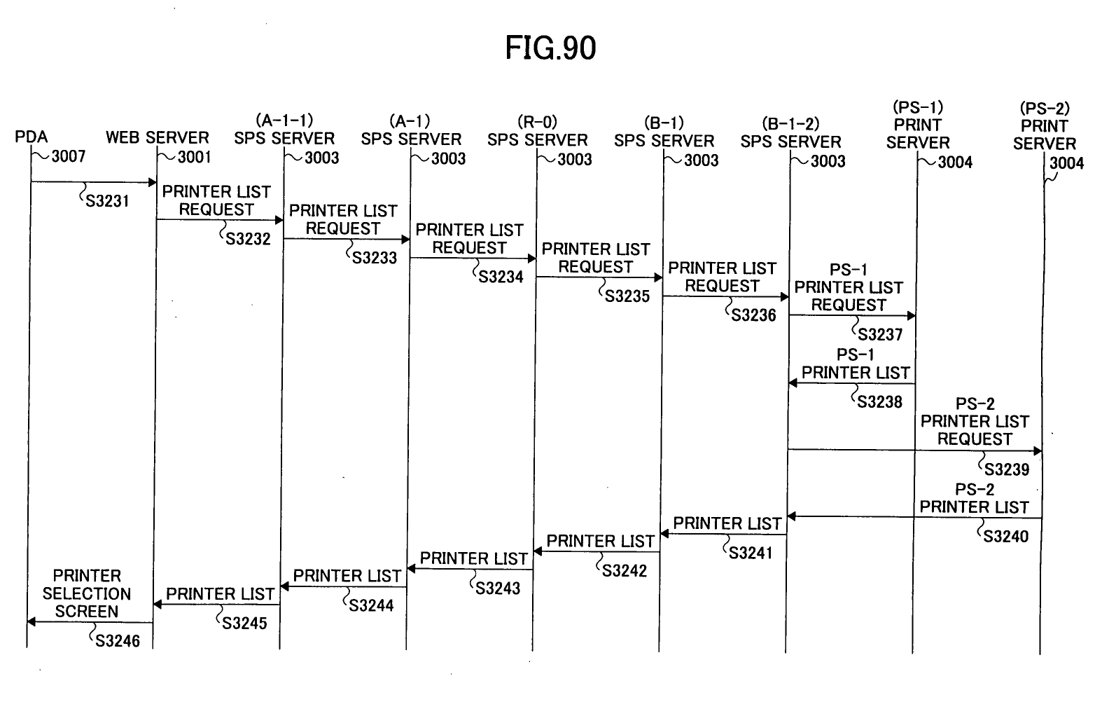

A description is given, with reference to FIG. 55, FIG. 56, FIG. 89 and FIG. 90, of an exemplary printer selection operation according to an embodiment of the present invention. In this embodiment, a printer list 3072, which is described in detail below, may be stored in each SPS server 3003 of shared print environment services 3013. Alternatively, the printer list 3072 may be stored in a print server 3004 mounting a document print service 3014.

A description is given, with reference to FIG. 89, of an exemplary printer list acquisition operation to acquire a printer list 3072 in a case where the printer list 3072 is stored in a SPS server 3003.

FIG. 89 is a sequence diagram for explaining an exemplary printer list acquisition operation according to an embodiment of the present invention.

Referring to FIG. 89, for example, as described previously with reference to FIG. 38 and FIG. 40, when a search operation for a print location (the shared print environment service 3013 (B-1-2)) is finished and a user pushes the “SELECT PRINTER” button in the print location selection confirmation screen shown in FIG. 38E, the user I/F control unit 3113 of the Web server 3001, which is in the system structure shown in FIG. 96, acquires an identifier to identify the print location (the shared print environment service 3013 (B-1-2) selected by the user via PDA 3007 and information to indicate that the user has pushed the “SELECT PRINTER” button (S3150 in FIG. 89).

When acquiring the information, the printer list acquisition unit 3115 of the Web server 3001 sends a printer list acquisition request for a printer list 3072 of the shared print environment service 3013 (B-1-2), including path information on a path to the shared print environment service 3013 (B-1-2), to the shared print environment service 3013 (A-1-1) (S3151 in FIG. 89).

The shared print environment service 3013 (A-1-1), in response to receipt of the printer list acquisition request, forwards the printer list acquisition request to the shared print environment service 3013 (A-1) based on the path information included in the printer list acquisition request (S3152 in FIG. 89).

The shared print environment service 3013 (A-1), in response to receipt of the printer list acquisition request, forwards the printer list acquisition request to the shared print environment service 3013 (R-0) based on the path information included in the printer list acquisition request (S3153 in FIG. 89).

The shared print environment service 3013 (R-0), in response to receipt of the printer list acquisition request, forwards the printer list acquisition request to the shared print environment service 3013 (B-1) based on the path information included in the printer list acquisition request (S3154 in FIG. 89).

The shared print environment service 3013 (B-1), in response to receipt of the printer list acquisition request, forwards the printer list acquisition request to the shared print environment service 3013 (B-1-2) based on the path information included in the printer list acquisition request (S3155 in FIG. 89).

The shared print environment service 3013 (B-1-2), in response to receipt of the printer list acquisition request, acquires the printer list 3072 from the SPS server 3003 (B-1-2), and sends the printer list 3072 to the shared print environment service 3013 (B-1) (S3156 in FIG. 89).

The shared print environment service 3013 (B-1) forwards the received printer list 3072 of the shared print environment service 3013 (B-1-2) to the shared print environment service 3013 (R-0) based on the path information (S3157 in FIG. 89).

The shared print environment service 3013 (R-0) forwards the received printer list 3072 of the shared print environment service 3013 (B-1-2) to the shared print environment service 3013 (A-1) based on the path information (S3158 in FIG. 89).

The shared print environment service 3013 (A-1) forwards the received printer list 3072 of the shared print environment service 3013 (B-1-2) to the shared print environment service 3013 (A-1-1) based on the path information (S3159 in FIG. 89).

The shared print environment service 3013 (A-1-1) forwards the received printer list 3072 of the shared print environment service 3013 (B-1-2) to the printer list acquisition unit 3115 of the Web server 3001 based on the path information (S3160 in FIG. 89).

Based upon the acquired printer list 3072 of the shared print environment service 3013 (B-1-2), the screen creation unit 3111 of the Web server 3001 creates a printer selection screen as illustrated in FIG. 56A.

The screen providing unit 3112 of the Web server 3001 provides the created printer selection screen to PDA 3007 (S3161 in FIG. 89).

A description is given, with reference to FIG. 90, of an exemplary printer list acquisition operation in a case where a printer list 3072 is stored in the printer server 3004.

FIG. 90 is a sequence diagram of an exemplary printer list acquisition operation according to an embodiment of the present invention.

Referring to FIG. 90, as described with reference to FIG. 38 and FIG. 40, for example, when a search operation for a print location (the shared print environment service 3013 (B-1-2)) is finished and a user pushes the “SELECT PRINTER” button in the print location selection confirmation screen shown in FIG. 38E, the user I/F control unit 3113 of the Web server 3001, which is in the system structure shown in FIG. 96, acquires an identifier to identify the print location (the shared print environment service 3013 (B-1-2)) selected by the user and information to indicate that the user has pushed the “SELECT PRINTER” button (S3231 in FIG. 90).

When acquiring the information, the printer list acquisition unit 3115 of the Web server 3001 sends a printer list acquisition request for a printer list 3072 of a document print service 3014 that the shared print environment service 3013 (B-1-2) can refer to, including path information on a path to the shared print environment service 3013 (B-1-2), to the shared print environment service 3013 (A-1-1) (S3232 in FIG. 90).

The shared print environment service 3013 (A-1-1), in response to receipt of the printer list acquisition request, forwards the printer list acquisition request to the shared print environment service 3013 (A-1) based on the path information (S3233 in FIG. 90).

The shared print environment service 3013 (A-1), in response to receipt of the printer list acquisition request, forwards the printer list acquisition request to the shared print environment service 3013 (R-0) based on the path information (S3234 in FIG. 90).

The shared print environment service 3013 (R-0), in response to receipt of the printer list acquisition request, forwards the printer list acquisition request to the shared print environment service 3013 (B-1) based on the path information (S3235 in FIG. 90).

The shared print environment service 3013 (B-1), in response to receipt of the printer list acquisition request, forwards the printer list acquisition request to the shared print environment service 3013 (B-1-2) based on the path information (S3236 in FIG. 90).

The shared print environment service 3013 (B-1-2), in response to receipt of the printer list acquisition request for the printer list 3072 of the document print service 3014 that the shared print environment service 3013 (B-1-2) can refer to, sends the printer list acquisition request for the printer list 3072 of the document print service 3014 (PS-1) to the document print service 3014 (PS-1) (S3237 in FIG. 90).

The document print service 3014 (PS-1), in response to receipt of the printer list acquisition request, for example, stores the printer list 3072 from the print server 3004 (PS-1), and sends the printer list 3072 to the shared print environment service 3013 (B-1-2) (S3238 in FIG. 90).

The shared print environment service 3013 (B-1-2), in response to receipt of the printer list acquisition request, sends a printer list acquisition request for a printer list 3072 of the document print service 3014 (PS-2) to the document print service 3014 (PS-2) (S3239 in FIG. 90).

The document print service 3014 (PS-2), in response to receipt of the printer list acquisition request, for example, stores the printer list 3072 from the print server 3004 (PS-2), and sends the printer list 3072 to the shared print environment service 3013 (B-1-2) (S3240 in FIG. 90).

The shared print environment service 3013 (B-1-2) sends the received printer lists 3072 of the document print services 3014 (PS-1) and (PS-2) to the shared print environment service 3013 (B-1) based on the path information (S3241 in FIG. 90).

The shared print environment service 3013 (B-1) forwards the printer lists 3072 to the shared print environment service 3013 (R-0) based on the path information (S3242 in FIG. 90).

The shared print environment service 3013 (R-0) forwards the printer lists 3072 to the shared print environment service 3013 (A-1) based on the path information (S3243 in FIG. 90).

The shared print environment service 3013 (A-1) forwards the printer lists 3072 to the shared print environment service 3013 (A-1-1) based on the path information (S3244 in FIG. 90).

The shared print environment service 3013 (A-1-1) forwards the received printer lists 3072 to the printer list acquisition unit 3115 of the Web server 3001 (S3245 in FIG. 90).

Based upon the acquired printer lists 3072 of the document print services that the shared print environment service 3013 (B-1-2) can refer to, the screen creation unit 3111 of the Web server 3001 creates a printer selection screen as illustrated in FIG. 56A.

The screen providing unit 3112 of the Web server 3001 sends the created printer list selection screen to PDA 3007 (S3246 in FIG. 90).

In the following, for simplicity, it is supposed that the printer list 3072 is stored in each SPS server 3003 mounting shared print environment services 3013.

A description is given, with reference to FIG. 55, of an exemplary printer list 3072 according to an embodiment of the present invention.

Referring to FIG. 55, a printer list 3072 includes URIs of one or more document print services 3014 that the corresponding shared print environment service 3013 can refer to and printer IDs of one or more printers that the document print services 3014 manage.

For simplicity, identifiers to identify document print services 3014, such as PS-1 and PS-2, are used in the printer list shown in FIG. 55 instead of URIs of the document print services 3014.

Referring to FIG. 56, which is a diagram for explaining an exemplary printer selection operation, for example, when a user selects “P-1-2” in the printer selection screen shown in FIG. 56A and pushes the “OK” button, the user I/F control unit 3113 of the Web server 3001 acquires information to indicate that the user has selected “P-1-2” and pushed the “OK” button via PDA 3007 (not illustrated).

When acquiring the information, the screen creation unit 3111 of the Web server 3001 creates a printer selection confirmation screen as illustrated in FIG. 56B.

The screen providing unit 3112 of the Web server 3001 provides the created printer selection confirmation screen via PDA 3007 (not illustrated).

As described with reference to FIG. 55, FIG. 56, FIG. 89 and FIG. 90, the Web server 3001 allows a user to select a desired printer and print-reserve a desired document by using the printer by acquiring a printer list 3072 and creating screens as illustrated in FIGS. 56A and 56B.

In addition, when the user pushes the “RESERVE PRINT” button in the printer selection confirmation screen shown in FIG. 56B, the user I/F control unit 3113 of the Web server 3001 acquires information that the user has pushed the “RESERVE PRINT” button via PDA 3007 (not illustrated).

The screen providing unit 3112 of the Web server 3001 provides the created print reservation confirmation screen to PDA 3007 (not illustrated).

As shown in FIG. 59C, the printer information is set in the print reservation confirmation screen compared to the print reservation confirmation screen shown in FIG. 38G.

For example, the user can make print reservation by selecting a target document, a print location and a printer and pushing the “RESERVE” button in the print reservation confirmation screen shown in FIG. 56C without setting any print condition. In this case, after the print reservation is made, for example, the user can print the document by visiting a meeting room, confirming the number of participants and setting a print condition later.

Also, in this case, a print reservation request, which is described in detail below with reference to FIG. 92, includes the document ID of the document selected by the user as the document to be print-reserved, a document ticket to give the user permission to use the document, identification information to identify the print location, path information on a path to the print location, and identification information to identify the selected printer.

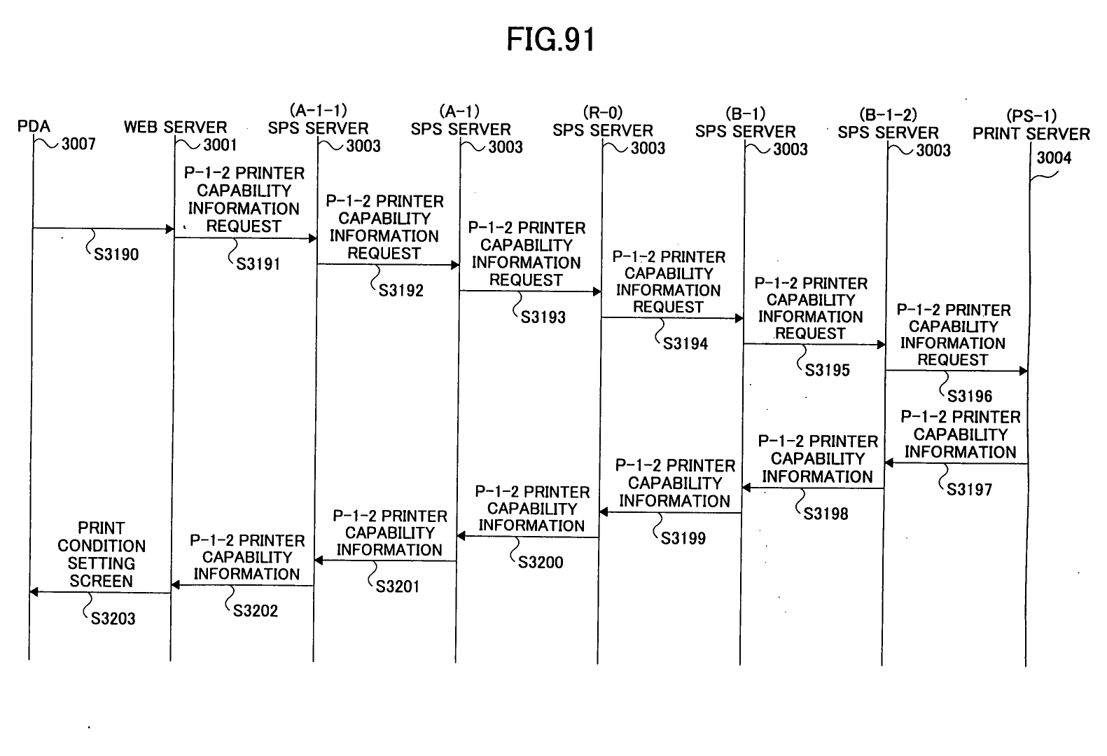

A description is given, with reference to FIG. 53 and FIG. 91, of an exemplary print condition setting operation according to an embodiment of the present invention.

FIG. 91 is a sequence diagram for explaining an exemplary printer capability information acquisition operation according to an embodiment of the present invention.

Referring to FIG. 91, for example, as described with reference to FIG. 56, when a printer is selected and a user pushes the “SET PRINT CONDITION” button in the printer selection confirmation screen shown in FIG. 56B, the user I/F control unit 3113 of the Web server 3001, in the case of the system structure shown in FIG. 96, acquires an identifier to identify a printer selected by the user and information to indicate that the user has pushed the “SET PRINT CONDITION” button via PDA 3007 (S3190 in FIG. 91).

When acquiring the identifier and the information, the printer capability information acquisition unit 3116 of the Web server 3001 sends a printer capability information acquisition request for capability information of a printer 3006 (P-1-2), including path information on a path to the shared print environment service 3013 (B-1-2), to the shared print environment service 3013 (A-1-1) (S3191 in FIG. 91).

It is noted that the printer capability information is information involved in functions and/or processing capability of each printer, such as color printing availability or both-sided printing availability of the printer, that the document print service 3014 managing the printer has.

The shared print environment service 3013 (A-1-1), in response to receipt of the printer capability information acquisition request, forwards the printer capability information acquisition request to the shared print environment service 3013 (A-1) based on the path information included in the printer capability information acquisition request (S3192 in FIG. 91).

The shared print environment service 3013 (A-1), in response to receipt of the printer capability information acquisition request, forwards the printer capability information acquisition request to the shared print environment service 3013 (R-0) based on the path information included in the printer capability information acquisition request (S3193 in FIG. 91).

The shared print environment service 3013 (R-0), in response to receipt of the printer capability information acquisition request, forwards the printer capability information acquisition request to the shared print environment service 3013 (B-1) based on the path information included in the printer capability information acquisition request (S3194 in FIG. 91).

The shared print environment service 3013 (B-1), in response to receipt of the printer capability information acquisition request, forwards the printer capability information acquisition request to the shared print environment service 3013 (B-1-2) based on the path information included in the printer capability information acquisition request (S3195 in FIG. 91).

The shared print environment service 3013 (B-1-2), in response to receipt of the printer capability information acquisition request, forwards the printer capability information acquisition request to the document print service 3014 (PS-1) (S3196 in FIG. 91).

The document print service 3014 (PS-1), in response to receipt of the printer capability information acquisition request, for example, acquires the capability information of the printer 3006 (P-1-2) from the print server 3004 (PS-1) and sends the capability information to the shared print environment service 3013 (B-1-2) (S3197 in FIG. 91).

Here, capability information on a printer 3006 may be stored in the print server 3004. Alternatively, a collection of capability information may be stored in another server for individual printers 3006. In the following, it is supposed for simplicity that the capability information is stored in the print server 3004.

The shared print environment service 3013 (B-1-2) forwards the received capability information on the printer 3006 (P-1-2) to the shared print environment service 3013 (B-1) based on the path information (S3198 in FIG. 91).

The shared print environment service 3013 (B-1) forwards the received capability information on the printer 3006 (P-1-2) to the shared print environment service 3013 (R-0) based on the path information (S3199 in FIG. 91).

The shared print environment service 3013 (R-0) forwards the received capability information on the printer 3006 (P-1-2) to the shared print environment service 3013 (A-1) based on the path information (S3200 in FIG. 91).

The shared print environment service 3013 (A-1) forwards the received capability information on the printer 3006 (P-1-2) to the shared print environment service 3013 (A-1-1) based on the path information (S3201 in FIG. 91).

The shared print environment service 3013 (A1-1) forwards the received capability information on the printer 3006 (P-1-2) to the printer capability information acquisition unit 3116 of the Web server 3001 based on the path information (S3202 in FIG. 91).

Based upon the acquired capability information on the printer 3006 (P-1-2), the screen creation unit 3111 of the Web server 3001 creates a print condition setting screen as illustrated in FIG. 58A.

The screen providing unit 3112 of the Web server 3001 provides the created print condition setting screen to PDA 3007 (S3203 in FIG. 91).

For example, when the user sets a print condition in the print condition setting screen shown in FIG. 58A and pushes the “RESERVE PRINT” button, the user I/F control unit 3113 of the Web server 3001 acquires the print condition set by the user and information to indicate that the user has pushed the “RESERVE PRINT” button (not illustrated).

With the print condition and the information, the screen creation unit 3111 creates a print reservation confirmation screen as illustrated in FIG. 58B.

The screen providing unit 3112 of the Web server 3001 provides the created print reservation confirmation screen to PDA 3007 (not illustrated).

As shown in FIG. 58B, the print condition is set in the print reservation confirmation screen compared to the print reservation confirmation screen shown in FIG. 56C.

For example, the user can make a print reservation by setting a target document, a print location and a print condition and pushing the “RESERVE” button in the print reservation confirmation screen shown in FIG. 58B.

In this case, a print reservation request, which is described in detail below with reference to FIG. 92, includes a document ID of the document selected by the user as the document to be print-reserved, a document ticket to give the user permission to use the document, identification information to identify the print location, path information on a path to the print location, identification information to identify the printer and the print condition.

As described with reference to FIG. 58 and FIG. 91, the Web server 3001 allows the user to set a print condition and make a print reservation by acquiring capability information on a printer, creating a print condition setting screen shown in FIG. 58A, and providing the created screen to the user.

A description is given, with reference to FIG. 60 and FIG. 92, of an exemplary print reservation request and print start request operation according to an embodiment of the present invention.

FIG. 92 is a sequence diagram for explaining an exemplary print reservation request and print start request operation according to an embodiment of the present invention.

Referring to FIG. 92, for example, when a user pushes the “RESERVE” button in the print reservation confirmation screen as illustrated in FIG. 58B, the user I/F control unit 3113 of the Web server 3001 acquires information to indicate that the user has pushed the “RESERVE” button via PDA 3007 (S3210 in FIG. 92).

When acquiring the information, the reservation request transmission unit 3118 of the Web server 3001 sends a print reservation request to include a document ID of a document selected by the user as the document to be print-reserved, a document ticket to give the user permission to use the document, identification information to identify the print location, path information on a path to the print location, identification information to identify the printer, and the print condition to the shared print environment service 3013 (A-1-1) based on the path information (S3211 in FIG. 92).

The shared print environment service 3013 (A-1-1), in response to receipt of the print reservation request, sends a document data acquisition request, including the document ID and the document ticket, included in the received print reservation request to the repository service 3012 (S3212 in FIG. 92).

The repository service 3012 determines validity of the document ticket, and if the repository service 3012 determines that the document ticket is valid, the repository service 3012 acquires document data of the document designated by the document ID from the repository server 3002, and sends the document data to the shared print environment service 3013 (A-1-1) (S3213 in FIG. 92).

The shared print environment service 3013 (A-1-1) forwards reservation information included in the print reservation request (for example, the identification information to identify the print location, the identification information to identify the printer, the print condition, and the path information to the print location) and the acquired document data to the shared print environment service 3013 (A-1) based on the path information (S3214 in FIG. 92).

The shared print environment service 3013 (A-1-1) stores the reservation information in the HDD 3039 of the SPS server 3003 on which the shared print environment service 3013 (A-1-1) is mounted.

The shared print environment service 3013 (A-1), in response to receipt of the reservation information and the document data, forwards the reservation information and the document data to the shared print environment service 3013 (R-0) based on the path information included in the reservation information (S3215 in FIG. 92).

The shared print environment service 3013 (R-0), in response to receipt of the reservation information and the document data, forwards the reservation information and the document data to the shared print environment service 3013 (B-1) based on the path information included in the reservation information (S3216 in FIG. 92).

The shared print environment service 3013 (B-1), in response to receipt of the reservation information and the document data, forwards the reservation information and the document data to the shared print environment service 3013 (B-1-2) based on the path information included in the reservation information (S3217 in FIG. 92).

When acquiring the reservation information and the document data, the shared print environment service 3013 (B-1-2) stores the reservation information and the document data in HDD 3099 of the SPS server 3003 (B-1-2).

On the other hand, the Web server 3001, in response to receipt of a request for displaying the print reservation selection screen from PDA 3007 (S3218 in FIG. 92), sends a reservation information list acquisition request for a list of reservation information items, which are stored in HDD 3099 of the SPS server 3003 (A-1-1) for each user, to the shared print environment service 3013 (A-1-1) (S3219 in FIG. 92).

The shared print environment service 3013 (A-1-1), in response to receipt of the reservation information list acquisition request, acquires the reservation information list on a designated user from HDD 3099 of the SPS server 3003 (A-1-1), and sends the reservation information list to the Web server 3001 (S3220 in FIG. 92).

Based upon the acquired reservation information list, the screen creation unit 3111 of the Web server 3001 creates a print reservation selection screen, as illustrated in FIG. 60, to allow the user to select a print reservation item.

The screen providing unit 3112 of the Web server 3001 provides the created print reservation selection screen to PDA 3007 (S3221 in FIG. 92).

The user can use the print reservation selection screen shown in FIG. 60, for example, to request print start, display reservation contents, and confirm the reservation by selecting the print reservation item.

For example, when the user selects “RESERVATION 1” and pushes the “PRINT” button in the print reservation selection screen shown in FIG. 60, the user I/F control unit 3113 of the Web server 3001 acquires information to indicate that the user has selected “RESERVATION 1” and pushed the “PRINT” button (S3222 in FIG. 92).

When acquiring the information, the print start request transmission unit 3119 of the Web server 3001, in the system structure shown in FIG. 96, sends a print start request to the shared print environment service 3013 (A-1-1) based on information involved in individual reservation items in the Web server 3001 (for example, an identifier of each print reservation item, an identifier of a shared print environment service 3013 having print reservation information and document data and path information to the shared print environment service 3013) (S3223 of FIG. 92).

The shared print environment service 3013 (A-1-1), in response to receipt of the print start request, forwards the print start request to the shared print environment service 3013 (A-1) based on the path information to the print location included in the print start request (S3224 in FIG. 92).

The shared print environment service 3013 (A-1), in response to receipt of the print start request, forwards the print start request to the shared print environment service 3013 (R-0) based on the path information to the print location included in the print start request (S3225 in FIG. 92).

The shared print environment service 3013 (R-0), in response to receipt of the print start request, forwards the print start request to the shared print environment service 3013 (B-1) based on the path information to the print location included in the print start request (S3226 in FIG. 92).

The shared print environment service 3013 (B-1), in response to receipt of the print start request, forwards the print start request to the shared print environment service 3013 (B-1-2) based on the path information to the print location included in the print start request (S3227 in FIG. 92).

The shared print environment service 3013 (B-1-2), in response to receipt of the print start request, acquires the reservation information and the document data from HDD 3099 of the SPS server 3003 (B-1-2), and sends the print start request having the print condition and the document data included in the reservation information to the document print service 3014 (PS-1) (S3228 in FIG. 92).

The document print service 3014 (PS-1), in response to receipt of the print start request having the print condition and the document data, converts the document data into print data printable in the designated printer 3006 (P-1-2), and sends the print start request including the print data to the printer 3006 (P-1-2) (S3229 in FIG. 92).

Corresponding to the received print start request, the printer 3006 (P-1-2) prints the print data.

As described with reference to FIG. 60 and FIG. 92, the Web server 3001 can send a print reservation request to a shared print environment service 3013 based on a request from PDA 3007.

In addition, the Web server 3001 can send a print start request to the shared print environment service 3013 based on a request from PDA 3007.

In the previous embodiment, the Web server 3001 creates HTML data as illustrated in FIG. 81, sends the created HTML data to PDA 3007, and displays the screen. In another embodiment of the present invention, the screen may be created and displayed in PDA 3007 by exchanging SOAP messages between the Web server 3001 and PDA 3007.

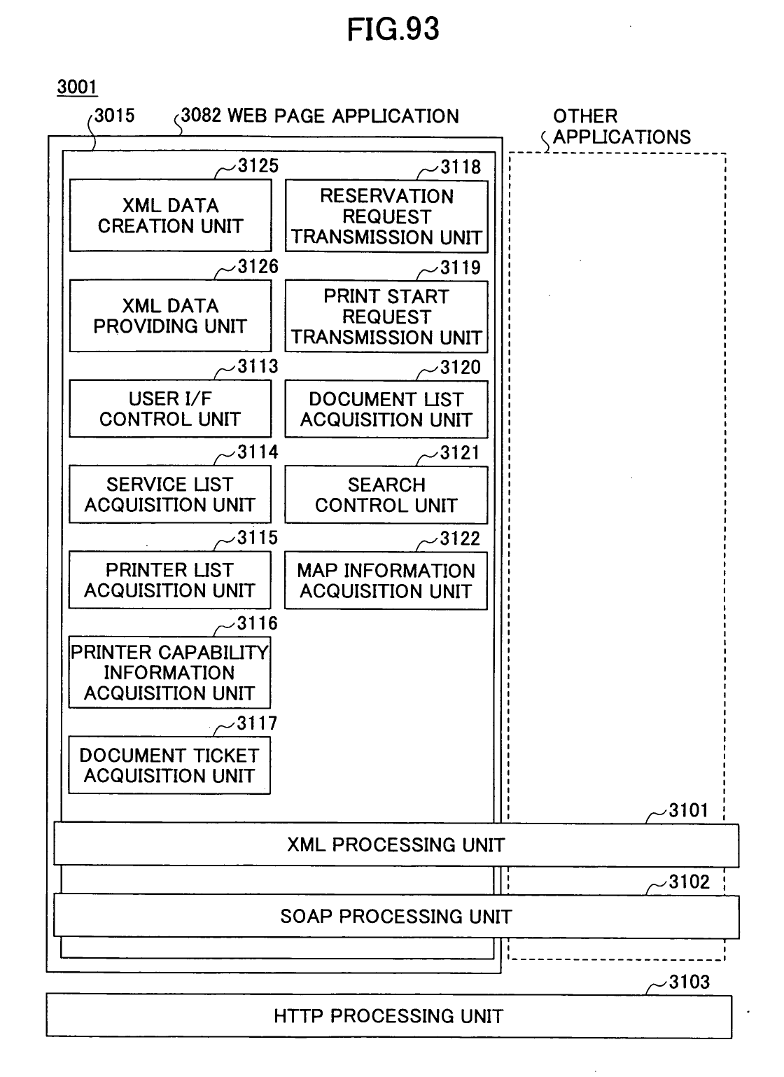

A description is given, with reference to FIG. 93, of another exemplary functional structure of the Web server 3001 according to an embodiment of the present invention.

FIG. 93 is a schematic diagram showing another exemplary functional structure of the Web server 3001 according to an embodiment of the present invention. In this embodiment, differences between functional structures, shown in FIG. 76 and FIG. 93, of the Web server 3001 are mainly described.

Referring to FIG. 93, the Web server 3001 newly includes an XML data creation unit 3125 and an XML data providing unit 3126 instead of the screen creation unit 3111 and the screen providing unit 3112 compared to the functional structure shown in FIG. 76.

The XML data creation unit 3125 creates XML data involved in a screen described in detail below. The XML data providing unit 3126 provides the XML data created by the XML data creation unit 3125, for example, to a user terminal such as PDA 3007.

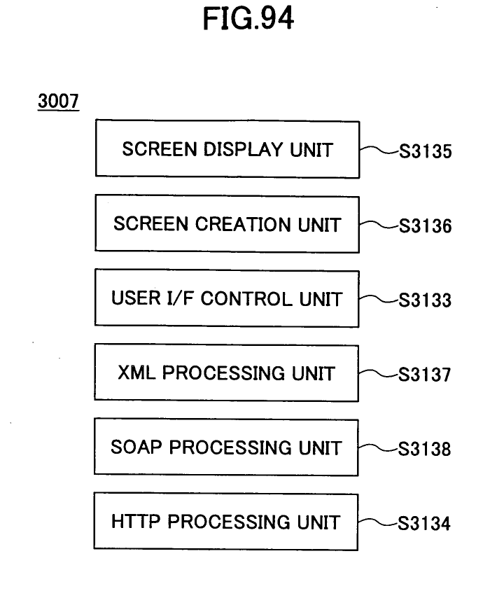

A description is given, with reference to FIG. 94, of another exemplary functional structure of PDA 3007 according to an embodiment of the present invention.

FIG. 94 is a schematic diagram showing another exemplary functional structure of PDA 3007 according to an embodiment of the present invention.

Referring to FIG. 94, PDA 3007 includes a user I/F control unit 3133, an HTTP processing unit 3134, a screen display unit 3135, a screen creation unit 3136, an XML processing unit 3137 and a SOAP processing unit 3138.

The HTTP processing unit 3134 serves as a communication control unit to control communications in accordance with HTTP. The XML processing unit 3137 serves as a processing unit to process XML messages. The SOAP processing unit 3138 serves as a processing unit to exchange messages in accordance with SOAP.

The screen creation unit 3136 serves as a creation unit to create screens based on XML data involved in the screens described in detail below. The screen display unit 3135 serves as a display unit to display screens created by the screen creation unit 3136. The user I/F control unit 3133, for example, sends input information from screens to the Web server 3001.

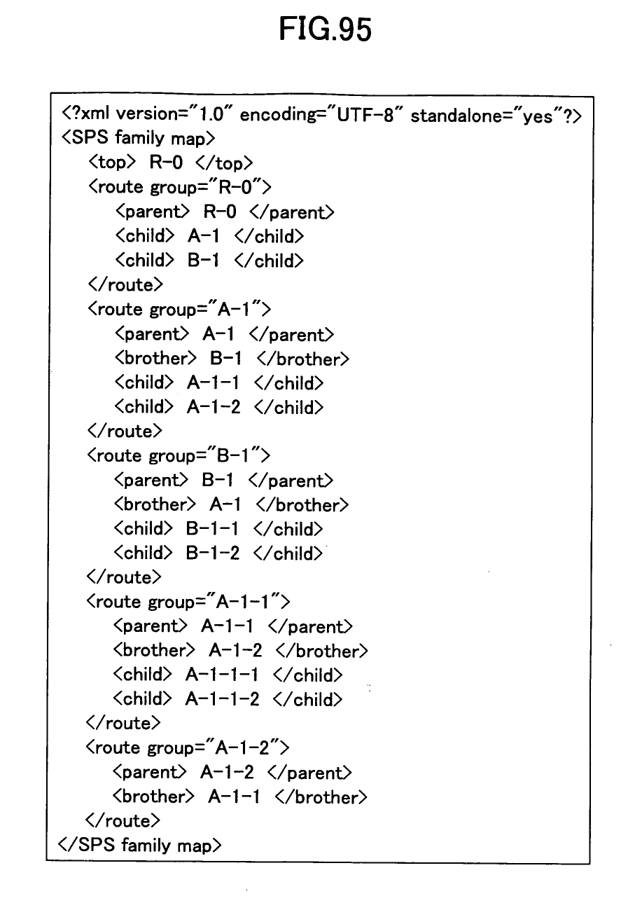

A description is given, with reference to FIG. 95, of exemplary XML data involved in screens according to an embodiment of the present invention.

FIG. 95 is a schematic diagram showing exemplary XML data involved in a screen according to an embodiment of the present invention.

Referring to FIG. 95, the Web server 3001 creates illustrated XML data and sends the XML data to PDA 3007. PDA 3007, in response to receipt of the XML data shown in FIG. 95, creates and displays a print location selection result display screen, as illustrated in FIG. 38F, based on the XML data.

The present invention is not limited to these embodiments, but variations and modifications may be made without departing from the scope of the present invention.

This patent application is based on Japanese Priority Patent Applications No. 2003-78990 filed on Mar. 20, 2003, No. 2003-78991 filed on Mar. 20, 2003, No. 2003-78992 filed on Mar. 20, 2003, No. 2004-76964 filed on Mar. 17, 2004, No. 2004-76965 filed on Mar. 17, 2004, No. 2004-76966 filed on Mar. 17, 2004, the entire contents of which are hereby incorporated by reference.

What is claimed is:

1. An apparatus, comprising:
a first sharing unit that shares a print environment thereof with other apparatuses,
wherein
the first sharing unit includes:
a connection management unit that manages the connecting of the first sharing unit to a second sharing unit of another apparatus; and
a transfer unit that transfers at least one of reservation information and a document related to a print reservation to the second sharing unit.

2. The apparatus as claimed in claim 1,
wherein
the connection management unit adds connection data related to the second sharing unit to service data including other sharing units that are connected to the first sharing unit in response to a connection request from the second sharing unit.

3. The apparatus as claimed in claim 1,
wherein
the connection management unit deletes connection data related to the second sharing unit to service data including other sharing units that are connected to the first sharing unit in response to a disconnection request from the second sharing unit.

4. The apparatus as claimed in claim 2,
wherein
the connection data related to the second sharing unit added to the service data are managed as one of upper level data, same level data, and lower level data depending on a relation between the first sharing unit and the second sharing unit.

5. The apparatus as claimed in claim 2, further comprising:
a service data storage unit that stores the service data.

6. The apparatus as claimed in claim 2,
wherein
the first sharing unit further comprises:
an acquisition unit that acquires the service data from the second sharing unit.

7. The apparatus as claimed in claim 1,
wherein
the first sharing unit further comprises:
a consistency check unit that checks consistency of a connection state in which the second sharing unit is connected to the first sharing unit and a disconnection state in which the second sharing unit is disconnected from the first sharing unit.

8. The apparatus as claimed in claim 1, further comprising:
a reservation data storage unit that stores the reservation information and the document.

9. The apparatus as claimed in claim 1, further comprising:
a document acquisition unit that acquires the document.

10. The apparatus as claimed in claim 1, further comprising:
a document management service unit that provides a service for managing the document.

11. The apparatus as claimed in claim 1, further comprising:
a document storage unit that stores the document.

12. The apparatus as claimed in claim 1, further comprising:
a print service unit that provides service related to printing.

13. The apparatus as claimed in claim 1, further comprising:
a print unit that prints the document.

14. A method of providing a sharing service in which a first sharing unit shares a print environment thereof with a second sharing unit, the method comprising the steps of:
managing the connecting and the disconnecting of the second sharing unit; and
transferring at least one of reservation information and a document related to a print reservation to the second sharing unit.

15. The method as claimed in claim 14, further comprising the step of:
adding data related to the second sharing unit to service data including data related to other sharing units to which the first sharing unit can refer, in response to a connection request from the second sharing unit.

16. The method as claimed in claim 14, further comprising the step of:
deleting data related to the second sharing unit from service data including data related to other sharing units to which the first sharing unit can refer, in response to a disconnection request from the second sharing unit.

17. The method as claimed in claim 15,
wherein
the data related to the second sharing unit added to the service data are managed as one of upper level data, same level data, and lower level data depending on a relation between the first sharing unit and the second sharing unit.

18. The method as claimed in claim 14, further comprising the step of:
checking consistency of a connection state in which the second sharing unit is connected to the first sharing unit and a disconnection state in which the second sharing unit is disconnected from the first sharing unit.

19. A computer program that causes a computer to share a print environment thereof with another computer, the computer program comprising the steps of:
managing connecting and disconnecting of the other computer with the computer; and
transferring at least one of reservation information and a document related to a print reservation to the other computer.

20. The computer program as claimed in claim 19, further comprising the step of:
adding data related to the other computer to service data including data related to third computers to which the computer can refer, in response to a connection request from the other computer.

21. The computer program as claimed in claim 19, further comprising the step of:
deleting data related to the other computer from service data including data related to third computers to which the computer can refer, in response to a disconnection request from the other computer.

22. The computer program as claimed in claim 20,
wherein
the data related to the other computer added to the service data are managed as one of upper level data, same level data, and lower level data depending on a relation between the computer and the other computer.

23. The computer program as claimed in claim 19, further comprising the step of:
checking consistency of a connection state in which the other computer is connected to the computer and a disconnection state in which the other computer is disconnected from the computer.

24. A computer readable recording medium that stores the computer program as claimed in claim 19.

25. An apparatus, comprising:
a first sharing unit that shares a print environment thereof with other apparatuses,
wherein
the first sharing unit includes:
a search unit that searches a print location; and
a transfer unit that transfers at least one of reservation information and a document related to a print reservation to a second sharing unit.

26. The apparatus as claimed in claim 25, wherein
the search unit further comprises:
a route information acquisition unit that acquires route information about a route to the print location.

27. The apparatus as claimed in claim 25, wherein
the search unit further comprises:
a service data acquisition unit that acquires service data including data about referential relation between sharing units from a third sharing unit.

28. The apparatus as claimed in claim 25,
wherein
the reservation information includes document identification information for identifying the document and document use permission information for being permitted to use the document.

29. The apparatus as claimed in claim 25,
wherein
the reservation information includes print location identification information for identifying the print location and route information to the print location.

30. The apparatus as claimed in claim 25, wherein
the reservation information includes printer identification information for identifying a printer.

31. The apparatus as claimed in claim 25, wherein
the reservation information includes information about a print condition.

32. The apparatus as claimed in claim 25, wherein
the first sharing unit further comprises:
a data adding unit that adds, in response to a connection request from the second sharing unit, data related to the second sharing unit to service data including sharing units other than the first sharing unit to which the first sharing unit can refer.

33. The apparatus as claimed in claim 25, wherein
the first sharing unit further comprises:
a data deleting unit that deletes, in response to a disconnection request from the second sharing unit, data related to the second sharing unit from the service data including data related to sharing units other than the first sharing unit to which the first sharing unit can refer.

34. The apparatus as claimed in claim 27,
wherein
the data related to the second sharing unit added to the service data are managed as one of upper level data, same level data, and lower level data depending on a relation between the first sharing unit and the second sharing unit.

35. The apparatus as claimed in claim 25, further comprising:
a service data storage unit that stores the service data including data related to a referential relation between the first sharing unit and other sharing units.

36. The apparatus as claimed in claim 25,
wherein
the first sharing unit further comprises:
a document acquisition unit that acquires the document.

37. The apparatus as claimed in claim 25,
wherein
the first sharing unit further comprises:
a printer data acquisition unit that acquires printer data.

38. The apparatus as claimed in claim 37,
wherein
the printer data are managed by a corresponding sharing unit that shares a print environment thereof with other apparatuses.

39. The apparatus as claimed in claim 37,
wherein
the printer data are managed by a print service providing unit that provides a print service.

40. The apparatus as claimed in claim 25,
wherein
the first sharing unit further comprises:
a function information acquisition unit that acquires function information of a printer.

41. The apparatus as claimed in claim.25, further comprising a data storage unit that stores at least one of reservation information and a document related to the print reservation.

42. The apparatus as claimed in claim 25, further comprising a document management service providing unit that manages the document.

43. The apparatus as claimed in claim 25, further comprising a document storage unit that stores the document.

44. The apparatus as claimed in claim 25, further comprising a print service providing unit that provides a print service.

45. The apparatus as claimed in claim 25, further comprising a print unit that prints the document.

46. A method of providing a sharing service in which a first sharing unit shares print environment thereof with a second sharing unit, the method comprising the steps of:
searching for a print location; and
transferring at least one of reservation information and a document related to a print reservation to the second sharing unit.

47. The method as claimed in claim 46,
wherein
the step of searching for the print location further comprises the step of acquiring route information of a route to the print location.

48. The method as claimed in claim 46,
wherein the step of searching for the print location further comprises the step of acquiring service data including data about referential relations between sharing units from a third sharing unit.

49. The method as claimed in claim 46,
wherein the reservation information includes document identification information for identifying the document and document use permission information for being permitted to use the document.

50. The apparatus as claimed in claim 46,
wherein
the reservation information includes print location identification information for identifying the print location and route information to the print location.

51. The apparatus as claimed in claim 46,
wherein
the reservation information includes printer identification information for identifying a printer.

52. The apparatus as claimed in claim 46,
wherein
the reservation information includes information about a print condition.

53. The method as claimed in claim 46,
wherein
the first sharing unit adds, in response to a connection request from the second sharing unit, data related to the second sharing unit to service data including sharing units other than the first sharing unit to which the first sharing unit can refer.

54. The method as claimed in claim 46,
wherein
the first sharing unit deletes, in response to a disconnection request from the second-sharing unit, data related to the second sharing unit from the service data including data related to sharing units other than the first sharing unit to which the first sharing unit can refer.

55. The method as claimed in claim 46,
wherein
the data related to the second sharing unit added to the service data are managed as one of upper level data, same level data, and lower level data depending on a relation between the first sharing unit and the second sharing unit.

56. The method as claimed in claim 46, further comprising the step of acquiring the document.

57. The method as claimed in claim 46, further comprising the step of:
acquiring printer data including data related to printers.

58. The method as claimed in claim 57,
wherein
the printer data are managed by a corresponding sharing unit that shares a print environment thereof with other apparatuses.

59. The method as claimed in claim 57,
wherein
the printer data are managed by a print service providing unit that provides a print service.

60. The method as claimed in claim 46, further comprising the step of:
acquiring function information of a printer.

61. The method as claimed in claim 46, further comprising the step of:
receiving a reservation request for a print reservation.

62. The method as claimed in claim 46, further comprising the step of receiving a print request.

63. A computer program that causes a computer to share a print environment thereof with another computer, the computer program comprising the steps of:
searching for a print location; and
transferring at least one of reservation information and a document related to a print reservation to the other computer.

64. A computer readable recording medium that stores the computer program as claimed in claim 63.

65. A service providing apparatus, comprising:
a screen data providing unit that provides data related to a screen to a user terminal in response to a request from the user terminal; and
a print reservation request transmission unit that transmits a reservation request to a print environment sharing service providing unit in response to the request from the user terminal,
wherein
the service providing apparatus is included in a print environment sharing service providing system, the system further including:
at least one print environment sharing service providing unit including a print environment sharing'service providing unit that provides a sharing service of a print environment; and
the user terminal.

66. The service providing apparatus as claimed in claim 65,
wherein
the screen is a document selection screen for selecting at least one of a print reservation and a document.

67. The service providing apparatus as claimed in claim 65,
wherein
the screen is a document overview screen that displays an overview of print reservations or documents to be printed.

68. The service providing apparatus, as claimed in claim 65,
wherein
the screen is a print location selection screen for selecting a print location.

69. The service providing apparatus as claimed in claim 65,
wherein
the screen is a map screen related to a print location.

70. The service providing apparatus as claimed in claim 65,
wherein
the screen is a printer selection screen for selecting a printer.

71. The service providing apparatus as claimed in claim 65,
wherein
the screen is a print condition selection screen for selecting a print condition.

72. The service providing apparatus as claimed in claim 65,
wherein
the print environment sharing service providing unit adds, in response to receipt of a connection request from another print environment sharing service providing unit, data related to the other print environment sharing service providing unit to service data including data related to other print environment service providing units to which the print environment sharing service providing unit can refer.

73. The service providing apparatus as claimed in claim 65,
wherein
the print environment sharing service providing unit deletes, in response to receipt of a disconnection request from another print environment sharing service providing unit, data related to the other print environment sharing service providing unit to service data including data related to other print environment service providing units to which the print environment sharing service providing unit can refer.

74. The service providing apparatus as claimed in claim 72,
wherein
the data related to the other sharing unit added to the service data are managed as one of upper level data, same level data, and lower level data depending on a relation between the print environment sharing service unit and the other print environment sharing service unit.

75. The service providing apparatus as claimed in claim 65, further comprising:
a service data acquisition unit that acquires, in response to a request from the user terminal, service data including data related to referential relations between print environment sharing service providing units from the print environment sharing service providing units.

76. The service providing apparatus as claimed in claim 65, further comprising:
a printer data acquisition unit that acquires, in response to receipt of a request from the user terminal, printer data including data related to printers to which the print environment sharing service providing unit can refer from the print environment sharing service providing unit.

77. The service providing apparatus as claimed in claim 65, further comprising:
a function information acquisition unit that acquires, in response to receipt of a request from the user terminal, function information related to functions of printers from the print environment sharing service providing unit.

78. The service providing apparatus as claimed in claim 65, further comprising:
a document use permission information acquisition unit that acquires, in response to receipt of a request from the user terminal, document use permission information for permitting the use of the document from a document management service providing unit that provides a service related to management of documents.

79. The service providing apparatus as claimed in claim 78, further comprising the document management service providing unit.

80. The service providing apparatus as claimed in claim 78, further comprising a document storage unit that stores the document.

81. The service providing apparatus as claimed in claim 65, further comprising:
a print start request transmitting unit that transmits, in response to receipt of a request from the user terminal, a request to start printing, to the print environment sharing service providing unit.

82. The service providing apparatus as claimed in claim 65, further comprising the print environment sharing service providing unit.

83. The service providing apparatus as claimed in claim 65, further comprising a print service providing unit that provides a print service.

84. The service providing unit as claimed in claim 65, further comprising a print unit.

85. A method of providing a service for sharing a print environment, comprising the steps of:
providing data related to a screen to a user terminal in response to a request from the user terminal; and
transmitting a reservation request to a print environment sharing service providing unit in response to the request from the user terminal,
wherein
the service providing apparatus is included in a print environment sharing service providing system, the system further including:
at least one print environment sharing service providing unit including a print environment sharing service providing unit that provides a sharing service of print environment; and
the user terminal.

86. The method as claimed in claim 85,
wherein
the screen is a document selection screen for selecting at least one of a print reservation and a document.

87. The method as claimed in claim 85,
wherein
the screen is a document overview screen that displays an overview of print reservations or documents to be printed.

88. The method as claimed in claim 85,
wherein
the screen is a print location selection screen for selecting a print location.

89. The method as claimed in claim 85,
wherein
the screen is a map screen related to a print location.

90. The method as claimed in claim 85,
wherein
the screen is a printer selection screen for selecting a printer.

91. The method as claimed in claim 85,
wherein
the screen is a print condition selection screen for selecting a print condition.

92. The apparatus as claimed in claim 85,
wherein
the print environment sharing service providing unit adds, in response to receipt of a connection request from another print environment sharing service providing unit, data related to the other print environment sharing service providing unit to service data including data related to other print environment service providing units to which the print environment sharing service providing unit can refer.

93. The method as claimed in claim 85,
wherein
the print environment sharing service providing unit deletes, in response to receipt of a disconnection request from another print environment sharing service providing unit, data related to the other print environment sharing service providing unit to service data including data related to other print environment service providing units to which the print environment sharing service providing unit can refer.

94. The method as claimed in claim 92,
wherein
the data related to the other sharing unit added to the service data are managed as one of upper level data, same level data, and lower level data depending on a relation between the print environment sharing service unit and the other print environment sharing service unit.

95. The method as claimed in claim 85,
wherein
the service providing apparatus further comprises the print environment sharing service providing unit.

96. A computer program that causes a computer to perform the method as claimed in claim 85.

97. A computer readable recording medium that stores the computer program as claimed in claim 96.

98. The apparatus as claimed in claim 37, further comprising a printer data storage unit that stores the printer data.

99. The method as claimed in claim 46, further comprising the step of transmitting a reservation request about printing.

100. The method as claimed in claim 46, further comprising the step of transmitting a print request.

101. The service providing apparatus as claimed in claim 65, further comprising:
a document overview acquisition unit that acquires, in response to receipt of a request from the user terminal, information about a document overview from a document management service providing unit that provides a management service of a document.
